(19) United States
(12) Patent Application Publication
(10) Pub. No.: US 2023/0348634 A1
(43) Pub. Date: Nov. 2, 2023

(54) Propylene Polymers Obtained Using Transition Metal Bis(Phenolate) Catalyst Complexes and Homogeneous Process for Production Thereof

(71) Applicant: ExxonMobil Chemical Patents Inc., Baytown, TX (US)

(72) Inventors: Jo Ann M. Canich, Houston, TX (US); Ru Xie, Baytown, TX (US); Gregory J. Smith-Karahalis, Houston, TX (US); Sarah J. Mattler, League City, TX (US); Mikhail I. Sharikov, Moscow (RU); Alexander Z. Voskoboynikov, Moscow (RU); Vladislav A. Popov, Moscow (RU); Dmitry V. Uborsky, Moscow (RU); Georgy P. Goryunov, Kokoshkino (RU); John R. Hagadorn, Houston, TX (US); Peijun Jiang, Katy, TX (US)

(21) Appl. No.: 17/796,519

(22) PCT Filed: Aug. 11, 2020
(86) PCT No.: PCT/US2020/045820

§ 371 Date: Jul. 29, 2022

Related U.S. Application Data
(60) Provisional application No. 62/972,953, filed on Feb. 11, 2020.

(51) Int. Cl. C08F 4/659; C08F 10/06

(52) U.S. Cl. CPC C08F 4/65912; C08F 10/06; C08F 4/65908

(57) ABSTRACT

This invention relates to a homogeneous process to produce propylene polymers using transition metal complexes of a dianionic, tridentate ligand that features a central neutral heterocyclic Lewis base and two phenolate donors, where the tridentate ligand coordinates to the metal center to form two eight-membered rings. Preferably the bis(phenolate) complexes are represented by Formula (I):

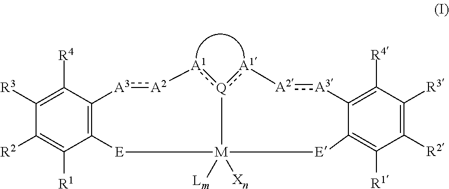

where M, L, X, m, n, E, E′, Q, R¹, R², R³, R⁴, R^{1′}, R^{2′}, R^{3′}, R^{4′}, A¹, A^{1′},

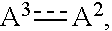

and

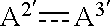

are as defined herein, where A¹QA^{1′} are part of a heterocyclic Lewis base containing 4 to 40 non-hydrogen atoms that links A² to A^{2′} via a 3-atom bridge with Q being the central atom of the 3-atom bridge.

### PRIORITY

This application claims priority to and the benefit of U.S. Ser. No. 62/972,953, filed Feb. 11, 2020.

### CROSS REFERENCE TO RELATED APPLICATIONS

This invention is related to:
1) U.S. Ser. No. 16/788,022, filed Feb. 11, 2020;
2) U.S. Ser. No. 16/788,088, filed Feb. 11, 2020;
3) U.S. Ser. No. 16/788,124, filed Feb. 11, 2020;
4) U.S. Ser. No. 16/787,909, filed Feb. 11, 2020;
5) U.S. Ser. No. 16/787,837, filed Feb. 11, 2020;
6) concurrently filed PCT application number PCT/US2020/______ entitled “Propylene Copolymers Obtained Using Transition Metal Bis(Phenolate) Catalyst Complexes and Homogeneous Process for Production Thereof” (attorney docket number 2020EM048);
8) concurrently filed PCT application number PCT/US2020/______ entitled “Ethylene-Alpha-Olefin-Diene Monomer Copolymers Obtained Using Transition Metal Bis(Phenolate) Catalyst Complexes and Homogeneous Process for Production Thereof” (attorney docket number 2020EM050);
9) concurrently filed PCT application number PCT/US2020/______ entitled “Polyethylene Compositions Obtained Using Transition Metal Bis(Phenolate) Catalyst Complexes and Homogeneous Process for Production Thereof” (attorney docket number 2020EM051).

### FIELD OF THE INVENTION

This invention relates propylene polymers prepared using novel catalyst compounds comprising group 4 bis(phenolate) complexes, compositions comprising such, and processes to prepare such propylene polymers.

### BACKGROUND OF THE INVENTION

Olefin polymerization catalysts are of great use in industry. Hence there is interest in finding new catalyst systems that increase the commercial usefulness of the catalyst and allow the production of polymers having improved properties.

Catalysts for olefin polymerization can be based on bis(phenolate) complexes as catalyst precursors, which are activated typically by an alumoxane or an activator containing a non-coordinating anion. Examples of bis(phenolate) complexes can be found in the following references:
KR 2018-022137 (LG Chem.) describes transition metal complexes of bis(methylphenyl phenolate)pyridine.
U.S. Pat. No. 7,030,256 B2 (Symyx Technologies, Inc.) describes bridged bi-aromatic ligands, catalysts, processes for polymerizing and polymers therefrom.
U.S. Pat. No. 6,825,296 (University of Hong Kong) describes transition metal complexes of bis(phenolate) ligands that coordinate to metal with two 6-membered rings.
U.S. Pat. No. 7,847,099 (California Institute of Technology) describes transition metal complexes of bis(phenolate) ligands that coordinate to metal with two 6-membered rings.
WO 2016/172110 (Univation Technologies) describes complexes of tridentate bis(phenolate) ligands that feature a non-cyclic ether or thioether donor.

Other references of interest include: Baier, M. C. (2014) “Post-Metallocenes in the Industrial Production of Polyolefins,” Angew. Chem. Int. Ed. 2014, v. 53, pp. 9722-9744; and Golisz, S. et al. (2009) “Synthesis of Early Transition Metal Bisphenolate Complexes and Their Use as Olefin Polymerization Catalysts,” Macromolecules, v. 42(22), pp. 8751-8762.

New catalysts capable of polymerizing olefins to yield high molecular weight and/or high tacticity polymers at high process temperatures are desirable for the industrial production of polyolefins. There is still a need in the art for new and improved catalyst systems for the polymerization of olefins, in order to achieve specific polymer properties, such as high molecular weight and/or high tacticity polymers, preferably at high process temperatures.

Further, it is advantageous to conduct commercial solution polymerization reactions at elevated temperatures. Major catalyst limitations often preventing access to such high temperature polymerizations are the catalyst efficiency, molecular weight of produced polymers, and for propylene homo-polymerization, high polymer crystallinity. All of these factors typically decrease with rising reactor temperature. Typical metallocene catalysts suitable for use in producing isotactic polypropylene require lower process temperatures to achieve a desired polymer crystallinity.

The newly developed single-site catalyst described herein and in related U.S. Ser. No. 16/787,909 filed Feb. 11, 2020 entitled “Transition Metal Bis(Phenolate) Complexes and Their Use as Catalysts for Olefin Polymerization,” (attorney docket number 2020EM045), has the capability of producing high molecular weight and highly crystalline isotactic polypropylene at elevated polymerization temperatures. These catalysts, when paired with various types of activators and used in a solution process can produce propylene based polymers with high crystallinity and molecular weight, among other things. Further, the catalyst activity is high which facilitates use in commercially relevant process conditions. This new process provides new propylene polymers having high crystallinity that can be produced with increased reactor throughput and at higher polymerization temperatures during polymer production.

### SUMMARY OF THE INVENTION

This invention relates to propylene polymers, such as propylene homopolymers, propylene copolymers with C₄ and higher alpha olefins, and blends comprising such propylene polymers, where the propylene polymers are prepared in a solution process using transition metal catalyst complexes of a dianionic, tridentate ligand that features a central neutral heterocyclic Lewis base and two phenolate donors, where the tridentate ligand coordinates to the metal center to form two eight-membered rings.

This invention also relates to propylene homopolymers, such as isotactic propylene polymers, isotactic propylene copolymers with C₄ and higher alpha olefins, and blends comprising such propylene polymers, where the propylene polymers are, prepared in a solution process using bis(phenolate) complexes represented by Formula (I):

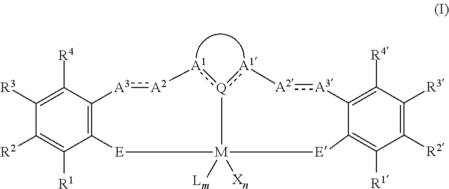

wherein:
M is a group 3-6 transition metal or Lanthanide;
E and E′ are each independently O, S, or NR⁹, where R⁹ is independently hydrogen, C₁-C₄₀ hydrocarbyl, C₁-C₄₀ substituted hydrocarbyl, or a heteroatom-containing group;
Q is group 14, 15, or 16 atom that forms a dative bond to metal M;
A¹QA^{1′} are part of a heterocyclic Lewis base containing 4 to 40 non-hydrogen atoms that links A² to A^{2′} via a 3-atom bridge with Q being the central atom of the 3-atom bridge, A¹ and A^{1′} are independently C, N, or C(R²²), where R²² is selected from hydrogen, C₁-C₂₀ hydrocarbyl, C₁-C₂₀ substituted hydrocarbyl;

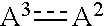

is a divalent group containing 2 to 40 non-hydrogen atoms that links A¹ to the E-bonded aryl group via a 2-atom bridge;

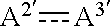

is a divalent group containing 2 to 40 non-hydrogen atoms that links A^{1′} to the E′-bonded aryl group via a 2-atom bridge;
L is a neutral Lewis base;
X is an anionic ligand;
n is 1, 2 or 3;
m is 0, 1, or 2;
n+m is not greater than 4;
each of R¹, R², R³, R⁴, R^{1′}, R^{2′}, R^{3′}, and R^{4′} is independently hydrogen, C₁-C₄₀ hydrocarbyl, C₁-C₄₀ substituted hydrocarbyl, a heteroatom or a heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings;
any two L groups may be joined together to form a bidentate Lewis base;
an X group may be joined to an L group to form a monoanionic bidentate group;
any two X groups may be joined together to form a dianionic ligand group.

This invention also relates to a solution phase method to polymerize olefins comprising contacting a catalyst compound as described herein with an activator. This invention further relates to propylene polymer compositions produced by the methods described herein.

### BRIEF DESCRIPTION OF THE DRAWINGS

FIG. 1 is a graph of the polymerization temperature (° C.) vs. polypropylene Tm (° C.) for polymer samples produced in a continuous polymerization unit.

### DEFINITIONS

For the purposes of this invention and the claims thereto, the following definitions shall be used:

The new numbering scheme for the Periodic Table Groups is used as described in Chemical And Engineering News, v. 63(5), pg. 27 (1985). Therefore, a “group 4 metal” is an element from group 4 of the Periodic Table, e.g. Hf, Ti, or Zr.

“Catalyst productivity” is a measure of the mass of polymer produced using a known quantity of polymerization catalyst. Typically, “catalyst productivity” is expressed in units of (g of polymer)/(g of catalyst) or (g of polymer)/(mmols of catalyst) or the like. If units are not specified then the “catalyst productivity” is in units of (g of polymer)/(g of catalyst). For calculating catalyst productivity only the weight of the transition metal component of the catalyst is used (i.e. the activator and/or co-catalyst are omitted). “Catalyst activity” is a measure of the mass of polymer produced using a known quantity of polymerization catalyst per unit time for batch and semi-batch polymerizations. Typically, “catalyst activity” is expressed in units of (g of polymer)/(mmol of catalyst)/hour or (kg of polymer)/(mmols of catalyst)/hour or the like. If units are not specified then the “catalyst activity” is in units of (g of polymer)/(mmol of catalyst)/hour.

“Conversion” is the percentage of a monomer that is converted to polymer product in a polymerization, and is reported as % and is calculated based on the polymer yield, the polymer composition, and the amount of monomer fed into the reactor.

An “olefin,” alternatively referred to as “alkene,” is a linear, branched, or cyclic compound of carbon and hydrogen having at least one double bond. For purposes of this specification and the claims appended thereto, when a polymer or copolymer is referred to as comprising an olefin, the olefin present in such polymer or copolymer is the polymerized form of the olefin. For example, when a copolymer is said to have a “propylene” content of 35 wt % to 55 wt %, it is understood that the mer unit in the copolymer is derived from propylene in the polymerization reaction and said derived units are present at 35 wt % to 55 wt %, based upon the weight of the copolymer. A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. Accordingly, the definition of copolymer, as used herein, includes terpolymers and the like. “Different” as used to refer to mer units indicates that the mer units differ from each other by at least one atom or are different isomerically. A “propylene polymer” or “propylene copolymer” is a polymer or copolymer comprising at least 50 mole % propylene derived units, and so on.

An alpha olefin is defined as a linear or branched C₃ or higher olefin containing at least one vinyl (CH₂═CH—) group. Non-limiting examples of alpha olefins include propylene, 1-butene, 1-pentene, 1-hexene, 1-octene, 1-decene, 1-dodecene, 1-tetradecene, 4-methyl-1-pentene, and styrene.

Unless otherwise specified, the term “Cₙ” means hydrocarbon(s) having n carbon atom(s) per molecule, wherein n is a positive integer.

The term “hydrocarbon” means a class of compounds containing hydrogen bound to carbon, and encompasses (i) saturated hydrocarbon compounds, (ii) unsaturated hydrocarbon compounds, and (iii) mixtures of hydrocarbon compounds (saturated and/or unsaturated), including mixtures of hydrocarbon compounds having different values of n. Likewise, a “Cₘ-C_{y}” group or compound refers to a group or compound comprising carbon atoms at a total number thereof in the range from m to y. Thus, a C₁-C₅₀ alkyl group refers to an alkyl group comprising carbon atoms at a total number thereof in the range from 1 to 50.

The terms “group,” “radical,” and “substituent” may be used interchangeably.

The terms “hydrocarbyl radical,” “hydrocarbyl group,” or “hydrocarbyl” may be used interchangeably and are defined to mean a group consisting of hydrogen and carbon atoms only. Preferred hydrocarbyls are C₁-C₁₀₀ radicals that may be linear, branched, or cyclic, and when cyclic, aromatic or non-aromatic. Examples of such radicals include, but are not limited to, alkyl groups such as methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and the like, aryl groups, such as phenyl, benzyl, naphthalen-2-yl, and the like.

Unless otherwise indicated, (e.g., the definition of “substituted hydrocarbyl”, etc.), the term “substituted” means that at least one hydrogen atom has been replaced with at least one non-hydrogen group, such as a hydrocarbyl group, a heteroatom or heteroatom-containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, —(CH₂)_{q}—SiR*₃, and the like, where q is 1 to 10 and each R* is independently hydrogen, a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The term “substituted hydrocarbyl” means a hydrocarbyl radical in which at least one hydrogen atom of the hydrocarbyl radical has been substituted with at least one heteroatom (such as halogen, e.g., Br, Cl, F or I) or heteroatom-containing group (such as a functional group, e.g., —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, —(CH₂)_{q}—SiR*₃, and the like, where q is 1 to 10 and each R* is independently hydrogen, a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

Silylcarbyl radicals are radicals in which one or more hydrocarbyl hydrogen atoms have been substituted with at least one SiR*₃ containing group or where at least one —Si(R*)₂— has been inserted within the hydrocarbyl radical where R* is independently a hydrocarbyl or halocarbyl radical, and two or more R* may join together to form a substituted or unsubstituted saturated, partially unsaturated or aromatic cyclic or polycyclic ring structure.

Substituted silylcarbyl radicals are radicals in which at least one hydrogen atom has been substituted with at least one functional group such as NR*₂, OR*, SeR*, TeR*, PR*₂, AsR*₂, SbR*₂, SR*, BR*₂, GeR*3, SnR*3, PbR*₃ and the like or where at least one non-hydrocarbon atom or group has been inserted within the silylcarbyl radical, such as —O—, —S—, —Se—, —Te—, —N(R*)—, ═N—, —P(R*)—, ═P—, —As(R*)—, ═As—, —Sb(R*)—, ═Sb—, —B(R*)—, ═B—, —Ge(R*)₂—, —Sn(R*)₂—, —Pb(R*)₂— and the like, where R* is independently a hydrocarbyl or halocarbyl radical, and two or more R* may join together to form a substituted or unsubstituted saturated, partially unsaturated or aromatic cyclic or polycyclic ring structure. Substituted silylcarbyl radicals are only bonded via a carbon or silicon atom.

The term “aryl” or “aryl group” means an aromatic ring (typically made of 6 carbon atoms) and the substituted variants thereof, such as phenyl, 2-methyl-phenyl, xylyl, 4-bromo-xylyl. Likewise, heteroaryl means an aryl group where a ring carbon atom (or two or three ring carbon atoms) has been replaced with a heteroatom, such as N, O, or S. As used herein, the term “aromatic” also refers to pseudoaromatic heterocycles which are heterocyclic substituents that have similar properties and structures (nearly planar) to aromatic heterocyclic ligands, but are not by definition aromatic.

The term “substituted aromatic,” means an aromatic group having 1 or more hydrogen groups replaced by a hydrocarbyl, substituted hydrocarbyl, heteroatom or heteroatom containing group.

A “substituted phenolate” is a phenolate group where at least one, two, three, four or five hydrogen atoms in the 2, 3, 4, 5, and/or 6 positions has been replaced with at least one non-hydrogen group, such as a hydrocarbyl group, a heteroatom or heteroatom-containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, —(CH₂)_{q}—SiR*₃, and the like, where q is 1 to 10 and each R* is independently hydrogen, a hydrocarbyl or halocarbyl radical, and two or more R* may join together to form a substituted or unsubstituted completely saturated, partially unsaturated, or aromatic cyclic or polycyclic ring structure), where the 1 position is the phenolate group (Ph-O—, Ph-S—, and Ph-N(R\hat{ })-groups, where R\hat{ } is hydrogen, C₁-C₄₀ hydrocarbyl, C₁-C₄₀ substituted hydrocarbyl, a heteroatom or a heteroatom-containing group). Preferably, a “substituted phenolate” group in the catalyst compounds described herein is represented by the formula:

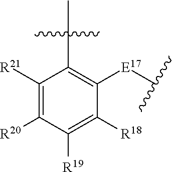

where R¹⁸ is hydrogen, C₁-C₄₀ hydrocarbyl (such as C₁-C₄₀ alkyl) or C₁-C₄₀ substituted hydrocarbyl, a heteroatom or a heteroatom-containing group, E¹⁷ is oxygen, sulfur, or NR¹⁷, and each of R¹⁷, R¹⁹, R²⁰, and R²¹ is independently selected from hydrogen, C₁-C₄₀ hydrocarbyl (such as C₁-C₄₀ alkyl) or C₁-C₄₀ substituted hydrocarbyl, a heteroatom or a heteroatom-containing group, or two or more of R, R¹⁹, R²⁰, and R²¹ are joined together to form a C₄-C₆₂ cyclic or polycyclic ring structure, or a combination thereof, and the wavy lines show where the substituted phenolate group forms bonds to the rest of the catalyst compound.

An “alkyl substituted phenolate” is a phenolate group where at least one, two, three, four or five hydrogen atoms in the 2, 3, 4, 5, and/or 6 positions has been replaced with at least one alkyl group, such as a C₁ to C₄₀, alternately C₂ to C₂₀, alternately C₃ to C₁₂ alkyl, such as methyl, ethyl, methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, adamantanyl and the like including their substituted analogues.

An “aryl substituted phenolate” is a phenolate group where at least one, two, three, four or five hydrogen atoms in the 2, 3, 4, 5, and/or 6 positions has been replaced with at least one aryl group, such as a C₁ to C₄₀, alternately C₂ to C₂₀, alternately C₃ to C₁₂ aryl group, such as phenyl, 4-fluorophenyl, 2-methylphenyl, 2-propylphenyl, 2,6-dimethylphenyl, mesityl, 2-ethylphenyl, naphthalen-2-yl and the like including their substituted analogues.

The term “ring atom” means an atom that is part of a cyclic ring structure. By this definition, a benzyl group has six ring atoms and tetrahydrofuran has 5 ring atoms.

A heterocyclic ring, also referred to as a heterocyclic, is a ring having a heteroatom in the ring structure as opposed to a “heteroatom-substituted ring” where a hydrogen on a ring atom is replaced with a heteroatom. For example, tetrahydrofuran is a heterocyclic ring and 4-N,N-dimethylamino-phenyl is a heteroatom substituted ring. A substituted heterocyclic ring means a heterocyclic ring having 1 or more hydrogen groups replaced by a hydrocarbyl, substituted hydrocarbyl, heteroatom or heteroatom containing group.

A substituted hydrocarbyl ring means a ring comprised of carbon and hydrogen atoms having 1 or more hydrogen groups replaced by a hydrocarbyl, substituted hydrocarbyl, heteroatom or heteroatom containing group.

For purposes of the present disclosure, in relation to catalyst compounds (e.g., substituted bis(phenolate) catalyst compounds), the term “substituted” means that a hydrogen group has been replaced with a hydrocarbyl group, a heteroatom or heteroatom-containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, —(CH₂)_{q}—SiR*3, and the like, where q is 1 to 10 and each R* is independently hydrogen, a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

A tertiary hydrocarbyl group possesses a carbon atom bonded to three other carbon atoms. When the hydrocarbyl group is an alkyl group, tertiary hydrocarbyl groups are also referred to as tertiary alkyl groups. Examples of tertiary hydrocarbyl groups include tert-butyl, 2-methylbutan-2-yl, 2-methylhexan-2-yl, 2-phenylpropan-2-yl, 2-cyclohexylpropan-2-yl, 1-methylcyclohexyl, 1-adamantyl, bicyclo[2.2.1]heptan-1-yl and the like. Tertiary hydrocarbyl groups can be illustrated by formula A:

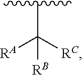

wherein R^{A}, R^{B} and R^{C} are hydrocarbyl groups or substituted hydrocarbyl groups that may optionally be bonded to one another, and the wavy line shows where the tertiary hydrocarbyl group forms bonds to other groups.

A cyclic tertiary hydrocarbyl group is defined as a tertiary hydrocarbyl group that forms at least one alicyclic (non-aromatic) ring. Cyclic tertiary hydrocarbyl groups are also referred to as alicyclic tertiary hydrocarbyl groups. When the hydrocarbyl group is an alkyl group, cyclic tertiary hydrocarbyl groups are also referred to as cyclic tertiary alkyl groups or alicyclic tertiary alkyl groups. Examples of cyclic tertiary hydrocarbyl groups include 1-adamantanyl, 1-methylcyclohexyl, 1-methylcyclopentyl, 1-methylcyclooctyl, 1-methylcyclodecyl, 1-methylcyclododecyl, bicyclo[3.3.1]nonan-1-yl, bicyclo[2.2.1]heptan-1-yl, bicyclo[2.3.3]hexan-1-yl, bicycle[1.1.1]pentan-1-yl, bicycle[2.2.2]octan-1-yl, and the like. Cyclic tertiary hydrocarbyl groups can be illustrated by formula B:

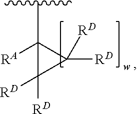

wherein R^{A} is a hydrocarbyl group or substituted hydrocarbyl group, each R^{D} is independently hydrogen or a hydrocarbyl group or substituted hydrocarbyl group, w is an integer from 1 to about 30, and R^{A}, and one or more R^{D}, and or two or more R^{D} may optionally be bonded to one another to form additional rings.

When a cyclic tertiary hydrocarbyl group contains more than one alicyclic ring, it can be referred to as polycyclic tertiary hydrocarbyl group or if the hydrocarbyl group is an alkyl group, it may be referred to as a polycyclic tertiary alkyl group.

The terms “alkyl radical,” and “alkyl” are used interchangeably throughout this disclosure. For purposes of this disclosure, “alkyl radical” is defined to be C₁-C₁₀₀ alkyls that may be linear, branched, or cyclic. Examples of such radicals can include methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and the like including their substituted analogues. Substituted alkyl radicals are radicals in which at least one hydrogen atom of the alkyl radical has been substituted with at least a non-hydrogen group, such as a hydrocarbyl group, a heteroatom or heteroatom-containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, —(CH₂)_{q}—SiR*₃, and the like, where q is 1 to 10 and each R* is independently hydrogen, a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

Where isomers of a named alkyl, alkenyl, alkoxide, or aryl group exist (e.g., n-butyl, iso-butyl, sec-butyl, and tert-butyl) reference to one member of the group (e.g., n-butyl) shall expressly disclose the remaining isomers (e.g., iso-butyl, sec-butyl, and tert-butyl) in the family. Likewise, reference to an alkyl, alkenyl, alkoxide, or aryl group without specifying a particular isomer (e.g., butyl) expressly discloses all isomers (e.g., n-butyl, iso-butyl, sec-butyl, and tert-butyl).

As used herein, Mn is number average molecular weight, Mw is weight average molecular weight, and Mz is z average molecular weight, wt % is weight percent, and mol % is mole percent. Molecular weight distribution (MWD), also referred to as polydispersity index (PDI), is defined to be Mw divided by Mn. Unless otherwise noted, all molecular weight units (e.g., Mw, Mn, Mz) are g/mol (g mol-1).

The following abbreviations may be used herein: Me is methyl, Et is ethyl, Pr is propyl, cPr is cyclopropyl, nPr is n-propyl, iPr is isopropyl, Bu is butyl, nBu is normal butyl, iBu is isobutyl, sBu is sec-butyl, tBu is tert-butyl, Oct is octyl, Ph is phenyl, MAO is methylalumoxane, dme (also referred to as DME) is 1,2-dimethoxyethane, p-tBu is para-tertiary butyl, TMS is trimethylsilyl, TIBAL is triisobutylaluminum, TNOA and TNOAL are tri(n-octyl)aluminum, p-Me is para-methyl, Bn is benzyl (i.e., CH₂Ph), THF (also referred to as thf) is tetrahydrofuran, RT is room temperature (and is 23° C. unless otherwise indicated), tol is toluene, EtOAc is ethyl acetate, Cbz is Carbazole, and Cy is cyclohexyl. Micromoles may be abbreviated as umol or mol. Microliters may be abbreviated as uL or μL.

A “catalyst system” is a combination comprising at least one catalyst compound and at least one activator. When “catalyst system” is used to describe such a pair before activation, it means the unactivated catalyst complex (precatalyst) together with an activator and, optionally, a co-activator. When it is used to describe such a pair after activation, it means the activated complex and the activator or other charge-balancing moiety. The transition metal compound may be neutral as in a precatalyst, or a charged species with a counter ion as in an activated catalyst system. For the purposes of this invention and the claims thereto, when catalyst systems are described as comprising neutral stable forms of the components, it is well understood by one of ordinary skill in the art, that the ionic form of the component is the form that reacts with the monomers to produce polymers. A polymerization catalyst system is a catalyst system that can polymerize monomers to polymer.

In the description herein, the catalyst may be described as a catalyst, a catalyst precursor, a pre-catalyst compound, catalyst compound or a transition metal compound, and these terms are used interchangeably.

An “anionic ligand” is a negatively charged ligand which donates one or more pairs of electrons to a metal ion. The term “anionic donor” is used interchangeably with “anionic ligand”. Examples of anionic donors in the context of the present invention include, but are not limited to, methyl, chloride, fluoride, alkoxide, aryloxide, alkyl, alkenyl, thiolate, carboxylate, amido, methyl, benzyl, hydrido, amidinate, amidate, and phenyl. Two anionic donors may be joined to form a dianionic group.

A “neutral Lewis base or “neutral donor group” is an uncharged (i.e. neutral) group which donates one or more pairs of electrons to a metal ion. Non-limiting examples of neutral Lewis bases include ethers, thioethers, amines, phosphines, ethyl ether, tetrahydrofuran, dimethylsulfide, triethylamine, pyridine, alkenes, alkynes, allenes, and carbenes. Lewis bases may be joined together to form bidentate or tridentate Lewis bases.

For purposes of this invention and the claims thereto, phenolate donors include Ph-O—, Ph-S—, and Ph-N(R\hat{ })— groups, where R\hat{ } is hydrogen, C₁-C₄₀ hydrocarbyl, C₁-C₄₀ substituted hydrocarbyl, a heteroatom or a heteroatom-containing group, and Ph is optionally substituted phenyl.

### DETAILED DESCRIPTION

This invention relates solution processes to produce propylene polymers using a new catalyst family comprising transition metal complexes of a dianionic, tridentate ligand that features a central neutral donor group and two phenolate donors, where the tridentate ligands coordinate to the metal center to form two eight-membered rings. In complexes of this type it is advantageous for the central neutral donor to be a heterocyclic group. It is particularly advantageous for the heterocyclic group to lack hydrogens in the position alpha to the heteroatom. In complexes of this type it is also advantageous for the phenolates to be substituted with one or more cyclic tertiary alkyl substituents. The use of cyclic tertiary alkyl substituted phenolates is demonstrated to improve the ability of these catalysts to produce high molecular weight polymer.

Complexes of substituted bis(phenolate) ligands (such as adamantanyl-substituted bis(phenolate) ligands) useful herein form active olefin polymerization catalysts when combined with activators, such as non-coordinating anion or alumoxane activators. Useful bis(aryl phenolate)pyridine complexes comprise a tridentate bis(aryl phenolate)pyridine ligand that is coordinated to a group 4 transition metal with the formation of two eight-membered rings.

This invention also relates to solution processes to produce propylene polymers utilizing a metal complex comprising: a metal selected from groups 3-6 or Lanthanide metals, and a tridentate, dianionic ligand containing two anionic donor groups and a neutral Lewis base donor, wherein the neutral Lewis base donor is covalently bonded between the two anionic donors, and wherein the metal-ligand complex features a pair of 8-membered metallocycle rings.

This invention relates to catalyst systems used in solution processes to prepare propylene polymers comprising activator and one or more catalyst compounds as described herein.

This invention also relates to solution processes (preferably at higher temperatures) to polymerize propylene using the catalyst compounds described herein comprising contacting propylene with a catalyst system comprising an activator and a catalyst compound described herein.

This invention also relates to solution processes (preferably at higher temperatures) to copolymerize propylene and at least one C₄-C₂₀ alpha olefin using the catalyst compounds described herein comprising contacting propylene and at least one C₄-C₂₀ alpha olefin with a catalyst system comprising an activator and a catalyst compound described herein.

The present disclosure also relates to a catalyst system comprising a transition metal compound and an activator compound as described herein, to the use of such activator compounds for activating a transition metal compound in a catalyst system for polymerizing propylene, and to processes for polymerizing propylene, the process comprising contacting under polymerization conditions propylene with a catalyst system comprising a transition metal compound and activator compounds, where aromatic solvents, such as toluene, are absent (e.g. present at zero mol % relative to the moles of activator, alternately present at less than 1 mol %, preferably the catalyst system, the polymerization reaction and/or the polymer produced are free of “detectable aromatic hydrocarbon solvent,” such as toluene). For purposes of the present disclosure, “detectable aromatic hydrocarbon solvent” means 1 ppm or more as determined by gas phase chromatography. For purposes of the present disclosure, “detectable toluene” means 1 ppm or more as determined by gas phase chromatography.

The catalyst systems used herein preferably contain 0 ppm (alternately less than 1 ppm) of aromatic hydrocarbon. Preferably, the catalyst systems used herein contain 0 ppm (alternately less than 1 ppm) of toluene.

### Catalyst Compounds

The terms “catalyst”, “compound”, “catalyst compound”, “pre-catalyst” and “complex” may be used interchangeably to describe a transition metal or Lanthanide metal complex that forms an olefin polymerization catalyst when combined with a suitable activator.

The catalyst complexes of the present invention comprise a metal selected from groups 3, 4, 5 or 6 or Lanthanide metals of the Periodic Table of the Elements, a tridentate dianionic ligand containing two anionic donor groups and a neutral heterocyclic Lewis base donor, wherein the heterocyclic donor is covalently bonded between the two anionic donors. Preferably the dianionic, tridentate ligand features a central heterocyclic donor group and two phenolate donors and the tridentate ligand coordinates to the metal center to form two eight-membered rings.

The metal is preferably selected from group 3, 4, 5, or 6 elements. Preferably the metal, M, is a group 4 metal. Most preferably the metal, M, is zirconium or hafnium. When higher crystallinity polypropylene or propylene-alpha-olefin copolymers is desired, M is preferably hafnium.

Preferably the heterocyclic Lewis base donor features a nitrogen or oxygen donor atom. Preferred heterocyclic groups include derivatives of pyridine, pyrazine, pyrimidine, triazine, thiazole, imidazole, thiophene, oxazole, thiazole, furan, and substituted variants of thereof. Preferably the heterocyclic Lewis base lacks hydrogen(s) in the position alpha to the donor atom. Particularly preferred heterocyclic Lewis base donors include pyridine, 3-substituted pyridines, and 4-substituted pyridines.

The anionic donors of the tridentate dianionic ligand may be arylthiolates, phenolates, or anilides. Preferred anionic donors are phenolates. It is preferred that the tridentate dianionic ligand coordinates to the metal center to form a complex that lacks a mirror plane of symmetry. It is preferred that the tridentate dianionic ligand coordinates to the metal center to form a complex that has a two-fold rotation axis of symmetry; when determining the symmetry of the bis(phenolate) complexes only the metal and dianionic tridentate ligand are considered (i.e. ignore remaining ligands).

A group 4 bis(phenolate) catalyst compound is a complex of a group 4 transition metal (Ti, Zr, or Hf) that is coordinated by a di-, tri- or tetradentate ligand that is dianionic, wherein the anionic groups are phenolate anions. Preferred group 4 bis(phenolate) catalyst compounds feature tri- or tetradentate dianionic ligands that coordinate to the group 4 metal in such a fashion that a pair of 7- or 8-membered metallocycle rings are formed. More preferred group 4 bis(phenolate) catalyst complexes feature tridentate dianionic ligands that coordinate to the group 4 metals in such a fashion that a pair of 8-membered metallocycle rings are formed.

The bis(phenolate) ligands useful in the present invention are preferably tridentate dianionic ligands that coordinate to the metal M in such a fashion that a pair of 8-membered metallocycle rings are formed. Preferably, the bis(phenolate) ligands wrap around the metal to form a complex with a 2-fold rotation axis, thus giving the complexes C₂ symmetry. The C₂ geometry and the 8-membered metallocycle rings are features of these complexes that make them effective catalyst components for the production of polyolefins, particularly isotactic poly(alpha olefins). If the ligands were coordinated to the metal in such a manner that the complex had mirror-plane (Cₛ) symmetry, then the catalyst would be expected to produce only atactic poly(alpha olefins); these symmetry-reactivity rules are summarized by Bercaw, J. (2009) Macromolecules, v. 42, pp. 8751-8762. The pair of 8-membered metallocycle rings of the inventive complexes is also a notable feature that is advantageous for catalyst activity, temperature stability, and isoselectivity of monomer enchainment. Related group 4 complexes featuring smaller 6-membered metallocycle rings are known (Macromolecules 2009, v. 42, pp. 8751-8762) to form mixtures of C₂ and Cₛ symmetric complexes when used in olefin polymerizations and are thus not well suited to the production of highly isotactic poly(alpha olefins).

Bis(phenolate) ligands in the present invention feature phenolate groups that are preferably substituted with alkyl, substituted alkyl, aryl, or other groups. It is advantageous that each phenolate group be substituted in the ring position that is adjacent to the oxygen donor atom. It is preferred that substitution at the position adjacent to the oxygen donor atom be an alkyl group containing 1-20 carbon atoms. It is preferred that substitution at the position next to the oxygen donor atom be a non-aromatic cyclic alkyl group with one or more five- or six-membered rings. It is preferred that substitution at the position next to the oxygen donor atom be a cyclic tertiary alkyl group. It is highly preferred that substitution at the position next to the oxygen donor atom be adamantan-1-yl or substituted adamantan-1-yl.

The neutral heterocyclic Lewis base donor is covalently bonded between the two anionic donors via “linker groups” that join the heterocyclic Lewis base to the phenolate groups. The “linker groups” are indicated by (A³A²) and (A^{2′}A^{3′}) in Formula (I). The choice of each linker group may affect the catalyst performance, such as the tacticity of the poly(alpha olefin) produced. Each linker group is typically a C₂-C₄₀ divalent group that is two-atoms in length. One or both linker groups may independently be phenylene, substituted phenylene, heteroaryl, vinylene, or a non-cyclic two-carbon long linker group. When one or both linker groups are phenylene, the alkyl substituents on the phenylene group may be chosen to optimize catalyst performance. Typically, one or both phenylenes may be unsubstituted or may be independently substituted with C₁ to C₂₀ alkyl, such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, or an isomer thereof, such as isopropyl, etc.

This invention further relates to catalyst compounds, and catalyst systems comprising such compounds, represented by the Formula (I):

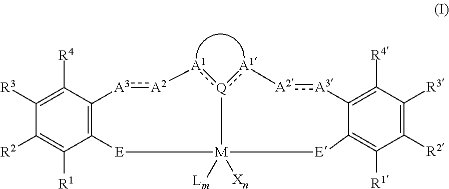

wherein:
M is a group 3, 4, 5, or 6 transition metal or a Lanthanide (such as Hf, Zr or Ti);
E and E′ are each independently O, S, or NR⁹, where R⁹ is independently hydrogen, C₁-C₄₀ hydrocarbyl, C₁-C₄₀ substituted hydrocarbyl, or a heteroatom-containing group, preferably O, preferably both E and E′ are O;
Q is group 14, 15, or 16 atom that forms a dative bond to metal M, preferably Q is C, O, S or N, more preferably Q is C, N or O, most preferably Q is N;
A¹QA^{1′} are part of a heterocyclic Lewis base containing 4 to 40 non-hydrogen atoms that links A² to A^{2′} via a 3-atom bridge with Q being the central atom of the 3-atom bridge (A¹QA^{1′} combined with the curved line joining A¹ and A^{1′} represents the heterocyclic Lewis base),
A¹ and A^{1′} are independently C, N, or C(R²²), where R²² is selected from hydrogen, C₁-C₂₀ hydrocarbyl, and C₁-C₂₀ substituted hydrocarbyl. Preferably A¹ and A^{1′} are C;

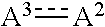

is a divalent group containing 2 to 40 non-hydrogen atoms that links A¹ to the E-bonded aryl group via a 2-atom bridge, such as ortho-phenylene, substituted ortho-phenylene, ortho-arene, indolene, substituted indolene, benzothiophene, substituted benzothiophene, pyrrolene, substituted pyrrolene, thiophene, substituted thiophene, 1,2-ethylene (—CH₂CH₂—), substituted 1,2-ethylene, 1,2-vinylene (—HC═CH—), or substituted 1,2-vinylene, preferably

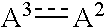

is a divalent hydrocarbyl group;

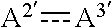

is a divalent group containing 2 to 40 non-hydrogen atoms that links A^{1′} to the E′-bonded aryl group via a 2-atom bridge such as ortho-phenylene, substituted ortho-phenylene, ortho-arene, indolene, substituted indolene, benzothiophene, substituted benzothiophene, pyrrolene, substituted pyrrolene, thiophene, substituted thiophene, 1,2-ethylene (—CH₂CH₂—), substituted 1,2-ethylene, 1,2-vinylene (—HC═CH—), or substituted 1,2-vinylene, preferably

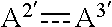

is a divalent hydrocarbyl group;
each L is independently a Lewis base;
each X is independently an anionic ligand;
n is 1, 2 or 3;
m is 0, 1, or 2;
n+m is not greater than 4;
each of R¹, R², R³, R⁴, R^{1′}, R^{2′}, R^{3′}, and R^{4′} is independently hydrogen, C₁-C₄₀ hydrocarbyl, C₁-C₄₀ substituted hydrocarbyl, a heteroatom or a heteroatom-containing group (preferably R^{1′} and R¹ are independently a cyclic group, such as a cyclic tertiary alkyl group), or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings;
any two L groups may be joined together to form a bidentate Lewis base;
an X group may be joined to an L group to form a monoanionic bidentate group;
any two X groups may be joined together to form a dianionic ligand group.

This invention is further related to catalyst compounds, and catalyst systems comprising such compounds, represented by the Formula (II):

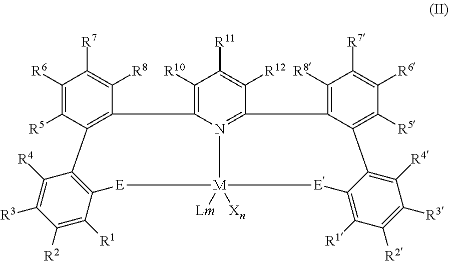

wherein:
M is a group 3, 4, 5, or 6 transition metal or a Lanthanide (such as Hf, Zr or Ti);
E and E′ are each independently O, S, or NR⁹, where R⁹ is independently hydrogen, C₁-C₄₀ hydrocarbyl, C₁-C₄₀ substituted hydrocarbyl, or a heteroatom-containing group, preferably O, preferably both E and E′ are O;
each L is independently a Lewis base;
each X is independently an anionic ligand;
n is 1, 2 or 3;
m is 0, 1, or 2;
n+m is not greater than 4;
each of R¹, R², R³, R⁴, R^{1′}, R^{2′}, R^{3′}, and R^{4′} is independently hydrogen, C₁-C₄₀ hydrocarbyl, C₁-C₄₀ substituted hydrocarbyl, a heteroatom or a heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings;
any two L groups may be joined together to form a bidentate Lewis base;
an X group may be joined to an L group to form a monoanionic bidentate group;
any two X groups may be joined together to form a dianionic ligand group;
each of R⁵, R⁶, R⁷, R⁸, R^{5′}, R^{6′}, R^{7′}; R^{8′}, R¹⁰, R¹¹, and R¹² is independently hydrogen, C₁-C₄₀ hydrocarbyl, C₁-C₄₀ substituted hydrocarbyl, a heteroatom or a heteroatom-containing group, or one or more of R⁵ and R⁶, R⁶ and R⁷, R⁷ and R⁸, R^{5′} and R^{6′}, R^{6′} and R^{7′}, R^{7′} and R^{8′}, R¹⁰ and R¹¹, or R¹¹ and R¹² may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings.

The metal, M, is preferably selected from group 3, 4, 5, or 6 elements, more preferably group 4. Most preferably the metal, M, is zirconium or hafnium.

The donor atom Q of the neutral heterocyclic Lewis base (in Formula (I)) is preferably nitrogen, carbon, or oxygen. Preferred Q is nitrogen.

Non-limiting examples of neutral heterocyclic Lewis base groups include derivatives of pyridine, pyrazine, pyrimidine, triazine, thiazole, imidazole, thiophene, oxazole, thiazole, furan, and substituted variants of thereof. Preferred heterocyclic Lewis base groups include derivatives of pyridine, pyrazine, thiazole, and imidazole.

Each A¹ and A^{1′} of the heterocyclic Lewis base (in Formula (I)) are independently C, N, or C(R²²), where R²² is selected from hydrogen, C₁-C₂₀ hydrocarbyl, and C₁-C₂₀ substituted hydrocarbyl. Preferably A¹ and A^{1′} are carbon. When Q is carbon, it is preferred that A¹ and A^{1′} be selected from nitrogen and C(R²²). When Q is nitrogen, it is preferred that A¹ and A^{1′} be carbon. It is preferred that Q=nitrogen, and A¹=A^{1′}=carbon. When Q is nitrogen or oxygen, is preferred that the heterocyclic Lewis base in Formula (I) not have any hydrogen atoms bound to the A¹ or A^{1′} atoms. This is preferred because it is thought that hydrogens in those positions may undergo unwanted decomposition reactions that reduce the stability of the catalytically active species.

The heterocyclic Lewis base (of Formula (I)) represented by A¹QA^{1′} combined with the curved line joining A¹ and A^{1′} is preferably selected from the following, with each R²³ group selected from hydrogen, heteroatoms, C₁-C₂₀ alkyls, C₁-C₂₀ alkoxides, C₁-C₂₀ amides, and C₁-C₂₀ substituted alkyls.

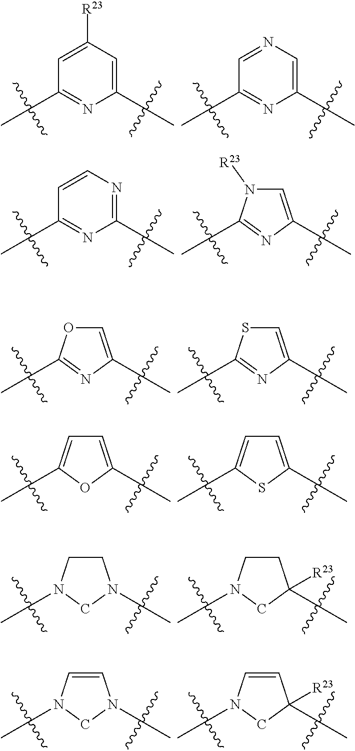

In Formula (I) or (II), E and E′ are each selected from oxygen or NR⁹, where R⁹ is independently hydrogen, C₁-C₄₀ hydrocarbyl, C₁-C₄₀ substituted hydrocarbyl, or a heteroatom-containing group. It is preferred that E and E′ are oxygen. When E and/or E′ are NR⁹ it is preferred that R⁹ be selected from C₁ to C₂₀ hydrocarbyls, alkyls, or aryls. In one embodiment E and E′ are each selected from O, S, or N(alkyl) or N(aryl), where the alkyl is preferably a C₁ to C₂₀ alkyl, such as methyl, ethyl, propyl, butyl, pentyl, hexyl, octyl, nonyl, decyl, undecyl, dodeceyl and the like, and aryl is a C₆ to C₄₀ aryl group, such as phenyl, naphthalen-2-yl, benzyl, methylphenyl, and the like.

In embodiments,

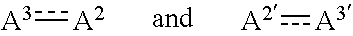

are independently a divalent hydrocarbyl group, such as C₁ to C₁₂ hydrocarbyl group.

In complexes of Formula (I) or (II), when E and E′ are oxygen it is advantageous that each phenolate group be substituted in the position that is next to the oxygen atom (i.e. R¹ and R^{1′} in Formula (I) and (II)). Thus, when E and E′ are oxygen it is preferred that each of R¹ and R^{1′} is independently a C₁-C₄₀ hydrocarbyl, a C₁-C₄₀ substituted hydrocarbyl, a heteroatom or a heteroatom-containing group, more preferably, each of R¹ and R^{1′} is independently a non-aromatic cyclic alkyl group with one or more five- or six-membered rings (such as cyclohexyl, cyclooctyl, adamantanyl, or 1-methylcyclohexyl, or substituted adamantanyl), most preferably a non-aromatic cyclic tertiary alkyl group (such as 1-methylcyclohexyl, adamantanyl, or substituted adamantanyl).

In some embodiments of the invention of Formula (I) or (II), each of R¹ and R^{1′} is independently a tertiary hydrocarbyl group. In other embodiments of the invention of Formula (I) or (II), each of R¹ and R^{1′} is independently a cyclic tertiary hydrocarbyl group. In other embodiments of the invention of Formula (I) or (II), each of R¹ and R^{1′} is independently a polycyclic tertiary hydrocarbyl group.

In some embodiments of the invention of Formula (I) or (II), each of R¹ and R^{1′} is independently a tertiary hydrocarbyl group. In other embodiments of the invention of Formula (I) or (II), each of R¹ and R^{1′} is independently a cyclic tertiary hydrocarbyl group. In other embodiments of the invention of Formula (I) or (II), each of R¹ and R^{1′} is independently a polycyclic tertiary hydrocarbyl group.

The linker groups (i.e.

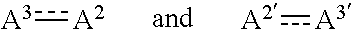

in Formula (I)) are each preferably part of an ortho-phenylene group, preferably a substituted ortho-phenylene group. It is preferred for the R⁷ and R^{7′} positions of Formula (II) to be hydrogen, or C₁ to C₂₀ alkyl, such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, or an isomer thereof, such as isopropyl, etc. For applications targeting polymers with high tacticity it is preferred for the R⁷ and R^{7′} positions of Formula (II) to be a C₁ to C₂₀ alkyl, most preferred for both R⁷ and R^{7′} to be a C₁ to C₃ alkyl.

In embodiments of Formula (I) herein, Q is C, N or O, preferably Q is N.

In embodiments of Formula (I) herein, A¹ and A^{1′} are independently carbon, nitrogen, or C(R²²), with R²² selected from hydrogen, C₁-C₂₀ hydrocarbyl, C₁-C₂₀ substituted hydrocarbyl. Preferably A¹ and A^{1′} are carbon.

In embodiments of Formula (I) herein, A¹QA^{1′} in Formula (I) is part of a heterocyclic Lewis base, such as a pyridine, pyrazine, pyrimidine, triazine, thiazole, imidazole, thiophene, oxazole, thiazole, furan, or a substituted variant of thereof.

In embodiments of Formula (I) herein, A¹QA^{1′} are part of a heterocyclic Lewis base containing 2 to 20 non-hydrogen atoms that links A² to A^{2′} via a 3-atom bridge with Q being the central atom of the 3-atom bridge. Preferably each A¹ and A^{1′} is a carbon atom and the A¹QA^{1′} fragment forms part of a pyridine, pyrazine, pyrimidine, triazine, thiazole, imidazole, thiophene, oxazole, thiazole, furan, or a substituted variant of thereof group, or a substituted variant thereof.

In one embodiment of Formula (I) herein, Q is carbon, and each A¹ and A^{1′} is N or C(R²²), where R²² is selected from hydrogen, C₁-C₂₀ hydrocarbyl, C₁-C₂₀ substituted hydrocarbyl, a heteroatom or a heteroatom-containing group. In this embodiment, the A¹QA^{1′} fragment forms part of a cyclic carbene, N-heterocyclic carbene, cyclic amino alkyl carbene, or a substituted variant of thereof group, or a substituted variant thereof.

In embodiments of formula I herein,

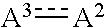

is a divalent group containing 2 to 20 non-hydrogen atoms that links A¹ to the E-bonded aryl group via a 2-atom bridge, where the

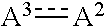

is a linear alkyl or forms part of a cyclic group (such as an optionally substituted ortho-phenylene group, or ortho-arylene group) or a substituted variant thereof.

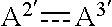

is a divalent group containing 2 to 20 non-hydrogen atoms that links A^{1′} to the E′-bonded aryl group via a 2-atom bridge, where the

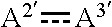

is a linear alkyl or forms part of a cyclic group (such as an optionally substituted ortho-phenylene group, or ortho-arylene group or, or a substituted variant thereof.

In embodiments of the invention herein, in Formula (I) and (II), M is a group 4 metal, such as Hf or Zr.

In embodiments of the invention herein, in Formula (I) and (II), E and E′ are O.

In embodiments of the invention herein, in Formula (I) and (II), R¹, R², R³, R⁴, R^{1′}, R^{2′}, R^{3′}, and R^{4′}is independently hydrogen, C₁-C₄₀ hydrocarbyl, C₁-C₄₀ substituted hydrocarbyl, a heteroatom or a heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings, preferably hydrogen, methyl, ethyl, propyl, butyl, pentyl, hexyl, or an isomer thereof.

In embodiments of the invention herein, in Formula (I) and (II), R¹, R², R³, R⁴, R^{1′}, R^{2′}, R^{3′}, R^{4′}, and R⁹ are independently selected from methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthalen-2-yl, cyclohexyl, cyclohexenyl, methylcyclohexyl, and isomers thereof.

In embodiments of the invention herein, in Formula (I) and (II), R⁴ and R^{4′} is independently hydrogen or a C₁ to C₃ hydrocarbyl, such as methyl, ethyl or propyl.

In embodiments of the invention herein, in Formula (I) and (II), R⁹ is hydrogen, C₁-C₄₀ hydrocarbyl, C₁-C₄₀ substituted hydrocarbyl, or a heteroatom-containing group, preferably hydrogen, methyl, ethyl, propyl, butyl, pentyl, hexyl, or an isomer thereof. Preferably R⁹ is methyl, ethyl, propyl, butyl, C₁ to C₆ alkyl, phenyl, 2-methylphenyl, 2,6-dimethylphenyl, or 2,4,6-trimethylphenyl.

In embodiments of the invention herein, in Formula (I) and (II), each X is, independently, selected from the group consisting of hydrocarbyl radicals having from 1 to 30 carbon atoms (such as alkyls or aryls or alkylaryls), silylcarbyl radicals having from 3 to 30 carbon atoms, hydrides, amides, alkoxides, sulfides, phosphides, halides, alkyl sulfonates, and a combination thereof, (two or more X's may form a part of a fused ring or a ring system), preferably each X is independently selected from halides, aryls, and C₁ to C₅ alkyl groups, C₇ to C₃₀ alkylaryls, preferably each X is independently a hydrido, dimethylamido, diethylamido, methyltrimethylsilyl, neopentyl, phenyl, benzyl, methylbenzyl, ethylbenzyl, propylbenzyl, butylbenzyl (including para-tert-butylbenzyl), 4-hexylbenzyl, 4-octylbenzyl, 4-decylbenzyl, 4-dodecylbenzyl, 4-tetradecylbenzyl, 4-hexadecylbenzyl, 4-octadecylbenzyl, 4-nonadecylbenzyl, 4-icosylbenzyl, 4-heniocosylbenzyl, methylene(trimethylsilane), methylene(triethylsilane), methyl, ethyl, propyl, butyl, pentyl, hexyl, heptyl, octyl, nonyl, decyl, fluoro, iodo, bromo, or chloro group.

Alternatively, each X may be, independently, a halide, a hydride, an alkyl group, an alkenyl group or an arylalkyl group.

In embodiments of the invention herein, in Formula (I) and (II), each L is a Lewis base, independently, selected from the group consisting of ethers, thioethers, amines, nitriles, imines, pyridines, halocarbons, and phosphines, preferably ethers and thioethers, and a combination thereof, optionally two or more L's may form a part of a fused ring or a ring system, preferably each L is independently selected from ether and thioether groups, preferably each L is a ethyl ether, tetrahydrofuran, dibutyl ether, or dimethylsulfide group.

In embodiments of the invention herein, in Formula (I) and (II), R1 and R1′ are independently cyclic tertiary alkyl groups.

In embodiments of the invention herein, in Formula (I) and (II), n is 1, 2 or 3, typically 2.

In embodiments of the invention herein, in Formula (I) and (II), m is 0, 1 or 2, typically 0.

In embodiments of the invention herein, in Formula (I) and (II), R¹ and R^{1′} are not hydrogen.

In embodiments of the invention herein, in Formula (I) and (II), M is Hf or Zr, E and E′ are 0; each of R¹ and R^{1′} is independently a C₁-C₄₀ hydrocarbyl, a C₁-C₄₀ substituted hydrocarbyl, a heteroatom or a heteroatom-containing group, each R², R³, R⁴, R^{2′}, R^{3′}, and R^{4′} is independently hydrogen, C₁-C₂₀ hydrocarbyl, C₁-C₂₀ substituted hydrocarbyl, a heteroatom or a heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings; each X is, independently, selected from the group consisting of hydrocarbyl radicals having from 1 to 20 carbon atoms (such as alkyls or aryls), hydrides, amides, alkoxides, sulfides, phosphides, halides, and a combination thereof, (two or more X's may form a part of a fused ring or a ring system); each L is, independently, selected from the group consisting of ethers, thioethers, and halo carbons (two or more L's may form a part of a fused ring or a ring system).

In embodiments of the invention herein, in Formula (II), each of R⁵, R⁶, R⁷, R⁸, R^{5′}, R^{6′}, R^{7′}, R^{8′}, R¹⁰, R¹¹ and R¹² is independently hydrogen, C₁-C₄₀ hydrocarbyl, C₁-C₄₀ substituted hydrocarbyl, a heteroatom or a heteroatom-containing group, or one or more adjacent R groups may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings.

In embodiments of the invention herein, in Formula (II), each of R⁵, R⁶, R⁷, R⁸, R^{5′}, R^{6′}, R^{7′}, R^{8′}, R¹⁰, R¹¹ and R¹² is independently hydrogen, methyl, ethyl, propyl, butyl, pentyl, hexyl, or an isomer thereof.

In embodiments of the invention herein, in Formula (II), each of R⁵, R⁶, R⁷, R⁸, R^{5′}, R^{6′}, R^{7′}, R^{8′}, R¹⁰, R¹¹ and R¹² is are independently selected from methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthalen-2-yl, cyclohexyl, cyclohexenyl, methylcyclohexyl, and isomers thereof.

In embodiments of the invention herein, in Formula (II), M is Hf or Zr, E and E′ are O; each of R¹ and R^{1′} is independently a C₁-C₄₀ hydrocarbyl, a C₁-C₄₀ substituted hydrocarbyl, a heteroatom or a heteroatom-containing group,
each R¹, R², R³, R⁴, R^{1′}, R^{2′}, R^{3′}, and R^{4′} is independently hydrogen, C₁-C₂₀ hydrocarbyl, C₁-C₂₀ substituted hydrocarbyl, a heteroatom or a heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings; R⁹ is hydrogen, C₁-C₂₀ hydrocarbyl, C₁-C₂₀ substituted hydrocarbyl, or a heteroatom-containing group, such as hydrogen, methyl, ethyl, propyl, butyl, pentyl, hexyl, or an isomer thereof;
each X is, independently, selected from the group consisting of hydrocarbyl radicals having from 1 to 20 carbon atoms (such as alkyls or aryls), hydrides, amides, alkoxides, sulfides, phosphides, halides, dienes, amines, phosphines, ethers, and a combination thereof, (two or more X's may form a part of a fused ring or a ring system); n is 2; m is 0; and each of R⁵, R⁶, R⁷, R⁸, R^{5′}, R^{6′}, R^{7′}, R^{8′}, R¹⁰, R¹¹ and R¹² is independently hydrogen, C₁-C₂₀ hydrocarbyl, C₁-C₂₀ substituted hydrocarbyl, a heteroatom or a heteroatom-containing group, or one or more adjacent R groups may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings, such as each of R⁵, R⁶, R⁷, R⁸, R^{5′}, R^{6′}, R^{7′}, R^{8′}, R¹⁰, R¹¹ and R¹² is are independently selected from methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthyl, cyclohexyl, cyclohexenyl, methylcyclohexyl, and isomers thereof.

Preferred embodiment of Formula (I) is M is Zr or Hf, Q is nitrogen, both A¹ and A^{1′} are carbon, both E and E′ are oxygen, and both R¹ and R^{1′} are C₄-C₂₀ cyclic tertiary alkyls.

Preferred embodiment of Formula (I) is M is Zr or Hf, Q is nitrogen, both A¹ and A^{1′} are carbon, both E and E′ are oxygen, and both R¹ and R^{1′} are adamantan-1-yl or substituted adamantan-1-yl.

Preferred embodiment of Formula (I) is M is Zr or Hf, Q is nitrogen, both A¹ and A^{1′} are carbon, both E and E′ are oxygen, and both R¹ and R^{1′} are C₆-C₂₀ aryls.

Preferred embodiment of Formula (II) is M is Zr or Hf, both E and E′ are oxygen, and both R¹ and R^{1′} are C₄-C₂₀ tertiary hydrocarbyls.

Preferred embodiment of Formula (II) is M is Zr or Hf, both E and E′ are oxygen, and both R¹ and R^{1′} are C₄-C₂₀ cyclic tertiary alkyls.

Preferred embodiment of Formula (II) is M is Zr or Hf, both E and E′ are oxygen, and both R¹ and R^{1′} are adamantan-1-yl or substituted adamantan-1-yl.

Preferred embodiment of Formula (II) is M is Zr or Hf, both E and E′ are oxygen, and each of R¹, R^{1′}, R³ and R^{3′} are adamantan-1-yl or substituted adamantan-1-yl.

Preferred embodiment of Formula (II) is M is Zr or Hf, both E and E′ are oxygen, both R¹ and R^{1′} are C₄-C₂₀ cyclic tertiary alkyls, and both R⁷ and R^{7′} are C₁-C₂₀ alkyls.

In some preferred embodiments of Formula (I) and (II), M is Hf.

Catalyst compounds that are particularly useful in this invention include one or more of: dimethylzirconium[2′,2′″-(pyridine-2,6-diyl)bis(3-adamantan-1-yl)-5-(tert-butyl)-[1,1′-biphenyl]-2-olate)], dimethylhafnium[2′,2′″-(pyridine-2,6-diyl)bis(3-adamantan-1-yl)-5-(tert-butyl)-[1,1′-biphenyl]-2-olate)], dimethylzirconium[6,6′-(pyridine-2,6-diylbis(benzo[b]thiophene-3,2-diyl))bis(2-adamantan-1-yl)-4-methylphenolate)], dimethylhafnium[6,6′-(pyridine-2,6-diylbis(benzo[b]thiophene-3,2-diyl))bis(2-adamantan-1-yl)-4-methylphenolate)], dimethylzirconium[2′,2′″-(pyridine-2,6-diyl)bis(3-((3r,5r,7r)-adamantan-1-yl)-5-methyl-[1,1′-biphenyl]-2-olate)], dimethylhafnium[2′,2′″-(pyridine-2,6-diyl)bis(3-((3r,5r,7r)-adamantan-1-yl)-5-methyl-[1,1′-biphenyl]-2-olate)], dimethylzirconium[2′,2′″-(pyridine-2,6-diyl)bis(3-((3r,5r,7r)-adamantan-1-yl)-4′,5-dimethyl-[1,1′-biphenyl]-2-olate)], dimethylhafnium[2′,2′″-(pyridine-2,6-diyl)bis(3-((3r,5r,7r)-adamantan-1-yl)-4′,5-dimethyl-[1,1′-biphenyl]-2-olate)].

Catalyst compounds that are particularly useful in this invention include those represented by one or more of the formulas:

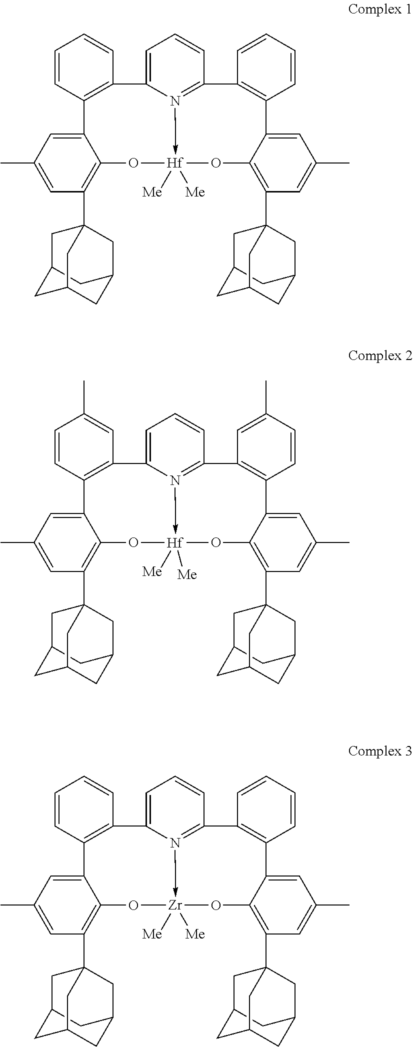

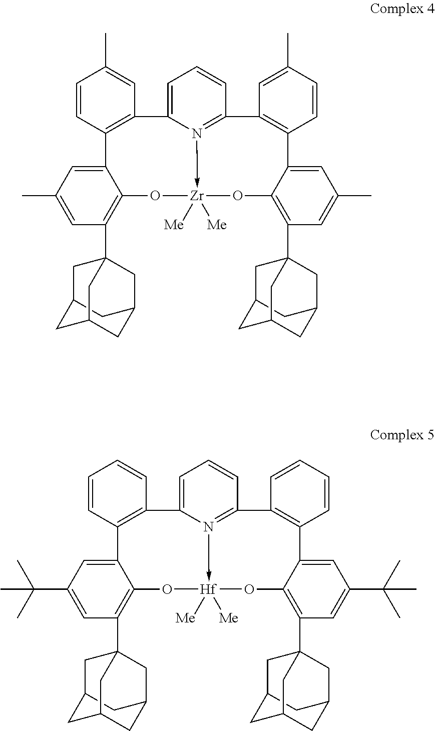

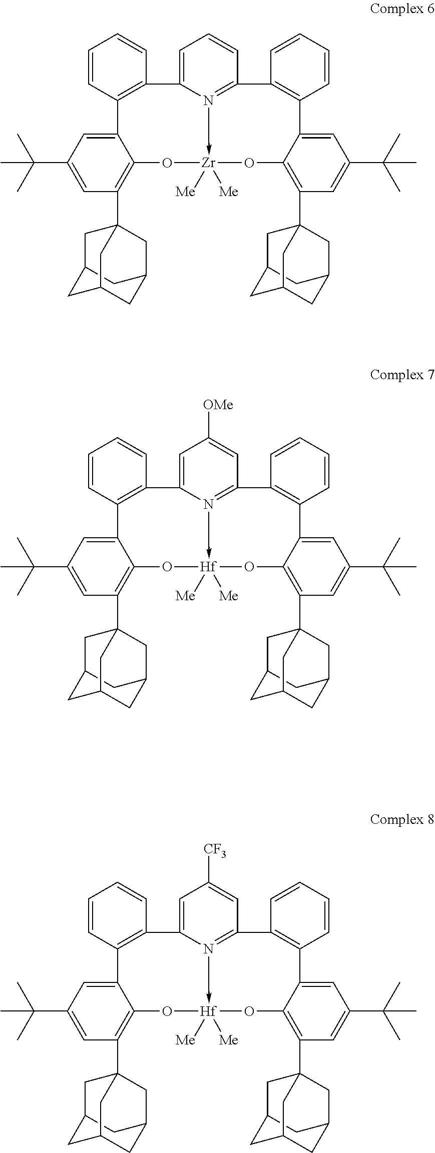

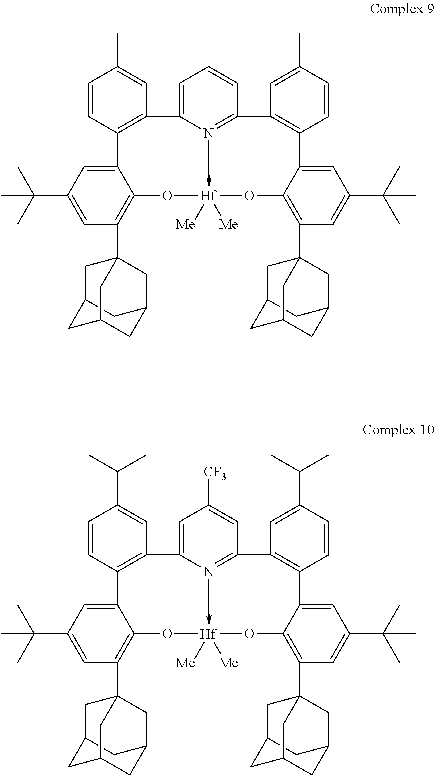

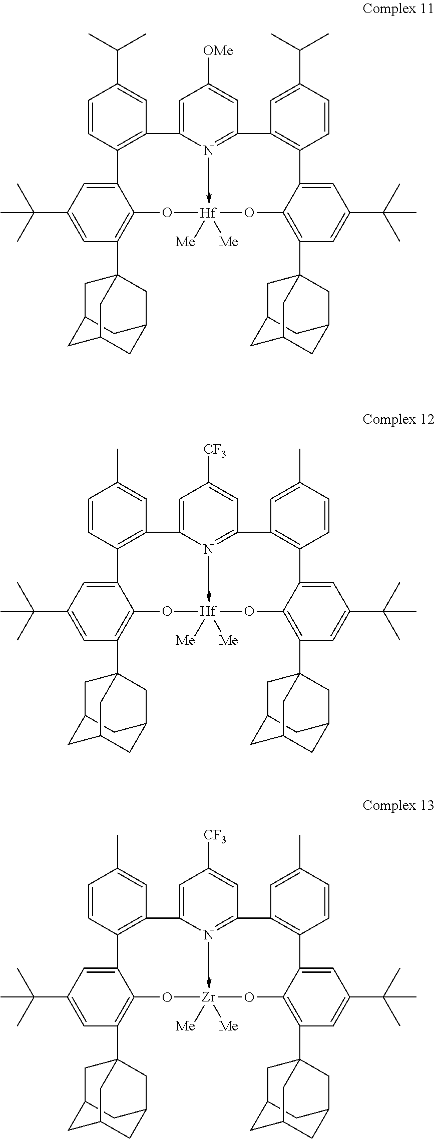

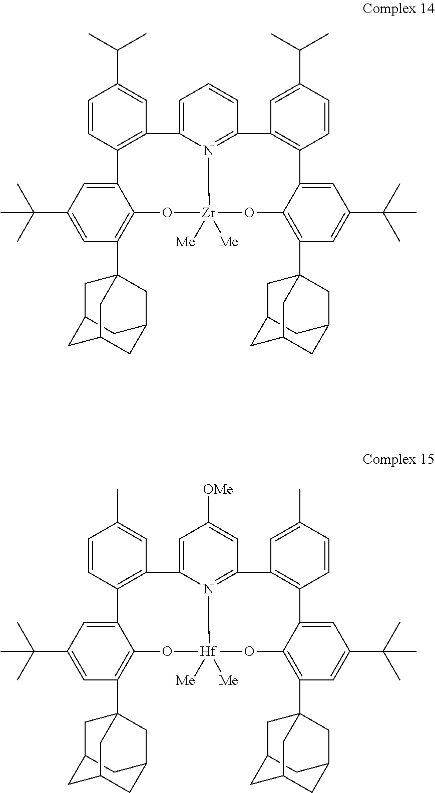

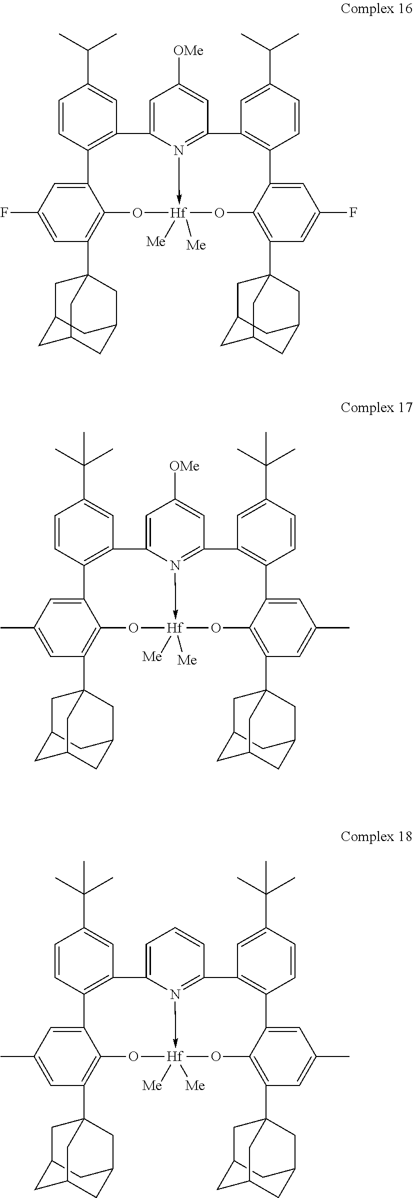

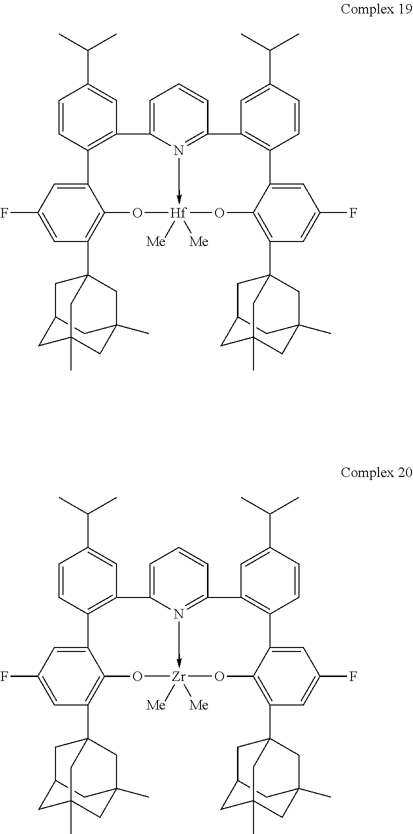

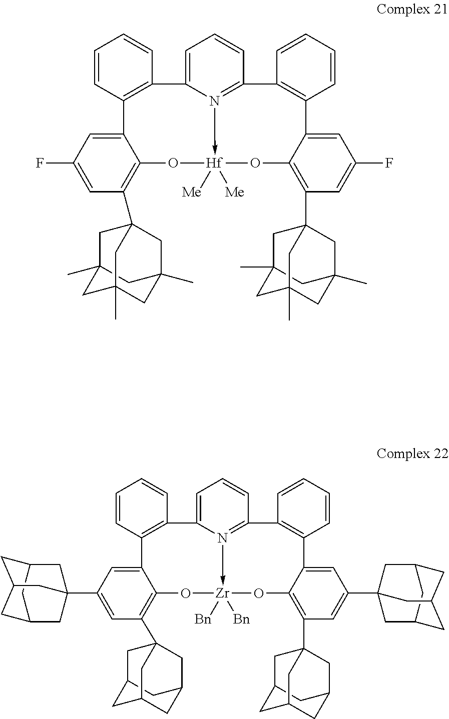

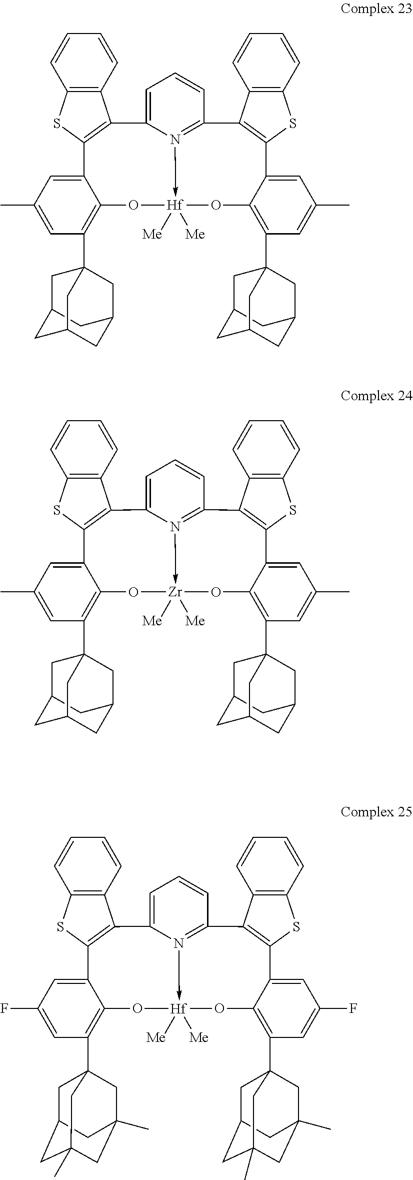

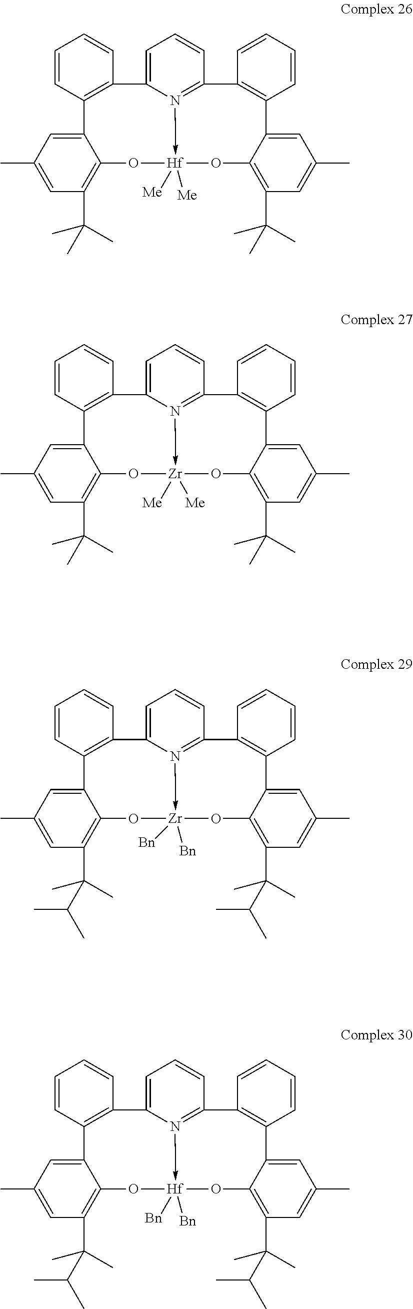

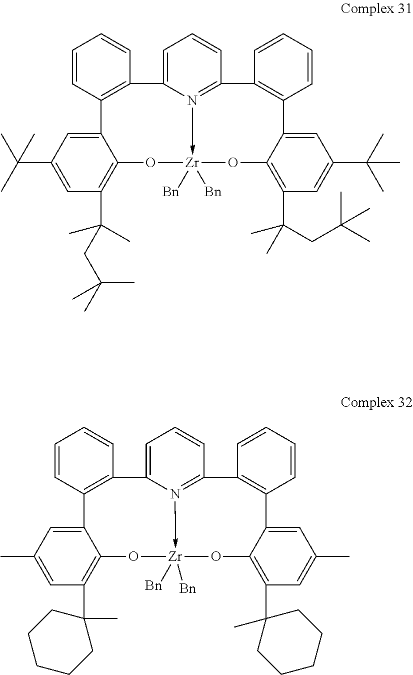

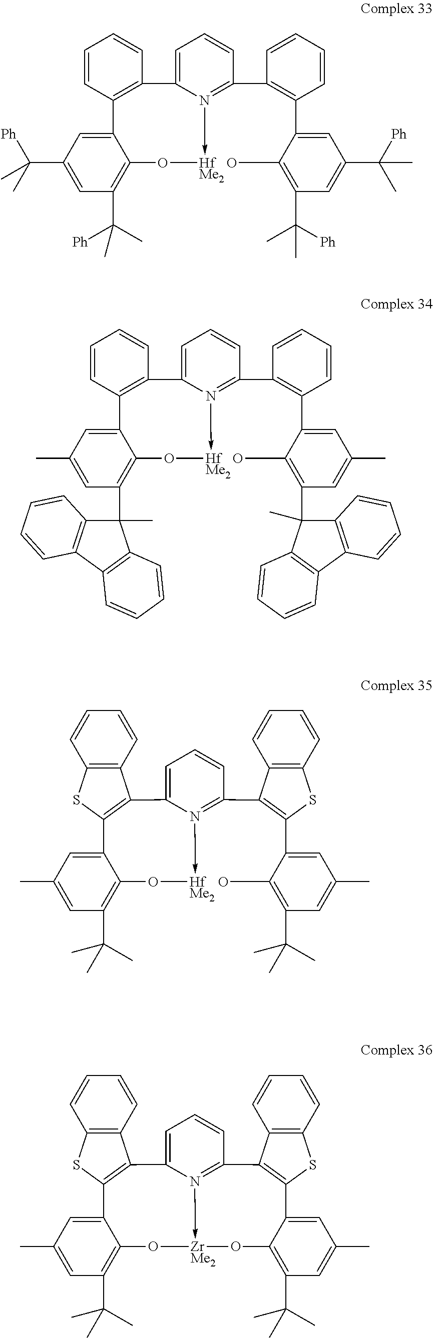

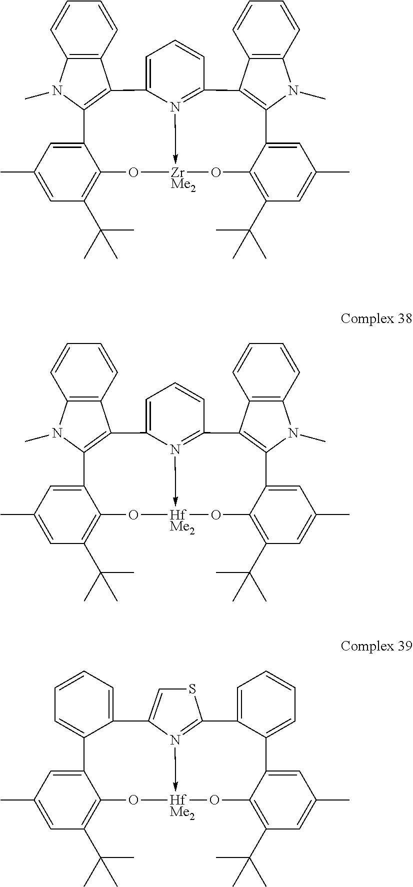

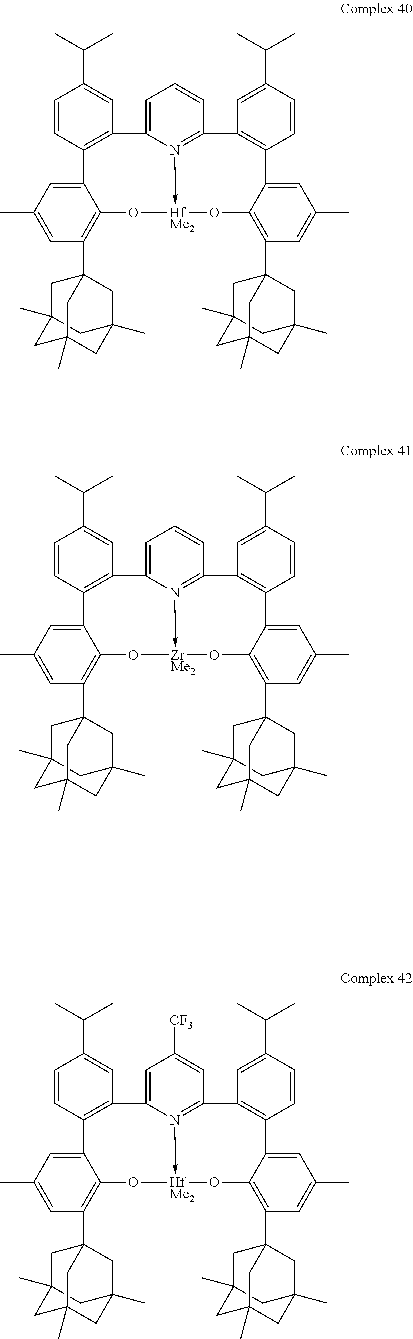

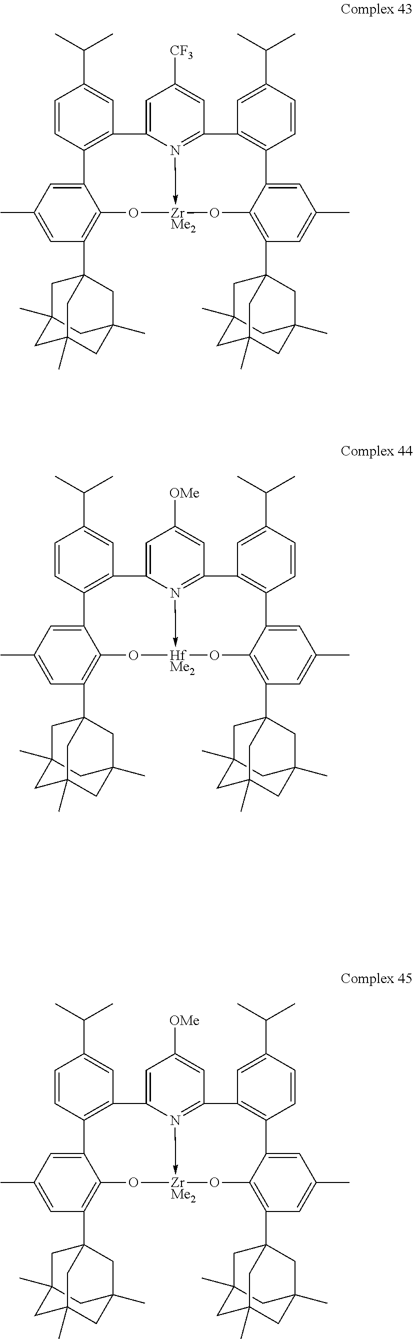

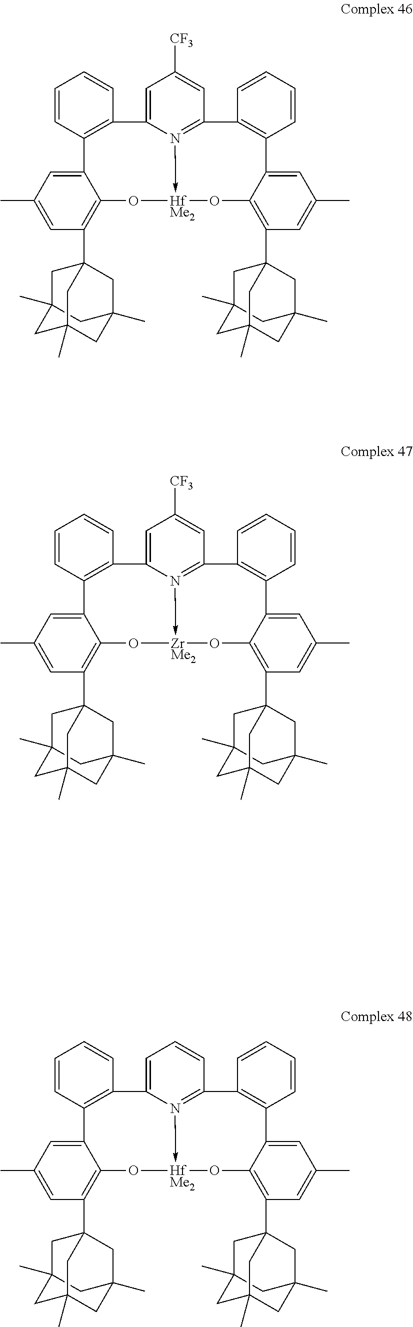

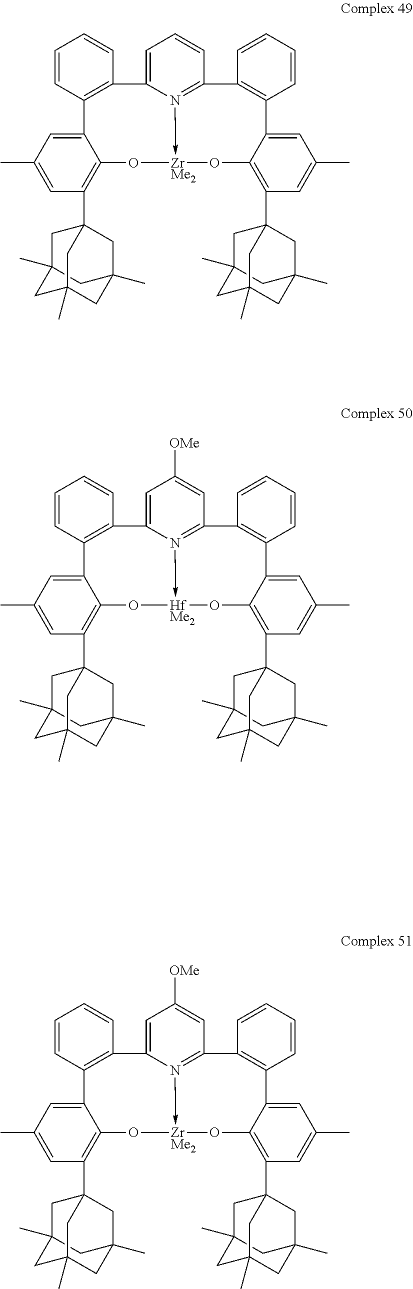

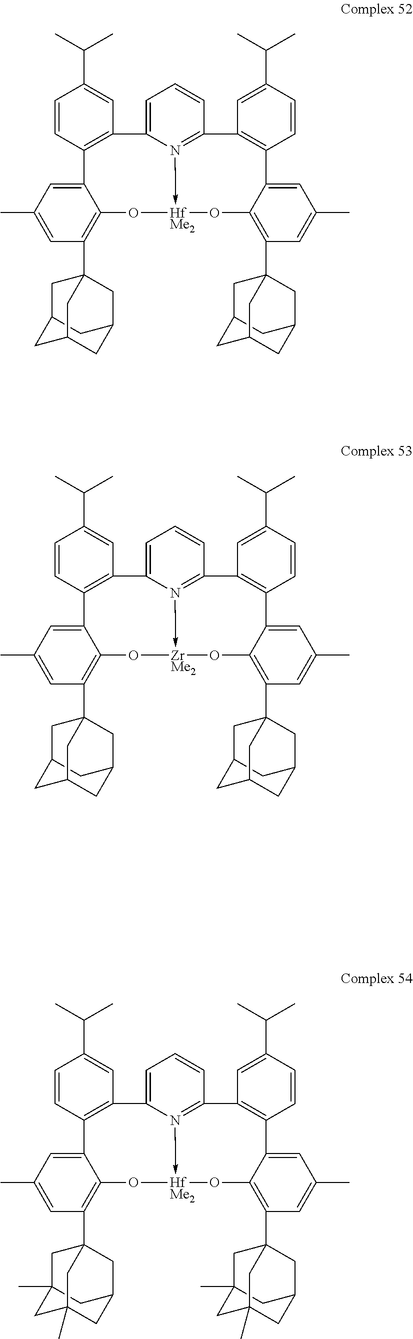

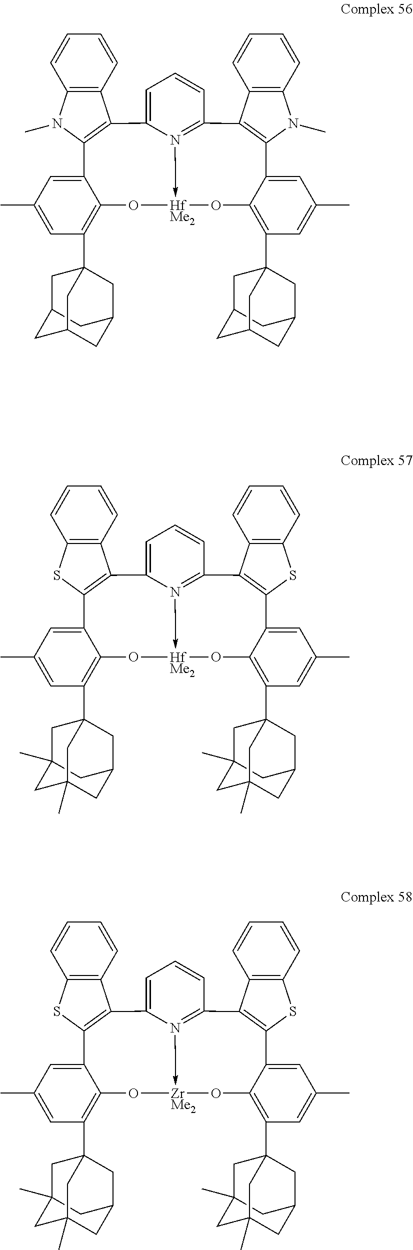

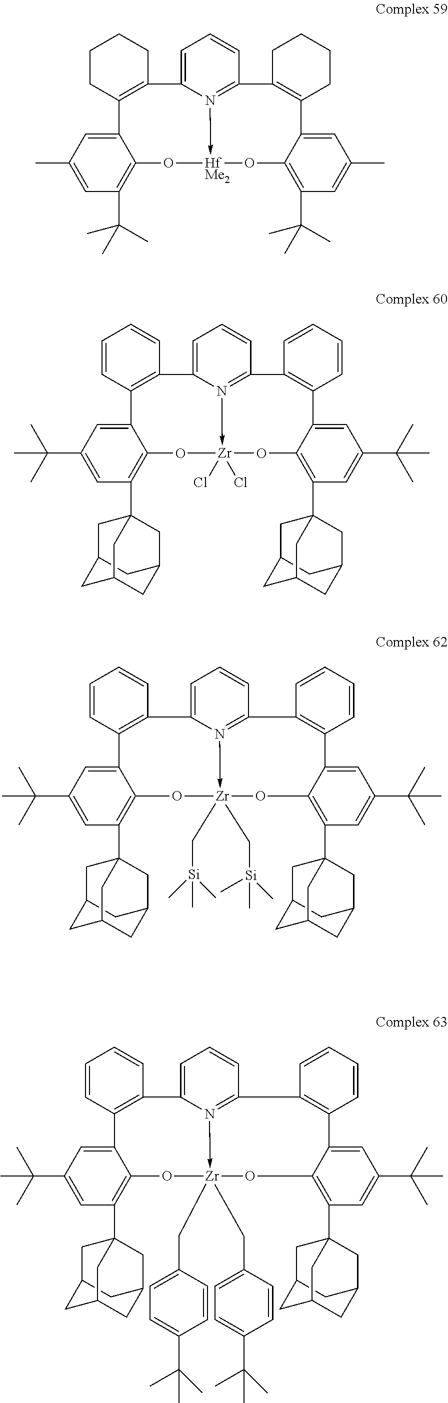

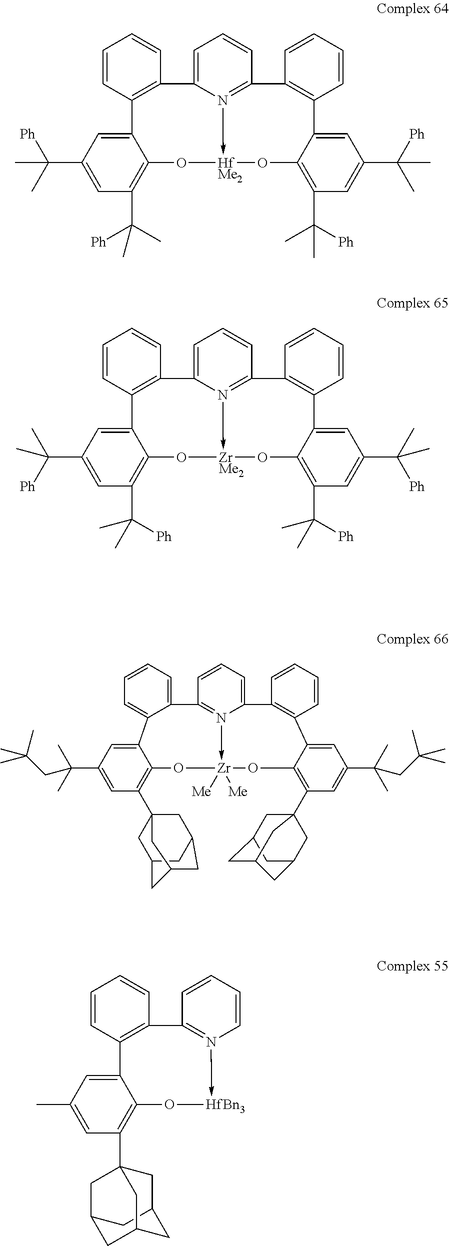

In some embodiments, two or more different catalyst compounds are present in the catalyst system used herein. In some embodiments, two or more different catalyst compounds are present in the reaction zone where the process(es) described herein occur. When two transition metal compound based catalysts are used in one reactor as a mixed catalyst system, the two transition metal compounds are preferably chosen such that the two are compatible. It is preferable to use the same activator for the transition metal compounds, however, two different activators, such as a non-coordinating anion activator and an alumoxane, can be used in combination. If one or more transition metal compounds contain an X group which is not a hydride, hydrocarbyl, or substituted hydrocarbyl, then the alumoxane can be contacted with the transition metal compounds prior to addition of the non-coordinating anion activator.

The two transition metal compounds (pre-catalysts) may be used in any ratio. Preferred molar ratios of (A) transition metal compound to (B) transition metal compound fall within the range of (A:B) 1:1000 to 1000:1, alternatively 1:100 to 500:1, alternatively 1:10 to 200:1, alternatively 1:1 to 100:1, and alternatively 1:1 to 75:1, and alternatively 5:1 to 50:1. The particular ratio chosen will depend on the exact pre-catalysts chosen, the method of activation, and the end product desired. In a particular embodiment, when using the two pre-catalysts, where both are activated with the same activator, useful mole percents, based upon the molecular weight of the pre-catalysts, are 10 to 99.9% A to 0.1 to 90% B, alternatively 25 to 99% A to 0.5 to 50% B, alternatively 50 to 99% A to 1 to 25% B, and alternatively 75 to 99% A to 1 to 10% B.

### Methods to Prepare the Catalyst Compounds.

### Ligand Synthesis

The bis(phenol) ligands may be prepared using the general methods shown in Scheme 1. The formation of the bis(phenol) ligand by the coupling of compound A with compound B (method 1) may be accomplished by known Pd- and Ni-catalyzed couplings, such as Negishi, Suzuki, or Kumada couplings. The formation of the bis(phenol) ligand by the coupling of compound C with compound D (method 2) may also be accomplished by known Pd- and Ni-catalyzed couplings, such as Negishi, Suzuki, or Kumada couplings. Compound D may be prepared from compound E by reaction of compound E with either an organolithium reagent or magnesium metal, followed by optional reaction with a main-group metal halide (e.g. ZnCl₂) or boron-based reagent (e.g. B(OⁱPr)₃, ⁱPrOB(pin)). Compound E may be prepared in a non-catalyzed reaction from by the reaction of an aryllithium or aryl Grignard reagent (compound F) with a dihalogenated arene (compound G), such as 1-bromo-2-chlorobenzene. Compound E may also be prepared in a Pd- or Ni-catalyzed reaction by reaction of an arylzinc or aryl-boron reagent (compound F) with a dihalogenated arene (compound G).

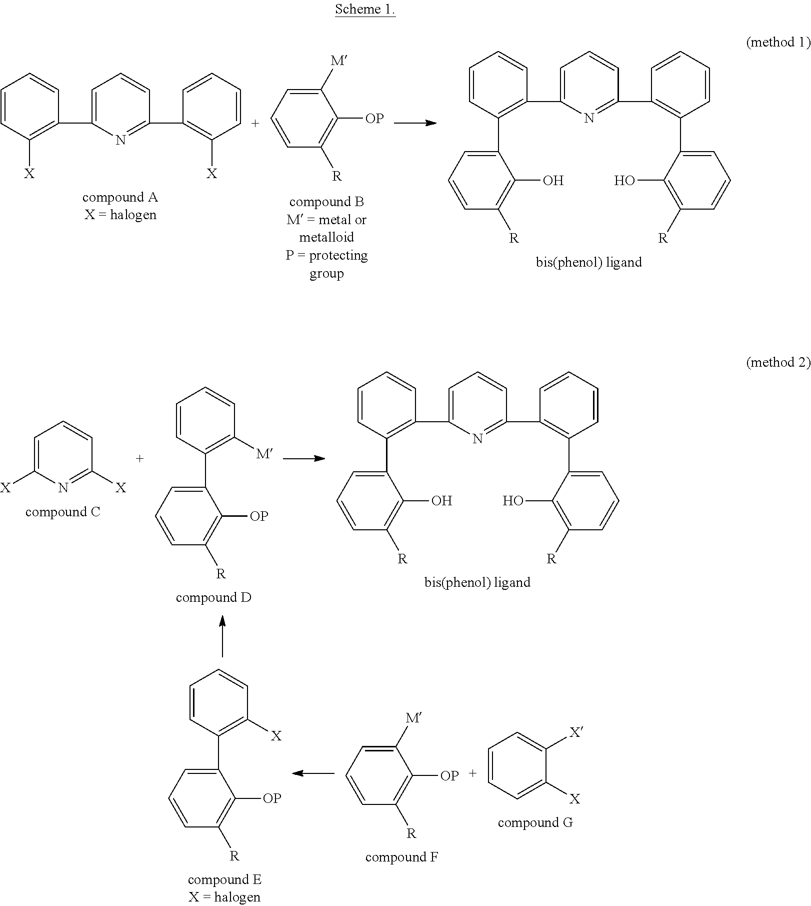

where M′ is a group 1, 2, 12, or 13 element or substituted element such as Li, MgCl, MgBr, ZnCl, B(OH)₂, B(pinacolate), P is a protective group such as methoxymethyl (MOM), tetrahydropyranyl (THP), t-butyl, allyl, ethoxymethyl, trialkylsilyl, t-butyldimethylsilyl, or benzyl, R is a C₁-C₄₀ alkyl, substituted alkyl, aryl, tertiary alkyl, cyclic tertiary alkyl, adamantanyl, or substituted adamantanyl and each X′ and X is halogen, such as Cl, Br, F or I.

### Synthesis of Carbene Bis(Phenol) Ligands

The general synthetic method to produce carbene bis(phenol) ligands is shown in Scheme 2. A substituted phenol can be ortho-brominated then protected by a known phenol protecting group, such as MOM, THP, t-butyldimethylsilyl (TBDMS), benzyl (Bn), etc. The bromide is then converted to a boronic ester (compound I) or boronic acid which can be used in a Suzuki coupling with bromoaniline. The biphenylaniline (compound J) can be bridged by reaction with dibromoethane or condensation with oxalaldehyde, then deprotected (compound K). Reaction with triethyl orthoformate forms an iminium salt that is deprotonated to a carbene.

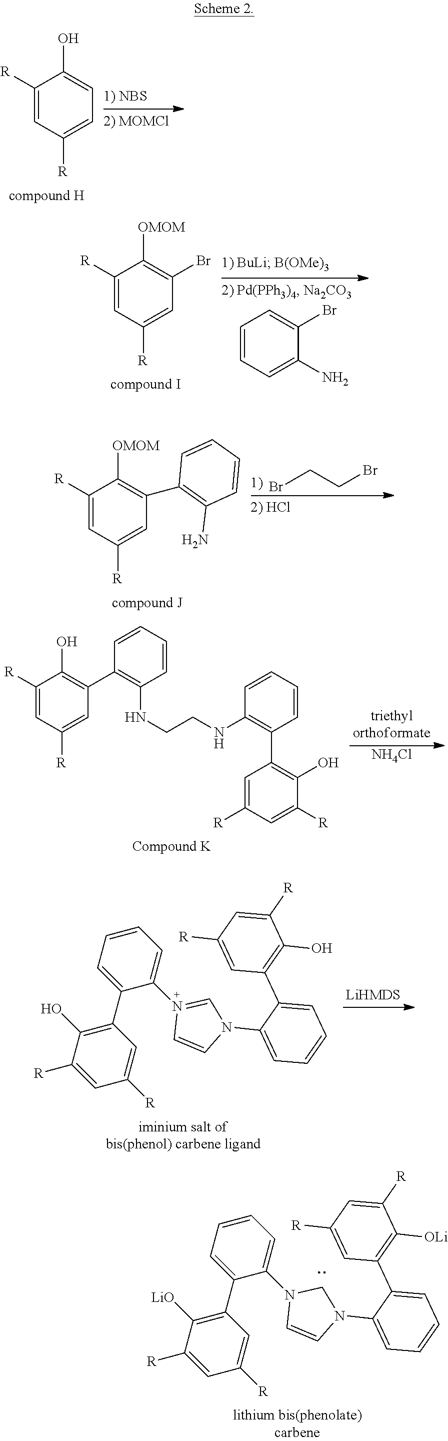

To substituted phenol (compound H) dissolved in methylene chloride, is added an equivalent of N-bromosuccinimide and 0.1 equivalent of diisopropylamine. After stirring at ambient temperature until completion, the reaction is quenched with a 10% solution of HCl. The organic portion is washed with brine, dried over magnesium sulfate, filtered, and concentrated under reduced pressure to give a bromophenol, typically as a solid. The substituted bromophenol, methoxymethylchloride, and potassium carbonate are dissolved in dry acetone and stirred at ambient temperature until completion of the reaction. The solution is filtered and the filtrate concentrated to give protected phenol (compound I). Alternatively, the substituted bromophenol and an equivalent of dihydropyran is dissolved in methylene chloride and cooled to 0° C. A catalytic amount of para-toluenesulfonic acid is added and the reaction stirred for 10 min, then quenched with trimethylamine. The mixture is washed with water and brine, then dried over magnesium sulfate, filtered, and concentrated under reduced pressure to give a tetrahydropyran-protected phenol.

Aryl bromide (compound I) is dissolved in THF and cooled to −78° C. n-Butyllithium is added slowly, followed by trimethoxy borate. The reaction is allowed to stir at ambient temperature until completion. The solvent is removed and the solid boronic ester washed with pentane. A boronic acid can be made from the boronic ester by treatment with HCl. The boronic ester or acid is dissolved in toluene with an equivalent of ortho-bromoaniline and a catalytic amount of palladium tetrakistriphenylphosphine. An aqueous solution of sodium carbonated is added and the reaction heated at reflux overnight. Upon cooling, the layers are separated and the aqueous layer extracted with ethyl acetate. The combined organic portions are washed with brine, dried (MgSO4), filtered, and concentrated under reduced pressure. Column chromatography is typically used to purify the coupled product (compound J).

The aniline (compound J) and dibromoethane (0.5 equiv.) are dissolved in acetonitrile and heated at 60° C. overnight. The reaction is filtered and concentrated to give an ethylene bridged dianiline. The protected phenol is deprotected by reaction with HCl to give a bridged bisamino(biphenyl)ol (compound K).

The diamine (compound K) is dissolved in triethylorthoformate. Ammonium chloride is added and the reaction heated at reflux overnight. A precipitate is formed which is collected by filtration and washed with ether to give the iminium salt. The iminium chloride is suspended in THF and treated with lithium or sodium hexamethyldisilylamide. Upon completion, the reaction is filtered and the filtrate concentrated to give the carbene ligand.

### Preparation of Bis(Phenolate) Complexes

Transition metal or Lanthanide metal bis(phenolate) complexes are used as catalyst components for olefin polymerization in the present invention. The terms “catalyst” and “catalyst complex” are used interchangeably. The preparation of transition metal or Lanthanide metal bis(phenolate) complexes may be accomplished by reaction of the bis(phenol) ligand with a metal reactant containing anionic basic leaving groups. Typical anionic basic leaving groups include dialkylamido, benzyl, phenyl, hydrido, and methyl. In this reaction, the role of the basic leaving group is to deprotonate the bis(phenol) ligand. Suitable metal reactants for this type of reaction include, but are not limited to, HfBn₄ (Bn=CH₂Ph), ZrBn₄, TiBn₄, ZrBn₂Cl₂(OEt₂), HfBn₂Cl₂(OEt₂)₂, Zr(NMe₂)₂Cl₂(dimethoxyethane), Hf(NMe₂)₂Cl₂(dimethoxyethane), Hf(NMe₂)₄, Zr(NMe₂)₄, and Hf(NEt₂)₄. Suitable metal reagents also include ZrMe₄, HfMe₄, and other group 4 alkyls that may be formed in situ and used without isolation.

A second method for the preparation of transition metal or Lanthanide bis(phenolate) complexes is by reaction of the bis(phenol) ligand with an alkali metal or alkaline earth metal base (e.g., Na, BuLi, ⁱPrMgBr) to generate deprotonated ligand, followed by reaction with a metal halide (e.g., HfCl₄, ZrCl₄) to form a bis(phenolate) complex. Bis(phenolate) metal complexes that contain metal-halide, alkoxide, or amido leaving groups may be alkylated by reaction with organolithium, Grignard, and organoaluminum reagents. In the alkylation reaction the alkyl groups are transferred to the bis(phenolate) metal center and the leaving groups are removed. Reagents typically used for the alkylation reaction include, but are not limited to, MeLi, MeMgBr, AlMe₃, Al(ⁱBu)₃, AlOct₃, and PhCH₂MgCl. Typically 2 to 20 molar equivalents of the alkylating reagent are added to the bis(phenolate) complex. The alkylations are generally performed in etherial or hydrocarbon solvents or solvent mixtures at temperatures typically ranging from −80° C. to 120° C.

### Activators

The terms “cocatalyst” and “activator” are used herein interchangeably.

The catalyst systems described herein typically comprises a catalyst complex, such as the transition metal or Lanthanide bis(phenolate) complexes described above, and an activator such as alumoxane or a non-coordinating anion. These catalyst systems may be formed by combining the catalyst components described herein with activators in any manner known from the literature. The catalyst systems may also be added to or generated in solution polymerization or bulk polymerization (in the monomer). Catalyst systems of the present disclosure may have one or more activators and one, two or more catalyst components. Activators are defined to be any compound which can activate any one of the catalyst compounds described above by converting the neutral metal compound to a catalytically active metal compound cation. Non-limiting activators, for example, include alumoxanes, ionizing activators, which may be neutral or ionic, and conventional-type cocatalysts. Preferred activators typically include alumoxane compounds, modified alumoxane compounds, and ionizing anion precursor compounds that abstract a reactive metal ligand making the metal compound cationic and providing a charge-balancing non-coordinating or weakly coordinating anion, e.g. a non-coordinating anion.

### Alumoxane Activators

Alumoxane activators are utilized as activators in the catalyst systems described herein. Alumoxanes are generally oligomeric compounds containing —Al(R¹)—O— sub-units, where R¹ is an alkyl group. Examples of alumoxanes include methylalumoxane (MAO), modified methylalumoxane (MMAO), ethylalumoxane and isobutylalumoxane. Alkylalumoxanes and modified alkylalumoxanes are suitable as catalyst activators, particularly when the abstractable ligand is an alkyl, halide, alkoxide or amide. Mixtures of different alumoxanes and modified alumoxanes may also be used. It may be preferable to use a visually clear methylalumoxane. A cloudy or gelled alumoxane can be filtered to produce a clear solution or clear alumoxane can be decanted from the cloudy solution. A useful alumoxane is a modified methyl alumoxane (MMAO) cocatalyst type 3A (commercially available from Akzo Chemicals, Inc. under the trade name Modified Methylalumoxane type 3A, covered under patent number U.S. Pat. No. 5,041,584). Another useful alumoxane is solid polymethylaluminoxane as described in U.S. Pat. Nos. 9,340,630; 8,404,880; and 8,975,209.

When the activator is an alumoxane (modified or unmodified), typically the maximum amount of activator is at up to a 5,000-fold molar excess Al/M over the catalyst compound (per metal catalytic site). The minimum activator-to-catalyst-compound is a 1:1 molar ratio. Alternate preferred ranges include from 1:1 to 500:1, alternately from 1:1 to 200:1, alternately from 1:1 to 100:1, or alternately from 1:1 to 50:1.

In an alternate embodiment, little or no alumoxane is used in the polymerization processes described herein. Preferably, alumoxane is present at zero mole %, alternately the alumoxane is present at a molar ratio of aluminum to catalyst compound transition metal less than 500:1, preferably less than 300:1, preferably less than 100:1, preferably less than 1:1.

### Ionizing/Non Coordinating Anion Activators

The term “non-coordinating anion” (NCA) means an anion which either does not coordinate to a cation or which is only weakly coordinated to a cation thereby remaining sufficiently labile to be displaced by a neutral Lewis base. Further, the anion will not transfer an anionic substituent or fragment to the cation so as to cause it to form a neutral transition metal compound and a neutral by-product from the anion. Non-coordinating anions useful in accordance with this invention are those that are compatible, stabilize the transition metal cation in the sense of balancing its ionic charge at +1, and yet retain sufficient lability to permit displacement during polymerization. The term NCA is also defined to include multicomponent NCA-containing activators, such as N,N-dimethylanilinium tetrakis(pentafluorophenyl)borate, that contain an acidic cationic group and the non-coordinating anion. The term NCA is also defined to include neutral Lewis acids, such as tris(pentafluorophenyl)boron, that can react with a catalyst to form an activated species by abstraction of an anionic group. Any metal or metalloid that can form a compatible, weakly coordinating complex may be used or contained in the non-coordinating anion. Suitable metals include, but are not limited to, aluminum, gold, and platinum. Suitable metalloids include, but are not limited to, boron, aluminum, phosphorus, and silicon.

It is within the scope of this invention to use an ionizing activator, neutral or ionic. It is also within the scope of this invention to use neutral or ionic activators alone or in combination with alumoxane or modified alumoxane activators.

In embodiments of the invention, the activator is represented by the Formula (III):

(Z)_{d}⁺(A^{d-}) (III)

wherein Z is (L-H) or a reducible Lewis Acid, L is an neutral Lewis base; H is hydrogen; (L-H)³⁰ is a Bronsted acid; A^{d-} is a non-coordinating anion having the charge d−; and d is an integer from 1 to 3 (such as 1, 2 or 3), preferably Z is (Ar₃C⁺), where Ar is aryl or aryl substituted with a heteroatom, a C₁ to C₄₀ hydrocarbyl, or a substituted C₁ to C₄₀ hydrocarbyl. The anion component A^{d-} includes those having the formula [M^{k+}Qₙ]^{d-} wherein k is 1, 2, or 3; n is 1, 2, 3, 4, 5, or 6 (preferably 1, 2, 3, or 4); n−k=d; M is an element selected from Group 13 of the Periodic Table of the Elements, preferably boron or aluminum, and Q is independently a hydride, bridged or unbridged dialkylamido, halide, alkoxide, aryloxide, hydrocarbyl, substituted hydrocarbyl, halocarbyl, substituted halocarbyl, and halosubstituted-hydrocarbyl radicals, said Q having up to 40 carbon atoms (optionally with the proviso that in not more than 1 occurrence is Q a halide). Preferably, each Q is a fluorinated hydrocarbyl group having 1 to 40 (such as 1 to 20) carbon atoms, more preferably each Q is a fluorinated aryl group, such as a perfluorinated aryl group and most preferably each Q is a pentafluoryl aryl group or perfluoronaphthalen-2-yl group. Examples of suitable A^{d-} also include diboron compounds as disclosed in U.S. Pat. No. 5,447,895, which is fully incorporated herein by reference.

When Z is the activating cation (L-H), it can be a Bronsted acid, capable of donating a proton to the transition metal catalytic precursor resulting in a transition metal cation, including ammoniums, oxoniums, phosphoniums, sulfoniums, and mixtures thereof, such as ammoniums of methylamine, aniline, dimethylamine, diethylamine, N-methylaniline, N-methyl-4-nonadecyl-N-octadecylaniline, N-methyl-4-octadecyl-N-octadecylaniline, diphenylamine, trimethylamine, triethylamine, N,N-dimethylaniline, methyldiphenylamine, pyridine, p-bromo N,N-dimethylaniline, p-nitro-N,N-dimethylaniline, dioctadecylmethylamine, phosphoniums from triethylphosphine, triphenylphosphine, and diphenylphosphine, oxoniums from ethers such as dimethyl ether, diethyl ether, tetrahydrofuran and dioxane, sulfoniums from thioethers, such as diethyl thioethers, tetrahydrothiophene, and mixtures thereof.

In particularly useful embodiments of the invention, the activator is soluble in non-aromatic-hydrocarbon solvents, such as aliphatic solvents.

In one or more embodiments, a 20 wt % mixture of the activator compound in n-hexane, isohexane, cyclohexane, methylcyclohexane, or a combination thereof, forms a clear homogeneous solution at 25° C., preferably a 30 wt % mixture of the activator compound in n-hexane, isohexane, cyclohexane, methylcyclohexane, or a combination thereof, forms a clear homogeneous solution at 25° C.

In embodiments of the invention, the activators described herein have a solubility of more than 10 mM (or more than 20 mM, or more than 50 mM) at 25° C. (stirred 2 hours) in methylcyclohexane.

In embodiments of the invention, the activators described herein have a solubility of more than 1 mM (or more than 10 mM, or more than 20 mM) at 25° C. (stirred 2 hours) in isohexane.

In embodiments of the invention, the activators described herein have a solubility of more than 10 mM (or more than 20 mM, or more than 50 mM) at 25° C. (stirred 2 hours) in methylcyclohexane and a solubility of more than 1 mM (or more than 10 mM, or more than 20 mM) at 25° C. (stirred 2 hours) in isohexane.

In a preferred embodiment, the activator is a non-aromatic-hydrocarbon soluble activator compound.

Non-aromatic-hydrocarbon soluble activator compounds useful herein include those represented by the Formula (V):

[R^{1′}R^{2′}R^{3′}EH]_{d+}[Mt^{k}+Qₙ]^{d-} (V)

wherein:
E is nitrogen or phosphorous;
d is 1, 2 or 3; k is 1, 2, or 3; n is 1, 2, 3, 4, 5, or 6; n−k=d (preferably d is 1, 2 or 3; k is 3; n is 4, 5, or 6);
R^{1′}, R^{2′}, and R^{3′} are independently a C₁ to C₅₀ hydrocarbyl group optionally substituted with one or more alkoxy groups, silyl groups, a halogen atoms, or halogen containing groups,
wherein R^{1′}, R^{2′}, and R^{3′} together comprise 15 or more carbon atoms;
Mt is an element selected from group 13 of the Periodic Table of the Elements, such as B or Al; and
each Q is independently a hydride, bridged or unbridged dialkylamido, halide, alkoxide, aryloxide, hydrocarbyl, substituted hydrocarbyl, halocarbyl, substituted halocarbyl, or halosubstituted-hydrocarbyl radical.

Non-aromatic-hydrocarbon soluble activator compounds useful herein include those represented by the Formula (VI):

[R^{1′}R^{2′}R^{3′}EH][BR^{4′}R^{5′}R^{6′}R^{7′}] (VI)

wherein: E is nitrogen or phosphorous; R1, is a methyl group; R^{2′} and R^{3′} are independently is C₄-C₅₀ hydrocarbyl group optionally substituted with one or more alkoxy groups, silyl groups, a halogen atoms, or halogen containing groups wherein R^{2′} and R^{3′} together comprise 14 or more carbon atoms; B is boron; and R^{4′}, R^{5′}, R^{6′}, and R^{7′} are independently hydride, bridged or unbridged dialkylamido, halide, alkoxide, aryloxide, hydrocarbyl, substituted hydrocarbyl, halocarbyl, substituted halocarbyl, or halosubstituted-hydrocarbyl radical.

Non-aromatic-hydrocarbon soluble activator compounds useful herein include those represented by the Formula (VII) or Formula (VIII):

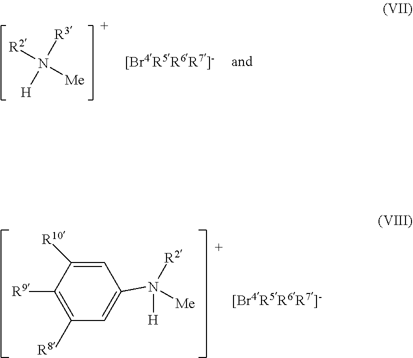

wherein:
N is nitrogen;
R^{2′} and R^{3′} are independently is C₆-C₄₀ hydrocarbyl group optionally substituted with one or more alkoxy groups, silyl groups, a halogen atoms, or halogen containing groups wherein R^{2′} and R^{3′} (if present) together comprise 14 or more carbon atoms;
R^{8′}, R^{9′}, and R^{10′} are independently a C₄-C₃₀ hydrocarbyl or substituted C₄-C₃₀ hydrocarbyl group;
B is boron;
and R^{4′}, R^{5′}, R^{6′}, and R^{7′} are independently hydride, bridged or unbridged dialkylamido, halide, alkoxide, aryloxide, hydrocarbyl, substituted hydrocarbyl, halocarbyl, substituted halocarbyl, or halosubstituted-hydrocarbyl radical.

Optionally, in any of Formulas (V), (VI), (VII), or (VIII) herein, R^{4′}, R^{5′}, R^{6′}, and R^{7′} are pentafluorophenyl.

Optionally, in any of Formulas (V), (VI), (VII), or (VIII) herein, R^{4′}, R^{5′}, R^{6′}, and R^{7′} are pentafluoronaphthalen-2-yl.

Optionally, in any embodiment of Formula (VIII) herein, R^{8′} and R^{10′} are hydrogen atoms and R^{9′} is a C₄-C₃₀ hydrocarbyl group which is optionally substituted with one or more alkoxy groups, silyl groups, a halogen atoms, or halogen containing groups.

Optionally, in any embodiment of Formula (VIII) herein, R^{9′} is a C₅-C₂₂ hydrocarbyl group which is optionally substituted with one or more alkoxy groups, silyl groups, a halogen atoms, or halogen containing groups.

Optionally, in any embodiment of Formula (VII) or (VIII) herein, R^{2′} and R^{3′} are independently a C₁₂-C₂₂ hydrocarbyl group.

Optionally, R^{1′}, R^{2′} and R^{3′} together comprise 15 or more carbon atoms (such as 18 or more carbon atoms, such as 20 or more carbon atoms, such as 22 or more carbon atoms, such as 25 or more carbon atoms, such as 30 or more carbon atoms, such as 35 or more carbon atoms, such as 38 or more carbon atoms, such as 40 or more carbon atoms, such as 15 to 100 carbon atoms, such as 25 to 75 carbon atoms).

Optionally, R^{2′} and R^{3″} together comprise 15 or more carbon atoms (such as 18 or more carbon atoms, such as 20 or more carbon atoms, such as 22 or more carbon atoms, such as 25 or more carbon atoms, such as 30 or more carbon atoms, such as 35 or more carbon atoms, such as 38 or more carbon atoms, such as 40 or more carbon atoms, such as 15 to 100 carbon atoms, such as 25 to 75 carbon atoms).

Optionally, R^{8′}, R^{9″}, and R^{10′} together comprise 15 or more carbon atoms (such as 18 or more carbon atoms, such as 20 or more carbon atoms, such as 22 or more carbon atoms, such as 25 or more carbon atoms, such as 30 or more carbon atoms, such as 35 or more carbon atoms, such as 38 or more carbon atoms, such as 40 or more carbon atoms, such as 15 to 100 carbon atoms, such as 25 to 75 carbon atoms).

Optionally, when Q is a fluorophenyl group, then R^{2′} is not a C₁-C₄₀ linear alkyl group (alternately R^{2′} is not an optionally substituted C₁-C₄₀ linear alkyl group).

Optionally, each of R^{4′}, R^{5′}, R^{6′}, and R^{7′} is an aryl group (such as phenyl or naphthalen-2-yl), wherein at least one of R^{4′}, R^{5′}, R^{6′}, and R^{7′} is substituted with at least one fluorine atom, preferably each of R^{4′}, R^{5′}, R^{6′}, and R^{7′} is a perfluoroaryl group (such as perfluorophenyl or perfluoronaphthalen-2-yl).

Optionally, each Q is an aryl group (such as phenyl or naphthalen-2-yl), wherein at least one Q is substituted with at least one fluorine atom, preferably each Q is a perfluoroaryl group (such as perfluorophenyl or perfluoronaphthalen-2-yl).

Optionally, R^{1′} is a methyl group; R^{2′} is C₆-C₅₀ aryl group; and R^{3′} is independently C₁-C₄₀ linear alkyl or C₅-C₅₀-aryl group.

Optionally, each of R^{2′} and R^{3′} is independently unsubstituted or substituted with at least one of halide, C₁-C₃₅ alkyl, C₅-C₁₅ aryl, C₆-C₃₅ arylalkyl, C₆-C₃₅ alkylaryl, wherein R², and R³ together comprise 20 or more carbon atoms.

Optionally, each Q is independently a hydride, bridged or unbridged dialkylamido, halide, alkoxide, aryloxide, hydrocarbyl, substituted hydrocarbyl, halocarbyl, substituted halocarbyl, or halosubstituted-hydrocarbyl radical, provided that when Q is a fluorophenyl group, then R^{2′} is not a C₁-C₄₀ linear alkyl group, preferably R^{2′} is not an optionally substituted C₁-C₄₀ linear alkyl group (alternately when Q is a substituted phenyl group, then R^{2′} is not a C₁-C₄₀ linear alkyl group, preferably R^{2′} is not an optionally substituted C₁-C₄₀ linear alkyl group). Optionally, when Q is a fluorophenyl group (alternately when Q is a substituted phenyl group), then R^{2′} is a meta- and/or para-substituted phenyl group, where the meta and para substituents are, independently, an optionally substituted C₁ to C₄₀ hydrocarbyl group (such as a C₆ to C₄₀ aryl group or linear alkyl group, a C₁₂ to C₃₀ aryl group or linear alkyl group, or a C₁₀ to C₂₀ aryl group or linear alkyl group), an optionally substituted alkoxy group, or an optionally substituted silyl group. Optionally, each Q is a fluorinated hydrocarbyl group having 1 to 30 carbon atoms, more preferably each Q is a fluorinated aryl (such as phenyl or naphthalen-2-yl) group, and most preferably each Q is a perflourinated aryl (such as phenyl or naphthalen-2-yl) group. Examples of suitable [Mt^{k+}Qₙ]^{d-} also include diboron compounds as disclosed in U.S. Pat. No. 5,447,895, which is fully incorporated herein by reference. Optionally, at least one Q is not substituted phenyl. Optionally all Q are not substituted phenyl. Optionally at least one Q is not perfluorophenyl. Optionally all Q are not perfluorophenyl.

In some embodiments of the invention, R^{1′} is not methyl, R^{2′} is not C₁₈ alkyl and R^{3′} is not C₁₈ alkyl, alternately R^{1′} is not methyl, R^{2′} is not C₁₈ alkyl and R^{3′} is not C₁₈ alkyl and at least one Q is not substituted phenyl, optionally all Q are not substituted phenyl.

Useful cation components in Formulas (III) and (V) to (VIII) include those represented by the formula:

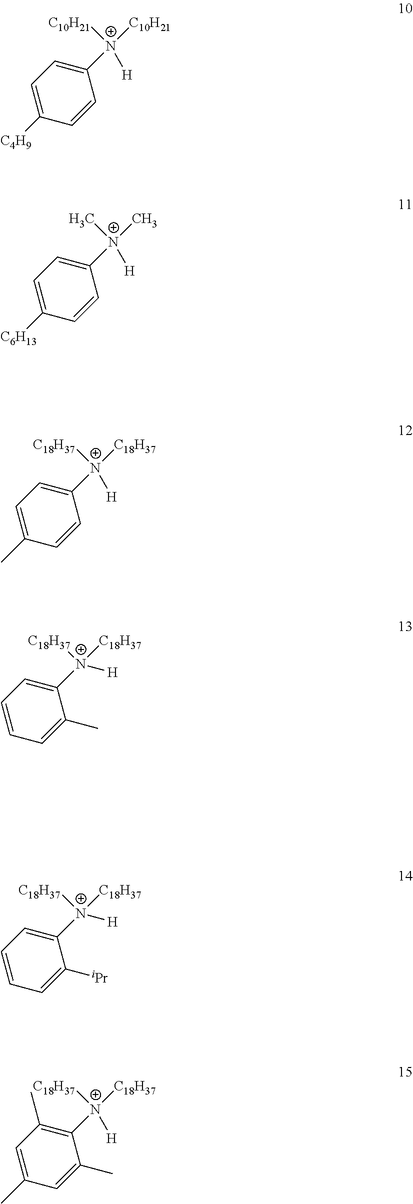

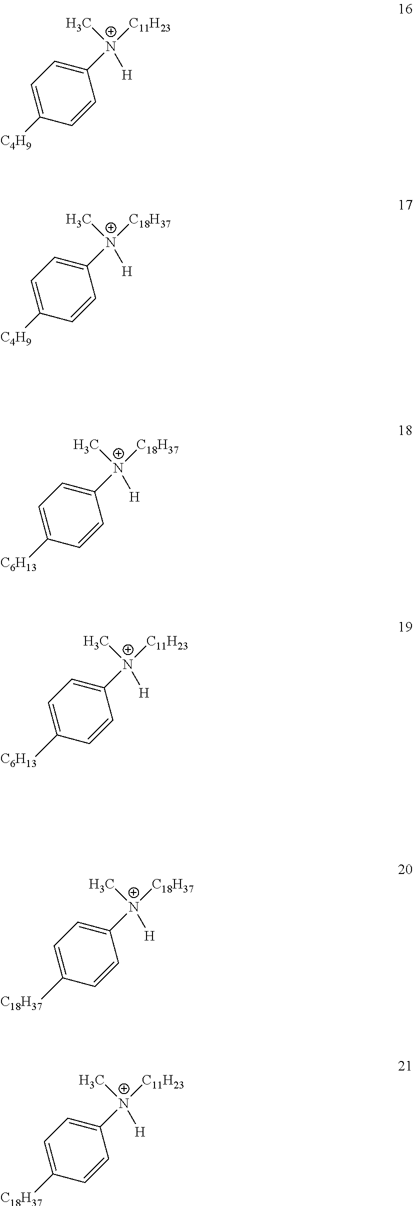

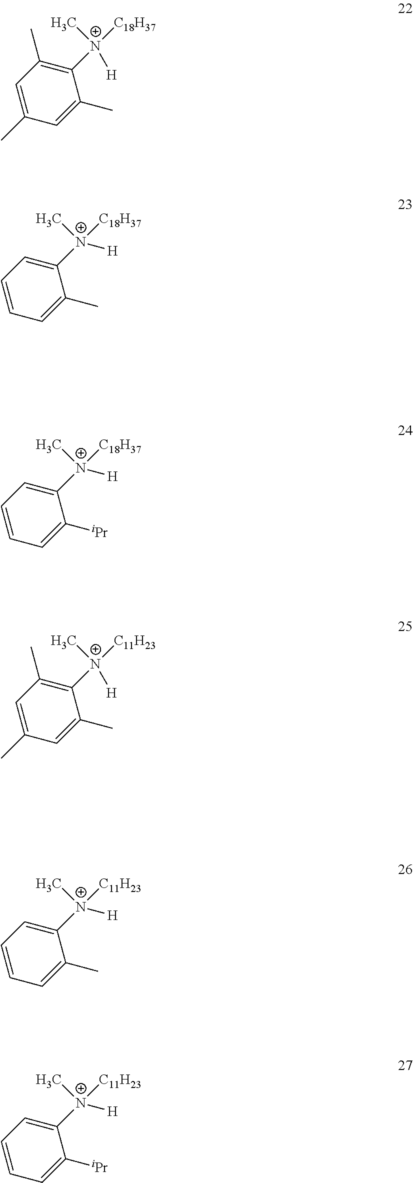

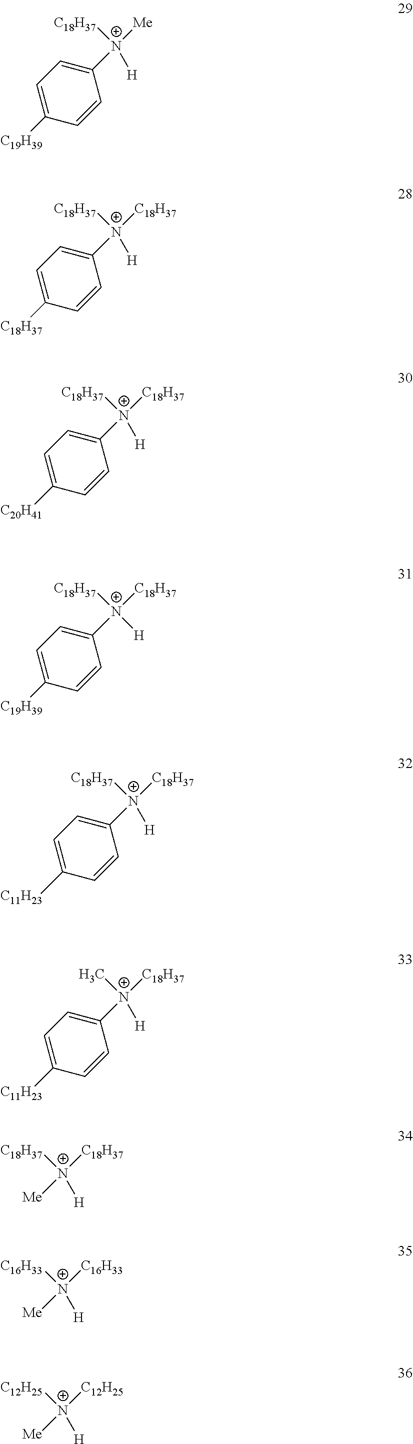

Useful cation components in Formulas (III) and (V) to (VIII) include those represented by the formulas:

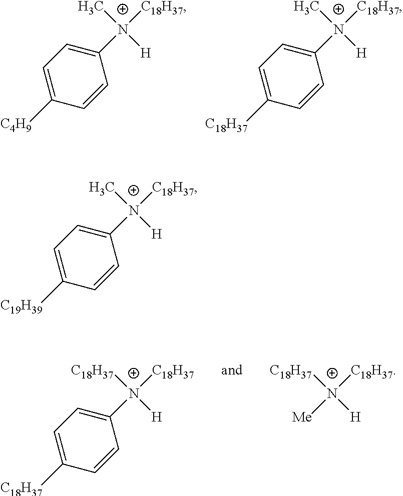

The anion component of the activators described herein includes those represented by the formula [Mt^{k+}Qₙ]⁻ wherein k is 1, 2, or 3; n is 1, 2, 3, 4, 5, or 6 (preferably 1, 2, 3, or 4), (preferably k is 3; n is 4, 5, or 6, preferably when M is B, n is 4); Mt is an element selected from Group 13 of the Periodic Table of the Elements, preferably boron or aluminum, and Q is independently a hydride, bridged or unbridged dialkylamido, halide, alkoxide, aryloxide, hydrocarbyl, substituted hydrocarbyl, halocarbyl, substituted halocarbyl, and halosubstituted-hydrocarbyl radicals, said Q having up to 20 carbon atoms with the proviso that in not more than 1 occurrence is Q a halide. Preferably, each Q is a fluorinated hydrocarbyl group, optionally having 1 to 20 carbon atoms, more preferably each Q is a fluorinated aryl group, and most preferably each Q is a perfluorinated aryl group. Preferably at least one Q is not substituted phenyl, such as perfluorophenyl, preferably all Q are not substituted phenyl, such as perfluorophenyl.

In one embodiment, the borate activator comprises tetrakis(heptafluoronaphthalen-2-yl)borate.

In one embodiment, the borate activator comprises tetrakis(pentafluorophenyl)borate.

Anions for use in the non-coordinating anion activators described herein also include those represented by Formula (7), below:

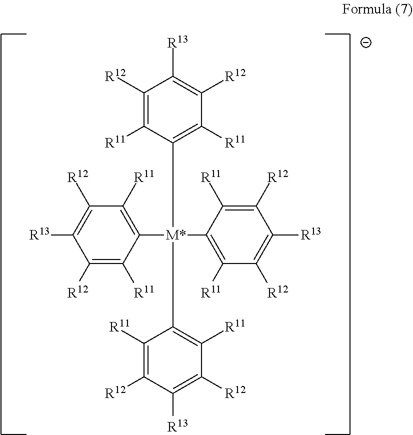

wherein:
M* is a group 13 atom, preferably B or Al, preferably B;
each R¹¹ is, independently, a halide, preferably a fluoride;
each R¹² is, independently, a halide, a C₆ to C₂₀ substituted aromatic hydrocarbyl group or a siloxy group of the formula —O—Si—R^{a}, where R^{a} is a C₁ to C₂₀ hydrocarbyl or hydrocarbylsilyl group, preferably R¹² is a fluoride or a perfluorinated phenyl group;
each R¹³ is a halide, a C₆ to C₂₀ substituted aromatic hydrocarbyl group or a siloxy group of the formula —O—Si—Rₐ, where R^{a} is a C₁ to C₂₀ hydrocarbyl or hydrocarbylsilyl group,
preferably R¹³ is a fluoride or a C₆ perfluorinated aromatic hydrocarbyl group; wherein R¹² and R¹³ can form one or more saturated or unsaturated, substituted or unsubstituted rings, preferably R¹² and R¹³ form a perfluorinated phenyl ring. Preferably the anion has a molecular weight of greater than 700 g/mol, and, preferably, at least three of the substituents on the M* atom each have a molecular volume of greater than 180 cubic A.

“Molecular volume” is used herein as an approximation of spatial steric bulk of an activator molecule in solution. Comparison of substituents with differing molecular volumes allows the substituent with the smaller molecular volume to be considered “less bulky” in comparison to the substituent with the larger molecular volume. Conversely, a substituent with a larger molecular volume may be considered “more bulky” than a substituent with a smaller molecular volume.

Molecular volume may be calculated as reported in “A Simple “Back of the Envelope” Method for Estimating the Densities and Molecular Volumes of Liquids and Solids,” Journal of Chemical Education, v. 71(11), November 1994, pp. 962-964. Molecular volume (MV), in units of cubic Å, is calculated using the formula: MV=8.3V_{S}, where V_{S} is the scaled volume. V_{S} is the sum of the relative volumes of the constituent atoms, and is calculated from the molecular formula of the substituent using Table A below of relative volumes. For fused rings, the V_{S} is decreased by 7.5% per fused ring. The Calculated Total MV of the anion is the sum of the MV per substituent, for example, the MV of perfluorophenyl is 183 Å³, and the Calculated Total MV for tetrakis(perfluorophenyl)borate is four times 183 Å³, or 732 Å³.

TABLE A

| Element | Relative Volume |
|---|---|
| H | 1 |
| 1^{st} short period, Li to F | 2 |
| 2^{nd} short period, Na to Cl | 4 |
| 1^{st} long period, K to Br | 5 |
| 2^{nd} long period, Rb to I | 7.5 |
| 3^{rd} long period, Cs to Bi | 9 |

Exemplary anions useful herein and their respective scaled volumes and molecular volumes are shown in Table B below. The dashed bonds indicate bonding to boron.

TABLE B

| | | Molecular | | MV | |
|---|---|---|---|---|---|
| | | Formula of | | Per | Calculated |
| | | Each | | subst. | Total MV |
| Ion | Structure of Boron Substituents | Substituent | V_{S} | (Å³) | (Å³) |
| tetrakis(perfluorophenyl) borate | 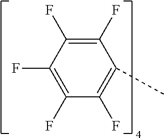 | C₆F₅ | 22 | 183 | 732 |
| tris(perfluorophenyl)- (perfluoronaphthalen-2-yl) borate | 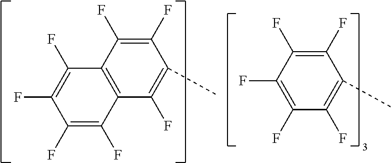 | C₆F₅ C₁₀F₇ | 22 34 | 183 261 | 810 |
| (perfluorophenyl)tris- (perfluoronaphthalen-2-yl) borate | 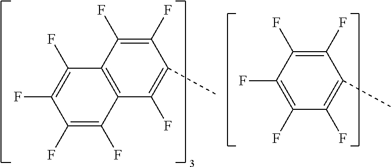 | C₆F₅ C₁₀F₇ | 22 34 | 183 261 | 966 |
| tetrakis(perfluoronaphthalen- 2-yl)borate | 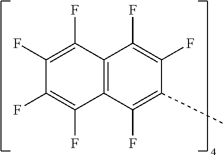 | C₁₀F₇ | 34 | 261 | 1044 |
| tetrakis(perfluorobiphenyl) borate | 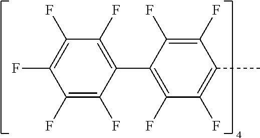 | C₁₂F₉ | 42 | 349 | 1396 |
| [(C₆F₃(C₆F₅)₂)₄B] | 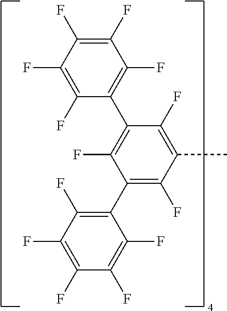 | C₁₈F₁₃ | 62 | 515 | 2060 |

The activators may be added to a polymerization in the form of an ion pair using, for example, [M2HTH]+ [NCA]− in which the di(hydrogenated tallow)methylamine (“M2HTH”) cation reacts with a basic leaving group on the transition metal complex to form a transition metal complex cation and [NCA]−. Alternatively, the transition metal complex may be reacted with a neutral NCA precursor, such as B(C₆F₅)₃, which abstracts an anionic group from the complex to form an activated species. Useful activators include di(hydrogenated tallow)methylammonium[tetrakis(pentafluorophenyl)borate] (i.e., [M2HTH]B(C₆F₅)₄) and di(octadecyl)tolylammonium [tetrakis(pentafluorophenyl)borate] (i.e., [DOdTH]B(C₆F₅)₄).

Activator compounds that are particularly useful in this invention include one or more of:
N,N-di(hydrogenated tallow)methylammonium [tetrakis(perfluorophenyl) borate],
N-methyl-4-nonadecyl-N-octadecylanilinium [tetrakis(perfluorophenyl)borate],
N-methyl-4-hexadecyl-N-octadecylanilinium [tetrakis(perfluorophenyl)borate],
N-methyl-4-tetradecyl-N-octadecylanilinium [tetrakis(perfluorophenyl)borate],
N-methyl-4-dodecyl-N-octadecylanilinium [tetrakis(perfluorophenyl)borate],
N-methyl-4-decyl-N-octadecylanilinium [tetrakis(perfluorophenyl)borate],
N-methyl-4-octyl-N-octadecylanilinium [tetrakis(perfluorophenyl)borate],
N-methyl-4-hexyl-N-octadecylanilinium [tetrakis(perfluorophenyl)borate],
N-methyl-4-butyl-N-octadecylanilinium [tetrakis(perfluorophenyl)borate],
N-methyl-4-octadecyl-N-decylanilinium [tetrakis(perfluorophenyl)borate],
N-methyl-4-nonadecyl-N-dodecylanilinium [tetrakis(perfluorophenyl)borate],
N-methyl-4-nonadecyl-N-tetradecylanilinium [tetrakis(perfluorophenyl)borate],
N-methyl-4-nonadecyl-N-hexadecylanilinium [tetrakis(perfluorophenyl)borate],
N-ethyl-4-nonadecyl-N-octadecylanilinium [tetrakis(perfluorophenyl)borate],
N-methyl-N,N-dioctadecylammonium [tetrakis(perfluorophenyl)borate],
N-methyl-N,N-dihexadecylammonium [tetrakis(perfluorophenyl)borate],
N-methyl-N,N-ditetradecylammonium [tetrakis(perfluorophenyl)borate],
N-methyl-N,N-didodecylammonium [tetrakis(perfluorophenyl)borate],
N-methyl-N,N-didecylammonium [tetrakis(perfluorophenyl)borate],
N-methyl-N,N-dioctylammonium [tetrakis(perfluorophenyl)borate],
N-ethyl-N,N-dioctadecylammonium [tetrakis(perfluorophenyl)borate],
N,N-di(octadecyl)tolylammonium [tetrakis(perfluorophenyl)borate],
N,N-di(hexadecyl)tolylammonium [tetrakis(perfluorophenyl)borate],
N,N-di(tetradecyl)tolylammonium [tetrakis(perfluorophenyl)borate],
N,N-di(dodecyl)tolylammonium [tetrakis(perfluorophenyl)borate],
N-octadecyl-N-hexadecyl-tolylammonium [tetrakis(perfluorophenyl)borate],
N-octadecyl-N-hexadecyl-tolylammonium [tetrakis(perfluorophenyl)borate],
N-octadecyl-N-tetradecyl-tolylammonium [tetrakis(perfluorophenyl)borate],
N-octadecyl-N-dodecyl-tolylammonium [tetrakis(perfluorophenyl)borate],
N-octadecyl-N-decyl-tolylammonium [tetrakis(perfluorophenyl)borate],
N-hexadecyl-N-tetradecyl-tolylammonium [tetrakis(perfluorophenyl)borate],
N-hexadecyl-N-dodecyl-tolylammonium [tetrakis(perfluorophenyl)borate],
N-hexadecyl-N-decyl-tolylammonium [tetrakis(perfluorophenyl)borate],
N-tetradecyl-N-dodecyl-tolylammonium [tetrakis(perfluorophenyl)borate],
N-tetradecyl-N-decyl-tolylammonium [tetrakis(perfluorophenyl)borate],
N-dodecyl-N-decyl-tolylammonium [tetrakis(perfluorophenyl)borate],
N-methyl-N-octadecylanilinium [tetrakis(perfluorophenyl)borate],
N-methyl-N-hexadecylanilinium [tetrakis(perfluorophenyl)borate],
N-methyl-N-tetradecylanilinium [tetrakis(perfluorophenyl)borate],
N-methyl-N-dodecylanilinium [tetrakis(perfluorophenyl)borate],
N-methyl-N-decylanilinium [tetrakis(perfluorophenyl)borate], and
N-methyl-N-octylanilinium [tetrakis(perfluorophenyl)borate].

Additional useful activators and the synthesis non-aromatic-hydrocarbon soluble activators, are described in U.S. Ser. No. 16/394,166 filed Apr. 25, 2019, U.S. Ser. No. 16/394,186, filed Apr. 25, 2019, and U.S. Ser. No. 16/394,197, filed Apr. 25, 2019, which are incorporated by reference herein.

Likewise, particularly useful activators also include dimethylaniliniumtetrakis (pentafluorophenyl) borate and dimethyl anilinium tetrakis(heptafluoro-2-naphthalen-2-yl) borate. For a more detailed description of useful activators please see WO 2004/026921 page 72, paragraph [00119] to page 81 paragraph [00151]. A list of additionally particularly useful activators that can be used in the practice of this invention may be found at page 72, paragraph [00177] to page 74, paragraph [00178] of WO 2004/046214.

For descriptions of useful activators please see U.S. Pat. Nos. 8,658,556 and 6,211,105.

Preferred activators for use herein also include N-methyl-4-nonadecyl-N-octadecylbenzenaminium tetrakis(pentafluorophenyl)borate, N-methyl-4-nonadecyl-N-octadecylbenzenaminium tetrakis(perfluoronaphthalen-2-yl)borate, N,N-dimethylanilinium tetrakis(perfluoronaphthalen-2-yl)borate, N,N-dimethylanilinium tetrakis(perfluorobiphenyl)borate, N,N-dimethylanilinium tetrakis(perfluorophenyl)borate, N,N-dimethylanilinium tetrakis(3,5-bis(trifluoromethyl)phenyl)borate, triphenylcarbenium tetrakis(perfluoronaphthalen-2-yl)borate, triphenylcarbenium tetrakis(perfluorobiphenyl)borate, triphenylcarbenium tetrakis(3,5-bis(trifluoromethyl)phenyl)borate, triphenylcarbenium tetrakis(perfluorophenyl)borate, [Me₃NH⁺][B(C₆F₅)₄⁻]; 1-(4-(tris(pentafluorophenyl)borate)-2,3,5,6-tetrafluorophenyl)pyrrolidinium; and tetrakis(pentafluorophenyl)borate, 4-(tris(pentafluorophenyl)borate)-2,3,5,6-tetrafluoropyridine.

In a preferred embodiment, the activator comprises a triaryl carbenium (such as triphenylcarbenium tetraphenylborate, triphenylcarbenium tetrakis(pentafluorophenyl)borate, triphenylcarbenium tetrakis-(2,3,4,6-tetrafluorophenyl)borate, triphenylcarbenium tetrakis(perfluoronaphthalen-2-yl)borate, triphenylcarbenium tetrakis(perfluorobiphenyl)borate, triphenylcarbenium tetrakis(3,5-bis(trifluoromethyl)phenyl)borate).

In another embodiment, the activator comprises one or more of trialkylammonium tetrakis(pentafluorophenyl)borate, N,N-dialkylanilinium tetrakis(pentafluorophenyl)borate, dioctadecylmethylammonium tetrakis(pentafluorophenyl)borate, dioctadecylmethylammonium tetrakis(perfluoronaphthalen-2-yl)borate, N,N-dimethyl-(2,4,6-trimethylanilinium) tetrakis(pentafluorophenyl)borate, trialkylammonium tetrakis-(2,3,4,6-tetrafluorophenyl) borate, N,N-dialkylanilinium tetrakis-(2,3,4,6-tetrafluorophenyl)borate, trialkylammonium tetrakis(perfluoronaphthalen-2-yl)borate, N,N-dialkylanilinium tetrakis(perfluoronaphthalen-2-yl)borate, trialkylammonium tetrakis(perfluorobiphenyl)borate, N,N-dialkylanilinium tetrakis(perfluorobiphenyl)borate, trialkylammonium tetrakis(3,5-bis(trifluoromethyl)phenyl)borate, N,N-dialkylanilinium tetrakis(3,5-bis(trifluoromethyl)phenyl)borate, N,N-dialkyl-(2,4,6-trimethylanilinium) tetrakis(3,5-bis(trifluoromethyl)phenyl)borate, di-(i-propyl)ammonium tetrakis(pentafluorophenyl)borate, (where alkyl is methyl, ethyl, propyl, n-butyl, sec-butyl, or t-butyl).

The typical activator-to-catalyst ratio, e.g., all NCA activators-to-catalyst ratio is about a 1:1 molar ratio. Alternate preferred ranges include from 0.1:1 to 100:1, alternately from 0.5:1 to 200:1, alternately from 1:1 to 500:1 alternately from 1:1 to 1000:1. A particularly useful range is from 0.5:1 to 10:1, preferably 1:1 to 5:1.

It is also within the scope of the present disclosure that the catalyst compounds can be combined with combinations of alumoxanes and NCA's (see for example, U.S. Pat. Nos. 5,153,157; 5,453,410; EP 0 573 120 B1; WO 1994/007928; and WO 1995/014044 (the disclosures of which are incorporated herein by reference in their entirety) which discuss the use of an alumoxane in combination with an ionizing activator).

### Optional Scavengers, Co-Activators, Chain Transfer Agents

In addition to activator compounds, scavengers or co-activators may be used. A scavenger is a compound that is typically added to facilitate polymerization by scavenging impurities. Some scavengers may also act as activators and may be referred to as co-activators. A co-activator, that is not a scavenger, may also be used in conjunction with an activator in order to form an active catalyst. In some embodiments a co-activator can be pre-mixed with the transition metal compound to form an alkylated transition metal compound.

Co-activators can include alumoxanes such as methylalumoxane, modified alumoxanes such as modified methylalumoxane, and aluminum alkyls such trimethylaluminum, tri-isobutylaluminum, triethylaluminum, and tri-isopropylaluminum, tri-n-hexylaluminum, tri-n-octylaluminum, tri-n-decylaluminum or tri-n-dodecylaluminum. Co-activators are typically used in combination with Lewis acid activators and ionic activators when the pre-catalyst is not a dihydrocarbyl or dihydride complex. Sometimes co-activators are also used as scavengers to deactivate impurities in feed or reactors.

Aluminum alkyl or organoaluminum compounds which may be utilized as scavengers or co-activators include, for example, trimethylaluminum, triethylaluminum, triisobutylaluminum, tri-n-hexylaluminum, tri-n-octylaluminum, and dialkyl zinc, such as diethyl zinc.

Chain transfer agents may be used in the compositions and or processes described herein. Useful chain transfer agents are typically hydrogen, alkylalumoxanes, a compound represented by the formula AlR₃, ZnR₂ (where each R is, independently, a C₁-C₈ aliphatic radical, preferably methyl, ethyl, propyl, butyl, pentyl, hexyl octyl or an isomer thereof) or a combination thereof, such as diethyl zinc, trimethylaluminum, triisobutylaluminum, trioctylaluminum, or a combination thereof.

### Polymerization Processes

For the polymerization processes described herein, the term “continuous” means a system that operates without interruption or cessation. For example a continuous process to produce a polymer would be one where the reactants are continually introduced into one or more reactors and polymer product is continually withdrawn.

A solution polymerization means a polymerization process in which the polymer is dissolved in a liquid polymerization medium, such as an inert solvent or monomer(s) or their blends. A solution polymerization is typically homogeneous. A homogeneous polymerization is one where the polymer product is dissolved in the polymerization medium. Such systems are preferably not turbid as described in J. Vladimir Oliveira, et al. (2000) Ind. Eng. Chem. Res., v. 29, pg. 4627.

A bulk polymerization means a polymerization process in which the monomers and/or comonomers being polymerized are used as a solvent or diluent using little or no inert solvent as a solvent or diluent. A small fraction of inert solvent might be used as a carrier for catalyst and scavenger. A bulk polymerization system contains less than 25 wt % of inert solvent or diluent, preferably less than 10 wt %, preferably less than 1 wt %, preferably 0 wt %. If a bulk polymerization process is performed such that the polymer remains dissolved in the polymerization medium then may be considered to be a type of a homogeneous polymerization process.

In embodiments herein, the invention relates to solution polymerization processes where propylene monomer, and optionally one or more C₄ or higher alpha olefin comonomers, are contacted with a catalyst system comprising an activator and at least one catalyst compound, as described above. The catalyst compound and activator may be combined in any order, and are combined typically prior to contacting with the monomer. Often such solution polymerization processes are referred to as homogeneous polymerization processes.

Monomers useful herein include substituted or unsubstituted C₃ to C₄₀ alpha olefins, preferably C₃ to C₂₀ alpha olefins, preferably C₃ to C₁₂ alpha olefins, preferably propylene, butene, pentene, hexene, heptene, octene, nonene, decene, undecene, dodecene and isomers thereof. In a preferred embodiment of the invention, the monomer comprises propylene and an optional comonomers comprising one or more C₄ to C₄₀ olefins, preferably C₄ to C₂₀ olefins, or preferably C₆ to C₁₂ olefins. The C₄ to C₄₀ olefin monomers may be linear, branched, or cyclic. The C₄ to C₄₀ cyclic olefins may be strained or unstrained, monocyclic or polycyclic, and may optionally include heteroatoms and/or one or more functional groups. In another preferred embodiment, the monomer comprises propylene and an optional comonomers comprising one or more C₄ to C₄₀ olefins, preferably C₄ to C₂₀ olefins, or preferably C₄ to C₈ olefins. The C₄ to C₄₀ olefin comonomers may be linear, branched, or cyclic. The C₄ to C₄₀ cyclic olefins may be strained or unstrained, monocyclic or polycyclic, and may optionally include heteroatoms and/or one or more functional groups.

Exemplary C₃ to C₄₀ olefin monomers and optional comonomers include propylene, butene, pentene, hexene, heptene, octene, nonene, decene, undecene, dodecene, norbornene, cyclobutene, cyclopentene, cycloheptene, cyclooctene, cyclododecene, substituted derivatives thereof, and isomers thereof, preferably hexene, heptene, octene, nonene, decene, dodecene, cyclooctene, 5-methylcyclopentene, cyclopentene, norbornene, 5-ethylidene-2-norbornene, and their respective homologs and derivatives.

In an embodiment one or more dienes are present in the polymer produced herein at up to 10 weight %, preferably at 0.00001 to 1.0 weight %, preferably 0.002 to 0.5 weight %, even more preferably 0.003 to 0.2 weight %, based upon the total weight of the composition. In some embodiments 500 ppm or less of diene is added to the polymerization, preferably 400 ppm or less, preferably or 300 ppm or less. In other embodiments at least 50 ppm of diene is added to the polymerization, or 100 ppm or more, or 150 ppm or more.

Preferred diolefin monomers useful in this invention include any hydrocarbon structure, preferably C₅ to C₃₀, having at least two unsaturated bonds. In certain embodiments the diolefin monomer contains at least two unsaturated bonds that are readily incorporated into a polymer. In certain embodiments, the diolefin monomer contains only one unsaturated bond that is readily incorporated into a polymer. Dienes may be conjugated or non-conjugated, acyclic or cyclic. Preferably, the dienes are non-conjugated. Dienes can include 5-ethylidene-2-norbornene (ENB); 5-vinyl-2-norbornene (VNB); 1,4-hexadiene; 5-methylene-2-norbornene (MNB); 1,6-octadiene; 3,7-dimethyl-1,6-octadiene (MOD); 1,3-cyclopentadiene; 1,4-cyclohexadiene; dicyclopentadiene (DCPD); and combinations thereof. Other exemplary dienes include butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, and isomers thereof. Examples of α,ω-dienes include 1,6-heptadiene, 1,7-octadiene, 1,8-nonadiene, 1,9-decadiene, 1,10-undecadiene, 1,11-dodecadiene, 1,12-tridecadiene, 1,13-tetradecadiene and divinylbenzene. Low molecular weight polybutadienes (Mw less than 1,000 g/mol) may also be used as the diene, which is sometimes also referred to as a polyene. Cyclic dienes include cyclopentadiene, norbornadiene, 5-ethylidene-2-norbornene, 5-vinyl-2-norbornene, divinylbenzene, dicyclopentadiene or higher ring containing diolefins with or without substituents at various ring positions.

In some embodiments the diene is preferably 5-ethylidene-2-norbornene, 5-vinyl-2-norbornene, norbornadiene, 1,4-hexadiene, 5-methylene-2-norbornene, 1,6-octadiene, 3,7-dimethyl-1,6-octadiene, dicyclopentadiene, cyclopentadiene, and combinations thereof.

Polymerization processes of this invention can be carried out in any manner known in the art. Any suspension, homogeneous, bulk, or solution polymerization process known in the art can be used. Such processes can be run in a batch, semi-batch, or continuous mode. Homogeneous polymerization processes are preferred. (A homogeneous polymerization process is preferably a process where at least 90 wt % of the product is soluble in the reaction media.) In some embodiments, a bulk homogeneous process is preferred. (A bulk process is preferably a process where monomer concentration in all feeds to the reactor is 70 volume % or more.) In useful embodiments the process is a solution process wherein solvent is added. Alternately, no solvent or diluent is present or added in the reaction medium, (except for the small amounts used as the carrier for the catalyst system or other additives, or amounts typically found with the monomer; e.g., propane in propylene).

Suitable diluents/solvents for polymerization include non-coordinating, inert liquids. Examples include straight and branched-chain hydrocarbons, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof, such as can be found commercially (Isopar™ fluids); perhalogenated hydrocarbons, such as perfluorinated C₄₋₁₀ alkanes, chlorobenzene, and aromatic and alkyl-substituted aromatic compounds, such as benzene, toluene, mesitylene, and xylene. Suitable solvents also include liquid olefins which may act as monomers or comonomers including propylene. In a preferred embodiment, aliphatic hydrocarbon solvents are used as the solvent, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof. In another embodiment, the solvent is not aromatic, preferably aromatics are present in the solvent at less than 1 wt %, preferably less than 0.5 wt %, preferably less than 0 wt % based upon the weight of the solvents.

In a preferred embodiment, the feed concentration of the propylene for the polymerization is 60 vol % solvent or less, preferably 40 vol % or less, or preferably 20 vol % or less, based on the total volume of the feedstream.

Preferred polymerizations can be run at any temperature and/or pressure suitable to obtain the desired propylene polymers. Typical temperatures and/or pressures include a temperature in the range of from about 0° C. to about 300° C., preferably about 20° C. to about 200° C., preferably about 70° C. to about 200° C., preferably from about 90° C. to about 180° C., preferably from about 100° C. to about 170° C.; preferably from about 120° C. to about 170° C.; and at a pressure in the range of from about 0.35 MPa to about 18 MPa, preferably from about 0.45 MPa to about 6 MPa, or preferably from about 0.5 MPa to about 4 MPa.

Alternately, typical temperatures and/or pressures include a temperature in the range of from about 0° C. to about 300° C., preferably about 20° C. to about 200° C., preferably about 35° C. to about 150° C., preferably from about 40° C. to about 120° C., preferably from about 45° C. to about 80° C.; and at a pressure in the range of from about 0.35 MPa to about 18 MPa, preferably from about 0.45 MPa to about 6 MPa, or preferably from about 0.5 MPa to about 4 MPa.

In a typical polymerization, the run time of the reaction is up to 300 minutes, preferably in the range of from about 5 to 250 minutes, or preferably from about 10 to 120 minutes. In a continuous polymerization the run time is the same thing as the average residence time.

In some embodiments, hydrogen is present in the polymerization reactor at a partial pressure of 0.001 to 50 psig (0.007 to 345 kPa), preferably from 0.01 to 25 psig (0.07 to 172 kPa), more preferably 0.1 to 10 psig (0.7 to 70 kPa).

In an alternate embodiment, the catalyst activity is at least 10,000 g/mmol/hour, preferably 100,000 or more g/mmol/hour, preferably 500,000 or more g/mmol/hr, preferably 1,000,000 or more g/mmol/hr, preferably 2,000,000 or more g/mmol/hr, preferably 5,000,000 or more g/mmol/hr. In an alternate embodiment, the catalyst productivity is at least 10,000 or more g polymer/g catalyst, preferably 50,000 or more g polymer/g catalyst, preferably 100,000 or more g polymer/g catalyst, preferably 200,000 or more g polymer/g catalyst, preferably 500,000 or more g polymer/g catalyst. In an alternate embodiment, the conversion of olefin monomer is at least 10%, based upon polymer yield and the weight of the monomer entering the reaction zone, preferably 20% or more, preferably 30% or more, preferably 50% or more, preferably 80% or more. In a preferred embodiment, little or no alumoxane is used in the process to produce the polymers. Preferably, alumoxane is present at zero mol %, alternately the alumoxane is present at a molar ratio of aluminum to transition metal less than 500:1, preferably less than 300:1, preferably less than 100:1, preferably less than 1:1.

In some embodiments, little or no scavenger is used in the process to produce the polymer. Preferably, scavenger (such as tri alkyl aluminum) is present at zero mol %, alternately the scavenger is present at a molar ratio of scavenger metal to transition metal of less than 100:1, preferably less than 50:1, preferably less than 15:1, preferably less than 10:1.

In a preferred embodiment, the homogeneous (solution or bulk) propylene polymerization: 1) is conducted at temperatures of 0 to 300° C. (preferably 25 to 150° C., preferably 40 to 140° C., preferably 50 to 130° C., preferably 60 to 120° C., alternatively 65 to 110° C., alternatively 70 to 100° C.,); 2) is conducted at a pressure of atmospheric pressure to 18 MPa (preferably 0.35 to 16 MPa, preferably from 0.45 to 14 MPa, preferably from 0.5 to 12 MPa, preferably from 0.5 to 10 MPa); 3) is conducted in an aliphatic hydrocarbon solvent (such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof; preferably where aromatics are preferably present in the solvent at less than 1 wt %, preferably less than 0.5 wt %, preferably at 0 wt % based upon the weight of the solvents); 4) wherein the catalyst system used in the polymerization comprises less than 0.5 mol %, preferably 0 mol % alumoxane, alternately the alumoxane is present at a molar ratio of aluminum to transition metal less than 500:1, preferably less than 300:1, preferably less than 100:1, preferably less than 1:1; 5) the polymerization preferably occurs in one reaction zone; 6) the catalyst productivity is at least 10,000 g polymer/g catalyst (preferably at least 100,000 g polymer/g catalyst, preferably at least 200,000 g polymer/g catalyst, preferably at least 500,000 g polymer/g catalyst, preferably at least 1,000,000 g polymer/g catalyst); 7) optionally scavengers (such as trialkyl aluminum compounds) are absent (e.g. present at zero mol %, alternately the scavenger is present at a molar ratio of scavenger metal to transition metal of less than 100:1, preferably less than 50:1, preferably less than 15:1, preferably less than 10:1); and 8) optionally hydrogen is present in the polymerization reactor at a partial pressure of 0.001 to 50 psig (0.007 to 345 kPa) (preferably from 0.01 to 25 psig (0.07 to 172 kPa), more preferably 0.1 to 10 psig (0.7 to 70 kPa)). In a preferred embodiment, the catalyst system used in the polymerization comprises no more than one catalyst compound per reaction zone. A “reaction zone” also referred to as a “polymerization zone” is a vessel where polymerization takes place, for example a batch reactor. When multiple reactors are used in either series or parallel configuration, each reactor is considered as a separate polymerization zone. For a multi-stage polymerization in both a batch reactor and a continuous reactor, each polymerization stage is considered as a separate polymerization zone. In a preferred embodiment, the polymerization occurs in one reaction zone. In an alternate embodiment, the polymerization occurs in two reaction zones, with each zone using the same polymerization catalyst.

The terms “dense fluid” “solid-fluid phase transition temperature” “phase transition” “solid-fluid phase transition pressure” “fluid-fluid phase transition pressure” “fluid-fluid phase transition temperature” “cloud point” “cloud point pressure” “cloud point temperature” “supercritical state” “critical temperature (Tc)” “critical pressure (Pc)” “supercritical polymerization” “homogeneous polymerization” “homogeneous polymerization system” are defined in U.S. Pat. No. 7,812,104, which is incorporated by reference herein.

A supercritical polymerization means a polymerization process in which the polymerization system is in a dense (i.e. its density is 300 kg/m³ or higher), supercritical state.

A super solution polymerization or super solution polymerization system is one where the polymerization occurs at a temperature of 65° C. to 150° C. and a pressure of between 250 to 5,000 psi (1.72 to 34.5 MPa), preferably the super solution polymerization polymerizes a C₃ to C₂₀ monomer (preferably propylene), and has: 1) 0 to 20 wt % of one or more comonomers (based upon the weight of all monomers and comonomers present in the feed) selected from the group consisting of C₄ to C₁₂ olefins, 2) from 20 to 65 wt % diluent or solvent, based upon the total weight of feeds to the polymerization reactor, 3) 0 to 5 wt % scavenger, based upon the total weight of feeds to the polymerization reactor, 4) the olefin monomers and any comonomers are present in the polymerization system at 15 wt % or more, 5) the polymerization temperature is above the solid-fluid phase transition temperature of the polymerization system and above a pressure greater than 1 MPa below the cloud point pressure of the polymerization system, provided however that the polymerization occurs: (1) at a temperature below the critical temperature of the polymerization system, or (2) at a pressure below the critical pressure of the polymerization system.

In a preferred embodiment of the invention, the polymerization process is conducted under homogeneous (such as solution, super solution, or supercritical) conditions preferably including a temperature of about 60° C. to about 200° C., preferably for 65° C. to 195° C., preferably for 90° C. to 190° C., preferably from greater than 100° C. to about 180° C., such as 105° C. to 170° C., preferably from about 110° C. to about 160° C. The process may conducted at a pressure in excess of 1.7 MPa, especially under super solution conditions including a pressure of between 1.7 MPa and 30 MPa, or especially under supercritical conditions including a pressure of between 15 MPa and 1,500 MPa, especially when the monomer composition comprises propylene or a mixture of propylene with at least one C₄ to C₂₀ α-olefin. In a preferred embodiment the monomer is propylene and the propylene is present at 15 wt % or more in the polymerization system, preferably at 20 wt % or more, preferably at 30 wt % or more, preferably at 40 wt % or more, preferably at 50 wt % or more, preferably at 60 wt % or more, preferably at 70 wt % or more, preferably 80 wt % or more. In an alternate embodiment, the monomer and any comonomer present are present at 15 wt % or more in the polymerization system, preferably at 20 wt % or more, preferably at 30 wt % or more, preferably at 40 wt % or more, preferably at 50 wt % or more, preferably at 60 wt % or more, preferably at 70 wt % or more, preferably 80 wt % or more.

In a preferred embodiment of the invention, the polymerization process is conducted under super solution conditions including temperatures from about 65° C. to about 150° C., preferably from about 75° C. to about 140° C., preferably from about 90° C. to about 140° C., more preferably from about 100° C. to about 140° C., and pressures of between 1.72 MPa and 35 MPa, preferably between 5 and 30 MPa.

In another particular embodiment of the invention, the polymerization process is conducted under supercritical conditions (preferably homogeneous supercritical conditions, e.g. above the supercritical point and above the cloud point) including temperatures from about 90° C. to about 200° C., and pressures of between 15 MPa and 1,500 MPa, preferably between 20 MPa and 140 MPa.

A particular embodiment of this invention relates to a process to polymerize propylene comprising contacting, at a temperature of 60° C. or more and a pressure of between 15 MPa (150 Bar, or about 2,175 psi) to 1,500 MPa (15,000 Bar, or about 217,557 psi), one or more olefin monomers having three or more carbon atoms, with: 1) the catalyst system, 2) optionally one or more comonomers, 3) optionally diluent or solvent, and 4) optionally scavenger, wherein: a) the olefin monomers and any comonomers are present in the polymerization system at 40 wt % or more, b) the propylene is present at 80 wt % or more based upon the weight of all monomers and comonomers present in the feed, c) the polymerization occurs at a temperature above the solid-fluid phase transition temperature of the polymerization system and a pressure no lower than 2 MPa below the cloud point pressure of the polymerization system.

Another particular embodiment of this invention relates to a process to polymerize olefins comprising contacting propylene, at a temperature of 65° C. to 150° C. and a pressure of between 250 to 5,000 psi (1.72 to 34.5 MPa), with: 1) the catalyst system, 2) 0 to 20 wt % of one or more comonomers (based upon the weight of all monomers and comonomers present in the feed) selected from the group consisting of C₄ to C₁₂ olefins, 3) from 20 to 65 wt % diluent or solvent, based upon the total weight of feeds to the polymerization reactor, and 4) 0 to 5 wt % scavenger, based upon the total weight of feeds to the polymerization reactor, wherein: a) the olefin monomers and any comonomers are present in the polymerization system at 15 wt % or more, b) the propylene is present at 80 wt % or more based upon the weight of all monomers and comonomers present in the feed, c) the polymerization occurs at a temperature above the solid-fluid phase transition temperature of the polymerization system and above a pressure greater than 1 MPa below the cloud point pressure of the polymerization system, provided however that the polymerization occurs: (1) at a temperature below the critical temperature of the polymerization system, or (2) at a pressure below the critical pressure of the polymerization system.

In another embodiment, the polymerization occurs at a temperature above the solid-fluid phase transition temperature of the polymerization system and a pressure no lower than 10 MPa below the cloud point pressure (CPP) of the polymerization system (preferably no lower than 8 MPa below the CPP, preferably no lower than 6 MPa below the CPP, preferably no lower than 4 MPa below the CPP, preferably no lower than 2 MPa below the CPP). Preferably, the polymerization occurs at a temperature and pressure above the solid-fluid phase transition temperature and pressure of the polymerization system and, preferably above the fluid-fluid phase transition temperature and pressure of the polymerization system.

In an alternate embodiment, the polymerization occurs at a temperature above the solid-fluid phase transition temperature of the polymerization system and a pressure greater than 1 MPa below the cloud point pressure (CPP) of the polymerization system (preferably greater than 0.5 MPa below the CPP, preferably greater than the CCP), and the polymerization occurs: (1) at a temperature below the critical temperature of the polymerization system, or (2) at a pressure below the critical pressure of the polymerization system, preferably the polymerization occurs at a pressure and temperature below the critical point of the polymerization system, most preferably the polymerization occurs: (1) at a temperature below the critical temperature of the polymerization system, and (2) at a pressure below the critical pressure of the polymerization system.

Alternately, the polymerization occurs at a temperature and pressure above the solid-fluid phase transition temperature and pressure of the polymerization system. Alternately, the polymerization occurs at a temperature and pressure above the fluid-fluid phase transition temperature and pressure of the polymerization system. Alternately, the polymerization occurs at a temperature and pressure below the fluid-fluid phase transition temperature and pressure of the polymerization system.

In another embodiment, the polymerization system is preferably a homogeneous, single phase polymerization system, preferably a homogeneous dense fluid polymerization system.

In another embodiment, the reaction temperature is preferably below the critical temperature of the polymerization system. Preferably, the temperature is above the solid-fluid phase transition temperature of the polymer-containing fluid reaction medium at the reactor pressure or at least 5° C. above the solid-fluid phase transition temperature of the polymer-containing fluid reaction medium at the reactor pressure, or at least 10° C. above the solid-fluid phase transformation point of the polymer-containing fluid reaction medium at the reactor pressure. In another embodiment, the temperature is above the cloud point of the single-phase fluid reaction medium at the reactor pressure, or 2° C. or more above the cloud point of the fluid reaction medium at the reactor pressure. In yet another embodiment, the temperature is between 60° C. and 150° C., between 60° C. and 140° C., between 70° C. and 130° C., or between 80° C. and 130° C. In one embodiment, the temperature is above 60° C., 65° C., 70° C., 75° C., 80° C., 85° C., 90° C., 95° C., 100° C., 105° C., or 110° C. In another embodiment, the temperature is below 150° C., 140° C., 130° C., or 120° C. In another embodiment, the cloud point temperature is below the supercritical temperature of the polymerization system or between 70° C. and 150° C.

In another embodiment, the polymerization occurs at a temperature and pressure above the solid-fluid phase transition temperature of the polymerization system, preferably the polymerization occurs at a temperature at least 5° C. higher (preferably at least 10° C. higher, preferably at least 20° C. higher) than the solid-fluid phase transition temperature and at a pressure at least 2 MPa higher (preferably at least 5 MPa higher, preferably at least 10 MPa higher) than the cloud point pressure of the polymerization system. In a preferred embodiment, the polymerization occurs at a pressure above the fluid-fluid phase transition pressure of the polymerization system (preferably at least 2 MPa higher, preferably at least 5 MPa higher, preferably at least 10 MPa higher than the fluid-fluid phase transition pressure). Alternately, the polymerization occurs at a temperature at least 5° C. higher (preferably at least 10° C. higher, preferably at least 20° C. higher) than the solid-fluid phase transition temperature and at a pressure higher than, (preferably at least 2 MPa higher, preferably at least 5 MPa higher, preferably at least 10 MPa higher) than the fluid-fluid phase transition pressure of the polymerization system.

In another embodiment, the polymerization occurs at a temperature above the solid-fluid phase transition temperature of the polymer-containing fluid reaction medium at the reactor pressure, preferably at least 5° C. above the solid-fluid phase transition temperature of the polymer-containing fluid reaction medium at the reactor pressure, or preferably at least 10° C. above the solid-fluid phase transformation point of the polymer-containing fluid reaction medium at the reactor pressure.

In another useful embodiment, the polymerization occurs at a temperature above the cloud point of the single-phase fluid reaction medium at the reactor pressure, more preferably 2° C. or more (preferably 5° C. or more, preferably 10° C. or more, preferably 30° C. or more) above the cloud point of the fluid reaction medium at the reactor pressure. Alternately, in another useful embodiment, the polymerization occurs at a temperature above the cloud point of the polymerization system at the reactor pressure, more preferably 2° C. or more (preferably 5° C. or more, preferably 10° C. or more, preferably 30° C. or more) above the cloud point of the polymerization system.

In another embodiment, the polymerization process temperature is above the solid-fluid phase transition temperature of the polymer-containing fluid polymerization system at the reactor pressure, or at least 2° C. above the solid-fluid phase transition temperature of the polymer-containing fluid polymerization system at the reactor pressure, or at least 5° C. above the solid-fluid phase transition temperature of the polymer-containing fluid polymerization at the reactor pressure, or at least 10° C. above the solid-fluid phase transformation point of the polymer-containing fluid polymerization system at the reactor pressure. In another embodiment, the polymerization process temperature should be above the cloud point of the single-phase fluid polymerization system at the reactor pressure, or 2° C. or more above the cloud point of the fluid polymerization system at the reactor pressure. In still another embodiment, the polymerization process temperature is between 50° C. and 350° C., or between 60° C. and 250° C., or between 70° C. and 250° C., or between 80° C. and 250° C. Exemplary lower polymerization temperature limits are 50° C., or 60° C., or 70° C., or 80° C., or 90° C., or 95° C., or 100° C., or 110° C., or 120° C. Exemplary upper polymerization temperature limits are 350° C., or 250° C., or 240° C., or 230° C., or 220° C., or 210° C., or 200° C.

In some embodiments of the invention, the preferred polymerization is 100° C. or higher, and when 100° C., the polymer produced can have a peak melting point Tm of greater than 155° C., preferably greater than 158° C., preferably greater than 160° C.

In other embodiments of the invention, the preferred polymerization is 70° C. or higher, and when 70° C., the polymer produced can have a peak melting point Tm of greater than 155° C., preferably greater than 160° C., preferably greater than 163° C.

Room temperature is 23° C. unless otherwise noted.

Other additives may also be used in the polymerization, as desired, such as one or more scavengers, hydrogen, aluminum alkyls, silanes, or chain transfer agents (such as alkylalumoxanes, a compound represented by the formula AlR₃ or ZnR₂ (where each R is, independently, a C₁-C₈ aliphatic radical, preferably methyl, ethyl, propyl, butyl, pentyl, hexyl octyl or an isomer thereof) or a combination thereof, such as diethyl zinc, methylalumoxane, MMAO-3A, trimethylaluminum, triisobutylaluminum, trioctylaluminum, or a combination thereof).

### Polyolefin Products

This invention also relates to compositions of matter produced by the methods described herein. The processes described herein may be used to produce polymers of olefins or mixtures of olefins. Polymers that may be prepared include polypropylene homopolymers having the properties described below.

This invention also relates to polymer compositions of matter described herein.

Generally, the process of this invention produces olefin polymers, preferably polypropylene homopolymers and propylene copolymers with C₄-C₂₀ alpha olefins.

While the molecular weight of propylene polymers is influenced by numerous process conditions that include temperature, monomer concentration and pressure, the presence of chain transfer agents and the like, the polypropylene homopolymer and copolymer products produced by the present process typically have a weight-average molecular weight (Mw) of about 1,000 to about 1,000,000 g/mol, alternately of about 10,000 to about 600,000 g/mol, or alternately of about 100,000 to about 500,000 g/mol (where all molecular weight values (Mn, Mw and Mz) are presented in terms of calculated polypropylene molecular weights).

Alternatively, in some embodiments of the invention, the polymers produced herein have an Mw of 1,000 to 2,000,000 g/mol (preferably 5,000 to 1,000,000 g/mol, alternatively 10,000 to 500,000 g/mol, alternatively 10,000 to 300,000 g/mol, and/or an Mw/Mn of greater than 1 to 40 (alternately 1.2 to 20, alternately 1.3 to 10, alternately 1.4 to 5, 1.5 to 4, alternately 1.5 to 3) wherein the molecular weight values are relative to linear polystyrene standards.

Likewise, while process conditions can influence polymer melting point, the polypropylene homopolymer and copolymer products produced by the present process typically have a Tₘ of about 100° C. to about 175° C., alternately of about 120° C. to about 170° C., alternately of about 140° C. to about 168° C. Alternately the polymers produced have a Tₘ of 150° C. or more. In addition, the polymer products typically have a heat of fusion, (H_{f} or ΔH_{f}), of up to 160 J/g, alternately from 20 up to 150 J/g, alternately from about 80 to 120 J/g, alternately from about 90 to 110 J/g, alternately greater than 90 J/g, alternately greater than 100 J/g, alternately greater than 110 J/g, alternately greater than 120 J/g.

In an embodiment, this invention relates to a propylene-alpha-olefin copolymer having 1) 20 wt. % alpha-olefin or less (alternatively 15 wt. % alpha-olefin or less, alternatively 10 wt. % alpha-olefin or less), 2) a Tm of 50° C. or more (alternatively 70° C. or more, alternatively 80° C. or more, alternatively 90° C. or more, alternatively 100° C. or more, alternatively 110° or more); and 3) greater than 0.02 unsaturated end-groups per 1,000 C as determined by ¹H NMR (alternatively greater than 0.05 unsaturated end-groups per 1,000 C, alternatively greater than 0.10 unsaturated end-groups per 1,000 C, alternatively greater than 0.30 unsaturated end-groups per 1,000 C, alternatively greater than 0.50 unsaturated end-groups per 1,000 C) and wherein the alpha-olefin is a C₄-C₂₀ alpha olefin.

In a preferred embodiment, the monomer is propylene and the comonomer is butene or hexene, preferably from 0.5 to 50 mole % butene or hexene, alternately 1 to 40 mole %, alternately 1 to 30% mole, alternately 1 to 25 mole %, alternately 1 to 20 mole %, alternatively 1 to 15 mole %, alternately 1 to 10 mole %.

In a preferred embodiment, the monomer is propylene and no comonomer is present.

In a preferred embodiment, the monomer is propylene, no comonomer is present, and the polymer is isotactic.

In a preferred embodiment the polymer produced herein has a unimodal or multimodal molecular weight distribution (MWD=Mw/Mn) as determined by Gel Permeation Chromatography (GPC). By “unimodal” is meant that the GPC trace has one peak or inflection point. By “multimodal” is meant that the GPC trace has at least two peaks or inflection points. An inflection point is that point where the second derivative of the curve changes in sign (e.g., from negative to positive or vice versus).

In a preferred embodiment the polypropylene produced herein has a Tₘ of 150° C. or more (preferably 155° C. or more, or 160° C. or more, or 162° C. or more, or 165° C. or more), and an Mn of 20,000 g/mol or more, preferably 50,000 g/mol or more, more preferably 100,000 g/mol or more, more preferably 150,000 g/mole or more (GPC-DRI, relative to linear polystyrene standards). GPC-DRI, relative to linear polystyrene standards means that the numerical values have not been corrected to polypropylene values.

In a preferred embodiment the polypropylene produced herein has a Tₘ of 150° C. or more (preferably 155° C. or more, 160° C. or more, or 162° C. or more, or 165° C. or more), and an Mw of 50,000 g/mol or more, preferably 100,000 g/mol or more, preferably 150,000 g/mol or more, more preferably 200,000 g/mol or more, more preferably 250,000 g/mole or more (GPC-DRI, relative to linear polystyrene standards). In a preferred embodiment the polypropylene produced herein has a Tₘ of 145° C. or more (preferably 150° C. or more, 155° C. or more, or 160° C. or more, or 163° C. or more), and an Mw of 50,000 to 350,000 g/mol, preferably 100,000 to 300,000 g/mol, preferably 150,000 to 275,000 g/mol, more preferably 200,000 to 260,000 g/mol (GPC-DRI, relative to linear polystyrene standards). GPC-DRI, relative to linear polystyrene standards means that the numerical values have not been corrected to polypropylene values.

In a preferred embodiment of the invention, the polymer Mw (GPC-DRI, relative to linear polystyrene standards) is less than 1E-08e^{0.1962x} where x is the Tm (° C.) of the polymer as measured by DSC (2^{nd} melt) (alternatively less than 4E-09e^{0.2019x}, alternatively less than 1E-09e^{0.2096x}), and greater than 2E-16e^{0.2956x} where x is the Tm of the polymer as measured by DSC (2^{nd} melt) (alternatively greater than y=5E-16e^{0.291x}, alternatively greater than 1E-15e^{0.2869x}) and where in the Tm of the polypropylene is 155° C. or greater.

Alternately, the polymer Mw (GPC-DRI, relative to linear polystyrene standards) is less than (10⁻⁸)(e^{0.1962z}), where z is the Tm (° C.) of the polymer as measured by DSC (2^{nd} d melt) (alternatively less than (4×10⁻⁹)(e^{0.2019z}), alternatively less than (10⁻⁹)(e^{0.2096z})), and greater than (2×10⁻¹⁶)(e^{0.2956z}) where z is the Tm of the polymer as measured by DSC (2^{nd} melt) (alternatively greater than (5×10⁻¹⁶)(e^{0.291z}), alternatively greater than (10⁻¹⁵)(e^{0.2869z})) and where in the Tm of the polypropylene is 155° C. or greater.

In another embodiment, the polypropylene produced herein has a Tₘ of 150° C. or more (preferably 155° C. or more, 160° C. or more, or 162° C. or more, 165° C. or more), and a Mw of 50,000 or more g/mol, preferably 80,000 g/mol or more, more preferably 100,000 g/mol or more (GPC-DRI, corrected to polypropylene values). GPC-DRI, corrected to polypropylene values means that while the GPC instrument was calibrated to linear polystyrene samples, values reported are corrected to polypropylene values using the appropriate Mark Houwink coefficients.

In a preferred embodiment of the invention, the polymer produced herein is isotactic, preferably highly isotactic. An “isotactic” polymer has at least 10% isotactic pentads, a “highly isotactic” polymer has at least 50% isotactic pentads, and a “syndiotactic” polymer has at least 10% syndiotactic pentads, according to analysis by ¹³C-NMR. Preferably isotactic polymers have at least 50% (preferably at least 60%, preferably at least 70%, preferably at least 80%, preferably at least 90%) isotactic pentads. A polyolefin is “atactic” if it has less than 5% isotactic pentads and less than 5% syndiotactic pentads.

In an embodiment of the invention, the polymer produced herein has an mmmm pentad tacticity index of 75% or greater (preferably 80% or greater, preferably 85% or greater, preferably 90% or greater, preferably 95% or greater, preferably 96% or greater, preferably 97% or greater, preferably 98% or greater as determined by ¹³C NMR as described below.

In a preferred embodiment of the invention, the polymer produced herein is isotactic, and contains 2,1- and in some instances, 1,3-regio defects (1,3-regio defects are also sometimes called 3,1-regio defects, and the term regio defect is also called regio-error). In some embodiments of the invention, the polymer produced herein has less than 200 total regio defects/10,000 monomer units (defined as the sum of 2,1-erythro and 2,1-threo insertions, and 3,1-isomerizations (also called 1,3-insertions) as measured by ¹³C-NMR (preferably less than 100 total regio defects/10,000 monomer units, preferably less than 50 total regio defects/10,000 monomer units, preferably less than 35 total regio defects/10,000 monomer units, preferably less than 30 total regio defects/10,000 monomer units, preferably less than 25 total regio defects/10,000 monomer units, preferably less than 20 total regio defects/10,000 monomer units) with the proviso that the total regio defects is not less than 1 total regio defects/10,000 monomer units, preferably not less than 2 total regio defects/10,000 monomer units, alternatively not less than 5 total regio defects/10,000 monomer units. In some embodiments of the invention, the isotactic polymers contain no measureable 1,3-regio defects.

In a preferred embodiment, the isotactic polypropylene polymer has 1,3-regio defects of 30/10,000 monomer units or less (preferably less than 20/10,000 monomer units, preferably less than 10/10,000 monomer units, preferably less than 5/10,000 monomer units, preferably less than 4/10,000 monomer units, preferably less than 3/10,000 monomer units, preferably less than 2/10,000 monomer units, preferably less than 1/10,000 monomer units) as determined by ¹³C NMR.

In a preferred embodiment, the isotactic polypropylene polymer has a Tm as measured by DSC of 155° C. or greater (preferably 157° C. or greater, alternatively 159° C. or greater, alternatively 160° C. or greater, alternatively 161° C. or greater, and wherein the total regio defects/10,000 monomer units is less than −1.18×Tm(° C.)+210, alternatively less than −1.18×Tm(° C.)+209.5, alternatively 1.18×Tm(° C.)+209 with the proviso that the total regio defects is not less than 3 total regio defects/10,000 monomer units, preferably not less than 4 total regio defects/10,000 monomer units, alternatively not less than 5 total regio defects/10,000 monomer units.

In addition to total regio defects defined above, isotactic polymers also exhibit stereo-defects. “Total defects” is defined to be total regio defects plus stereo-defects. Total regio defects times 100 and divided by the “total defects” is referred to as the percentage of total regio defects. In some embodiments of the invention the percentage of total regio defects is less than 40%, preferably less than 35%, preferably less than 32%, preferably less than 30%, alternatively less than 25%.

In some embodiments of the invention, the isotactic polypropylene has greater than 0.05 unsaturated end-groups per 1000 C as determined by ¹H NMR (alternatively greater than 0.10 unsaturated end-groups per 1000 C, alternatively greater than 0.30 unsaturated end-groups per 1000 C, alternatively greater than 0.50 unsaturated end-groups per 1000 C).

In some embodiments of the invention, the propylene based polymers are propylyene-alpha-olefin copolymers wherein the alpha-olefin is a C₄-C₂₀ alpha olefin. Preferably, the propylyene-alpha-olefin copolymer contains 50 mol % propylene or greater, alternatively 60 mol % propylene or greater, alternatively 70 mol % propylene or greater, alternatively 80 mol % propylene or greater, alternatively 90 mol % propylene or greater, with the lower limit of C₄-C₂₀ alpha-olefin being 1 mol %, alternatively 3 mol %, alternatively 5 mol %, alternatively 10 mol %, alternatively 15 mol %, alternatively 20 mol %, alternatively 30 mol %. In a preferred embodiment of the invention, the propylene-alpha-olefin copolymers have at least 50% (preferably at least 60%, preferably at least 70%, preferably at least 80%, preferably at least 90%) isotactic triads as measured by ¹³C NMR.

### ¹³C-NMR Spectroscopy on Polyolefins

Polypropylene microstructure is determined by ¹³C-NMR spectroscopy, including the concentration of isotactic and syndiotactic diads ([m] and [r]), triads ([mm] and [rr]), and pentads ([mmmm] and [rrrr]). The designation “m” or “r” describes the stereochemistry of pairs of contiguous propylene groups, “m” referring to meso and “r” to racemic. Samples are dissolved in d₂-1,1,2,2-tetrachloroethane, and spectra recorded at 120° C. using a ¹³C frequency of 125 MHz (or higher) NMR spectrometer. Polymer resonance peaks are referenced to mmmm=21.8 ppm. Calculations involved in the characterization of polymers by NMR are described by F. A. Bovey in Polymer Conformation and Configuration (Academic Press, New York 1969) and J. Randall in Polymer Sequence Determination, ¹³C-NMR Method (Academic Press, New York, 1977).

The “propylene tacticity index”, expressed herein as [m/r], is calculated as defined in H. N. Cheng (1984) Macromolecules, v. 17, p. 1950. When [m/r] is 0 to less than 1.0, the polymer is generally described as syndiotactic, when [m/r] is 1.0 the polymer is atactic, and when [m/r] is greater than 1.0 the polymer is generally described as isotactic.

The “mm triad tacticity index” of a polymer is a measure of the relative isotacticity of a sequence of three adjacent propylene units connected in a head-to-tail configuration. More specifically, in the present invention, the mm triad tacticity index (also referred to as the “mm Fraction”) of a polypropylene homopolymer or copolymer is expressed as the ratio of the number of units of meso tacticity to all of the propylene triads in the copolymer:

$$mm Fraction = \frac{PPP ( mm )}{PPP ( mm ) + PPP ( mr ) + PPP ( rr )}$$

where PPP(mm), PPP(mr) and PPP(rr) denote peak areas derived from the methyl groups of the second units in the possible triad configurations for three head-to-tail propylene units, shown below in Fischer projection diagrams:

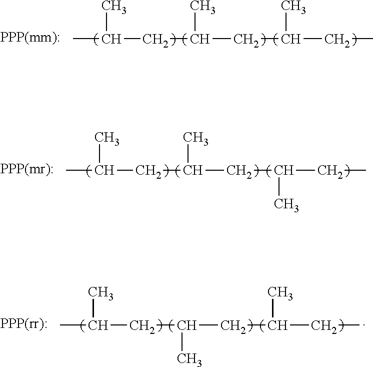

The calculation of the mm Fraction of a propylene polymer is described in U.S. Pat. No. 5,504,172 (homopolymer: column 25, line 49 to column 27, line 26; copolymer: column 28, line 38 to column 29, line 67). For further information on how the mm triad tacticity can be determined from a ¹³C-NMR spectrum, see 1) J. A. Ewen (1986), Catalytic Polymerization of Olefins: Proceedings of the International Symposium on Future Aspects of Olefin Polymerization, T. Keii and K. Soga, Eds. (Elsevier), pp. 271-292; and 2) US Patent Application Publication No. US2004/054086 (paragraphs [0043] to [0054]).

Similarly m diads and r diads can be calculated as follows where mm, mr and mr are defined above:

m=mm+½mr

r=rr+½mr.

In another embodiment of the invention, the propylene polymers produced herein (preferably a homopolypropylene) have regio defects (as determined by ¹³C NMR), based upon the total propylene monomer. Three types defects are defined to be the regio defects: 2,1-erythro, 2,1-threo, and 3,1-isomerization. The structures and peak assignments for these are given in [L. Resconi, et al. (2000) Chem. Rev., v. 100, pp. 1253-1345]. The regio defects each give rise to multiple peaks in the carbon NMR spectrum, and these are all integrated and averaged (to the extent that they are resolved from other peaks in the spectrum), to improve the measurement accuracy. The chemical shift offsets of the resolvable resonances used in the analysis are tabulated below. The precise peak positions may shift as a function of NMR solvent choice.

| Regio defect | Chemical shift range (ppm) |
|---|---|
| 2,1-erythro | 42.3, 38.6, 36.0, 35.9, 31.5, 30.6, 17.6, 17.2 |
| 2,1-threo | 43.4, 38.9, 35.6, 34.7, 32.5, 31.2, 15.4, 15.0 |
| 3,1 insertion | 37.6, 30.9, 27.7 |

The average integral for each defect is divided by the integral for one of the main propylene signals (CH₃, CH, CH₂), and multiplied by 10,000 to determine the defect concentration per 10,000 monomers.

Mn (¹H NMR) is determined according to the following NMR method. ¹H NMR data is collected at either room temperature or 120° C. (for purposes of the claims, 120° C. shall be used) in a 10 mm probe using a Bruker spectrometer with a ¹H frequency of 500 MHz or higher (for the purpose of the claims, a proton frequency of 600 MHz is used and the polymer sample is dissolved in 1,1,2,2-tetrachloroethane-d₂ (TCE-d₂) and transferred into a 10 mm glass NMR tube). Data are recorded using a maximum pulse width of 45° C., 5 seconds between pulses and signal averaging 512 transients. Spectral signals are integrated and the number of unsaturation types per 1,000 carbons is calculated by multiplying the different groups by 1,000 and dividing the result by the total number of carbons. Mn is calculated by dividing the total number of unsaturated species into 14,000, and has units of g/mol. The chemical shift regions for the olefin types are defined to be between the following spectral regions.

| | | Number of hydrogens |
|---|---|---|
| Unsaturation Type | Region (ppm) | per structure |
| Vinyl | 4.98-5.13 | 2 |
| Vinylidene (VYD) | 4.69-4.88 | 2 |
| Vinylene | 5.31-5.55 | 2 |
| Trisubstituted | 5.11-5.30 | 1 |

### Blends

In another embodiment, the propylene homopolymer or propylene copolymer with a C₄ or higher alpha olefin produced herein is combined with one or more additional polymers prior to being formed into a film, molded part or other article. Other useful polymers include polyethylene, isotactic polypropylene, highly isotactic polypropylene, syndiotactic polypropylene, random copolymer of propylene and ethylene, and/or butene, and/or hexene, polybutene, ethylene vinyl acetate, LDPE, LLDPE, HDPE, ethylene vinyl acetate, ethylene methyl acrylate, copolymers of acrylic acid, polymethylmethacrylate or any other polymers polymerizable by a high-pressure free radical process, polyvinylchloride, polybutene-1, isotactic polybutene, ABS resins, ethylene-propylene rubber (EPR), vulcanized EPR, EPDM, block copolymer, styrenic block copolymers, polyamides, polycarbonates, PET resins, cross linked polyethylene, copolymers of ethylene and vinyl alcohol (EVOH), polymers of aromatic monomers such as polystyrene, poly-1 esters, polyacetal, polyvinylidine fluoride, polyethylene glycols, and/or polyisobutylene.

In a preferred embodiment, the propylene polymer (preferably the homopolypropylene) is present in the above blends, at from 10 to 99 wt %, based upon the weight of the polymers in the blend, preferably 20 to 95 wt %, even more preferably at least 30 to 90 wt %, even more preferably at least 40 to 90 wt %, even more preferably at least 50 to 90 wt %, even more preferably at least 60 to 90 wt %, even more preferably at least 70 to 90 wt %.

The blends described above may be produced by mixing the polymers of the invention with one or more polymers (as described above), by connecting reactors together in series to make reactor blends or by using more than one catalyst in the same reactor to produce multiple species of polymer. The polymers can be mixed together prior to being put into the extruder or may be mixed in an extruder.

The blends may be formed using conventional equipment and methods, such as by dry blending the individual components and subsequently melt mixing in a mixer, or by mixing the components together directly in a mixer, such as, for example, a Banbury mixer, a Haake mixer, a Brabender internal mixer, or a single or twin-screw extruder, which may include a compounding extruder and a side-arm extruder used directly downstream of a polymerization process, which may include blending powders or pellets of the resins at the hopper of the film extruder. Additionally, additives may be included in the blend, in one or more components of the blend, and/or in a product formed from the blend, such as a film, as desired. Such additives are well known in the art, and can include, for example: fillers; antioxidants (e.g., hindered phenolics such as IRGANOX™ 1010 or IRGANOX™ 1076 available from Ciba-Geigy); phosphites (e.g., IRGAFOS™ 168 available from Ciba-Geigy); anti-cling additives; tackifiers, such as polybutenes, terpene resins, aliphatic and aromatic hydrocarbon resins, alkali metal and glycerol stearates, and hydrogenated rosins; UV stabilizers; heat stabilizers; anti-blocking agents; release agents; anti-static agents; pigments; colorants; dyes; waxes; silica; fillers; talc; and the like.

The polymer products produced by the present process may be blended with one or more other polymers, including but not limited to, thermoplastic polymer(s) and/or elastomer(s), such as those disclosed at page 59 of WO 2004/014998.

The polymers of this invention (and blends thereof as described above) whether formed in situ or by physical blending are preferably used in any known thermoplastic or elastomer application. Examples include uses in molded parts, films, tapes, sheets, tubing, hose, sheeting, wire and cable coating, adhesives, shoe soles, bumpers, gaskets, bellows, films, fibers, elastic fibers, nonwovens, spunbonds, sealants, surgical gowns and medical devices. Films of polymers produced herein may made according to WO 2004/014998 at page 63, line 1 to page 66, line 26, including that the films of polymers produced herein may be combined with one or more other layers as described at WO 2004/014998 at page 63, line 21 to page 65, line 2.

Any of the foregoing polymers and compositions in combination with optional additives (see, for example, US Patent Application Publication No. 2016/0060430, paragraphs [0082]-[0093]) may be used in a variety of end-use applications. Such end uses may be produced by methods known in the art. End uses include polymer products and products having specific end-uses. Exemplary end uses are films, film-based products, diaper backsheets, housewrap, wire and cable coating compositions, articles formed by molding techniques, e.g., injection or blow molding, extrusion coating, foaming, casting, and combinations thereof. End uses also include products made from films, e.g., bags, packaging, and personal care films, pouches, medical products, such as for example, medical films and intravenous (IV) bags.

### Films

Specifically, any of the foregoing polymers, such as the foregoing polypropylenes or blends thereof, may be used in a variety of end-use applications. Such applications include, for example, mono- or multi-layer blown, extruded, and/or shrink films. These films may be formed by any number of well-known extrusion or coextrusion techniques, such as a blown bubble film processing technique, wherein the composition can be extruded in a molten state through an annular die and then expanded to form a uni-axial or biaxial orientation melt prior to being cooled to form a tubular, blown film, which can then be axially slit and unfolded to form a flat film. Films may be subsequently unoriented, uniaxially oriented, or biaxially oriented to the same or different extents. One or more of the layers of the film may be oriented in the transverse and/or longitudinal directions to the same or different extents. The uniaxially orientation can be accomplished using typical cold drawing or hot drawing methods. Biaxial orientation can be accomplished using tenter frame equipment or a double bubble processes and may occur before or after the individual layers are brought together. For example, a polyethylene layer can be extrusion coated or laminated onto an oriented polypropylene layer or the polyethylene and polypropylene can be coextruded together into a film then oriented. Likewise, oriented polypropylene could be laminated to oriented polyethylene or oriented polyethylene could be coated onto polypropylene then optionally the combination could be oriented even further. Typically the films are oriented in the Machine Direction (MD) at a ratio of up to 15, preferably between 5 and 7, and in the Transverse Direction (TD) at a ratio of up to 15, preferably 7 to 9. However, in another embodiment the film is oriented to the same extent in both the MD and TD directions.

The films may vary in thickness depending on the intended application; however, films of a thickness from 1 to 50 m are usually suitable. Films intended for packaging are usually from 10 to 50 m thick. The thickness of the sealing layer is typically 0.2 to 50 m. There may be a sealing layer on both the inner and outer surfaces of the film or the sealing layer may be present on only the inner or the outer surface.

In another embodiment, one or more layers may be modified by corona treatment, electron beam irradiation, gamma irradiation, flame treatment, or microwave. In a preferred embodiment, one or both of the surface layers is modified by corona treatment.

In another embodiment, this invention relates to:

1. A polymerization process comprising contacting in a homogeneous phase, propylene with a catalyst system comprising activator and catalyst compound represented by the Formula (I):

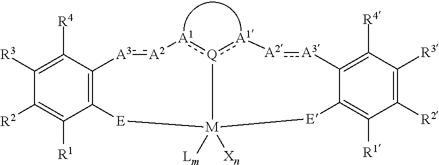

wherein:
M is a group 3, 4, 5, or 6 transition metal or a Lanthanide;
E and E′ are each independently O, S, or NR⁹ where R⁹ is independently hydrogen, a C₁-C₄₀ hydrocarbyl, a C₁-C₄₀ substituted hydrocarbyl or a heteroatom-containing group;
Q is group 14, 15, or 16 atom that forms a dative bond to metal M;
A¹QA^{1′} are part of a heterocyclic Lewis base containing 4 to 40 non-hydrogen atoms that links A² to A^{2′} via a 3-atom bridge with Q being the central atom of the 3-atom bridge, A¹ and A^{1′} are independently C, N, or C(R²²), where R²² is selected from hydrogen, C₁-C₂₀ hydrocarbyl, C₁-C₂₀ substituted hydrocarbyl;

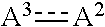

is a divalent group containing 2 to 40 non-hydrogen atoms that links A¹ to the E-bonded aryl group via a 2-atom bridge;

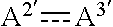

is a divalent group containing 2 to 40 non-hydrogen atoms that links A^{1′} to the E′-bonded aryl group via a 2-atom bridge;
L is a Lewis base; X is an anionic ligand; n is 1, 2 or 3; m is 0, 1, or 2; n+m is not greater than 4;
each of R¹, R², R³, R⁴, R^{1′}, R^{2′}, R^{3′}, and R^{4′} is independently hydrogen, a C₁-C₄₀ hydrocarbyl, a C₁-C₄₀ substituted hydrocarbyl, a heteroatom or a heteroatom-containing group,
and one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings;
any two L groups may be joined together to form a bidentate Lewis base;
an X group may be joined to an L group to form a monoanionic bidentate group;
any two X groups may be joined together to form a dianionic ligand group.

2. The process of paragraph 1 where the catalyst compound represented by the Formula (II):

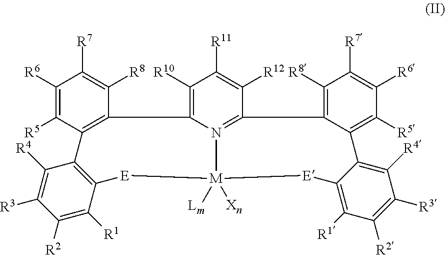

wherein:
M is a group 3, 4, 5, or 6 transition metal or a Lanthanide;
E and E′ are each independently O, S, or NR⁹, where R⁹ is independently hydrogen, a C₁-C₄₀ hydrocarbyl, a C₁-C₄₀ substituted hydrocarbyl, or a heteroatom-containing group;
each L is independently a Lewis base; each X is independently an anionic ligand; n is 1, 2 or 3; m is 0, 1, or 2; n+m is not greater than 4;
each of R¹, R², R³, R⁴, R^{1′}, R^{2′}, R^{3′}, and R^{4′} is independently hydrogen, C₁-C₄₀ hydrocarbyl, C₁-C₄₀ substituted hydrocarbyl, a heteroatom or a heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings; any two L groups may be joined together to form a bidentate Lewis base;
an X group may be joined to an L group to form a monoanionic bidentate group;
any two X groups may be joined together to form a dianionic ligand group;
each of R⁵, R⁶, R⁷, R⁸, R^{5′}, R^{6′}, R^{7′}, R^{8′}, R¹⁰, R¹¹, and R¹² is independently hydrogen, a C₁-C₄₀ hydrocarbyl, a C₁-C₄₀ substituted hydrocarbyl, a heteroatom or a heteroatom-containing group, or one or more of R⁵ and R⁶, R⁶ and R⁷, R⁷ and R⁸, R^{5′} and R^{6′}, R^{6′} and R^{7′}, R^{7′} and R^{8′}, R¹⁰ and R¹¹, or R¹¹ and R¹² may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings.

3. The process of paragraph 1 or 2 wherein the M is Hf, Zr or Ti, preferably Hf.

4. The process of paragraph 1, 2 or 3 wherein E and E′ are each O.

5. The process of paragraph 1, 2, 3, or 4 wherein R¹ and R^{1′} is independently a C₄-C₄₀ tertiary hydrocarbyl group, preferably a C₄-C₄₀ cyclic tertiary hydrocarbyl group, preferably a C₄-C₄₀ polycyclic tertiary hydrocarbyl group.

6. The process any of paragraphs 1 to 5 wherein each X is, independently, selected from the group consisting of substituted or unsubstituted hydrocarbyl radicals having from 1 to 30 (such as 1 to 20) carbon atoms, substituted or unsubstituted silylcarbyl radicals having from 3 to 30 carbon atoms, hydrides, amides, alkoxides, sulfides, phosphides, halides, substituted benzyl radicals having from 8 to 30 carbon atoms, and a combination thereof, (two X's may form a part of a fused ring or a ring system).

7. The process any of paragraphs 1 to 6 wherein each L is, independently, selected from the group consisting of: ethers, thioethers, amines, phosphines, ethyl ether, tetrahydrofuran, dimethylsulfide, triethylamine, pyridine, alkenes, alkynes, allenes, and carbenes and a combinations thereof, optionally two or more L's may form a part of a fused ring or a ring system).

8. The process of paragraph 1, wherein M is Zr or Hf, preferably Hf, Q is nitrogen, both A¹ and A^{1′} are carbon, both E and E′ are oxygen, and both R¹ and R^{1′} are C₄-C₂₀ cyclic tertiary alkyls.

9. The process of paragraph 1, wherein M is Zr or Hf, preferably Hf, Q is nitrogen, both A¹ and A^{1′} are carbon, both E and E′ are oxygen, and both R¹ and R^{1′} are adamantan-1-yl or substituted adamantan-1-yl.

10. The process of paragraph 1 or 2, wherein M is Hf.

11. The process of paragraph 1 or 2, wherein both R¹ and R^{1′} are adamantan-1-yl or substituted adamantan-1-yl.

12. The process of paragraph 1, wherein Q is carbon, A¹ and A^{1′} are both nitrogen, and both E and E′ are oxygen.

13. The process of paragraph 1, wherein Q is carbon, A¹ is nitrogen, A^{1′} is C(R²²), and both E and E′ are oxygen, where R²² is selected from hydrogen, C₁-C₂₀ hydrocarbyl, C₁-C₂₀ substituted hydrocarbyl.

14. The process of any of paragraphs 1 to 13, wherein the heterocyclic Lewis base is selected from the groups represented by the following formulas:

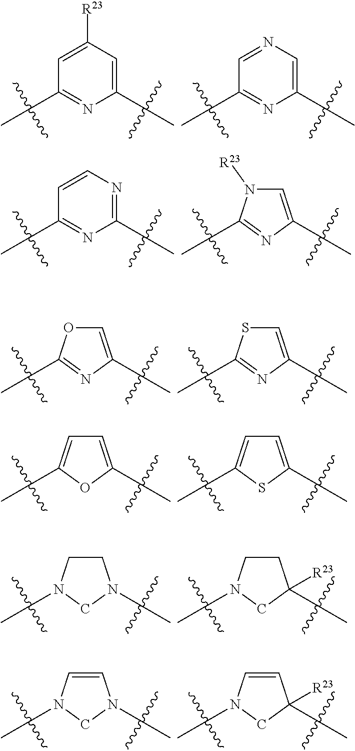

where each R²³ is independently selected from hydrogen, C₁-C₂₀ alkyls, and C₁-C₂₀ substituted alkyls.

15. The process of paragraph 2, wherein M is Zr or Hf, preferably Hf, both E and E′ are oxygen, and both R¹ and R^{1′} are C₄-C₂₀ cyclic tertiary alkyls.

16. The process of paragraph 2, wherein M is Zr or Hf, preferably Hf, both E and E′ are oxygen, and both R¹ and R^{1′} are adamantan-1-yl or substituted adamantan-1-yl.

17. The process of paragraph 2, wherein M is Zr or Hf, preferably Hf, both E and E′ are oxygen, and each of R¹, R^{1′}, R³ and R^{3′} are adamantan-1-yl or substituted adamantan-1-yl.

18. The process of paragraph 2, wherein M is Zr or Hf, preferably Hf, both E and E′ are oxygen, both R¹ and R^{1′} are C₄-C₂₀ cyclic tertiary alkyls, and both R⁷ and R^{7′} are C₁-C₂₀ alkyls.

19. The process of paragraph 2, wherein M is Zr or Hf, preferably Hf, both E and E′ are O, both R¹ and R^{1′} are C₄-C₂₀ cyclic tertiary alkyls, and both R⁷ and R^{7′} are C₁-C₂₀ alkyls.

20. The process of paragraph 2, wherein M is Zr or Hf, preferably Hf, both E and E′ are O, both R¹ and R^{1′} are C₄-C₂₀ cyclic tertiary alkyls, and both R⁷ and R^{7′} are C₁-C₃ alkyls.

21. The process of paragraph 1 wherein the catalyst compound is represented by one or more of the following formulas:

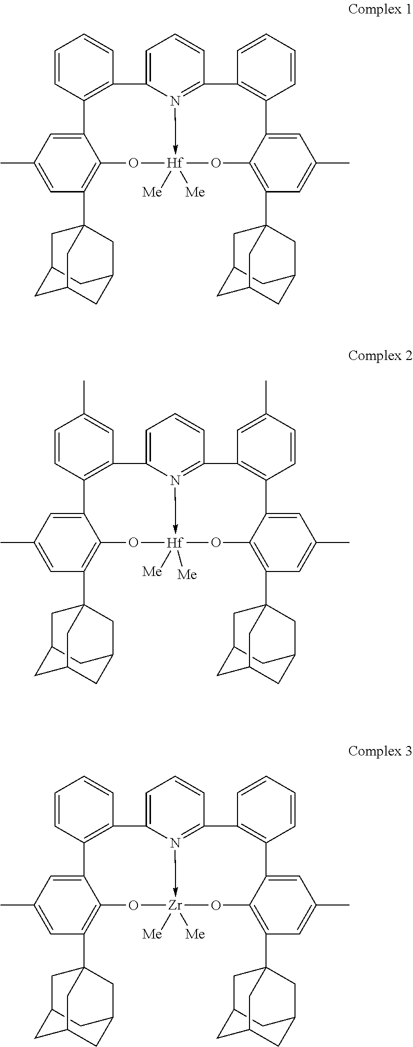

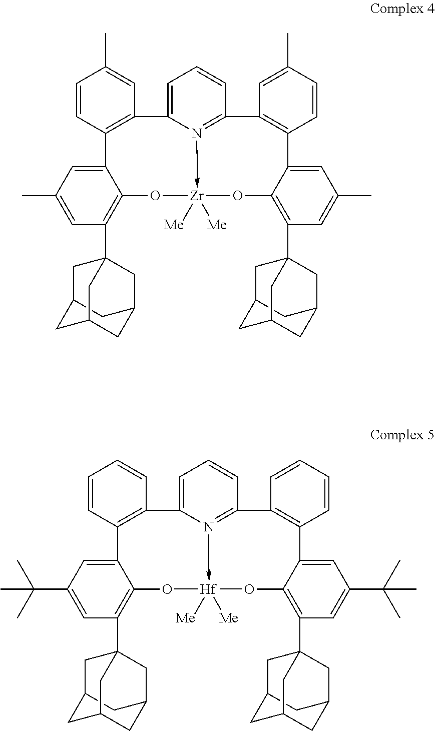

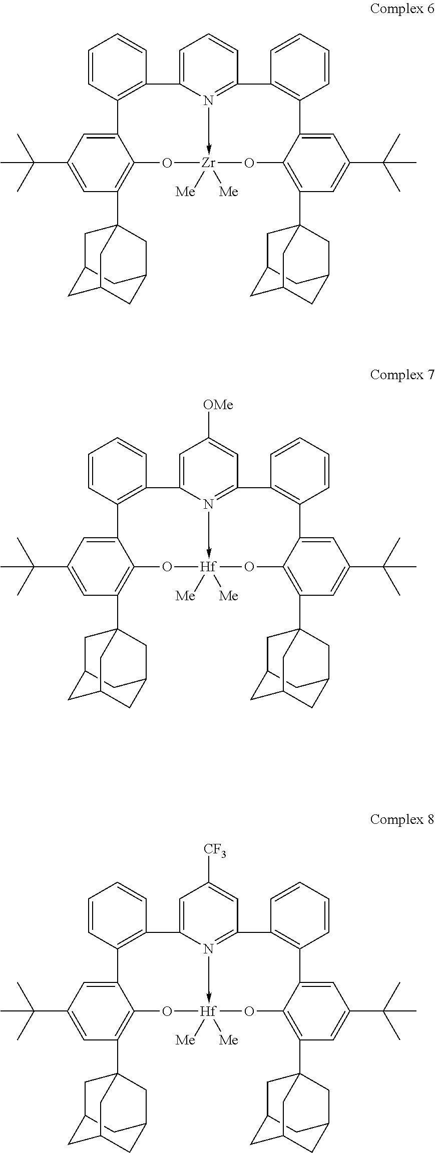

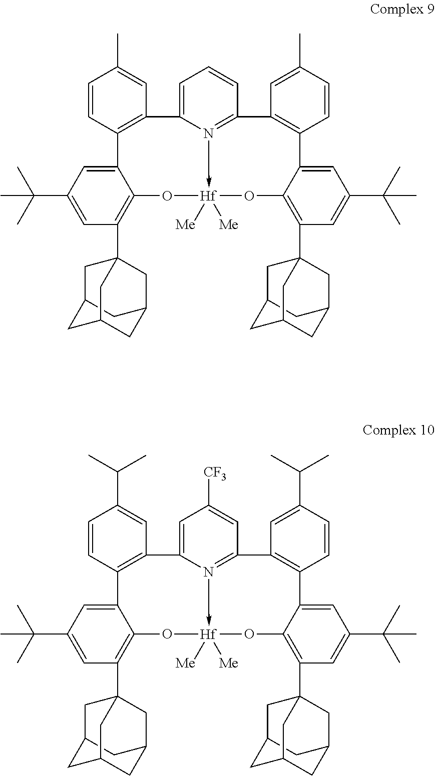

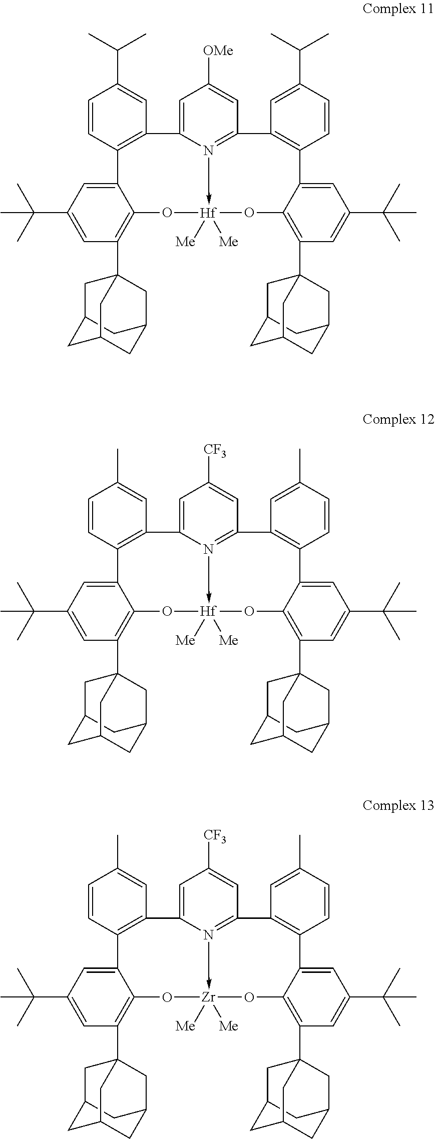

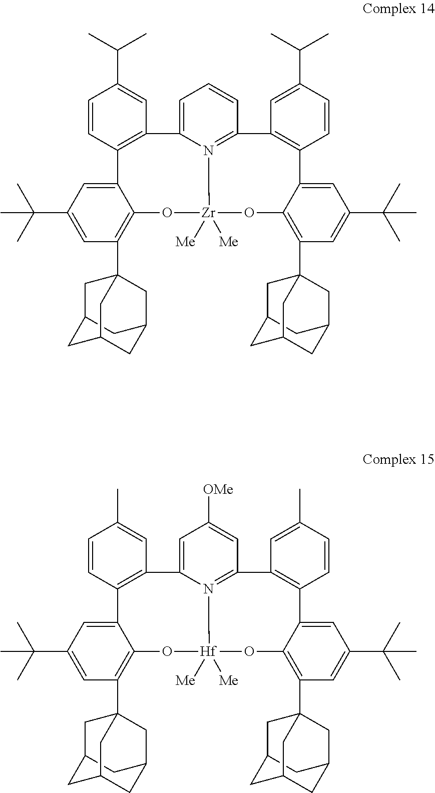

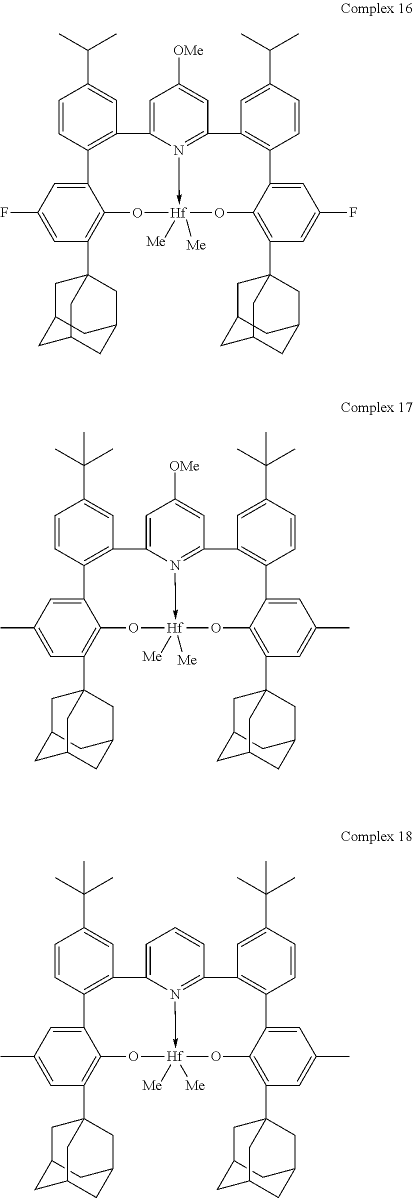

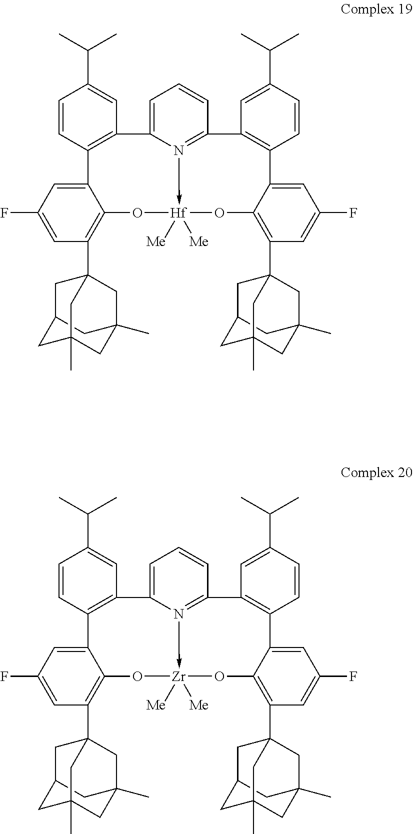

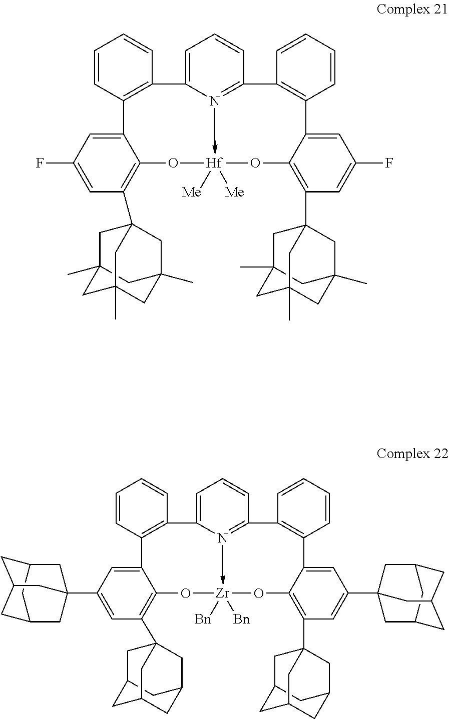

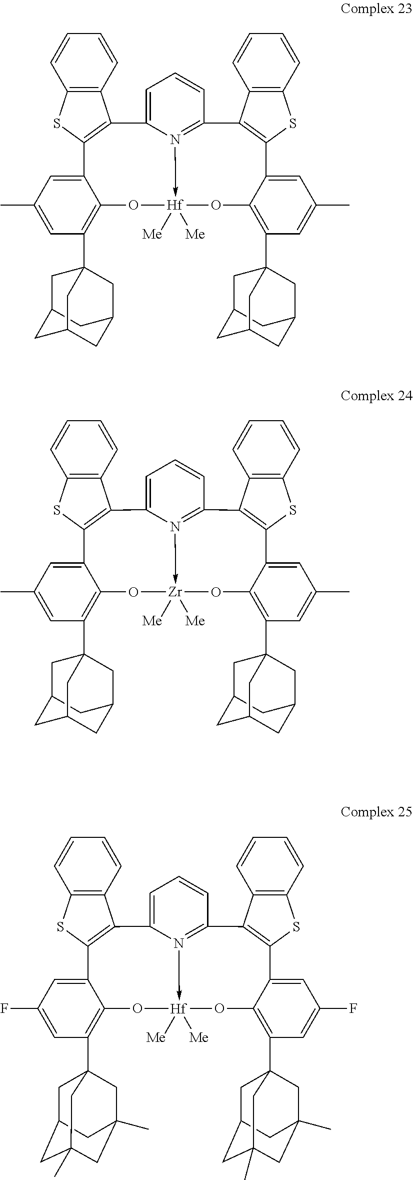

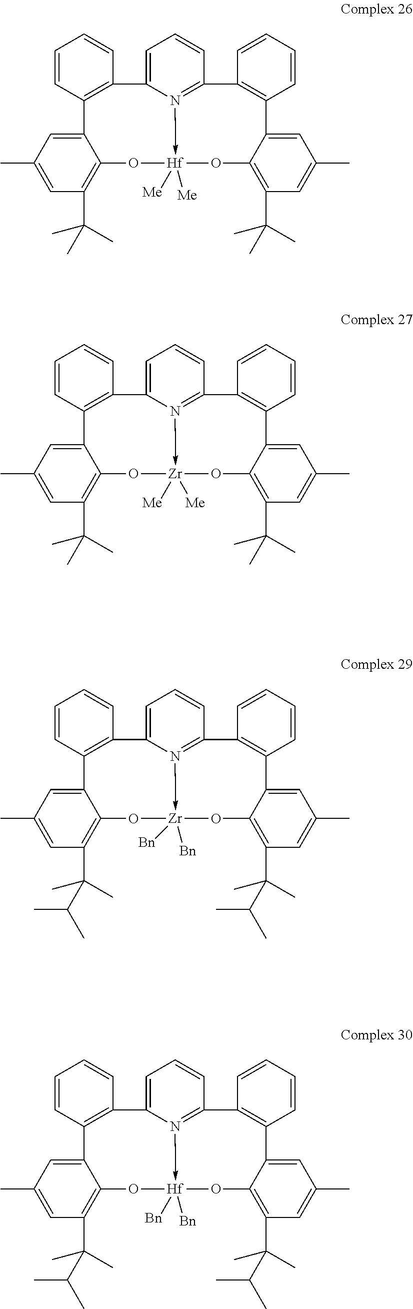

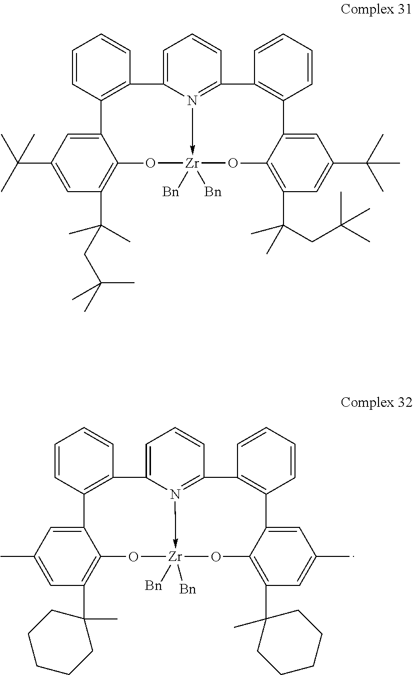

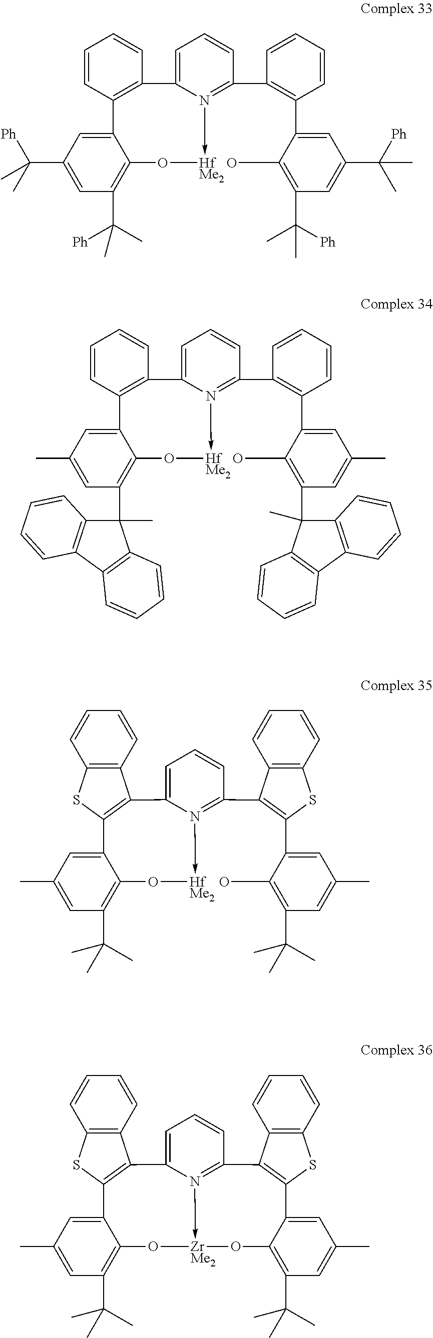

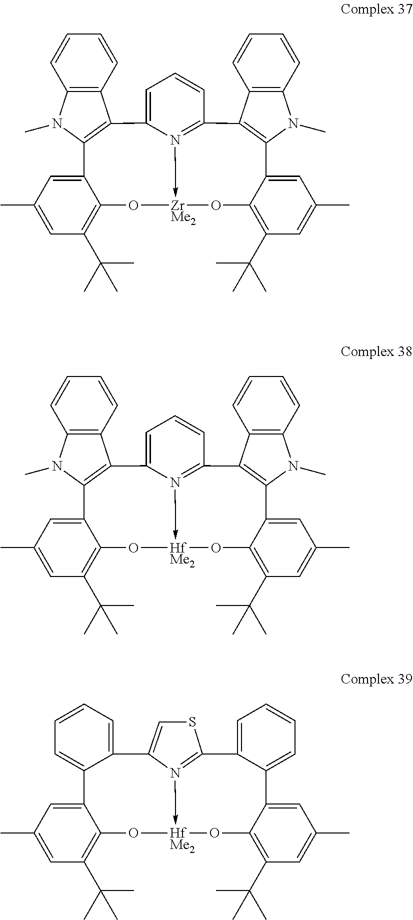

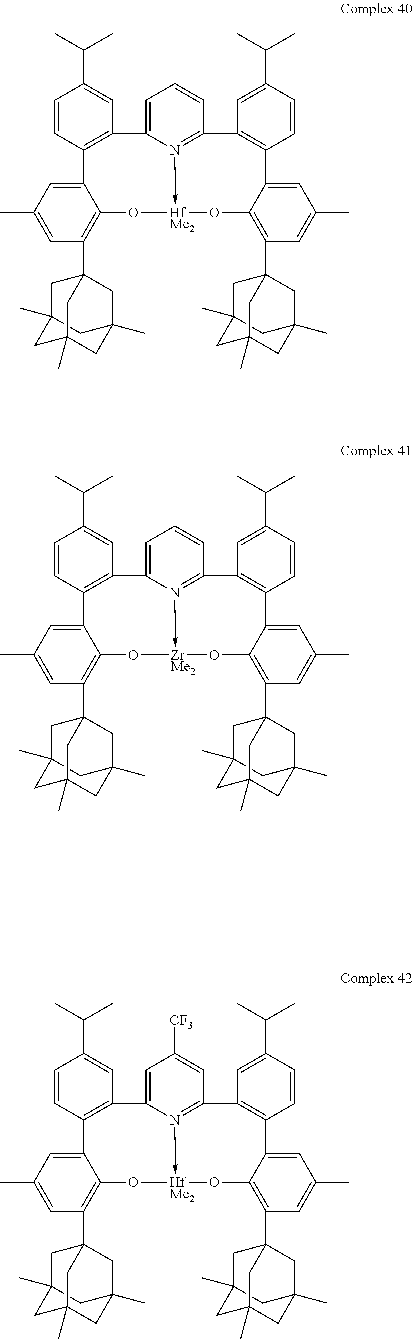

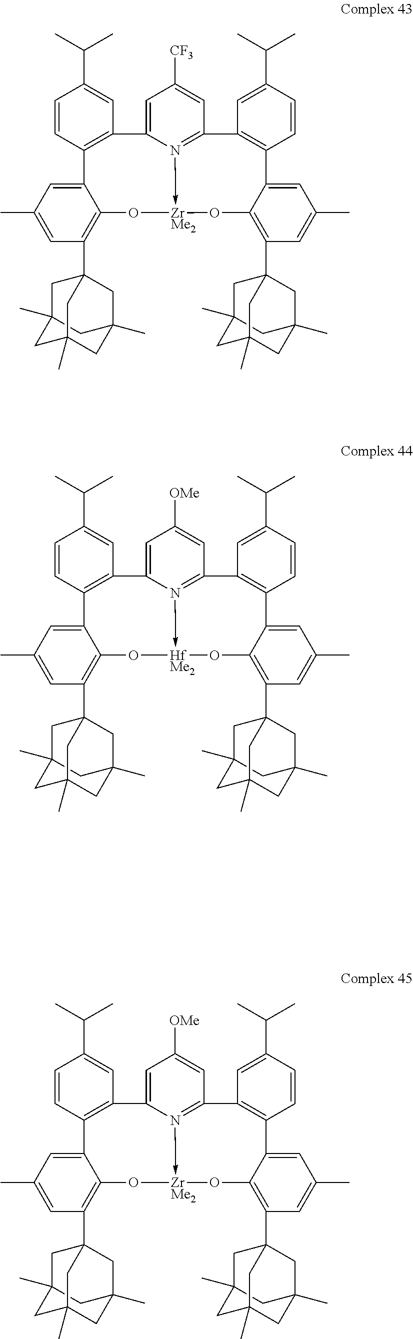

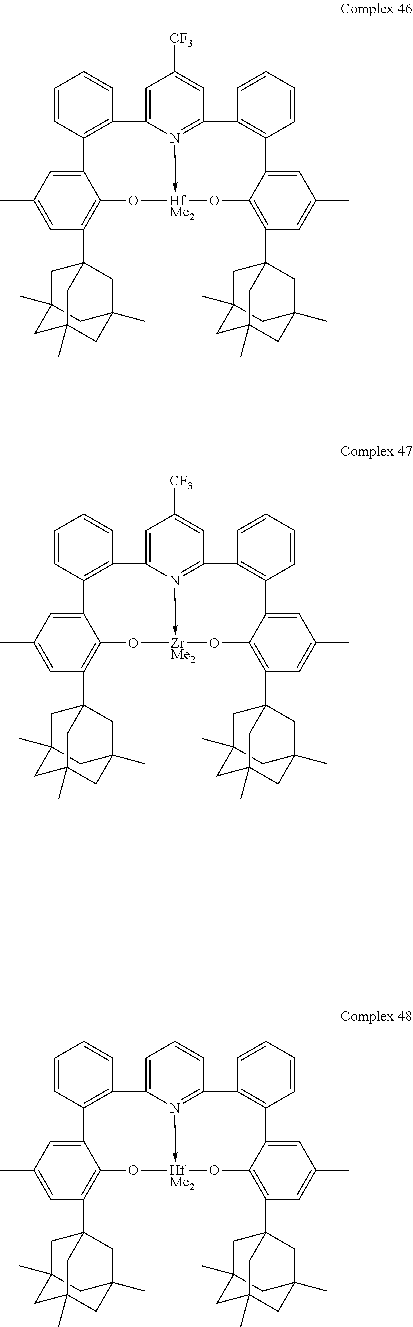

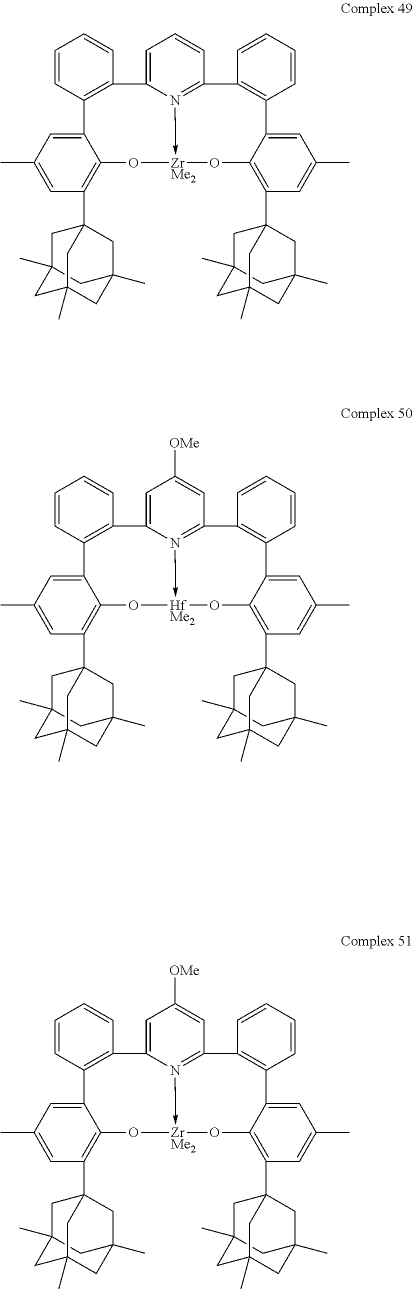

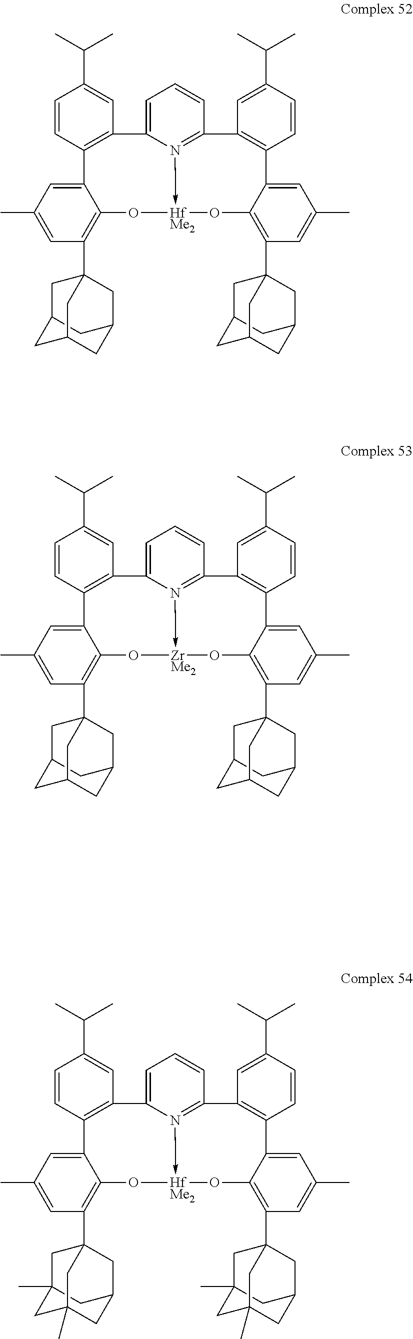

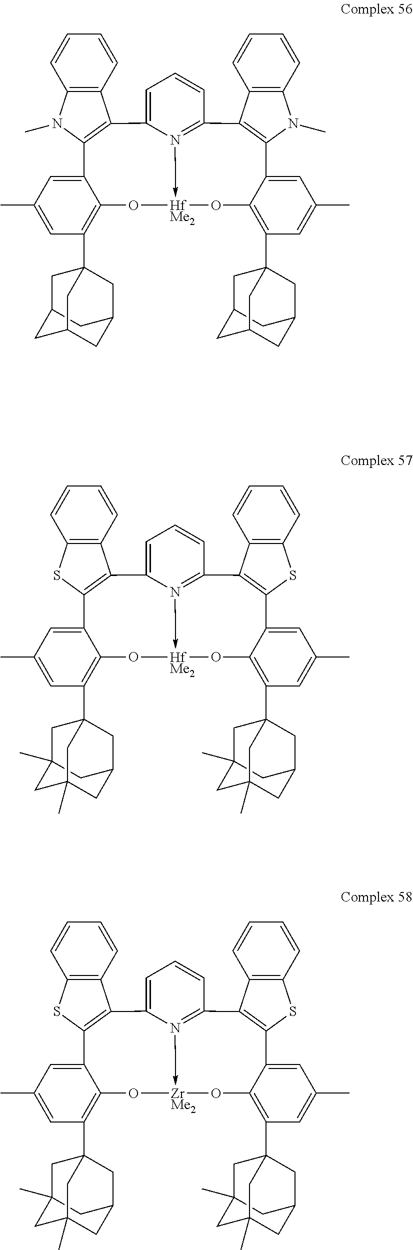

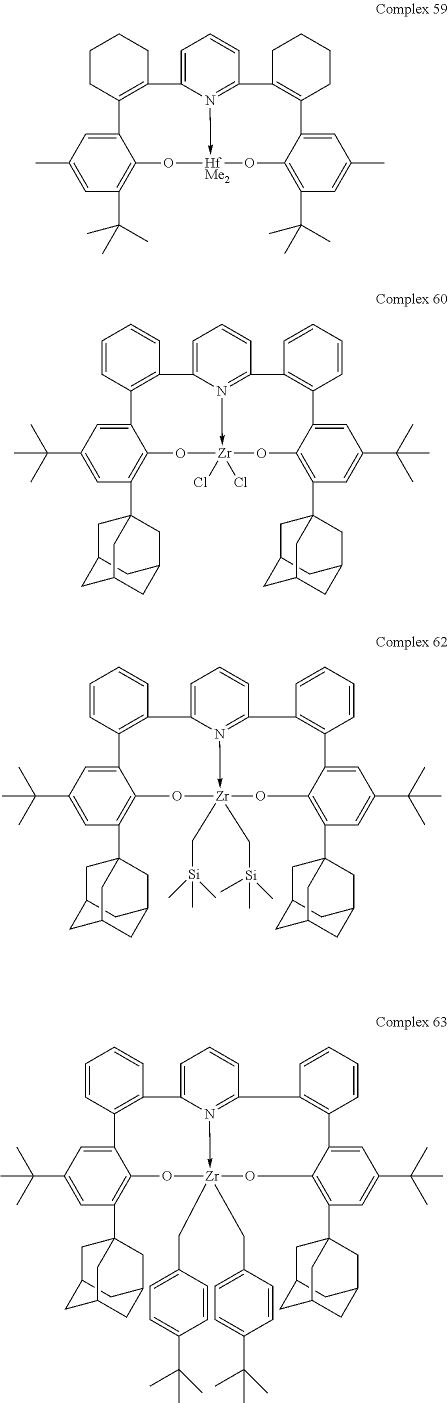

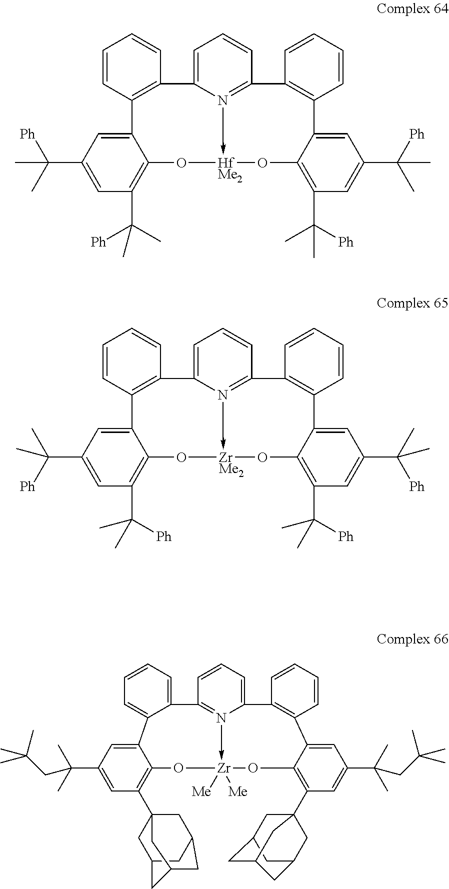

22. The process of paragraph 21 wherein the catalyst compound is selected from Complexes 1, 2, 5, 7, 9, 10, 11, 12, 14, 15, 16, 19, 20, 23, and 25.

23. The process of any of paragraphs 1 to 22 wherein the activator comprises an alumoxane or a non-coordinating anion.

24. The process of any of paragraphs 1 to 23, wherein the activator is soluble in non-aromatic-hydrocarbon solvent.

25. The process of any of paragraphs 1 to 24 wherein the catalyst system is free of aromatic solvent.

26. The process of any of paragraphs 1 to 25, wherein the activator is represented by the formula:

(Z)_{d}⁺(A^{d-})

wherein Z is (L-H) or a reducible Lewis Acid, L is an neutral Lewis base; H is hydrogen; (L-H)⁺ is a Bronsted acid; A^{d-} is a non-coordinating anion having the charge d−; and d is an integer from 1 to 3.

27. The process of any of paragraphs 1 to 25 wherein the activator is represented by the formula:

[R^{1′}R^{2′}R^{3′}EH]_{d+}[Mt^{k+}Qₙ]^{d-} (V)

wherein:
E is nitrogen or phosphorous;
d is 1, 2 or 3; k is 1, 2, or 3; n is 1, 2, 3, 4, 5, or 6; n−k=d;
R^{1′}, R^{2′}, and R^{3′} are independently a C₁ to C₅₀ hydrocarbyl group optionally substituted with one or more alkoxy groups, silyl groups, a halogen atoms, or halogen containing groups,
wherein R^{1′}, R^{2′}, and R^{3′} together comprise 15 or more carbon atoms;
Mt is an element selected from group 13 of the Periodic Table of the Elements; and each Q is independently a hydride, bridged or unbridged dialkylamido, halide, alkoxide, aryloxide, hydrocarbyl, substituted hydrocarbyl, halocarbyl, substituted halocarbyl, or halosubstituted-hydrocarbyl radical.

28. The process of any of paragraphs 1 to 22 wherein the activator is represented by the formula:

(Z)_{d}⁺(A^{d-})
wherein A^{d-} is a non-coordinating anion having the charge d−; and d is an integer from 1 to 3 and (Z)_{d}⁺ is represented by one or more of:

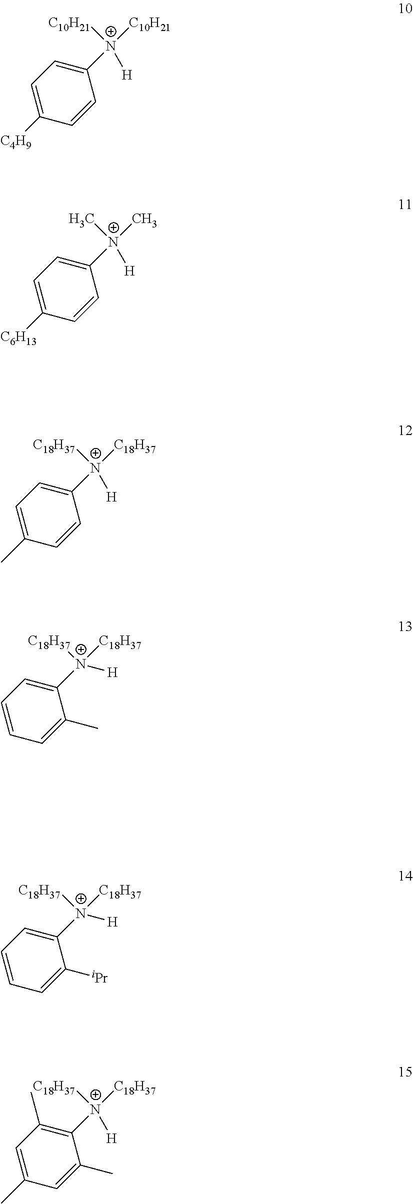

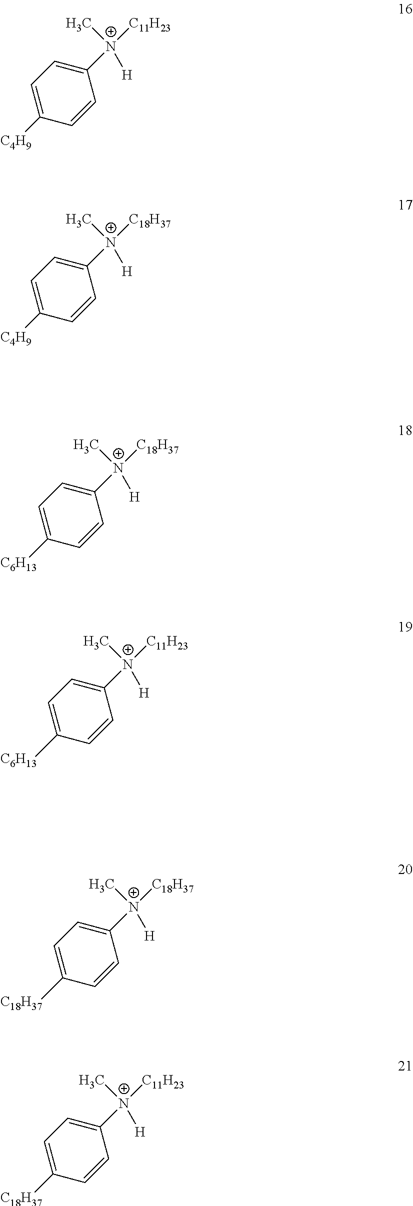

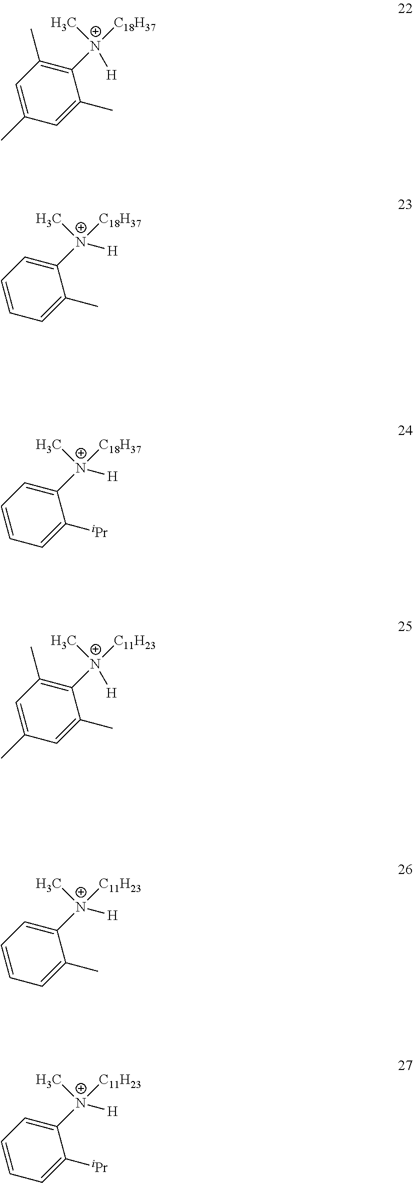

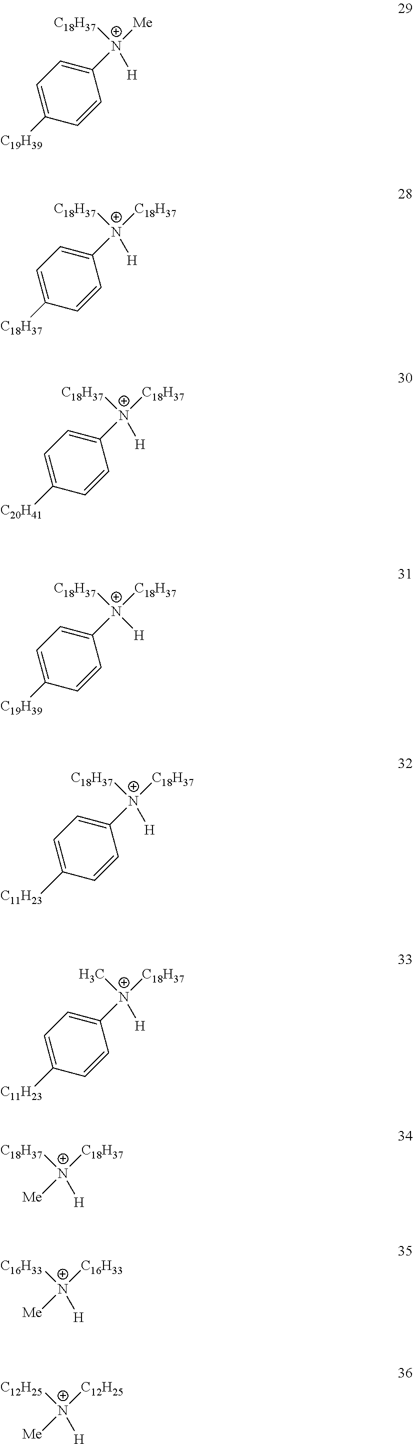

29. The process of any of paragraphs 1 to 25, wherein the activator is one or more of:
N-methyl-4-nonadecyl-N-octadecylbenzenaminium tetrakis(pentafluorophenyl)borate,
N-methyl-4-nonadecyl-N-octadecylbenzenaminium tetrakis(perfluoronaphthalen-2-yl)borate,
dioctadecylmethylammonium tetrakis(pentafluorophenyl)borate,
dioctadecylmethylammonium tetrakis(perfluoronaphthalen-2-yl)borate,
N,N-dimethylanilinium tetrakis(pentafluorophenyl)borate,
triphenylcarbenium tetrakis(pentafluorophenyl)borate,
trimethylammonium tetrakis(perfluoronaphthalen-2-yl)borate,
triethylammonium tetrakis(perfluoronaphthalen-2-yl)borate,
tripropylammonium tetrakis(perfluoronaphthalen-2-yl)borate,
tri(n-butyl)ammonium tetrakis(perfluoronaphthalen-2-yl)borate,
tri(t-butyl)ammonium tetrakis(perfluoronaphthalen-2-yl)borate,
N,N-dimethylanilinium tetrakis(perfluoronaphthalen-2-yl)borate,
N,N-diethylanilinium tetrakis(perfluoronaphthalen-2-yl)borate,
N,N-dimethyl-(2,4,6-trimethylanilinium) tetrakis(perfluoronaphthalen-2-yl)borate,
tropillium tetrakis(perfluoronaphthalen-2-yl)borate,
triphenylcarbenium tetrakis(perfluoronaphthalen-2-yl)borate,
triphenylphosphonium tetrakis(perfluoronaphthalen-2-yl)borate,
triethylsilylium tetrakis(perfluoronaphthalen-2-yl)borate,
benzene(diazonium) tetrakis(perfluoronaphthalen-2-yl)borate,
trimethylammonium tetrakis(perfluorobiphenyl)borate,
triethylammonium tetrakis(perfluorobiphenyl)borate,
tripropylammonium tetrakis(perfluorobiphenyl)borate,
tri(n-butyl)ammonium tetrakis(perfluorobiphenyl)borate,
tri(t-butyl)ammonium tetrakis(perfluorobiphenyl)borate,
N,N-dimethylanilinium tetrakis(perfluorobiphenyl)borate,
N,N-diethylanilinium tetrakis(perfluorobiphenyl)borate,
N,N-dimethyl-(2,4,6-trimethylanilinium) tetrakis(perfluorobiphenyl)borate,
tropillium tetrakis(perfluorobiphenyl)borate,
triphenylcarbenium tetrakis(perfluorobiphenyl)borate,
triphenylphosphonium tetrakis(perfluorobiphenyl)borate,
triethylsilylium tetrakis(perfluorobiphenyl)borate,
benzene(diazonium) tetrakis(perfluorobiphenyl)borate,
[4-t-butyl-PhNMe₂H][(C₆F₃(C₆F₅)₂)4B],
trimethylammonium tetraphenylborate,
triethylammonium tetraphenylborate,
tripropylammonium tetraphenylborate,
tri(n-butyl)ammonium tetraphenylborate,
tri(t-butyl)ammonium tetraphenylborate,
N,N-dimethylanilinium tetraphenylborate,
N,N-diethylanilinium tetraphenylborate,
N,N-dimethyl-(2,4,6-trimethylanilinium) tetraphenylborate,
tropillium tetraphenylborate,
triphenylcarbenium tetraphenylborate,
triphenylphosphonium tetraphenylborate,
triethylsilylium tetraphenylborate,
benzene(diazonium)tetraphenylborate,
trimethylammonium tetrakis(pentafluorophenyl)borate,
triethylammonium tetrakis(pentafluorophenyl)borate,
tripropylammonium tetrakis(pentafluorophenyl)borate,
tri(n-butyl)ammonium tetrakis(pentafluorophenyl)borate,
tri(sec-butyl)ammonium tetrakis(pentafluorophenyl)borate,
N,N-dimethylanilinium tetrakis(pentafluorophenyl)borate,
N,N-diethylanilinium tetrakis(pentafluorophenyl)borate,
N,N-dimethyl-(2,4,6-trimethylanilinium) tetrakis(pentafluorophenyl)borate,
tropillium tetrakis(pentafluorophenyl)borate,
triphenylcarbenium tetrakis(pentafluorophenyl)borate,
triphenylphosphonium tetrakis(pentafluorophenyl)borate,
triethylsilylium tetrakis(pentafluorophenyl)borate,
benzene(diazonium) tetrakis(pentafluorophenyl)borate,
trimethylammonium tetrakis-(2,3,4,6-tetrafluorophenyl) borate,
triethylammonium tetrakis-(2,3,4,6-tetrafluorophenyl)borate,
tripropylammonium tetrakis-(2,3,4,6-tetrafluorophenyl)borate,
tri(n-butyl)ammonium tetrakis-(2,3,4,6-tetrafluoro-phenyl)borate,
dimethyl(t-butyl)ammonium tetrakis-(2,3,4,6-tetrafluorophenyl)borate,
N,N-dimethylanilinium tetrakis-(2,3,4,6-tetrafluorophenyl)borate,
N,N-diethylanilinium tetrakis-(2,3,4,6-tetrafluorophenyl)borate,
N,N-dimethyl-(2,4,6-trimethylanilinium) tetrakis-(2,3,4,6-tetrafluorophenyl)borate,
tropillium tetrakis-(2,3,4,6-tetrafluorophenyl)borate,
triphenylcarbenium tetrakis-(2,3,4,6-tetrafluorophenyl)borate,
triphenylphosphonium tetrakis-(2,3,4,6-tetrafluorophenyl)borate,
triethylsilylium tetrakis-(2,3,4,6-tetrafluorophenyl)borate,
benzene(diazonium) tetrakis-(2,3,4,6-tetrafluorophenyl)borate,
trimethylammonium tetrakis(3,5-bis(trifluoromethyl)phenyl)borate,
triethylammonium tetrakis(3,5-bis(trifluoromethyl)phenyl)borate,
tripropylammonium tetrakis(3,5-bis(trifluoromethyl)phenyl)borate,
tri(n-butyl)ammonium tetrakis(3,5-bis(trifluoromethyl)phenyl)borate,
tri(t-butyl)ammonium tetrakis(3,5-bis(trifluoromethyl)phenyl)borate,
N,N-dimethylanilinium tetrakis(3,5-bis(trifluoromethyl)phenyl)borate,
N,N-diethylanilinium tetrakis(3,5-bis(trifluoromethyl)phenyl)borate,
N,N-dimethyl-(2,4,6-trimethylanilinium) tetrakis(3,5-bis(trifluoromethyl)phenyl)borate,
tropillium tetrakis(3,5-bis(trifluoromethyl)phenyl)borate,
triphenylcarbenium tetrakis(3,5-bis(trifluoromethyl)phenyl)borate,
triphenylphosphonium tetrakis(3,5-bis(trifluoromethyl)phenyl)borate,
triethylsilylium tetrakis(3,5-bis(trifluoromethyl)phenyl)borate,
benzene(diazonium) tetrakis(3,5-bis(trifluoromethyl)phenyl)borate,
di-(i-propyl)ammonium tetrakis(pentafluorophenyl)borate,
dicyclohexylammonium tetrakis(pentafluorophenyl)borate,
tri(o-tolyl)phosphonium tetrakis(pentafluorophenyl)borate,
tri(2,6-dimethylphenyl)phosphonium tetrakis(pentafluorophenyl)borate,
triphenylcarbenium tetrakis(perfluorophenyl)borate,
1-(4-(tris(pentafluorophenyl)borate)-2,3,5,6-tetrafluorophenyl)pyrrolidinium,
tetrakis(pentafluorophenyl)borate,
4-(tris(pentafluorophenyl)borate)-2,3,5,6-tetrafluoropyridine, and
triphenylcarbenium tetrakis(3,5-bis(trifluoromethyl)phenyl)borate).

30. The process of any of paragraphs 1 to 29 wherein the process is a solution process.

31. The process of any of paragraphs 1 to 30 wherein the process occurs at a temperature of from about 0° C. to about 300° C., at a pressure in the range of from about 0.35 MPa to about 18 MPa, and at a time up to 300 minutes.

32. The process of any of paragraphs 1 to 31 wherein the process occurs at a temperature of 65° C. to about 150° C.

33. The process of any of paragraphs 1 to 32 further comprising obtaining propylene polymer, preferably wherein the propylene polymer is isotactic and has a mmmm pentad tacticity index of 75% or greater.

34. The process of paragraph 33 wherein the polymer has a Tm of 150° C. or greater as measured by DSC.

35. The process of paragraph 33 or 34 wherein the polymer has a Mw of 50,000 g/mol or greater (as measured by GPC-DRI, relative to linear polystyrene standards).

36. The process of paragraph 33, 34 or 35 wherein the polymer has less than 200 total regio defects/10,000 monomer units and greater than 1 total regio defects/10,000 monomer units as measured by ¹³C-NMR.

37. The process of paragraph 33, 34, 35 or 36 wherein the polymer has less than 30 1,3-regio defects/10,000 monomer units as measured by ¹³C-NMR.

38. The process of any of paragraphs 33 to 37 wherein the polymer has a percentage of total regio defects less than 40%.

39. The process of paragraph 33 wherein the polymer has 1) a Tm as measured by DSC of 155° C. or greater, 2) wherein the total regio defects/10,000 monomer units is less than −1.18×Tm(° C.)+210, and 3) wherein the total regio defects is not less than 3 total regio defects/10,000 monomer units.

40. The process of any of paragraphs 33 to 39 wherein the polymer has greater than 0.05 unsaturated end-groups per 1000 C as determined by ¹H NMR.

41. The process of any of paragraphs 33 to 40 wherein the polymer has 1) a Mw (GPC-DRI, relative to linear polystyrene standards) less than (10⁻⁸)(e^{0.1962z}) where z is the Tm (° C.) of the polymer as measured by DSC (2^{nd} melt) and 2) a Mw greater than (2×10⁻¹⁶)(e^{0.2956z}) where z is the Tm of the polymer as measured by DSC (2^{nd} melt), and 3) wherein the Tm of the polymer is 155° C. or greater.

42. The process of any of paragraphs 33 to 41 wherein the polymer is a propylene-alpha-olefin copolymer wherein the alpha-olefin is a C₄-C₂₀ alpha olefin and wherein the propylene-alpha-olefin copolymer contains as 20 mol % propylene or greater, with the lower limit of C₄-C₂₀ alpha-olefin being 1 mol %.

43. The process of the paragraph 42 wherein the alpha-olefin is a C₄-C₈ alpha-olefin, or mixtures thereof.

44. The process of 42 or 43 wherein the propylene-alpha-olefin copolymer has at least 50% isotactic triads as measured by ¹³C NMR.

45. An isotactic polypropylene polymer
1) Tm of 155° C. or greater as measured by DSC (2^{nd} d melt),
2) a mmmm pentad tacticity index of 90% or greater,
3) a Mw of 50,000 g/mol or greater (as measured by GPC-DRI, relative to linear polystyrene standards),
4) less than 35 total regio defects/10,000 monomer units and greater than 1 total regio defects/10,000 monomer units as measured by ¹³C-NMR.

46. The polymer of paragraph 45 wherein the polymer has less than 5 1,3-regio defects/10,000 monomer units as measured by ¹³C-NMR.

47. The polymer of paragraph 45 or 46 wherein the polymer has a percentage of total regio defects less than 30%.

48. The polymer of paragraph 45, 46 or 47 wherein the polymer has 1) total regio defects/10,000 monomer units of less than −1.18×Tm+210, and 2) wherein the total regio defects is not less than 3 total regio defects/10,000 monomer units.

49. The polymer of any of paragraphs 45 to 48 wherein the polymer has greater than 0.05 unsaturated end-groups per 1000 C as determined by ¹H NMR.

50. The polymer of any of paragraphs 45 to 49 wherein the polymer has 1) a Mw (GPC-DRI, relative to linear polystyrene standards) less than (10⁻⁸)(e^{0.1962z}) where z is the Tm (° C.) of the polymer as measured by DSC (2^{nd} d melt) and 2) a Mw greater than (2×10⁻¹⁶)(e^{0.2956z}) where z is the Tm of the polymer as measured by DSC (2^{nd} d melt), and 3) wherein the Tm of the polymer is 155° C. or greater.

51. The polymer of any of paragraphs 45 to 50 wherein the Tm is 160° C. or greater.

52. The polymer of any of paragraphs 45 to 51 wherein the Mw is 100,000 g/mol or greater.

53. The polymer of any of paragraphs 45 to 52 wherein the mmmm pentad tacticity index of 95% or greater.

54. An isotactic crystalline propylene polymer produced in a process comprising contacting in a homogeneous phase, propylene with a catalyst system comprising activator and a transition metal catalyst complex of a dianionic, tridentate ligand that features a central neutral heterocyclic Lewis base and two phenolate donors, where the tridentate ligand coordinates to the metal center to form two eight-membered rings.

55. The polymer of paragraph 54 wherein the polymer has a melting point of 120° C. or higher.

56. The polymer of paragraph 54 or 55 wherein the polymer has a mmmm pentad tacticity index of 70% or greater.

57. The polymer of paragraph 54, 55, or 56 wherein the polymerization temperature is 70° C. or higher.

58. The process of any paragraphs 45 to 57, wherein the propylene copolymer has a heat of fusion of greater than 100 J/g, preferably greater than 110 J/g.

59. The process of any paragraphs 1 to 44, further comprising obtaining a propylene copolymer having a heat of fusion of greater than 100 J/g, preferably greater than 110 J/g.

60. An isotactic crystalline propylene polymer produced by a polymerization process comprising contacting in a homogeneous phase propylene with a catalyst system comprising an activator and a group 4 bis(phenolate) catalyst compound, wherein the polymerization process takes place at a temperature of 90° C. or higher, to produce a polymer with the following characteristics:
i. a Mw (GPC-DRI, relative to linear polystyrene standards) less than (10⁻⁸) (e^{0.1962z}) where z is the Tₘ (° C.) of the polymer as measured by DSC (2nd melt);
ii. a Mw (GPC-DRI, relative to linear polystyrene standards) greater than (2×10⁻¹⁶)(e^{0.2956z}) where z is the Tₘ (° C.) of the polymer as measured by DSC (2^{nd} d melt).

61. The polymer of paragraph 60 wherein the Tₘ is 160° C. or greater.

62. The polymer of paragraph 60 wherein the Mw is 100,000 g/mol or greater.

63. The polymer of paragraph 60 wherein the mmmm pentad tacticity index of 95% or greater.

### Experimental

### Starting Materials

4-Methylphenol (Merck), triphenylphosphine (Merck), 2-bromo-4-isopropyliodobenzene (abcr GmbH), 2-bromopyridine (abcr GmbH), 2,6-dibromo-4-methoxypyridine (abcr GmbH), 2,6-dichloro-4-trifluoromethylpyridine (abcr GmbH), 3,5-dimethyladamantan-1-ol (abcr GmbH), 3,5-dimethyl-1-bromoadamantane (abcr GmbH), benzo[b]thiophene (Merck), N-bromosuccinimide (Merck), bis(pinacolato)diboron (Aldrich), cyclohexanone (Merck), 2-isopropoxy-4,4,5,5-tetramethyl-1,3,2-dioxaborolane (Aldrich), 2,6-dibromopyridine (Aldrich), 2-bromoiodobenzene (Acros), 2.5 M ⁿBuLi in hexanes (Acros), Pd(PPh₃)₄(Aldrich), PdCl₂ (Aurat, Russia), RuCl₃ hydrate (Aurat, Russia), 1,1′-bis(di-tert-butylphosphino)ferrocene (Merck), methoxymethyl chloride (aka MOMCl, Aldrich), N-methylindole (Merck), N-(5-chloro-2-pyridyl)bis(trifluoromethanesulfonimide) (Aldrich), NaH, 60% wt. in mineral oil (Aldrich), ethyl acetate (Merck), methanol (Merck), toluene (Merck), n-hexane (Merck), n-pentane (Merck), isopropanol (Merck), diethyl ether (Merck), acetonitrile (Merck), hexanes (Merck), carbon tetrachloride (Merck), 1,4-dioxane (Merck), dichloromethane (Merck), HfCl₄ (<0.05% Zr, Strem), ZrCl₄ (Merck), Cs₂CO₃ (Merck), sodium periodate (Merck), iodine (Merck), bromine (Merck), methanesulfonic acid (Merck), acetic acid (Aldrich), potassium tert-butoxide (Merck), sodium hydrocarbonate (Merck), sulfuric acid 98% (Merck), ammonia solution 28-30% (Merck), 12N HCl (Merck), K₂CO₃ (Merck), Na₂SO₄ (Akzo Nobel), silica gel 60, 40-63 um (Merck), Celite 503 (Aldrich), CDCl₃ (Deutero GmbH) were used as received. Benzene-d₆ (Deutero GmbH) and dichloromethane-d₂ (Deutero GmbH) were dried over MS (mole sieves) 4A prior use. Tetrahydrofuran (aka THF, Merck), diethyl ether and 1,4-dioxane for organometallic synthesis were freshly distilled from sodium benzophenone ketyl. Toluene, n-hexane, hexanes and n-pentane for organometallic synthesis were dried over MS 4A. 3% aqueous ammonia and 10% HCl were prepared from corresponding reagents via dilution with distilled water. Ethylaluminum dichloride (1.0M in hexane) and (trimethylsilyl)methylmagnesium chloride (1.0M in diethyl ether) were purchased from Sigma Aldrich.

1-(tert-Butyl)-2-(methoxymethoxy)-5-methylbenzene was prepared as described in [Chem. Commun. 2015, 51, pp. 16675-16678]. Tetrabenzylhafnium was prepared as described in [J. Organomet. Chem. 1972, 36(1), pp. 87-92]. 2-(Adamantan-1-yl)-4-(tert-butyl)phenol was prepared from 4-tert-butylphenol (Merck) and adamantanol-1 (Aldrich) as described in [Organic Letters, 2015, v. 17(9), pp. 2242-2245]. 2-(Adamantan-1-yl)-4-methylphenol was prepared as described in [Angew. Chem., Int. Ed., 2002, 41(16), pp. 3059-3061].

The 4-tert-butylbenzyl Grignard was made using a modified procedure from Tetrahedron 2019, v. 75(32), pp. 4298-4306 using 4-tert-butylbenzyl bromide instead of benzyl bromide.

¹H and ¹³C{¹H} NMR spectra were recorded with at least a 400 MHz spectrometer (such as aBruker Avance-400 spectrometer) using 1-10% solutions in deuterated solvents. Chemical shifts for ¹H and ¹³C are referenced to the residual ¹H or ¹³C resonances of the deuterated solvents.

Transition metal complex 5 and complex 6 were prepared as follows:

### 2-(Adamantan-1-yl)-6-bromo-4-(tert-butyl)phenol

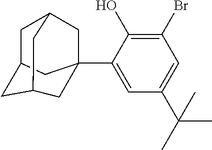 [SMILES: CC(C)(C)c1cc(Br)c(O)c(C23CC4CC(CC(C4)C2)C3)c1]

To a solution of 57.6 g (203 mmol) of 2-(adamantan-1-yl)-4-(tert-butyl)phenol in 400 mL of chloroform a solution of 10.4 mL (203 mmol) of bromine in 200 mL of chloroform was added dropwise for 30 minutes at room temperature. The resulting mixture was diluted with 400 mL of water. The obtained mixture was extracted with dichloromethane (3×100 mL), the combined organic extract was washed with 5% NaHCO₃, dried over Na₂SO₄, and then evaporated to dryness. Yield 71.6 g (97%) of a white solid. ¹H NMR (CDCl₃, 400 MHz): (7.32 (d, J=2.3 Hz, 1H), 7.19 (d, J=2.3 Hz, 1H), 5.65 (s, 1H), 2.18-2.03 (m, 9H), 1.78 (m, 6H), 1.29 (s, 9H). ¹³C NMR (CDCl₃, 100 MHz): δ 148.07, 143.75, 137.00, 126.04, 123.62, 112.11, 40.24, 37.67, 37.01, 34.46, 31.47, 29.03.

### (1-(3-Bromo-5-(tert-butyl)-2-(methoxymethoxy)phenyl)adamantane

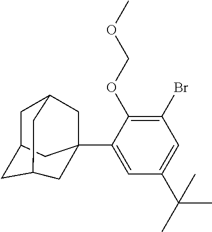 [SMILES: COCOc1c(Br)cc(C(C)(C)C)cc1C12CC3CC(CC(C3)C1)C2]

To a solution of 71.6 g (197 mmol) of 2-(adamantan-1-yl)-6-bromo-4-(tert-butyl)phenol in 1,000 mL of THF 8.28 g (207 mmol, 60% wt. in mineral oil) of sodium hydride was added portionwise at room temperature. To the resulting suspension 16.5 mL (217 mmol) of methoxymethyl chloride was added dropwise for 10 minutes at room temperature. The obtained mixture was stirred overnight, then poured into 1,000 mL of water. The obtained mixture was extracted with dichloromethane (3×300 mL), the combined organic extract was washed with 5% NaHCO₃, dried over Na₂SO₄ and then evaporated to dryness. Yield 80.3 g (˜quant.) of a white solid. ¹H NMR (CDCl₃, 400 MHz): δ 7.39 (d, J=2.4 Hz, 1H), 7.27 (d, J=2.4 Hz, 1H), 5.23 (s, 2H), 3.71 (s, 3H), 2.20-2.04 (m, 9H), 1.82-1.74 (m, 6H), 1.29 (s, 9H). ¹³C NMR (CDCl₃, 100 MHz): δ 150.88, 147.47, 144.42, 128.46, 123.72, 117.46, 99.53, 57.74, 41.31, 38.05, 36.85, 34.58, 31.30, 29.08.

### (2-(3-Adamantan-1-yl)-5-(tert-butyl)-2-(methoxymethoxy)phenyl)-4,4,5,5-tetramethyl-1,3,2-dioxaborolane

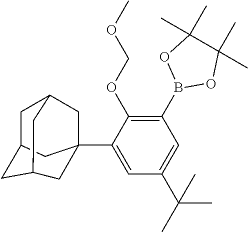 [SMILES: COCOc1c(B2OC(C)(C)C(C)(C)O2)cc(C(C)(C)C)cc1C12CC3CC(CC(C3)C1)C2]

To a solution of 22.5 g (55.0 mmol) of (1-(3-bromo-5-(tert-butyl)-2-(methoxymethoxy)phenyl)adamantane in 300 mL of dry THF 23.2 mL (57.9 mmol, 2.5 M) of ⁿ BuLi in hexanes was added dropwise for 20 minutes at −80° C. The reaction mixture was stirred at this temperature for 1 hour followed by addition of 14.5 mL (71.7 mmol) of 2-isopropoxy-4,4,5,5-tetramethyl-1,3,2-dioxaborolane. The obtained suspension was stirred at room temperature for 1 hour, then poured into 300 mL of water. The obtained mixture was extracted with dichloromethane (3×300 mL), the combined organic extract was dried over Na₂SO₄, and then evaporated to dryness. Yield 25.0 g (˜quant.) of a colorless viscous oil. ¹H NMR (CDCl₃, 400 MHz): δ 7.54 (d, J=2.5 Hz, 1H), 7.43 (d, J=2.6 Hz, 1H), 5.18 (s, 2H), 3.60 (s, 3H), 2.24-2.13 (m, 6H), 2.09 (br. s., 3H), 1.85-1.75 (m, 6H), 1.37 (s, 12H), 1.33 (s, 9H). ¹³C NMR (CDCl₃, 100 MHz): δ 159.64, 144.48, 140.55, 130.58, 127.47, 100.81, 83.48, 57.63, 41.24, 37.29, 37.05, 34.40, 31.50, 29.16, 24.79.

### 1-(2′-Bromo-5-(tert-butyl)-2-(methoxymethoxy)-[1,1′-biphenyl]-3-yl)adamantane

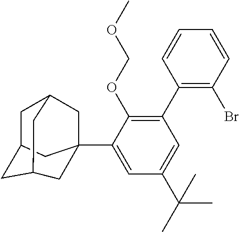 [SMILES: COCOc1c(-c2ccccc2Br)cc(C(C)(C)C)cc1C12CC3CC(CC(C3)C1)C2]

To a solution of 25.0 g (55.0 mmol) of (2-(3-adamantan-1-yl)-5-(tert-butyl)-2-(methoxymethoxy)phenyl)-4,4,5,5-tetramethyl-1,3,2-dioxaborolane in 200 mL of dioxane 15.6 g (55.0 mmol) of 2-bromoiodobenzene, 19.0 g (137 mmol) of potassium carbonate, and 100 mL of water were subsequently added. The mixture obtained was purged with argon for 10 minutes followed by addition of 3.20 g (2.75 mmol) of Pd(PPh₃)₄. Thus obtained mixture was stirred for 12 hours at 100° C., then cooled to room temperature and diluted with 100 mL of water. The obtained mixture was extracted with dichloromethane (3×100 mL), the combined organic extract was dried over Na₂SO₄ and then evaporated to dryness. The residue was purified by flash chromatography on silica gel 60 (40-63 um, eluent: hexane-dichloromethane=10:1, vol.). Yield 23.5 g (88%) of a white solid. ¹H NMR (CDCl₃, 400 MHz): δ 7.68 (dd, J=1.0, 8.0 Hz, 1H), 7.42 (dd, J=1.7, 7.6 Hz, 1H), 7.37-7.32 (m, 2H), 7.20 (dt, J=1.8, 7.7 Hz, 1H), 7.08 (d, J=2.5 Hz, 1H), 4.53 (d, J=4.6 Hz, 1H), 4.40 (d, J=4.6 Hz, 1H), 3.20 (s, 3H), 2.23-2.14 (m, 6H), 2.10 (br. s., 3H), 1.86-1.70 (m, 6H), 1.33 (s, 9H). ¹³C NMR (CDCl₃, 100 MHz): δ 151.28, 145.09, 142.09, 141.47, 133.90, 132.93, 132.41, 128.55, 127.06, 126.81, 124.18, 123.87, 98.83, 57.07, 41.31, 37.55, 37.01, 34.60, 31.49, 29.17.

### 2-(3′-(Adamantan-1-yl)-5′-(tert-butyl)-2′-(methoxymethoxy)-[1,1′-biphenyl]-2-yl)-4,4,5,5-tetramethyl-1,3,2-dioxaborolane

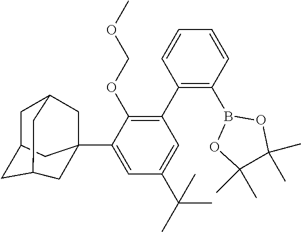 [SMILES: COCOc1c(-c2ccccc2B2OC(C)(C)C(C)(C)O2)cc(C(C)(C)C)cc1C12CC3CC(CC(C3)C1)C2]

To a solution of 30.0 g (62.1 mmol) of 1-(2′-bromo-5-(tert-butyl)-2-(methoxymethoxy)-[1,1′-biphenyl]-3-yl)adamantane in 500 mL of dry THF 25.6 mL (63.9 mmol, 2.5 M) of ⁿ BuLi in hexanes was added dropwise for 20 minutes at −80° C. The reaction mixture was stirred at this temperature for 1 hour followed by addition of 16.5 mL (80.7 mmol) of 2-isopropoxy-4,4,5,5-tetramethyl-1,3,2-dioxaborolane. The obtained suspension was stirred at room temperature for 1 hour, then poured into 300 mL of water. The obtained mixture was extracted with dichloromethane (3×300 mL), the combined organic extract was dried over Na₂SO₄ and then evaporated to dryness. Yield 32.9 g (˜quant.) of a colorless glassy solid. ¹H NMR (CDCl₃, 400 MHz): δ 7.75 (d, J=7.3 Hz, 1H), 7.44-7.36 (m, 1H), 7.36-7.30 (m, 2H), 7.30-7.26 (m, 1H), 6.96 (d, J=2.4 Hz, 1H), 4.53 (d, J=4.7 Hz, 1H), 4.37 (d, J=4.7 Hz, 1H), 3.22 (s, 3H), 2.26-2.14 (m, 6H), 2.09 (br. s., 3H), 1.85-1.71 (m, 6H), 1.30 (s, 9H), 1.15 (s, 6H), 1.10 (s, 6H). ¹³C NMR (CDCl₃, 100 MHz): δ 151.35, 146.48, 144.32, 141.26, 136.15, 134.38, 130.44, 129.78, 126.75, 126.04, 123.13, 98.60, 83.32, 57.08, 41.50, 37.51, 37.09, 34.49, 31.57, 29.26, 24.92, 24.21.

### 2′,2′″-(Pyridine-2,6-diyl)bis((3-adamantan-1-yl)-5-(tert-butyl)-[1,1′-biphenyl]-2-ol)) (QQ)

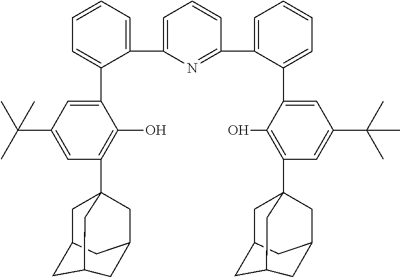 [SMILES: CC(C)(C)c1cc(-c2ccccc2-c2cccc(-c3ccccc3-c3cc(C(C)(C)C)cc(C45CC6CC(CC(C6)C4)C5)c3O)n2)c(O)c(C23CC4CC(CC(C4)C2)C3)c1]

To a solution of 32.9 g (62.0 mmol) of 2-(3′-(adamantan-1-yl)-5′-(tert-butyl)-2′-(methoxymethoxy)-[1,1′-biphenyl]-2-yl)-4,4,5,5-tetramethyl-1,3,2-dioxaborolane in 140 mL of dioxane 7.35 g (31.0 mmol) of 2,6-dibromopyridine, 50.5 g (155 mmol) of cesium carbonate and 70 mL of water were subsequently added. The mixture obtained was purged with argon for 10 minutes followed by addition of 3.50 g (3.10 mmol) of Pd(PPh₃)₄. This mixture was stirred for 12 hours at 100° C., then cooled to room temperature and diluted with 50 mL of water. The obtained mixture was extracted with dichloromethane (3×50 mL), the combined organic extract was dried over Na₂SO₄ and then evaporated to dryness. To the resulting oil 300 mL of THF, 300 mL of methanol, and 21 mL of 12 N HCl were subsequently added. The reaction mixture was stirred overnight at 60° C. and then poured into 500 mL of water. The obtained mixture was extracted with dichloromethane (3×350 mL), the combined organic extract was washed with 5% NaHCO₃, dried over Na₂SO₄, and then evaporated to dryness. The residue was purified by flash chromatography on silica gel 60 (40-63 um, eluent: hexane-ethyl acetate=10:1, vol.). The obtained glassy solid was triturated with 70 mL of n-pentane, the precipitate obtained was filtered off, washed with 2×20 mL of n-pentane, and dried in vacuo. Yield 21.5 g (87%) of a mixture of two isomers as a white powder. ¹H NMR (CDCl₃, 400 MHz): δ 8.10+6.59 (2s, 2H), 7.53-7.38 (m, 10H), 7.09+7.08 (2d, J=2.4 Hz, 2H), 7.04+6.97 (2d, J=7.8 Hz, 2H), 6.95+6.54 (2d, J=2.4 Hz), 2.03-1.79 (m, 18H), 1.74-1.59 (m, 12H), 1.16+1.01 (2s, 18H). ¹³C NMR (CDCl₃, 100 MHz, minor isomer shifts labeled with *): δ 157.86, 157.72*, 150.01, 149.23*, 141.82*, 141.77, 139.65*, 139.42, 137.92, 137.43, 137.32*, 136.80, 136.67*, 136.29*, 131.98*, 131.72, 130.81, 130.37*, 129.80, 129.09*, 128.91, 128.81*, 127.82*, 127.67, 126.40, 125.65*, 122.99*, 122.78, 122.47, 122.07*, 40.48, 40.37*, 37.04, 36.89*, 34.19*, 34.01, 31.47, 29.12, 29.07*.

### Dimethylhafnium[2′,2′″-(pyridine-2,6-diyl)bis((3-adamantan-1-yl)-5-(tert-butyl)-[1,1′-biphenyl]-2-olate))] (Complex 5)

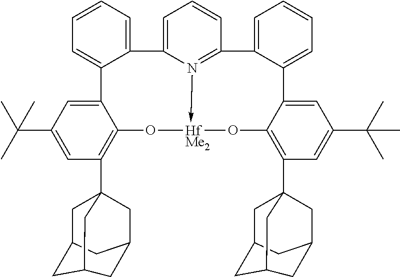

To a suspension of 3.22 g (10.05 mmol) of hafnium tetrachloride (<0.05% Zr) in 250 mL of dry toluene 14.6 mL (42.2 mmol, 2.9 M) of MeMgBr in diethyl ether was added in one portion via syringe at 0° C. The resulting suspension was stirred for 1 minute, and 8.00 g (10.05 mmol) of 2′,2′″-(pyridine-2,6-diyl)bis((3-adamantan-1-yl)-5-(tert-butyl)-[1,1′-biphenyl]-2-ol)) was added portion-wise for 1 minute. The reaction mixture was stirred for 36 hours at room temperature and then evaporated to near dryness. The solid obtained was extracted with 2×100 mL of hot toluene, and the combined organic extract was filtered through a thin pad of Celite 503. Next, the filtrate was evaporated to dryness. The residue was triturated with 50 mL of n-hexane, the obtained precipitate was filtered off (G3), washed with 20 mL of n-hexane (2×20 mL), and then dried in vacuo. Yield 6.66 g (61%, ˜1:1 solvate with n-hexane) of a light-beige solid. Anal. Calc. for C₅₉H₆₉HfNO₂×1.0 (C₆H₁₄): C, 71.70; H, 7.68; N, 1.29. Found: C 71.95; H, 7.83; N 1.18. ¹H NMR (C₆D₆, 400 MHz): δ 7.58 (d, J=2.6 Hz, 2H), 7.22-7.17 (m, 2H), 7.14-7.08 (m, 4H), 7.07 (d, J=2.5 Hz, 2H), 7.00-6.96 (m, 2H), 6.48-6.33 (m, 3H), 2.62-2.51 (m, 6H), 2.47-2.35 (m, 6H), 2.19 (br.s, 6H), 2.06-1.95 (m, 6H), 1.92-1.78 (m, 6H), 1.34 (s, 18H), −0.12 (s, 6H). ¹³C NMR (C₆D₆, 100 MHz): δ 159.74, 157.86, 143.93, 140.49, 139.57, 138.58, 133.87, 133.00, 132.61, 131.60, 131.44, 127.98, 125.71, 124.99, 124.73, 51.09, 41.95, 38.49, 37.86, 34.79, 32.35, 30.03.

### Dimethylzirconium[2′,2′″-(pyridine-2,6-diyl)bis((3-adamantan-1-yl)-5-(tert-butyl)-[1,1′-biphenyl]-2-olate))] (Complex 6)

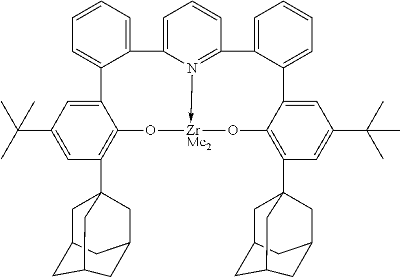

To a suspension of 2.92 g (12.56 mmol) of zirconium tetrachloride in 300 mL of dry toluene 18.2 mL (52.7 mmol, 2.9 M) of MeMgBr in diethyl ether was added in one portion via syringe at 0° C. To the resulting suspension 10.00 g (12.56 mmol) of 2′,2′″-(pyridine-2,6-diyl)bis((3-adamantan-1-yl)-5-(tert-butyl)-[1,1′-biphenyl]-2-ol)) was immediately added in one portion. The reaction mixture was stirred for 2 hours at room temperature and then evaporated to near dryness. The solid obtained was extracted with 2×100 mL of hot toluene, and the combined organic extract was filtered through a thin pad of Celite 503. Next, the filtrate was evaporated to dryness. The residue was triturated with 50 mL of n-hexane, the obtained precipitate was filtered off (G3), washed with n-hexane (2×20 mL), and then dried in vacuo. Yield 8.95 g (74%, ˜1:0.5 solvate with n-hexane) of a beige solid. Anal. Calc. for C₅₉H₆₉ZrNO₂×0.5 (C₆H₁₄): C, 77.69; H, 7.99; N, 1.46. Found: C 77.90; H, 8.15; N 1.36. ¹H NMR (C₆D₆, 400 MHz): δ 7.56 (d, J=2.6 Hz, 2H), 7.20-7.17 (m, 2H), 7.14-7.07 (m, 4H), 7.07 (d, J=2.5 Hz, 2H), 6.98-6.94 (m, 2H), 6.52-6.34 (m, 3H), 2.65-2.51 (m, 6H), 2.49-2.36 (m, 6H), 2.19 (br.s., 6H), 2.07-1.93 (m, 6H), 1.92-1.78 (m, 6H), 1.34 (s, 18H), 0.09 (s, 6H). ¹³C NMR (C₆D₆, 100 MHz): δ 159.20, 158.22, 143.79, 140.60, 139.55, 138.05, 133.77, 133.38, 133.04, 131.49, 131.32, 127.94, 125.78, 124.65, 124.52, 42.87, 41.99, 38.58, 37.86, 34.82, 32.34, 30.04.

### (1s,3s,5s)-1,3,5-Trimethyladamantane (A)

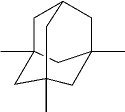

In a Parr pressure reactor, to a solution of 15.0 g (62.0 mmol) of 3,5-dimethyl-1-bromoadamantane in 80 ml of diethyl ether, 22.3 ml (64.0 mmol, 2.9 M) of MeMgBr in diethyl ether was added in one portion. The resulting solution was heated to 105° C. and stirred overnight at this temperature. After that, the reactor was cooled to room temperature, and pressure was released. Further on, 100 ml of 10% HCl was carefully added. The obtained mixture was extracted with diethyl ether (3×30 ml), the combined organic extract was dried over Na₂SO₄ and then evaporated to dryness. Yield 11.3 g (99%) of a colorless oil. ¹H NMR (CDCl₃, 400 MHz): δ 1.98-2.03 (m, 1H), 1.25-1.28 (m, 6H), 1.00-1.12 (m, 6H), 0.78 (s, 9H). ¹³C NMR (CDCl₃, 100 MHz) δ 51.1, 43.2, 31.4, 30.7, 30.0.

### (3s,5s,7s)-3,5,7-Trimethyladamantan-1-ol (B)

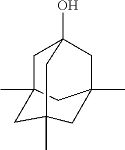

To a solution of 11.3 g (62.0 mmol) of (1s,3s,5s)-1,3,5-trimethyladamantane (A) in 70 ml of acetonitrile, 103 ml of water, 70 ml of carbon tetrachloride, 55.0 g (255 mmol) of sodium periodate, and 330 mg (1.28 mmol) of ruthenium(III) chloride (hydrate) were added. The resulting suspension was stirred for 12 hours at 60° C., then cooled to room temperature, and diluted with 50 ml of water. The obtained mixture was extracted with dichloromethane (3×50 ml), the combined organic extract was dried over Na₂SO₄ and then evaporated to dryness. The residue was purified using Kugelrohr apparatus (1 mbar, 100° C.). Yield 12.1 g (96%) of a white crystalline solid. ¹H NMR (CDCl₃, 400 MHz): δ 1.44 (br.s, 1H), 1.30 (s, 6H), 0.97-1.15 (m, 6H), 0.88 (s, 9H). ¹³C NMR (CDCl₃, 100 MHz) δ 70.5, 50.7, 49.8, 34.1, 29.5.

### 4-Methyl-2-((3r,5r,7r)-3,5,7-trimethyladamantan-1-yl)phenol (C)

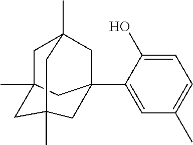

To a solution of 20.8 g (192 mmol) of 4-methylphenol and 18.7 g (96.3 mmol) of (3s,5s,7s)-3,5,7-trimethyladamantan-1-ol (B) in 100 ml of dichloromethane, 5.8 ml of 97% sulfuric acid was added dropwise for 30 minutes at room temperature. The resulting mixture was stirred for 30 minutes at room temperature and then carefully poured into 300 ml of 3% aqueous ammonia. The crude product was extracted with dichloromethane (3×50 ml), the combined organic extract was dried over Na₂SO₄ and then evaporated to dryness. The residue was purified using Kugelrohr apparatus (0.3 mbar, 160° C.) yielding 23.1 g (84%) of the title product as a white crystalline solid. ¹H NMR (CDCl₃, 400 MHz): δ 7.04 (d, J=2.1 Hz, 1H), 6.86 (ddd, J=7.9, 2.2, 0.6 Hz, 1H), 6.55 (d, J=7.9 Hz), 4.52 (s, 1H), 2.29 (s, 3H), 1.67 (s, 6H), 1.10-1.18 (m, 6H), 0.90 (s, 9H). ¹³C NMR (CDCl₃, 100 MHz): δ 151.9, 135.2, 129.7, 127.7, 127.0, 116.6, 50.4, 46.1, 39.1, 32.1, 30.6, 20.9.

### 2-Bromo-4-methyl-6-((3r,5r,7r)-3,5,7-trimethyladamantan-1-yl)phenol (D)

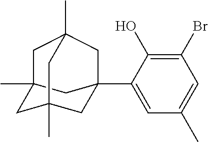

To a solution of 8.97 g (31.5 mmol) of 4-methyl-2-((3r,5r,7r)-3,5,7-trimethyladamantan-1-yl)phenol (C) in 90 ml of dichloromethane, 5.04 g (31.5 mmol) of bromine was added dropwise at room temperature. The resulting mixture was stirred for 12 hours at room temperature and then carefully poured into 200 ml of 5% NaHCO₃. The crude product was extracted with dichloromethane (3×50 ml), the combined organic extract was dried over Na₂SO₄ and then evaporated to dryness. Yield 11.4 g (99%) of a white solid. ¹H NMR (CDCl₃, 400 MHz): δ 7.17 (d, J=2.0 Hz, 1H), 6.99 (d, J=2.0 Hz, 1H), 5.65 (s, 1H), 2.28 (s, 3H), 1.67 (s. 6H), 1.10-1.21 (m, 6H), 0.91 (s, 9H). ¹³C NMR (CDCl₃, 100 MHz): δ 148.1, 136.5, 130.3, 129.4, 127.3, 112.1, 50.3, 45.8, 39.9, 32.1, 30.5, 20.6.

(3r,5r,7r)-1-(3-Bromo-2-(methoxymethoxy)-5-methylphenyl)-3,5,7-trimethyladamantane (E)

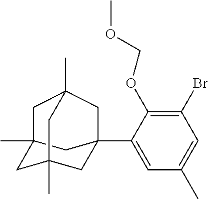

To a solution of 11.4 g (31.4 mmol) of 2-bromo-4-methyl-6-((3r,5r,7r)-3,5,7-trimethyladamantan-1-yl)phenol (D) in 100 ml of dry THF, 1.06 g (34.9 mmol, 60% wt. (in mineral oil) sodium hydride was added at room temperature. b After that, 2.65 ml (34.9 mmol) of MOMCl was added in one portion. The reaction mixture was heated for 24 hours at 60° C. and then poured into 130 ml of cold water. The crude product was extracted with 3×20 ml of dichloromethane. The combined organic extract was dried over Na₂SO₄ and then evaporated to dryness. Yield 11.9 g (91%) of a yellowish solid. ¹H NMR (CDCl₃, 400 MHz): δ 7.25 (d, J=2.0 Hz, 1H), 7.06 (d, J=2.0 Hz, 1H), 5.23 (s, 2H), 3.71 (s, 3H), 2.29 (s, 3H), 1.68 (s, 6H), 1.10-1.21 (m, 6H), 0.92 (s, 9H). ¹³C NMR (CDCl₃, 100 MHz): δ 151.3, 144.0, 134.4, 131.9, 127.4, 117.6, 99.9, 57.8, 50.2, 46.8, 40.3, 32.2, 30.6, 20.7.

### 2-(2-(Methoxymethoxy)-5-methyl-3-((3r,5r,7r)-3,5,7-trimethyladamantan-1-yl)phenyl)-4,4,5,5-tetramethyl-1,3,2-dioxaborolane (F)

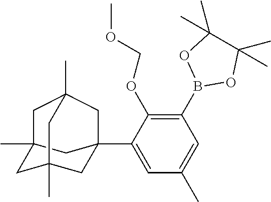

To a solution of 12.4 g (30.5 mmol) of (3r,5r,7r)-1-(3-bromo-2-(methoxymethoxy)-5-methyl phenyl)-3,5,7-trimethyladamantane (E) in 200 ml of dry THF, 14.6 ml (30.5 mmol) of 2.5 M ⁿ BuLi in hexanes was added dropwise for 20 minutes at −80° C. The reaction mixture was stirred at this temperature for 1 hour followed by addition of 9.33 ml (45.7 mmol) of 2-isopropoxy-4,4,5,5-tetramethyl-1,3,2-dioxaborolane. The obtained suspension was stirred for 1 hour at room temperature, then poured into 130 ml of water. The crude product was extracted with dichloromethane (3×40 ml), the combined organic extract was dried over Na₂SO₄ and then evaporated to dryness. Yield 12.9 g (93%) of a white solid. ¹H NMR (CDCl₃, 400 MHz): δ 7.39 (d, J=1.9 Hz, 1H), 7.22 (d, J=1.9 Hz, 1H), 5.16 (s, 2H), 3.61 (s, 3H), 2.31 (s, 3H), 1.72 (s, 6H), 1.38 (s, 12H), 1.09-1.18 (m, 6H), 0.90 (s, 9H). ¹³C NMR (CDCl₃, 100 MHz): δ 159.8, 140.4, 134.7, 131.6, 131.2, 101.2, 83.6, 57.9, 50.4, 46.7, 39.5, 32.2, 30.6, 24.74, 20.8.

### (3r,5r,7r)-1-(2′-Bromo-2-(methoxymethoxy)-5-methyl-[1,1′-biphenyl]-3-yl)-3,5,7-trimethyladamantane (G)

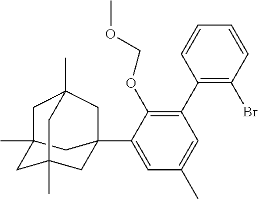 [SMILES: COCOc1c(-c2ccccc2Br)cc(C)cc1C12CC3(C)CC(C)(CC(C)(C3)C1)C2]

To a solution of 4.50 g (9.90 mmol) of 2-(2-(methoxymethoxy)-5-methyl-3-((3r,5r,7r)-3,5,7-trimethyladamantan-1-yl)phenyl)-4,4,5,5-tetramethyl-1,3,2-dioxaborolane (F) in 20 ml of 1,4-dioxane, 2.80 g (9.90 mmol) of 2-bromoiodobenzene, 3.42 g (24.8 mmol) of potassium carbonate, and 10 ml of water were subsequently added. The mixture obtained was purged with argon for 10 minutes followed by addition of 286 mg (0.25 mmol) of Pd(PPh₃)₄. This mixture was stirred for 12 hours at 105° C., then cooled to room temperature, and diluted with 100 ml of water. The crude product was extracted with dichloromethane (3×50 ml), the combined organic extract was dried over Na₂SO₄ and then evaporated to dryness. The residue was purified by flash chromatography on silica gel 60 (40-63 um, eluent: hexane-dichloromethane=10:1, vol.). Yield 3.90 g (82%) of a white solid. ¹H NMR (CDCl₃, 400 MHz): δ 7.73 (dd, J=8.0, 0.9 Hz, 1H), 7.38-7.46 (m, 2H), 7.24-7.28 (m, 1H), 7.23 (d, J=1.6 Hz, 1H), 6.97 (d, J=1.6 Hz, 1H), 4.56-4.58 (m, 1H), 4.47-4.48 (m, 1H), 3.31 (s, 3H), 2.41 (s, 3H), 1.80 (s, 6H), 1.17-1.29 (m, 6H), 0.98 (s, 9H). ¹³C NMR (CDCl₃, 100 MHz): δ 151.9, 141.8, 141.1, 134.5, 132.9, 132.2, 132.0, 130.0, 128.6, 127.8, 127.1, 124.0, 99.1, 57.1, 50.3, 46.8, 39.8, 32.2, 30.7, 21.1.

### 2-(2′-(Methoxymethoxy)-5′-methyl-3′-((3r,5r,7r)-3,5,7-trimethyladamantan-1-yl)-[1,1′-biphenyl]-2-yl)-4,4,5,5-tetramethyl-1,3,2-dioxaborolane (H)

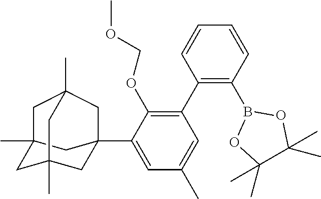

To a solution of 3.80 g (7.86 mmol) of (3r,5r,7r)-1-(2′-bromo-5-methyl-2-(methoxymethoxy)-[1,1′-biphenyl]-3-yl)-3,5,7-trimethyladamantane (G) in 40 ml of dry THF, 4.10 ml (10.2 mmol) of 2.5 M ⁿ BuLi in hexanes was added dropwise for 20 minutes at −80° C. The reaction mixture was stirred for 1 hour at this temperature followed by an addition of 2.57 ml (12.6 mmol) of 2-isopropoxy-4,4,5,5-tetramethyl-1,3,2-dioxaborolane. The obtained suspension was stirred for 1 hour at room temperature, then poured into 100 ml of water. The crude product was extracted with dichloromethane (3×100 ml), the combined organic extract was dried over Na₂SO₄ and then evaporated to dryness. The residue was purified by flash chromatography on silica gel 60 (40-63 um, eluent: hexane-diethyl ether=10:1, vol.). Yield 3.71 g (90%) of a colorless glassy solid. ¹H NMR (CDCl₃, 400 MHz): δ 7.78 (dd, J=7.4, 1.0 Hz, 1H), 7.32-7.45 (m, 3H), 7.11 (d, J=1.9 Hz, 1H), 6.89 (d, J=1.9 Hz, 1H), 4.41-4.48 (m, 2H), 3.32 (s, 3H), 2.33 (s, 3H), 1.79 (br.s, 6H), 1.13-1.25 (m, 18H), 0.94 (s, 9H). ¹³C NMR (CDCl₃, 100 MHz): δ 151.9, 145.6, 141.1, 136.6, 134.4, 131.5, 130.5, 130.3, 129.9, 126.7, 126.1, 98.9, 83.4, 57.2, 50.4, 47.0, 39.7, 32.2, 30.7, 25.2, 24.8, 24.1, 21.0.

### (3r,5r,7r)-1-(2′-Bromo-4′-isopropyl-2-(methoxymethoxy)-5-methyl-[1,1′-biphenyl]-3-yl)-3,5,7-trimethyladamantane (I)

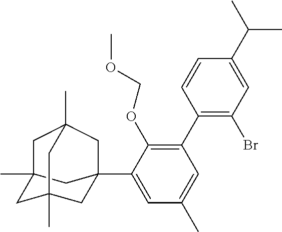 [SMILES: COCOc1c(-c2ccc(C(C)C)cc2Br)cc(C)cc1C12CC3(C)CC(C)(CC(C)(C3)C1)C2]

To a solution of 4.64 g (10.2 mmol) of 2-(2-(methoxymethoxy)-5-methyl-3-((3r,5r,7r)-3,5,7-trimethyladamantan-1-yl)phenyl)-4,4,5,5-tetramethyl-1,3,2-dioxaborolane (F) in 20 ml of 1,4-dioxane, 3.32 g (10.2 mmol) of 2-bromo-4-isopropyliodobenzene, 3.53 g (25.5 mmol) of potassium carbonate, and 10 ml of water were subsequently added. The mixture obtained was purged with argon for 10 minutes followed by addition of 295 mg (0.255 mmol) of Pd(PPh₃)₄. This mixture was stirred for 12 hours at 105° C., then cooled to room temperature, and diluted with 100 ml of water. The crude product was extracted with dichloromethane (3×50 ml), the combined organic extract was dried over Na₂SO₄ and then evaporated to dryness. The residue was purified by flash chromatography on silica gel 60 (40-63 um, eluent: hexane-dichloromethane=10:1, vol.). Yield 4.37 g (81%) of a yellow oil. ¹H NMR (CDCl₃, 400 MHz): δ 7.56 (d, J=1.5 Hz, 1H), 7.31-7.39 (m, 2H), 7.20-7.26 (m, 1H), 7.18 (d, J=2.0 Hz, 1H), 6.93 (d, J=2.0 Hz, 1H), 4.43-4.54 (m, 2H), 3.26 (s, 3H), 2.96 (sept, J=6.9 Hz, 1H), 2.37 (s, 3H), 1.76 (s, 6H), 1.32 (d, J=6.9 Hz, 6H), 1.14-1.24 (m, 6H), 0.95 (s, 9H). ¹³C NMR (CDCl₃, 100 MHz): δ 152.0, 149.9, 141.8, 138.4, 134.5, 132.1, 132.0, 130.7, 130.2, 127.6, 125.4, 123.8, 99.0, 57.0, 50.4, 46.8, 39.8, 33.6, 32.2, 30.7, 23.91, 23.88, 21.0.

### 2-(4-Isopropyl-2′-(methoxymethoxy)-5′-methyl-3′-((3r,5r,7r)-3,5,7-trimethyladamantan-1-yl)-[1,1′-biphenyl]-2-yl)-4,4,5,5-tetramethyl-1,3,2-dioxaborolane (J)

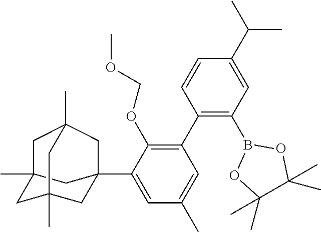

To a solution of 4.37 g (8.30 mmol) of (3r,5r,7r)-1-(2′-bromo-4′-isopropyl-2-(methoxymethoxy)-5-methyl- [1,1′-biphenyl]-3-yl)-3,5,7-trimethyladamantane (I) in 50 ml of dry THF 4.32 ml (10.8 mmol) of 2.5 M ⁿ BuLi in hexanes was added dropwise for 20 minutes at −80° C. The reaction mixture was stirred for 1 hour at this temperature followed by an addition of 2.71 ml (13.3 mmol) of 2-isopropoxy-4,4,5,5-tetramethyl-1,3,2-dioxaborolane. The obtained suspension was stirred for 1 hour at room temperature, then poured into 100 ml of water. The crude product was extracted with dichloromethane (3×100 ml), the combined organic extract was dried over Na₂SO₄ and then evaporated to dryness. The residue was purified by flash chromatography on silica gel 60 (40-63 um, eluent: hexane-diethyl ether=10:1, vol.). Yield 4.32 g (91%) of a colorless glassy solid. ¹H NMR (CDCl₃, 400 MHz): δ 7.61 (s, 1H), 7.29-7.37 (m, 2H), 7.08 (d, J=2.0 Hz, 1H), 6.88 (d, J=2.0 Hz, 1H), 4.40-4.47 (m, 2H), 3.30 (s, 3H), 2.99 (sept, J=6.9 Hz, 1H), 2.32 (s, 3H), 1.78 (br.s, 6H), 1.32 (d, J=6.9 Hz, 6H), 1.12-1.29 (m, 18H), 0.93 (s, 9H). ¹³C NMR (CDCl₃, 100 MHz): δ 152.0, 146.5, 143.1, 141.0, 136.7, 132.5, 131.4, 130.6, 130.3, 127.8, 126.5, 98.9, 83.3, 57.2, 50.4, 47.0, 39.7, 33.8, 32.2, 30.7, 25.2, 24.8, 24.1, 24.0, 21.0.

### 2′,2′″-(Pyridine-2,6-diyl)bis(4′-isopropyl-5-methyl-3-((3r,5r,7r)-3,5,7-trimethyladamantan-1-yl)-[1,1′-biphenyl]-2-ol) (K)

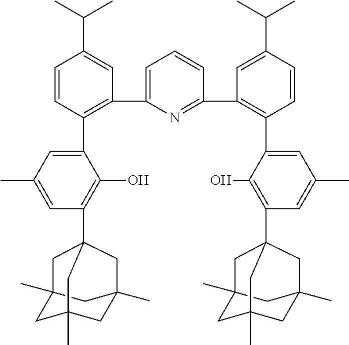

To a solution of 1.50 g (2.62 mmol) of 2-(4-isopropyl-2′-(methoxymethoxy)-5′-methyl-3′-((3r,5r,7r)-3,5,7-trimethyladamantan-1-yl)- [1,1′-biphenyl]-2-yl)-4,4,5,5-tetramethyl-1,3,2-dioxaborolane (J) in 7 ml of 1,4-dioxane, 310 mg (1.31 mmol) of 2,6-dibromopyridine, 2.13 g (6.55 mmol) of cesium carbonate, and 4 ml of water were subsequently added. The mixture obtained was purged with argon for 10 minutes followed by addition of 151 mg (0.131 mmol) of Pd(PPh₃)₄. This mixture was stirred for 12 hours at 100° C., then cooled to room temperature, and diluted with 50 ml of water. Thus obtained mixture was extracted with dichloromethane (3×50 ml), the combined organic extract was dried over Na₂SO₄ and then evaporated to dryness. To the resulting oil, 20 ml of THF, 20 ml of methanol, and 2 ml of 12 N HCl were subsequently added. The reaction mixture was stirred overnight at 60° C. and then poured into 200 ml of water. The crude product was extracted with dichloromethane (3×70 ml), the combined organic extract was washed with 5% NaHCO₃, dried over Na₂SO₄, and then evaporated to dryness. The residue was purified by flash chromatography on silica gel 60 (40-63 um, eluent: hexane-ethyl acetate=10:1, vol.). Yield 770 mg (67%) of a mixture of two isomers as a white foam. ¹H NMR (CDCl₃, 400 MHz): δ 7.24-7.40 (m, 7H), 7.06 (s, 1H), 6.88-6.96 (m, 6H), 6.37 (d, J=1.6 Hz, 1H), 2.97-3.06 (m, 2H), 2.29+2.03 (2s, 6H), 1.24-1.53 (m, 24H), 0.88-1.07 (m, 12H), 0.78+0.68 (2s, 18H). ¹³C NMR (CDCl₃, 100 MHz) δ 158.4, 158.3, 150.1, 149.4, 148.7, 148.4, 140.0, 138.9, 136.5, 136.47, 136.4, 134.2, 134.1, 133.8, 133.6, 132.5, 131.3, 130.0, 129.5, 129.04, 129.01, 128.97, 128.73, 128.69, 128.5, 128.44, 128.36, 127.5, 127.2, 126.9, 126.6, 122.4, 122.1, 50.5, 50.2, 46.0, 45.9, 39.3, 39.1, 33.9, 33.88, 32.0, 31.9, 30.7, 30.5, 24.12, 24.07, 24.04, 23.96, 21.1, 20.6.

### 2′,2′″-(4-Methoxypyridine-2,6-diyl)bis(4′-isopropyl-5-methyl-3-((3r,5r,7r)-3,5,7-trimethyladamantan-1-yl)-[1,1′-biphenyl]-2-ol) (L)

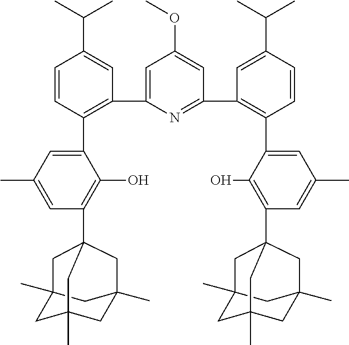

To a solution of 1.50 g (2.62 mmol) of 2-(4-isopropyl-2′-(methoxymethoxy)-5′-methyl-3′-((3r,5r,7r)-3,5,7-trimethyladamantan-1-yl)-[1,1′-biphenyl]-2-yl)-4,4,5,5-tetramethyl-1,3,2-dioxaborolane (J) in 7 ml of 1,4-dioxane, 350 mg (1.31 mmol) of 2,6-dibromo-4-methoxypyridine, 2.13 g (6.55 mmol) of cesium carbonate, and 4 ml of water were subsequently added. The mixture obtained was purged with argon for 10 minutes followed by addition of 151 mg (0.131 mmol) of Pd(PPh₃)₄. This mixture was stirred for 12 hours at 100° C., then cooled to room temperature, and diluted with 50 ml of water. Thus obtained mixture was extracted with dichloromethane (3×50 ml), the combined organic extract was dried over Na₂SO₄ and then evaporated to dryness. To the resulting oil, 20 ml of THF, 20 ml of methanol, and 2 ml of 12 N HCl were subsequently added. The reaction mixture was stirred overnight at 60° C. and then poured into 200 ml of water. The crude product was extracted with dichloromethane (3×70 ml), the combined organic extract was washed with 5% NaHCO₃, dried over Na₂SO₄, and then evaporated to dryness. The residue was purified by flash chromatography on silica gel 60 (40-63 um, eluent: hexane-ethyl acetate=10:1, vol.). Yield 930 mg (78%) of a mixture of two isomers as a white foam. ¹H NMR (CDCl₃, 400 MHz): δ 7.25-7.50 (m, 8H), 6.93-6.98+6.37-6.51 (2m, 6H), 3.36+3.50 (2s, 3H), 3.01-3.08 (m, 2H), 2.06+2.31 (2s, 6H), 1.25-1.60 (m, 24H), 0.91-1.11 (m, 12H), 0.80+0.70 (2s, 18H). ¹³C NMR (CDCl₃, 100 MHz) δ 165.63, 159.83, 159.64, 150.15, 149.57, 148.61, 148.36, 139.91, 138.70, 136.68, 136.63, 134.29, 134.27, 132.46, 131.32, 130.37, 129.84, 129.09, 129.04, 128.71, 128.45, 128.39, 127.63, 127.21, 126.82, 126.59, 108.71, 108.38, 55.08, 54.61, 50.42, 50.17, 46.18, 45.84, 39.34, 39.11, 33.89, 33.87, 32.02, 31.86, 30.69, 30.46, 24.10, 24.06, 23.94, 21.06, 20.59.

### 2′,2′″-(4-Trifluoromethylpyridine-2,6-diyl)bis(4′-isopropyl-5-methyl-3-((3r,5r,7r)-3,5,7-trimethyladamantan-1-yl)-[1,1′-biphenyl]-2-ol) (M)

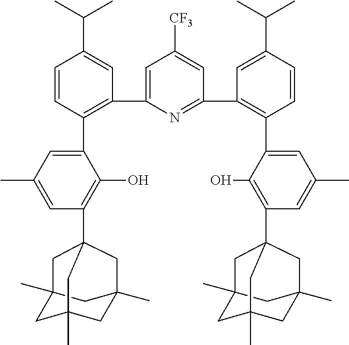

To a solution of 1.50 g (2.62 mmol) of 2-(4-isopropyl-2′-(methoxymethoxy)-5′-methyl-3′-((3r,5r,7r)-3,5,7-trimethyladamantan-1-yl)- [1,1′-biphenyl]-2-yl)-4,4,5,5-tetramethyl-1,3,2-dioxaborolane (J) in 7 ml of 1,4-dioxane, 283 mg (1.31 mmol) of 2,6-dichloro-4-trifluoromethylpyridine, 2.13 g (6.55 mmol) of cesium carbonate, and 4 ml of water were subsequently added. The mixture obtained was purged with argon for 10 minutes followed by addition of 151 mg (0.131 mmol) of Pd(PPh₃)₄. This mixture was stirred for 12 hours at 100° C., then cooled to room temperature, and diluted with 50 ml of water. Thus obtained mixture was extracted with dichloromethane (3×50 ml), the combined organic extract was dried over Na₂SO₄ and then evaporated to dryness. To the resulting oil, 20 ml of THF, 20 ml of methanol, and 2 ml of 12 N HCl were subsequently added. The reaction mixture was stirred overnight at 60° C. and then poured into 200 ml of water. The crude product was extracted with dichloromethane (3×70 ml), the combined organic extract was washed with 5% NaHCO₃, dried over Na₂SO₄, and then evaporated to dryness. The residue was purified by flash chromatography on silica gel 60 (40-63 um, eluent: hexane-ethyl acetate=10:1, vol.). Yield 930 mg (78%) of a mixture of two isomers as a light-yellow foam. ¹H NMR (CDCl₃, 400 MHz): δ 7.32-7.46 (m, 7H), 7.07-7.12 (m, 2H), 6.93-7.00 (m, 3H), 6.47+6.23+5.88 (3m, 2H), 3.00-3.08 (m, 2H), 2.10+2.31 (2s, 6H), 1.27-1.56 (m, 24H), 0.90-1.09 (m, 12H), 0.79+0.73 (2s, 18H). ¹³C NMR (CDCl₃, 100 MHz) δ 159.59, 159.49, 149.54, 149.24, 149.00, 148.78, 139.14, 138.36, 136.34, 136.13, 133.90, 133.82, 133.76, 133.62, 132.36, 131.46, 129.22, 128.86, 128.84, 128.75, 128.71, 128.69, 128.66, 128.57, 128.51, 128.44, 128.37, 127.98, 127.77, 127.25, 127.03, 117.95, 117.66, 50.41, 50.22, 45.94, 45.74, 39.26, 39.07, 33.96, 33.93, 32.01, 31.89, 30.61, 30.46, 24.09, 24.04, 24.00, 23.97, 20.98, 20.60.

### 2′,2′″-(Pyridine-2,6-diyl)bis(5-methyl-3-((3r,5r,7r)-3,5,7-trimethyladamantan-1-yl)-[1,1′-biphenyl]-2-ol) (N)

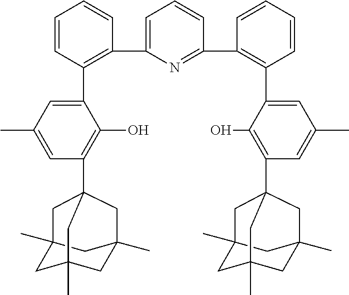

To a solution of 1.20 g (2.26 mmol) of 2-(2′-(methoxymethoxy)-5′-methyl-3′-((3r,5r,7r)-3,5,7-trimethyladamantan-1-yl)-[1,1′-biphenyl]-2-yl)-4,4,5,5-tetramethyl-1,3,2-dioxaborolane (H) in 7 ml of 1,4-dioxane, 241 mg (1.01 mmol) of 2,6-dibromopyridine, 1.84 g (6.55 mmol) of cesium carbonate, and 4 ml of water were subsequently added. The mixture obtained was purged with argon for 10 minutes followed by addition of 131 mg (0.113 mmol) of Pd(PPh₃)₄. This mixture was stirred for 12 hours at 100° C., then cooled to room temperature, and diluted with 50 ml of water. The obtained mixture was extracted with dichloromethane (3×50 ml), the combined organic extract was dried over Na₂SO₄ and then evaporated to dryness. To the resulting oil, 20 ml of THF, 20 ml of methanol, and 2 ml of 12 N HCl were subsequently added. The reaction mixture was stirred overnight at 60° C. and then poured into 200 ml of water. The crude product was extracted with dichloromethane (3×70 ml), the combined organic extract was washed with 5% NaHCO₃, dried over Na₂SO₄, and then evaporated to dryness. The residue was purified by flash chromatography on silica gel 60 (40-63 um, eluent: hexane-ethyl acetate=10:1, vol.). Yield 660 mg (82%) of a mixture of two isomers as a white foam. ¹H NMR (CDCl₃, 400 MHz): δ 7.46-7.51 (m, 6H), 7.34-7.40 (m, 3H), 6.89-6.98 (m, 5H), 6.47-6.60 (m, 3H), 2.12+2.30 (2s, 6H), 1.28-1.51 (m, 12H), 0.91-1.07 (m, 12H), 0.73+0.81 (2s, 18H). ¹³C NMR (CDCl₃, 100 MHz) δ 157.99, 157.84, 149.66, 149.12, 140.14, 139.26, 136.59, 136.53, 136.47, 136.39, 136.28, 136.22, 132.26, 131.43, 130.68, 130.25, 129.62, 129.49, 129.32, 129.09, 128.85, 128.81, 128.63, 128.51, 128.06, 128.03, 127.04, 126.81, 122.29, 121.99, 50.43, 50.22, 46.02, 45.88, 39.31, 39.14, 32.12, 32.04, 31.91, 30.68, 30.58, 30.50, 21.03, 20.67.

### 2′,2′″-(4-Methoxypyridine-2,6-diyl)bis(5-methyl-3-((3r,5r,7r)-3,5,7-trimethyladamantan-1-yl)-[1,1′-biphenyl]-2-ol) (O)

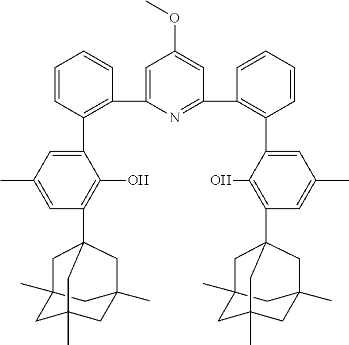

To a solution of 1.20 g (2.26 mmol) of 2-(2′-(methoxymethoxy)-5′-methyl-3′-((3r,5r,7r)-3,5,7-trimethyladamantan-1-yl)-[1,1′-biphenyl]-2-yl)-4,4,5,5-tetramethyl-1,3,2-dioxaborolane (H) in 7 ml of 1,4-dioxane, 272 mg (1.01 mmol) of 2,6-dibromo-4-methoxypyridine, 1.84 g (6.55 mmol) of cesium carbonate, and 4 ml of water were subsequently added. The mixture obtained was purged with argon for 10 minutes followed by addition of 131 mg (0.113 mmol) of Pd(PPh₃)₄. This mixture was stirred for 12 hours at 100° C., then cooled to room temperature, and diluted with 50 ml of water. The obtained mixture was extracted with dichloromethane (3×50 ml), the combined organic extract was dried over Na₂SO₄ and then evaporated to dryness. To the resulting oil, 20 ml of THF, 20 ml of methanol, and 2 ml of 12 N HCl were subsequently added. The reaction mixture was stirred overnight at 60° C. and then poured into 200 ml of water. The crude product was extracted with dichloromethane (3×70 ml), the combined organic extract was washed with 5% NaHCO₃, dried over Na₂SO₄, and then evaporated to dryness. The residue was purified by flash chromatography on silica gel 60 (40-63 um, eluent: hexane-ethyl acetate=10:1, vol.). Yield 680 mg (80%) of a mixture of two isomers as a white foam. ¹H NMR (CDCl₃, 400 MHz): δ 7.44-7.56 (m, 6H), 7.34-7.40 (m, 2H), 6.90-7.05 (m, 5H), 6.44-6.50 (m, 3H), 3.37+3.47 (2s, 3H), 2.11+2.30 (2s, 6H), 1.29-1.74 (m, 12H), 0.91-1.18 (m, 12H), 0.72+0.80 (2s, 18H). ¹³C NMR (CDCl₃, 100 MHz) δ 165.71, 165.62, 159.37, 159.22, 149.80, 149.35, 139.99, 138.99, 136.77, 136.74, 136.62, 136.59, 132.27, 131.43, 130.44, 130.15, 130.09, 129.71, 129.60, 129.12, 128.84, 128.72, 128.58, 127.96, 126.99, 126.81, 108.73, 108.35, 55.01, 54.66, 50.41, 50.19, 46.15, 46.03, 45.88, 39.36, 39.17, 32.12, 32.03, 31.89, 30.69, 30.58, 30.48, 21.02, 20.67.

### 2′,2′″-(4-Trifluoromethylpyridine-2,6-diyl)bis(5-methyl-3-((3r,5r,7r)-3,5,7-trimethyladamantan-1-yl)-[1,1′-biphenyl]-2-ol) (P)

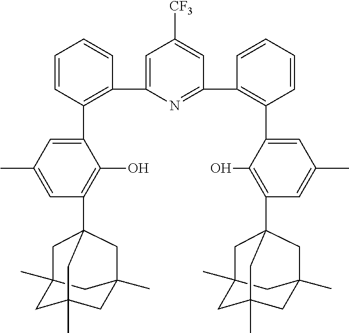

To a solution of 1.20 g (2.26 mmol) of 2-(2′-(methoxymethoxy)-5′-methyl-3′-((3r,5r,7r)-3,5,7-trimethyladamantan-1-yl)-[1,1′-biphenyl]-2-yl)-4,4,5,5-tetramethyl-1,3,2-dioxaborolane (H) in 7 ml of 1,4-dioxane, 220 mg (1.01 mmol) of 2,6-dichloro-4-trifluoromethylpyridine, 1.84 g (6.55 mmol) of cesium carbonate, and 4 ml of water were subsequently added. The mixture obtained was purged with argon for 10 minutes followed by addition of 131 mg (0.113 mmol) of Pd(PPh₃)₄. This mixture was stirred for 12 hours at 100° C., then cooled to room temperature, and diluted with 50 ml of water. Thus obtained mixture was extracted with dichloromethane (3×50 ml), the combined organic extract was dried over Na₂SO₄ and then evaporated to dryness. To the resulting oil 20 ml of THF, 20 ml of methanol, and 2 ml of 12 N HCl were subsequently added. The reaction mixture was stirred overnight at 60° C. and then poured into 200 ml of water. The crude product was extracted with dichloromethane (3×70 ml), the combined organic extract was washed with 5% NaHCO₃, dried over Na₂SO₄, and then evaporated to dryness. The residue was purified by flash chromatography on silica gel 60 (40-63 um, eluent: hexane-ethyl acetate=10:1, vol.). Yield 802 mg (93%) of a mixture of two isomers as a light-yellow foam. ¹H NMR (CDCl₃, 400 MHz): δ 7.43-7.56 (m, 8H), 7.09-7.11 (m, 2H), 6.97-7.01 (m, 2H), 6.57+6.92 (m, 2H), 5.57+5.72 (2s, 2H), 2.17+2.32 (2s, 6H), 1.28-1.54 (m, 12H), 0.90-1.12 (m, 12H), 0.77+0.82 (2s, 18H). ¹³C NMR (CDCl₃, 100 MHz) δ 159.12, 159.02, 149.14, 148.61, 139.31, 138.78, 136.26, 136.21, 136.18, 136.10, 132.02, 131.48, 130.59, 130.37, 130.06, 129.81, 129.33, 129.04, 128.47, 128.40, 128.33, 128.19, 127.37, 127.24, 117.81, 117.48, 50.39, 50.25, 45.92, 45.75, 39.27, 39.13, 32.02, 31.93, 30.59, 30.47, 20.90, 20.66.

### 2-((1r,3R,5S,7r)-3,5-Dimethyladamantan-1-yl)-4-methylphenol (Q)

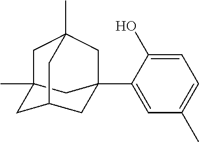

To a solution of 8.10 g (75.0 mmol) of 4-methylphenol and 13.5 g (75.0 mmol) of 3,5-dimethyladamantan-1-ol in 150 ml of dichloromethane, a solution of 4.90 ml (75.0 mmol) of methanesulfonic acid and 5 ml of acetic acid in 100 ml of dichloromethane was added dropwise for 1 hour at room temperature. The resulting mixture was stirred at room temperature for 12 hours and then carefully poured into 300 ml of 5% NaHCO₃. The obtained mixture was extracted with dichloromethane (3×50 ml), the combined organic extract was dried over Na₂SO₄ and then evaporated to dryness. The residue was purified using Kugelrohr apparatus (1 mbar, 70° C.) yielding 14.2 g (70%) of a product as a light-yellow oil. ¹H NMR (CDCl₃, 400 MHz): δ 7.02 (s, 1H), 6.86 (dd, J=8.0, 1.5 Hz, 1H), 6.54 (d, J=8.0 Hz, 1H), 4.61 (s, 1H), 2.27 (s, 3H), 2.14-2.19 (m, 1H), 1.95 (br.s, 2H), 1.65-1.80 (m, 4H), 1.34-1.48 (m, 4H), 1.21 (br.s, 2H), 0.88 (s, 6H). ¹³C NMR (CDCl₃, 100 MHz): δ 152.0, 135.5, 129.7, 127.7, 127.0, 116.6, 51.1, 46.8, 43.2, 39.0, 38.3, 31.4, 30.9, 30.0, 20.8.

### 2-Bromo-6-((1r,3R,5S,7r)-3,5-dimethyladamantan-1-yl)-4-methylphenol (R)

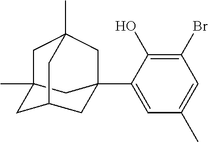 [SMILES: Cc1cc(Br)c(O)c(C23CC4CC(C)(CC(C)(C4)C2)C3)c1]

To a solution of 14.2 g (52.5 mmol) of 2-((1r,3R,5S,7r)-3,5-dimethyladamantan-1-yl)-4-methylphenol (Q) in 200 ml of dichloromethane, a solution of 2.70 ml (52.5 mmol) of bromine in 100 ml of dichloromethane was added dropwise for 1 hour at room temperature. The resulting mixture was stirred at room temperature for 12 hours and then carefully poured into 200 ml of 5% NaHCO₃. The obtained mixture was extracted with dichloromethane (3×50 ml), the combined organic extract was dried over Na₂SO₄ and then evaporated to dryness. Yield 17.0 g (92%) of a light-yellow solid. ¹H NMR (CDCl₃, 400 MHz): δ 7.16 (d, J=2.0 Hz, 1H), 6.97 (d, J=1.8 Hz, 1H), 5.64 (s, 1H), 2.27 (s, 3H), 2.14-2.20 (m, 1H), 1.94 (br.s, 2H), 1.67-1.79 (m, 4H), 1.35-1.47 (m, 4H), 1.21 (br.s, 2H), 0.88 (s, 6H). ¹³C NMR (CDCl₃, 100 MHz): δ 148.2, 136.8, 130.3, 129.4, 127.3, 112.1, 51.0, 46.4, 43.1, 39.1, 38.7, 31.4, 30.9, 30.0, 20.6.

### (1r,3R,5S,7r)-1-(3-Bromo-2-(methoxymethoxy)-5-methylphenyl)-3,5-dimethyladamantane (S)

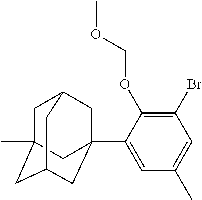

To a solution of 17.0 g (48.7 mmol) of 2-bromo-6-((1r,3R,5S,7r)-3,5-dimethyladamantan-1-yl)-4-methylphenol (R) in 200 ml of dry THF, 1.95 g (50.0 mmol, 60% wt. in mineral oil) of sodium hydride was added portionwise at room temperature. After that, 4.00 ml (53.0 mmol) of MOMCl was added dropwise for 1 hour. The reaction mixture was heated at 60° C. for 24 hours and then poured into 300 ml of cold water. The crude product was extracted with 3×200 ml of dichloromethane. The combined organic extract was dried over Na₂SO₄ and then evaporated to dryness. Yield 17.2 g (90%) of a white solid. ¹H NMR (CDCl₃, 400 MHz): δ 7.22 (d, J=1.5 Hz, 1H), 7.04 (d, J=1.5 Hz, 1H), 5.21 (s, 2H), 3.69 (s, 3H), 2.26 (s, 3H), 2.11-2.19 (m, 1H), 1.92 (br.s, 2H), 1.65-1.80 (m, 4H), 1.34-1.43 (m, 4H), 1.20 (s, 2H), 0.87 (s. 6H). ¹³C NMR (CDCl₃, 100 MHz): δ 151.21, 144.4, 134.4, 131.9, 127.5, 117.6, 99.8, 57.9, 50.9, 47.5, 43.0, 39.8, 39.5, 31.5, 31.0, 30.0, 20.7.

### 2-(3-((1r,3R,5S,7r)-3,5-Dimethyladamantan-1-yl)-2-(methoxymethoxy)-5-methylphenyl)-4,4,5,5-tetramethyl-1,3,2-dioxaborolane (T)

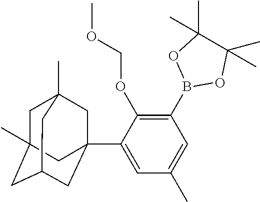

To a solution of 12.8 g (32.4 mmol) of (1r,3R,5S,7r)-1-(3-bromo-2-(methoxymethoxy)-5-methyl-phenyl)-3,5-dimethyladamantane (S) in 200 ml of dry THF, 14.3 ml (35.6 mmol) of 2.5 M ⁿ BuLi in hexanes was added dropwise for 20 minutes at −80° C. The reaction mixture was stirred at this temperature for 1 hour followed by addition of 10.0 ml (48.7 mmol) of 2-isopropoxy-4,4,5,5-tetramethyl-1,3,2-dioxaborolane. The obtained suspension was stirred for 1 hour at room temperature, then poured into 300 ml of water. The crude product was extracted with dichloromethane (3×100 ml), the combined organic extract was dried over Na₂SO₄ and then evaporated to dryness. The residue was recrystallized from isopropanol. Yield 11.1 g (78%) of a white solid. ¹H NMR (CDCl₃, 400 MHz): δ 7.37 (d, J=1.8 Hz, 1H), 7.20 (d, J=2.0 Hz, 1H), 5.14 (s, 2H), 3.60 (s, 3H), 2.29 (s, 3H), 2.11-2.18 (m, 1H), 1.97 (br.s, 2H), 1.69-1.84 (m, 4H), 1.34-1.47 (m, 4H), 1.36 (s, 12H), 1.20 (s, 2H), 0.87 (s, 6H). ¹³C NMR (CDCl₃, 100 MHz): δ 159.8, 140.7, 134.7, 131.7, 131.2, 101.1, 83.7, 57.9, 51.1, 47.4, 43.2, 39.7, 38.7, 31.5, 31.0, 30.1, 24.8, 20.8.

### (1r,3R,5S,7r)-1-(2′-Bromo-4′-isopropyl-2-(methoxymethoxy)-5-methyl-[1,1′-biphenyl]-3-yl)-3,5-dimethyladamantane (U)

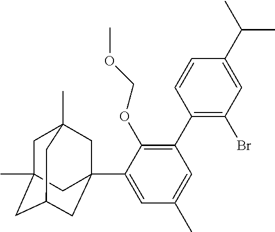 [SMILES: COCOc1c(-c2ccc(C(C)C)cc2Br)cc(C)cc1C12CC3CC(C)(CC(C)(C3)C1)C2]

To a solution of 4.00 g (9.09 mmol) of 2-(3-((1r,3R,5S,7r)-3,5-dimethyladamantan-1-yl)-2-(methoxymethoxy)-5-methylphenyl)-4,4,5,5-tetramethyl-1,3,2-dioxaborolane (T) in 20 ml of 1,4-dioxane, 3.55 g (10.9 mmol) of 2-bromo-4-isopropyliodobenzene, 7.40 g (22.7 mmol) of cesium carbonate, and 10 ml of water were subsequently added. The mixture obtained was purged with argon for 10 minutes followed by addition of 525 mg (0.454 mmol) of Pd(PPh₃)₄. This mixture was stirred for 12 hours at 105° C., then cooled to room temperature, and diluted with 100 ml of water. The crude product was extracted with dichloromethane (3×50 ml), the combined organic extract was dried over Na₂SO₄ and then evaporated to dryness. The residue was purified by flash chromatography on silica gel 60 (40-63 um, eluent: hexane-dichloromethane=10:1, vol.). Yield 3.16 g (68%) of a yellow oil. ¹H NMR (CDCl₃, 400 MHz): δ 7.50 (d, J=1.7 Hz, 1H), 7.24-7.25 (m, 1H), 7.18 (dd, J=8.0, 1.7 Hz, 1H), 7.11 (d, J=2.0 Hz, 1H), 6.88 (d, J=1.7 Hz, 1H), 4.38-4.48 (m, 2H), 3.18 (s, 3H), 2.91 (sept, J=6.9 Hz, 1H), 2.31 (s, 3H), 2.13-2.19 (m, 1H), 1.94-2.01 (m, 2H), 1.78-1.86 (m, 2H), 1.66-1.72 (m, 2H), 1.34-1.46 (m, 4H), 1.27 (d, J=6.9 Hz, 6H), 1.19 (s, 2H), 0.87 (s, 6H). ¹³C NMR (CDCl₃, 100 MHz): δ 151.9, 149.9, 142.1, 138.4, 134.6, 132.0, 130.7, 130.2, 127.6, 125.4, 123.9, 99.0, 57.0, 51.0, 47.53, 47.49, 43.2, 39.7, 39.0, 33.6, 31.5, 31.1, 30.1, 23.90, 23.88, 21.0.

### 2-(3′-((1r,3R,5S,7r)-3,5-Dimethyladamantan-1-yl)-4-isopropyl-2′-(methoxymethoxy)-5′-methyl-[1,1′-biphenyl]-2-yl)-4,4,5,5-tetramethyl-1,3,2-dioxaborolane (V)

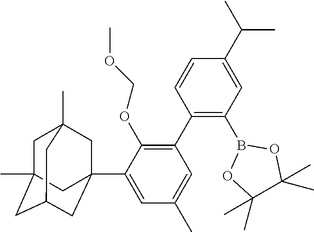

To a solution of 3.15 g (6.16 mmol) of (1r,3R,5S,7r)-1-(2′-bromo-4′-isopropyl-2-(methoxymethoxy)-5-methyl-[1,1′-biphenyl]-3-yl)-3,5-dimethyladamantane (U) in 50 ml of dry THF, 2.51 ml (6.28 mmol) of 2.5 M ⁿ BuLi in hexanes was added dropwise for 20 minutes at −80° C. The reaction mixture was stirred for 1 hour at this temperature followed by an addition of 1.90 ml (9.24 mmol) of 2-isopropoxy-4,4,5,5-tetramethyl-1,3,2-dioxaborolane. The obtained suspension was stirred for 1 hour at room temperature, then poured into 100 ml of water. The crude product was extracted with dichloromethane (3×100 ml), the combined organic extract was dried over Na₂SO₄ and then evaporated to dryness. The residue was purified by flash chromatography on silica gel 60 (40-63 um, eluent: hexane-diethyl ether=10:1, vol.). Yield 2.96 g (84%) of a colorless glassy solid. ¹H NMR (CDCl₃, 400 MHz): (7.58 (s, 1H), 7.28-7.30 (m, 2H), 7.06 (d, J=2.0 Hz, 1H), 6.85 (d, J=1.7 Hz, 1H), 4.39-4.47 (m, 2H), 3.27 (s, 3H), 2.96 (sept, J=6.9 Hz, 1H), 2.29 (s, 3H), 2.15-2.21 (m, 1H), 1.73-2.05 (m, 6H), 1.34-1.52 (m, 4H), 1.30 (d, J=6.9 Hz, 6H), 1.16-1.23 (m, 14H), 0.90 (s, 6H). ¹³C NMR (CDCl₃, 100 MHz): δ 151.8, 146.5, 143.1, 141.3, 136.7, 132.4, 131.4, 130.6, 130.3, 127.8, 126.5, 98.8, 83.3, 57.2, 51.0, 43.2, 39.9, 38.9, 33.8, 31.5, 31.0, 30.2, 25.2, 24.2, 24.1, 24.05, 21.0.

### 2′,2′″-(Pyridine-2,6-diyl)bis(3-((1r,3R,5S,7r)-3,5-dimethyladamantan-1-yl)-4′-isopropyl-5-methyl-[1,1′-biphenyl]-2-ol) (W)

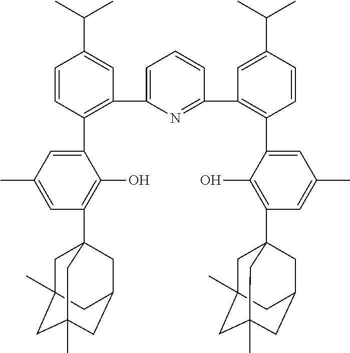

To a solution of 2.90 g (5.30 mmol) of 2-(3′-((1r,3R,5S,7r)-3,5-dimethyladamantan-1-yl)-4-isopropyl-2′-(methoxymethoxy)-5′-methyl- [1,1′-biphenyl]-2-yl)-4,4,5,5-tetramethyl-1,3,2-dioxaborolane (V) in 20 ml of 1,4-dioxane, 625 mg (2.65 mmol) of 2,6-dibromopyridine, 5.13 g (15.4 mmol) of cesium carbonate, and 10 ml of water were subsequently added. The mixture obtained was purged with argon for 10 minutes followed by addition of 355 mg (0.300 mmol) of Pd(PPh₃)₄. This mixture was stirred for 12 hours at 100° C., then cooled to room temperature, and diluted with 50 ml of water. Thus obtained mixture was extracted with dichloromethane (3×50 ml), the combined organic extract was dried over Na₂SO₄ and then evaporated to dryness. To the resulting oil 20 ml of THF, 20 ml of methanol, and 2 ml of 12 N HCl were subsequently added. The reaction mixture was stirred overnight at 60° C. and then poured into 200 ml of water. The crude product was extracted with dichloromethane (3×70 ml), the combined organic extract was washed with 5% NaHCO₃, dried over Na₂SO₄, and then evaporated to dryness. The residue was purified by flash chromatography on silica gel 60 (40-63 um, eluent: hexane-ethyl acetate=10:1, vol.). Yield 1.30 g (57%) of a mixture of two isomers as a white foam. ¹H NMR (CDCl₃, 400 MHz): δ 7.42-7.50+7.67-7.75 (m, 2H), 7.25-7.40 (m, 5H), 7.10-7.24 (m, 2H), 6.81-7.01 (m, 5H), 6.18 (br.s, 1H), 2.96-3.04 (m, 2H), 1.96+2.25 (2s, 6H), 1.46-1.91 (m, 8H), 0.97-1.37 (m, 28H), 0.80+0.71 (2s, 3H), 0.77+0.68 (2s, 3H). ¹³C NMR (CDCl₃, 100 MHz) δ 150.44, 149.62, 148.52, 148.29, 136.86, 134.84, 134.61, 132.37, 131.35, 129.28, 129.03, 128.66, 128.42, 127.58, 126.79, 122.13, 51.23, 50.89, 47.46, 47.02, 46.48, 43.29, 43.04, 42.88, 38.36, 38.17, 33.85, 33.74, 31.47, 31.25, 31.16, 31.13, 31.00, 30.92, 30.81, 30.14, 30.06, 23.99, 23.94, 21.03, 20.57.

### (3r,5r,7r)-1-(2′-Bromo-4′-isopropyl-2-(methoxymethoxy)-5-methyl-[1,1′-biphenyl]-3-yl)adamantane (X)

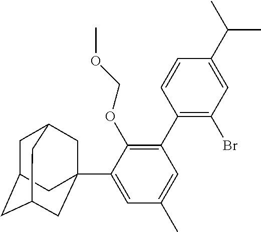 [SMILES: COCOc1c(-c2ccc(C(C)C)cc2Br)cc(C)cc1C12CC3CC(CC(C3)C1)C2]

To a solution of 8.00 g (19.4 mmol) of 2-(3-((3r,5r,7r)-adamantan-1-yl)-2-(methoxymethoxy)-5-methylphenyl)-4,4,5,5-tetramethyl-1,3,2-dioxaborolane (LL) in 40 ml of 1,4-dioxane, 6.92 g (21.3 mmol) of 2-bromo-4-isopropyliodobenzene, 6.70 g (48.5 mmol) of potassium carbonate, and 20 ml of water were subsequently added. The mixture obtained was purged with argon for 10 minutes followed by addition of 1.15 g (1.00 mmol) of Pd(PPh₃)₄. This mixture was stirred for 12 hours at 105° C., then cooled to room temperature, and diluted with 100 ml of water. The crude product was extracted with dichloromethane (3×50 ml), the combined organic extract was dried over Na₂SO₄ and then evaporated to dryness. The residue was purified by flash chromatography on silica gel 60 (40-63 um, eluent: hexane-dichloromethane=10:1, vol.). Yield 7.03 g (75%) of a colorless oil. ¹H NMR (CDCl₃, 400 MHz): δ 7.57 (d, J=1.7 Hz, 1H), 7.31-7.33 (m, 1H), 7.23 (dd, J=7.9, 1.7 Hz, 1H), 7.18 (d, J=2.0 Hz, 1H), 6.94 (d, J=1.7 Hz, 1H), 4.48-4.54 (m, 2H), 3.22 (s, 3H), 2.96 (sept, J=6.9 Hz, 1H), 2.37 (s, 3H), 2.20-2.24 (m, 6H), 2.14 (br.s, 3H), 1.80-1.88 (m, 6H), 1.32 (d, J=6.9 Hz, 6H). ¹³C NMR (CDCl₃, 100 MHz): δ 151.6, 149.9, 142.8, 138.4, 134.7, 132.1, 132.0, 130.7, 130.0, 127.6, 125.3, 123.9, 98.8, 56.9, 41.3, 37.2, 37.0, 33.6, 29.2, 23.88, 23.87, 21.0.

### 4-((3r,5r,7r)-Adamantan-1-yl)-6-isopropoxy-8-isopropyl-2-methyl-6H-dibenzo[c,e][1,2]oxaborinine (Y)

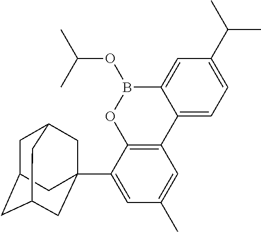 [SMILES: Cc1cc2c(c(C34CC5CC(CC(C5)C3)C4)c1)OB(OC(C)C)c1cc(C(C)C)ccc1-2]

To a solution of 7.00 g (14.5 mmol) of (3r,5r,7r)-1-(2′-bromo-4′-isopropyl-2-(methoxymethoxy)-5-methyl-[1,1′-biphenyl]-3-yl)adamantane (X) in 150 ml of dry THF, 8.71 ml (21.7 mmol) of 2.5 M ⁿ BuLi in hexanes was added dropwise for 20 minutes at −80° C. The reaction mixture was stirred for 1 hour at this temperature followed by an addition of 7.40 ml (36.3 mmol) of 2-isopropoxy-4,4,5,5-tetramethyl-1,3,2-dioxaborolane. The obtained suspension was stirred for 1 hour at room temperature, then poured into 100 ml of water. The crude product was extracted with dichloromethane (3×100 ml), the combined organic extract was dried over Na₂SO₄ and then evaporated to dryness. The residue was recrystallized from isopropanol. Yield 3.01 g (48%) of a white solid. ¹H NMR (CDCl₃, 400 MHz): δ 8.06 (d, J=8.4 Hz, 1H), 7.89 (d, J=1.8 Hz, 1H), 7.81 (s, 1H), 7.51 (dd, J=8.4, 2.0 Hz, 1H), 7.12 (d, J=1.6 Hz, 1H), 5.24 (sept, J=6.1 Hz, 1H), 3.02 (sept, J=6.9 Hz, 1H), 2.42 (s, 3H), 2.25-2.29 (m, 6H), 2.14 (br.s, 3H), 1.83 (br.s, 6H), 1.41 (d, J=6.1 Hz, 6H), 1.32 (d, J=6.9 Hz, 6H).

### 2′,2′″-(Pyridine-2,6-diyl)bis(3-((3r,5r,7r)-adamantan-1-yl)-4′-isopropyl-5-methyl-[1,1′-biphenyl]-2-ol) (Z)

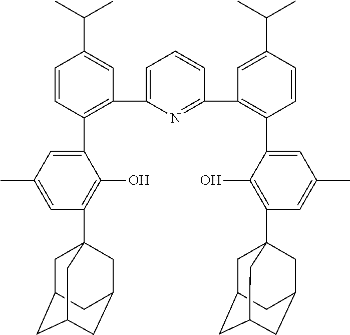

To a solution of 2.90 g (6.77 mmol) of 4-((3r,5r,7r)-adamantan-1-yl)-6-isopropoxy-8-isopropyl-2-methyl-6H-dibenzo[c,e][1,2]oxaborinine (Y) in 20 ml of 1,4-dioxane, 786 mg (3.32 mmol) of 2,6-dibromopyridine, 5.52 g (16.9 mmol) of cesium carbonate, and 10 ml of water were subsequently added. The mixture obtained was purged with argon for 10 minutes followed by addition of 313 mg (0.271 mmol) of Pd(PPh₃)₄. This mixture was stirred for 12 hours at 100° C., then cooled to room temperature, and diluted with 50 ml of water. Thus obtained mixture was extracted with dichloromethane (3×50 ml), the combined organic extract was dried over Na₂SO₄ and then evaporated to dryness. The residue was purified by flash chromatography on silica gel 60 (40-63 um, eluent: hexane-ethyl acetate=10:1, vol.). Yield 1.60 g (61%) of a mixture of two isomers as a white foam. ¹H NMR (CDCl₃, 400 MHz): δ 7.14-7.17+7.25-7.47+7.70-7.74 (3m, 9H), 6.97-7.04 (m, 2H), 6.85-6.90+6.15 (2m, 4H), 3.00-3.10 (m, 2H), 1.90-1.98+2.26 (2m, 18H), 1.56-1.84 (m, 18H), 1.35-1.38 (m, 12H). ¹³C NMR (CDCl₃, 100 MHz) δ 158.36, 158.29, 150.47, 149.79, 148.39, 139.71, 138.46, 137.87, 137.49, 136.93, 136.64, 134.88, 134.73, 132.29, 131.09, 130.62, 130.01, 129.33, 129.03, 128.59, 128.39, 128.27, 127.51, 126.93, 126.74, 126.35, 122.25, 122.00, 40.37, 40.22, 37.03, 36.85, 36.67, 36.48, 33.82, 33.65, 29.11, 28.99, 23.98, 23.94, 23.92, 20.87, 20.52.

### 2-(3-((1r,3R,5S,7r)-3,5-Dimethyladamantan-1-yl)-2-(methoxymethoxy)-5-methyl phenyl)benzo[b]thiophene (AA)

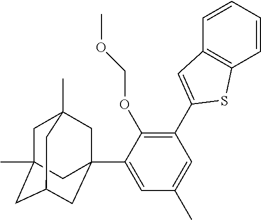 [SMILES: COCOc1c(-c2cc3ccccc3s2)cc(C)cc1C12CC3CC(C)(CC(C)(C3)C1)C2]

To a solution of 6.14 g (45.8 mmol) of benzo[b]thiophene in 200 ml of dry THF, 17.4 ml (43.5 mmol, 2.5 M) of ⁿ BuLi in hexanes was added dropwise at −10° C. The reaction mixture was stirred for 2 hours at 0° C., followed by an addition of 5.94 g (43.5 mmol) of ZnCl₂. Next, the obtained solution was warmed to room temperature, 9.00 g (22.9 mmol) of (1r,3R,5S,7r)-1-(3-bromo-2-(methoxymethoxy)-5-methylphenyl)-3,5-dimethyladamantane (S) and 1.17 g (2.29 mmol) of Pd[P^{t}Bu₃]₂ were subsequently added. The resulting mixture was stirred overnight at 60° C., then poured into 250 ml of water. The crude product was extracted with 3×150 ml of dichloromethane. The combined organic extract was dried over Na₂SO₄ and then evaporated to dryness. The residue was purified by flash chromatography on silica gel 60 (40-63 um; eluent: hexane-ethyl acetate=10:1, vol.). Yield 8.30 g (81%) of an light-yellow solid. ¹H NMR (CDCl₃, 400 MHz): δ 7.86 (d, J=7.8 Hz, 1H), 7.80 (d, J=7.6 Hz, 1H), 7.52 (s, 1H), 7.32-7.40 (m, 2H), 7.17-7.20 (m, 2H), 4.76 (s, 2H), 3.48 (s, 3H), 2.37 (s, 3H), 2.19-2.26 (m, 1H), 2.04 (br.s, 2H), 1.76-1.90 (m, 4H), 1.40-1.52 (m, 4H), 1.25 (s, 2H), 0.93 (s, 6H). ¹³C NMR (CDCl₃, 100 MHz): δ 152.1, 142.9, 141.9, 140.2, 140.1, 133.0, 130.0, 128.5, 124.3, 124.1, 123.4, 122.1, 99.1, 57.7, 50.1, 47.5, 43.1, 39.8, 39.1, 31.5, 31.0, 30.1, 21.0.

### 3-Bromo-2-(3-((1r,3R,5S,7r)-3,5-dimethyladamantan-1-yl)-2-(methoxymethoxy)-5-methyl phenyl)benzo[b]thiophene (BB)

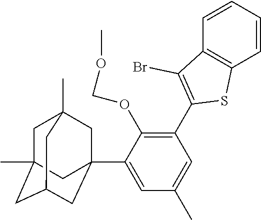 [SMILES: COCOc1c(-c2sc3ccccc3c2Br)cc(C)cc1C12CC3CC(C)(CC(C)(C3)C1)C2]

To a solution of 8.25 g (18.5 mmol) of 2-(3-((1r,3R,5S,7r)-3,5-dimethyladamantan-1-yl)-2-(methoxymethoxy)-5-methylphenyl)benzo[b]thiophene (AA) in 150 ml of dichloromethane, 3.29 g (18.5 mmol) of N-bromosuccinimide was added at room temperature. The reaction mixture was stirred for 12 hours at this temperature, then poured into 100 ml of water. The crude product was extracted with 3×50 ml of dichloromethane. The combined organic extract was dried over Na₂SO₄ and then evaporated to dryness. The residue was recrystallized from 120 ml of n-hexane. Yield 9.03 g (93%) of a beige solid. ¹H NMR (CDCl₃, 400 MHz): δ 7.92 (d, J=8.0 Hz, 1H), 7.86 (d, J=7.8 Hz, 1H), 7.52 (t, J=7.8 Hz, 1H), 7.45 (t, J=8.0 Hz, 1H), 7.27 (s, 1H), 7.15 (s, 1H), 4.68 (s, 2H), 3.38 (s, 3H), 2.41 (s, 3H), 2.21-2.28 (m, 1H), 2.08 (br.s, 2H), 1.79-1.96 (m, 4H), 1.40-1.56 (m, 4H), 1.28 (s, 2H), 0.96 (s, 6H). ¹³C NMR (CDCl₃, 100 MHz): δ 153.4, 142.4, 138.6, 138.2, 137.4, 132.4, 130.8, 129.3, 125.9, 125.4, 125.0, 123.4, 122.2, 107.7, 99.4, 57.4, 51.0, 47.4, 43.1, 39.6, 39.0, 31.5, 31.0, 30.1, 21.0.

### 6,6′-(Pyridine-2,6-diylbis(benzo[b]thiophene-3,2-diyl))bis(2-((1r,3R,5S,7r)-3,5-dimethyladamantan-1-yl)-4-methylphenol) (CC)

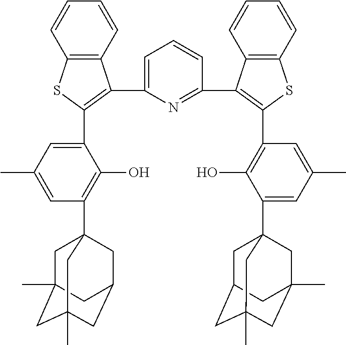

To a solution of 4.00 g (7.55 mmol) of 3-bromo-2-(3-((1r,3R,5S,7r)-3,5-dimethyladamantan-1-yl)-2-(methoxymethoxy)-5-methylphenyl)benzo[b]thiophene (BB) in 50 ml of dry THF, 3.08 ml (7.70 mmol, 2.5M) of ⁿ BuLi in hexanes was added dropwise at −80° C. The reaction mixture was stirred for 30 minutes at this temperature, then 1.03 g (7.70 mmol) of ZnCl₂ was added. The obtained mixture was warmed to room temperature, then 0.86 g (3.63 mmol) of 2,6-dibromopyridine and 194 mg (0.38 mmol) of Pd[P^{t}Bu₃]₂ were subsequently added. The obtained mixture was stirred overnight at 60° C. and then poured into 100 ml of water. Thus obtained mixture was extracted with dichloromethane (3×50 ml), the combined organic extract was dried over Na₂SO₄ and then evaporated to dryness. To the resulting oil, 50 ml of THF, 50 ml of methanol and 2 ml of 12 N HCl were subsequently added. The reaction mixture was stirred overnight at 60° C. and then poured into 200 ml of water. The obtained mixture was extracted with dichloromethane (3×50 ml), the combined organic extract was dried over Na₂SO₄ and then evaporated to dryness. The residue was purified by flash chromatography on silica gel 60 (40-63 um; eluent: hexane-ethyl acetate-triethylamine=100:10:1, vol.). Yield 1.12 g (35%) of a light-yellow foam. ¹H NMR (CDCl₃, 400 MHz): δ 7.87-7.93 (m, 5H), 7.66 (t, J=7.8 Hz, 1H), 7.39-7.46 (m, 5H), 7.23 (d, J=7.8 Hz, 2H), 6.90-6.98 (m, 4H), 2.24 (s, 6H), 1.78-1.82 (m, 2H), 1.50-1.56 (m, 4H), 0.97-1.34 (m, 18H), 0.70 (s, 12H). ¹³C NMR (CDCl₃, 100 MHz): δ 153.5, 150.6, 140.3, 140.0, 138.9, 137.9, 137.8, 131.9, 129.5, 128.7, 128.5, 124.9, 124.8, 123.9, 122.9, 122.1, 50.9, 46.6, 42.9, 38.3, 37.8, 31.2, 30.9, 30.2, 20.9.

### 3-((3r,5r,7r)-Adamantan-1-yl)-5-methyl-2′-(pyridin-2-yl)-[1,1′-biphenyl]-2-ol (DD)

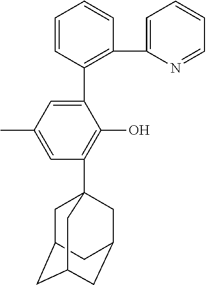

To a solution of 2.42 g (6.27 mmol) of 4-((3r,5r,7r)-adamantan-1-yl)-6-isopropoxy-2-methyl-6H-dibenzo[c,e][1,2]oxaborinine (NN) in 20 ml of 1,4-dioxane, 1.04 g (6.58 mmol) of 2-bromopyridine, 5.11 g (15.7 mmol) of cesium carbonate, and 10 ml of water were subsequently added. The mixture obtained was purged with argon for 10 minutes followed by addition of 362 mg (0.310 mmol) of Pd(PPh₃)₄. This mixture was stirred for 12 hours at 100° C., then cooled to room temperature, and diluted with 50 ml of water. Thus obtained mixture was extracted with dichloromethane (3×50 ml), the combined organic extract was dried over Na₂SO₄ and then evaporated to dryness. The residue was purified by flash chromatography on silica gel 60 (40-63 um, eluent: hexane-ethyl acetate=10:1, vol.). Yield 1.83 g (74%) as a white solid. ¹H NMR (CDCl₃, 400 MHz): δ 9.62 (s, 1H), 8.41-8.44 (m, 1H), 7.67 (td, J=7.8, 1.8 Hz, 1H), 7.44-7.49 (m, 3H), 7.31-7.36 (m, 2H), 7.18 (ddd, J=7.6, 5.0, 1.1 Hz, 1H), 6.97 (d, J=1.9 Hz, 1H), 6.68 (d, J=2.1 Hz, 1H), 2.16-2.27 (m, 6H), 2.21 (s, 3H), 2.10 (br.s, 3H), 1.75-1.86 (m, 6H). ¹³C NMR (CDCl₃, 100 MHz) δ 159.2, 151.4, 147.0, 139.5, 139.0, 138.6, 137.3, 133.3, 132.3, 129.5, 129.0, 128.9, 128.6, 127.5, 126.7, 123.9, 122.2, 40.6, 37.2, 36.9, 29.2, 20.9.

### 1-(tert-Butyl)-3-iodo-2-(methoxymethoxy)-5-methylbenzene (EE)

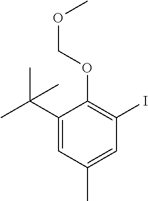 [SMILES: COCOc1c(I)cc(C)cc1C(C)(C)C]

To a solution of 20.0 g (96.1 mmol) of 1-(tert-butyl)-2-(methoxymethoxy)-5-methylbenzene in 500 ml of diethyl ether, 77.1 ml (192 mmol, 2.5 M) of ⁿ BuLi in hexanes was added dropwise at 0° C. The resulting solution was stirred overnight at room temperature. Further on, the reaction mixture was cooled to −80° C., and 51.2 g (202 mmol) of iodine was added in one portion. The obtained mixture was stirred overnight at room temperature and then poured into 100 ml of water. The obtained mixture was extracted with dichloromethane (3×50 ml), the combined organic extract was washed twice with saturated Na₂SO₃, dried over Na₂SO₄ and then evaporated to dryness. The residue was purified by vacuum distillation (1 mbar, bp. 127° C.). Yield 26.7 g (83%) of an yellow oil. ¹H NMR (CDCl₃, 400 MHz): δ 7.52 (d, J=2.1 Hz, 1H), 7.14 (d, J=1.5 Hz, 1H), 5.19 (s, 2H), 3.72 (s, 3H), 2.27 (s, 3H), 1.42 (s, 9H). ¹³C NMR (CDCl₃, 100 MHz) δ 153.1, 144.5, 138.5, 135.9, 135.1, 128.9, 99.5, 57.8, 35.6, 30.9, 20.4.

### 2-(3-(tert-Butyl)-2-(methoxymethoxy)-5-methylphenyl)cyclohexan-1-one (FF)

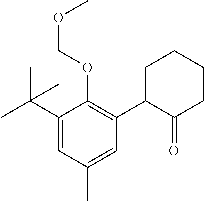 [SMILES: COCOc1c(C2CCCCC2=O)cc(C)cc1C(C)(C)C]

To a solution of 21.0 g (62.9 mmol) of 1-(tert-butyl)-3-iodo-2-(methoxymethoxy)-5-methylbenzene (EE) in 60 ml of dry 1,4-dioxane, 51.2 g (157 mmol) of cesium carbonate, 1.00 g of Pd₂(dba)₃, 1.70 g of 1,1′-bis(di-tert-butylphosphino)ferrocene, and 12.3 g (126 mmol) of cyclohexanone were subsequently added. The resulting suspension was stirred at 80° C. overnight, then cooled to room temperature, and diluted with 50 ml of water. Thus obtained mixture was extracted with dichloromethane (3×50 ml), the combined organic extract was dried over Na₂SO₄ and then evaporated to dryness. The residue was purified using Kugelrohr apparatus (0.4 mbar, 210° C.). Yield 13.0 g (68%) of a red solid. ¹H NMR (CDCl₃, 400 MHz): δ 7.05 (d, J=2.2 Hz, 1H), 6.86 (d, J=2.2 Hz, 1H), 4.92-4.93 (m, 1H), 4.63-4.64 (m, 1H), 4.32 (dd, J=12.0, 5.0 Hz, 1H), 3.58 (s, 3H), 2.52-2.57 (m, 2H), 2.31 (s, 3H), 2.14-2.20 (m, 2H), 1.82-2.04 (m, 4H), 1.38 (s, 9H). ¹³C NMR (CDCl₃, 100 MHz) δ 211.6, 153.6, 142.2, 132.8, 132.7, 128.3, 126.7, 100.7, 56.6, 51.6, 42.3, 35.6, 34.8, 31.1, 28.0, 26.1, 21.3.

### 3′-(tert-Butyl)-2′-(methoxymethoxy)-5′-methyl-3,4,5,6-tetrahydro-[1,1′-biphenyl]-2-yl trifluoromethanesulfonate (GG)

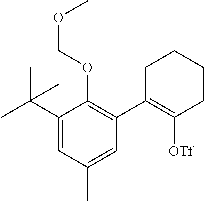 [SMILES: COCOc1c(C2=C(OS(=O)(=O)C(F)(F)F)CCCC2)cc(C)cc1C(C)(C)C]

To a solution of 9.54 g (31.4 mmol) of 2-(3-(tert-butyl)-2-(methoxymethoxy)-5-methylphenyl)cyclohexan-1-one (FF) in 100 ml of THF, 4.22 g (37.7 mmol) of potassium tert-butoxide was added at 0° C. The resulting suspension was stirred at room temperature for 2 hours and then cooled to −30° C. Further on, 14.8 g (37.7 mmol) of N-(5-chloro-2-pyridyl)bis(trifluoromethanesulfonimide) was added in one portion. The resulting mixture was stirred for 30 minutes at room temperature and then diluted with 50 ml of water. The obtained mixture was extracted with dichloromethane (3×50 ml), the combined organic extract was dried over Na₂SO₄ and then evaporated to dryness. The residue was purified by flash chromatography on silica gel 60 (40-63 um, eluent: dichloromethane). Yield 13.0 g (95%) as an yellow oil. ¹H NMR (CDCl₃, 400 MHz): δ 7.11 (d, J=2.2 Hz, 1H), 6.83 (d, J=2.2 Hz, 1H), 4.95-4.96 (m, 1H), 4.89-4.90 (m, 1H), 3.60 (s, 3H), 2.60-2.70 (m, 1H), 2.49-2.54 (m, 2H), 2.35-2.43 (m, 1H), 2.30 (s, 3H), 1.87-1.94 (m, 2H), 1.76-1.82 (m, 2H), 1.42 (s, 9H). ¹³C NMR (CDCl₃, 100 MHz) δ 151.7, 144.1, 142.8, 132.4, 130.0, 129.5, 128.5, 127.9, 119.6, 99.4, 57.2, 35.0, 30.7, 30.6, 28.0, 22.9, 22.0, 20.9.

### 6′,6′″-(Pyridine-2,6-diyl)bis(3-(tert-butyl)-5-methyl-2′,3′,4′,5′-tetrahydro-[1,1′-biphenyl]-2-ol) (HH)

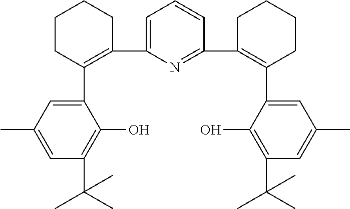

To a solution of 1.13 g (4.30 mmol) of triphenylphosphine in 50 ml of 1,4-dioxane, 380 mg (2.15 mmol) of PdCl₂ was added at room temperature. The reaction mixture was heated at 90° C. for 10 minutes and then cooled to room temperature. After that, 11.7 g (26.9 mmol) of 3′-(tert-butyl)-2′-(methoxymethoxy)-5′-methyl-3,4,5,6-tetrahydro-[1,1′-biphenyl]-2-yl trifluoromethanesulfonate (GG), 7.50 g (29.5 mmol) of bis(pinacolato)diboron, and 11.2 g (80.5 mmol) of potassium carbonate were subsequently added. The resulting mixture was stirred at 90° C. for 2 days, then diluted with 50 ml of water. Thus obtained mixture was extracted with dichloromethane (3×50 ml), the combined organic extract was dried over Na₂SO₄ and then evaporated to dryness yielding 11.2 g of the crude product. To 3.90 g (9.28 mmol) of this product, 1.00 g (4.22 mmol) of 2,6-dibromopyridine, 8.25 g (25.3 mmol) of cesium carbonate, 490 mg (0.42 mmol) of Pd(PPh₃)₄, 20 ml of 1,4-dioxane, and 10 ml of water were added. The resulting mixture was stirred at 90° C. for 7 days, then diluted with 50 ml of water. Thus obtained mixture was extracted with dichloromethane (3×50 ml), the combined organic extract was dried over Na₂SO₄ and then evaporated to dryness. The residue was purified by preparative HPLC (eluent: acetonitrile). Yield 290 mg (10%) of a white foam. ¹H NMR (CDCl₃, 400 MHz): δ 6.49-7.16 (m, 7H), 2.32-2.71 (m, 6H), 2.11+2.21 (2s, 8H), 1.78-1.89 (m, 8H), 1.27+1.14 (2s, 18H). ¹³C NMR (CDCl₃, 100 MHz) δ 161.7, 148.0, 140.7, 137.9, 136.9, 136.2, 135.0, 130.2, 128.3, 126.6, 126.3, 125.8, 122.1, 74.1, 58.3, 34.5, 32.7, 32.2, 29.6, 29.54, 29.49, 27.7, 23.1, 22.9, 22.7, 22.6, 20.9.

### 2-(3-((3r,5r,7r)-Adamantan-1-yl)-2-(methoxymethoxy)-5-methylphenyl)-1-methyl-1H-indole (II)

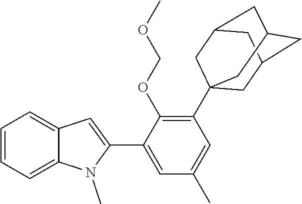 [SMILES: COCOc1c(-c2cc3ccccc3n2C)cc(C)cc1C12CC3CC(CC(C3)C1)C2]

To a solution of 3.52 g (26.9 mmol) of N-methylindole in 250 ml of dry THF, 10.0 ml (25.0 mmol, 2.5 M) of ⁿ BuLi in hexanes was added dropwise at −10° C. The reaction mixture was stirred for 1 hour at 0° C. followed by an addition of 3.40 g (25.0 mmol) of ZnCl₂. Next, the obtained solution was warmed to room temperature, 7.00 g (19.2 mmol) of (3r,5r,7r)-1-(3-bromo-2-(methoxymethoxy)-5-methylphenyl)adamantane and 447 mg (0.876 mmol) of Pd[P^{t}Bu₃]₂ were subsequently added. The resulting mixture was stirred overnight at 60° C., then poured into 250 ml of water. The crude product was extracted with 3×50 ml of dichloromethane. The combined organic extract was dried over Na₂SO₄ and then evaporated to dryness. The residue was purified by flash chromatography on silica gel 60 (40-63 um; eluent: hexane-ethyl acetate=10:1, vol.). Yield 4.04 g (51%) of a yellow solid. ¹H NMR (CDCl₃, 400 MHz): δ 7.65-7.68 (m, 1H), 7.37-7.41 (m, 1H), 7.13-7.28 (m, 3H), 7.08-7.10 (m, 1H), 6.55-6.56 (m, 1H), 4.42-4.53 (m, 2H), 3.64 (s, 3H), 3.23 (s, 3H), 2.38 (s, 3H), 2.21 (s, 6H), 2.14 (br.s, 3H), 1.82 (br.s, 6H). ¹³C NMR (CDCl₃, 100 MHz): δ 152.4, 143.0, 139.9, 137.5, 132.8, 131.0, 128.6, 128.1, 126.1, 121.4, 120.4, 119.6, 109.4, 101.6, 98.6, 57.4, 41.2, 37.2, 37.0, 30.7, 29.1, 21.0.

### 2-(3-((3r,5r,7r)-Adamantan-1-yl)-2-(methoxymethoxy)-5-methylphenyl)-3-bromo-1-methyl-1H-indole (JJ)

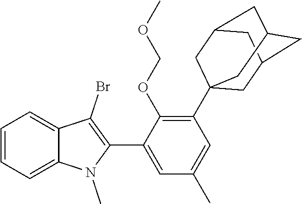 [SMILES: COCOc1c(-c2c(Br)c3ccccc3n2C)cc(C)cc1C12CC3CC(CC(C3)C1)C2]

To a solution of 3.15 g (7.58 mmol) of 2-(3-((3r,5r,7r)-adamantan-1-yl)-2-(methoxymethoxy)-5-methylphenyl)-1-methyl-1H-indole (II) in 80 ml of chloroform, 1.38 g (7.73 mmol) of N-bromosuccinimide was added at room temperature. The reaction mixture was stirred for 2 hours at this temperature, then poured into 100 ml of water. The crude product was extracted with 3×50 ml of dichloromethane. The combined organic extract was dried over Na₂SO₄ and then evaporated to dryness. The residue was triturated with 5 ml of n-hexane and dried in vacuo. Yield 3.66 g (98%) of a light-yellow solid. ¹H NMR (CDCl₃, 400 MHz): δ 7.64 (d, J=7.8 Hz, 1H), 7.35-7.40 (m, 1H), 7.30-7.35 (m, 1H), 7.23-7.28 (m, 2H), 7.09 (m, 1H), 4.66-4.67 (m, 1H), 4.24-4.26 (m, 1H), 3.61 (s, 3H), 3.15 (s, 3H), 2.40 (s, 3H), 2.13-2.23 (m, 9H), 1.83 (br.s, 6H). ¹³C NMR (CDCl₃, 100 MHz): δ 153.2, 143.0, 136.8, 136.3, 132.7, 131.4, 129.3, 127.0, 123.7, 122.6, 120.3, 119.2, 109.5, 99.0, 90.2, 57.3, 41.2, 37.2, 37.0, 31.1, 29.1, 21.0.

### 6,6′-(Pyridine-2,6-diylbis(1-methyl-1H-indole-3,2-diyl))bis(2-((3r,5r,7r)-adamantan-1-yl)-4-methylphenol) (KK)

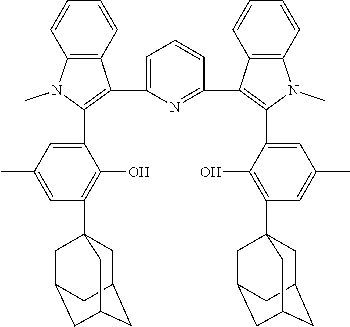

To a solution of 3.61 g (7.30 mmol) of 2-(3-((3r,5r,7r)-adamantan-1-yl)-2-(methoxymethoxy)-5-methylphenyl)-3-bromo-1-methyl-1H-indole (JJ) in 100 ml of dry THF, 3.02 ml (7.45 mmol, 2.5 M) of ⁿ BuLi in hexanes was added dropwise at −80° C. The reaction mixture was stirred for 30 minutes at this temperature, then 1.01 g (7.45 mmol) of ZnCl₂ was added. The obtained mixture was warmed to room temperature, then 822 mg (3.47 mmol) of 2,6-dibromopyridine and 311 mg (0.61 mmol) of Pd[P^{t}Bu₃]₂ were subsequently added. The obtained mixture was stirred overnight at 60° C. and then poured into 100 ml of water. The crude product was extracted with dichloromethane (3×50 ml), the combined organic extract was dried over Na₂SO₄ and then evaporated to dryness. To the resulting oil, 50 ml of THF, 50 ml of methanol and 4 ml of 12 N HCl were subsequently added. The reaction mixture was stirred overnight at 60° C. and then poured into 200 ml of water. The obtained mixture was extracted with dichloromethane (3×50 ml), the combined organic extract was dried over Na₂SO₄ and then evaporated to dryness. The residue was purified by flash chromatography on silica gel 60 (40-63 um; eluent: hexane-ethyl acetate-triethylamine=100:10:1, vol.). Yield 1.92 g (67%) of a mixture of two isomers as a yellow foam. ¹H NMR (CDCl₃, 400 MHz): δ 8.91+8.52 (2br.s, 2H), 7.83-7.85+7.89-7.91 (2m, 2H), 7.54+7.60 (2t, J=7.6 Hz, 1H), 7.42-7.44 (m, 2H), 7.33-7.36 (m, 2H), 7.13-7.27 (m, 4H), 6.98 (s, 2H), 6.60+6.91 (2s, 2H), 3.61+3.57 (2s, 6H), 2.30+2.18 (2s, 6H), 1.39-1.93 (m, 30H). ¹³C NMR (CDCl₃, 100 MHz): δ 154.0, 153.7, 152.5, 152.0, 139.4, 138.8, 137.7, 137.4, 137.3, 135.7, 135.5, 129.6, 129.1, 128.7, 128.5, 128.3, 128.1, 126.8, 126.6, 122.5, 122.4, 121.8, 121.6, 121.1, 120.7, 120.5, 119.5, 119.3, 115.2, 114.7, 109.62, 109.58, 40.3, 40.0, 36.9, 36.8, 36.7, 36.6, 30.9, 30.7, 29.0, 28.95, 20.9, 20.8.

### 2-((3r,5r,7r)-Adamantan-1-yl)-6-bromo-4-methylphenol (00)

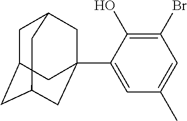 [SMILES: Cc1cc(Br)c(O)c(C23CC4CC(CC(C4)C2)C3)c1]

To a solution of 21.2 g (87.0 mmol) of 2-(adamantan-1-yl)-4-methylphenol in 200 ml of dichloromethane, a solution of 4.50 ml (87.0 mmol) of bromine in 100 ml of dichloromethane was added dropwise for 10 minutes at room temperature. The resulting mixture was diluted with 400 ml of water. The crude product was extracted with dichloromethane (3×70 ml), the combined organic extract was washed with 5% NaHCO₃, dried over Na₂SO₄ and then evaporated to dryness. Yield 21.5 g (77%) of a white solid. ¹H NMR (CDCl₃, 400 MHz): δ 7.17 (s, 1H), 6.98 (s, 1H), 5.65 (s, 1H), 2.27 (s, 3H), 2.10-2.13 (m, 9H), 1.80 (m, 6H), ¹³C NMR (CDCl₃, 100 MHz): δ 148.18, 137.38, 130.24, 129.32, 127.26, 112.08, 40.18, 37.32, 36.98, 28.99, 20.55.

### (3r,5r,7r)-1-(3-Bromo-2-(methoxymethoxy)-5-methylphenyl)adamantine (PP)

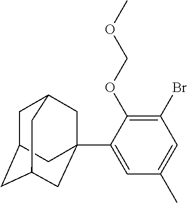 [SMILES: COCOc1c(Br)cc(C)cc1C12CC3CC(CC(C3)C1)C2]

To a solution of 21.3 g (66.4 mmol) of 2-((3r,5r,7r)-adamantan-1-yl)-6-bromo-4-methylphenol (OO) in 400 ml of THF, 2.79 g (69.7 mmol, 60% wt. in mineral oil) of sodium hydride was added portionwise at room temperature. To the resulting suspension 5.55 ml (73.0 mmol) of methoxymethyl chloride was added dropwise for 10 minutes at room temperature. The obtained mixture was stirred overnight, then poured into 200 ml of water. Thus obtained mixture was extracted with dichloromethane (3×200 ml), the combined organic extract was washed with 5% NaHCO₃, dried over Na₂SO₄, and then evaporated to dryness. Yield 24.3 g (quant.) of a white solid. ¹H NMR (CDCl₃, 400 MHz): δ 7.24 (d, J=1.5 Hz, 1H), 7.05 (d, J=1.8 Hz, 1H), 5.22 (s, 2H), 3.71 (s, 3H), 2.27 (s, 3H), 2.05-2.12 (m, 9H), 1.78 (m, 6H). ¹³C NMR (CDCl₃, 100 MHz): δ 151.01, 144.92, 134.34, 131.80, 127.44, 117.57, 99.56, 57.75, 41.27, 37.71, 36.82, 29.03, 20.68.

### 2-(3-((3r,5r,7r)-Adamantan-1-yl)-2-(methoxymethoxy)-5-methylphenyl)-4,4,5,5-tetramethyl-1,3,2-dioxaborolane (LL)

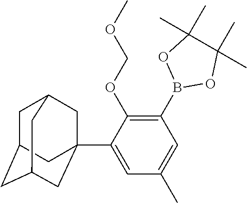 [SMILES: COCOc1c(B2OC(C)(C)C(C)(C)O2)cc(C)cc1C12CC3CC(CC(C3)C1)C2]

To a solution of 20.0 g (55.0 mmol) of (3r,5r,7r)-1-(3-bromo-2-(methoxymethoxy)-5-methylphenyl)adamantine (PP) in 400 ml of dry THF, 22.5 ml (56.4 mmol) of 2.5 M ⁿ BuLi in hexanes was added dropwise for 20 minutes at −80° C. The reaction mixture was stirred at this temperature for 1 hour followed by addition of 16.7 ml (82.2 mmol) of 2-isopropoxy-4,4,5,5-tetramethyl-1,3,2-dioxaborolane. The obtained suspension was stirred for 1 hour at room temperature, then poured into 300 ml of water. The crude product was extracted with dichloromethane (3×300 ml), the combined organic extract was dried over Na₂SO₄ and then evaporated to dryness. Yield 22.4 g (99%) of a colorless viscous oil. ¹H NMR (CDCl₃, 400 MHz): δ 7.35 (d, J=2.3 Hz, 1H), 7.18 (d, J=2.3 Hz, 1H), 5.14 (s, 2H), 3.58 (s, 3H), 2.28 (s, 3H), 2.14 (m, 6H), 2.06 (m, 3H), 1.76 (m, 6H), 1.35 (s, 12H). ¹³C NMR (CDCl₃, 100 MHz): δ 159.68, 141.34, 134.58, 131.69, 131.14, 100.96, 83.61, 57.75, 41.25, 37.04, 29.14, 24.79, 20.83.

### (3r,5r,7r)-1-(2′-Bromo-2-(methoxymethoxy)-5-methyl-[1,1′-biphenyl]-3-yl)adamantane (MM)

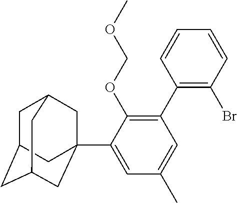 [SMILES: COCOc1c(-c2ccccc2Br)cc(C)cc1C12CC3CC(CC(C3)C1)C2]

To a solution of 10.0 g (24.3 mmol) of 2-(3-((3r,5r,7r)-adamantan-1-yl)-2-(methoxymethoxy)-5-methylphenyl)-4,4,5,5-tetramethyl-1,3,2-dioxaborolane (LL) in 100 ml of 1,4-dioxane, 7.22 g (25.5 mmol) of 2-bromoiodobenzene, 8.38 g (60.6 mmol) of potassium carbonate, and 50 ml of water were subsequently added. The mixture obtained was purged with argon for 10 minutes followed by addition of 1.40 g (1.21 mmol) of Pd(PPh₃)₄. This mixture was stirred for 12 hours at 100° C., then cooled to room temperature and diluted with 100 ml of water. The crude product was extracted with dichloromethane (3×150 ml), the combined organic extract was dried over Na₂SO₄ and then evaporated to dryness. The residue was purified by flash chromatography on silica gel 60 (40-63 um, eluent: hexane-dichloromethane=10:1, vol.). Yield 10.7 g (quant.) of a white solid. ¹H NMR (CDCl₃, 400 MHz): δ 7.72 (d, J=7.9 Hz, 1H), 7.35-7.44 (m, 3H), 7.19-7.26 (m, 1H), 6.94 (m, 1H), 4.53 (dd, J=20.0, 4.6 Hz, 2H), 3.24 (s, 3H), 2.38 (s, 3H), 2.23 (m, 6H), 2.15 (m, 3H), 1.84 (m, 6H). ¹³C NMR (CDCl₃, 100 MHz): δ 151.51, 142.78, 141.11, 134.63, 132.76, 132.16, 132.13, 129.83, 128.57, 127.76, 127.03, 124.05, 98.85, 56.95, 41.21, 37.18, 36.94, 29.07, 21.00.

### 4-((3r,5r,7r)-Adamantan-1-yl)-6-isopropoxy-2-methyl-6H-dibenzo[c,e][1,2]oxaborinine (NN)

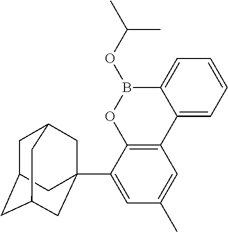 [SMILES: Cc1cc2c(c(C34CC5CC(CC(C5)C3)C4)c1)OB(OC(C)C)c1ccccc1-2]

To a solution of 10.0 g (22.7 mmol) of 1-(2′-bromo-2-(methoxymethoxy)-5-methyl-[1,1′-biphenyl]-3-yl)adamantine (MM) in 120 ml of dry THF, 10.9 ml (27.2 mmol) of 2.5 M ⁿ BuLi in hexanes was added dropwise for 20 minutes at −80° C. The reaction mixture was stirred for 1 hour at this temperature followed by addition of 6.93 ml (40.0 mmol) of 2-isopropoxy-4,4,5,5-tetramethyl-1,3,2-dioxaborolane. The obtained suspension was stirred at room temperature for 1 hour, then poured into 300 ml of water. The crude product was extracted with dichloromethane (3×300 ml), the combined organic extract was dried over Na₂SO₄ and then evaporated to dryness. The residue was recrystallized from 30 ml of isopropanol. Yield 6.48 g (74%) of a white crystals. ¹H NMR (CDCl₃, 400 MHz): δ 8.16 (d, J=8.3 Hz, 1H), 8.09 (dd, J=7.4, 1.0 Hz, 1H), 7.86 (d, J=1.2 Hz, 1H), 7.63-7.68 (m, 1H), 7.43 (td, J=7.3, 1.0 Hz), 7.19 (d, J=1.8 Hz, 1H), 5.27 (sept, J=6.1 Hz, 1H), 2.46 (s, 3H), 2.30-2.32 (m, 6H), 2.17 (br.s, 3H), 1.86 (br.s, 6H), 1.44 (d, J=6.1 Hz, 6H). ¹³C NMR (CDCl₃, 100 MHz): δ 148.4, 140.6, 139.3, 133.0, 131.8, 130.7, 127.5, 126.6, 122.8, 121.9, 121.6, 65.7, 40.7, 37.2, 29.1, 24.7, 21.4.

### ((4-(Methoxymethoxy)-1,3-phenylene)bis(propane-2,2-diyl))dibenzene (RR)

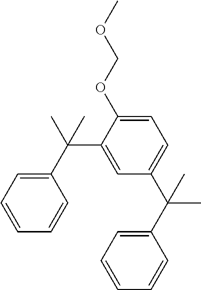 [SMILES: COCOc1ccc(C(C)(C)c2ccccc2)cc1C(C)(C)c1ccccc1]

To a solution of 30.0 g (90.8 mmol) of 2,4-bis(2-phenylpropan-2-yl)phenol in 500 ml of THF, 3.81 g (95.3 mmol, 60% wt. in mineral oil) of sodium hydride was added portionwise at room temperature. To the resulting suspension, 7.60 ml (99.9 mmol) of methoxymethyl chloride was added dropwise for 10 minutes at room temperature. The obtained mixture was stirred overnight, then poured into 500 ml of water. The obtained mixture was extracted with dichloromethane (3×300 ml), the combined organic extract was washed with 5% NaHCO₃, dried over Na₂SO₄, and then evaporated to dryness. Yield 34.0 g (quant.) of a light-yellow oil. ¹H NMR (CDCl₃, 400 MHz): δ 7.49 (d, J=2.3 Hz, 1H), 7.37-7.42 (m, 4H), 7.25-7.32 (m, 5H), 7.15-7.19 (m, 2H), 7.00 (d, J=8.5 Hz, 1H), 4.68 (s, 2H), 3.06 (s, 3H), 1.84 (s, 6H), 1.74 (s, 6H). ¹³C NMR (CDCl₃, 100 MHz): δ 153.09, 151.59, 150.96, 143.14, 137.65, 127.90, 127.58, 126.72, 125.63, 125.49, 125.41, 124.75, 114.23, 93.75, 55.28, 42.59, 42.04, 30.99, 29.55.

### 2-(2-(Methoxymethoxy)-3,5-bis(2-phenylpropan-2-yl)phenyl)-4,4,5,5-tetramethyl-1,3,2-dioxaborolane (SS)

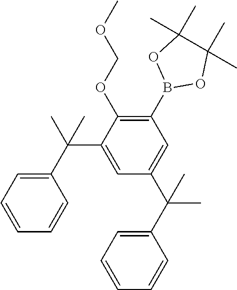 [SMILES: COCOc1c(B2OC(C)(C)C(C)(C)O2)cc(C(C)(C)c2ccccc2)cc1C(C)(C)c1ccccc1]

To a solution of 15.0 g (40.1 mmol) of ((4-(methoxymethoxy)-1,3-phenylene)bis(propane-2,2-diyl))dibenzene (RR) in 400 ml of dry diethyl ether, 32.0 ml (80.2 mmol) of 2.5 M ⁿ BuLi in hexanes was added dropwise for 20 minutes at 0° C. The reaction mixture was stirred for 3 hours at room temperature, then cooled to −80° C., followed by an addition of 24.5 ml (120 mmol) of 2-isopropoxy-4,4,5,5-tetramethyl-1,3,2-dioxaborolane. The obtained suspension was stirred for 1 hour at room temperature, then poured into 400 ml of water. The obtained mixture was extracted with dichloromethane (3×300 ml), the combined organic extract was dried over Na₂SO₄ and then evaporated to dryness. Yield 20.0 g (quant.) of a colorless viscous oil. ¹H NMR (CDCl₃, 400 MHz): δ 7.49 (d, J=2.4 Hz, 1H), 7.34 (d, J=2.5 Hz, 1H), 7.29 (d, J=4.7 Hz, 4H), 7.06-7.22 (m, 6H), 4.13 (s, 2H), 3.10 (s, 3H), 1.74 (s, 6H), 1.61 (s, 6H), 1.32 (s, 12H). ¹³C NMR (CDCl₃, 100 MHz): δ 156.94, 151.72, 150.92, 143.88, 140.51, 131.17, 129.39, 127.81, 127.70, 126.74, 125.82, 125.41, 124.95, 98.10, 83.57, 82.74, 56.52, 42.66, 42.22, 30.88, 30.11, 26.15, 25.36, 24.76, 13.85.

### 2′-Bromo-2-(methoxymethoxy)-3,5-bis(2-phenylpropan-2-yl)-1,1′-biphenyl (TT)

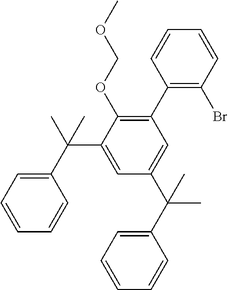 [SMILES: COCOc1c(-c2ccccc2Br)cc(C(C)(C)c2ccccc2)cc1C(C)(C)c1ccccc1]

To a solution of 20.0 g (40.0 mmol) of 2-(2-(methoxymethoxy)-3,5-bis(2-phenylpropan-2-yl)phenyl)-4,4,5,5-tetramethyl-1,3,2-dioxaborolane (SS) in 200 ml of dioxane, 12.5 g (44.0 mmol) of 2-bromoiodobenzene, 13.8 g (100 mmol) of potassium carbonate, and 100 ml of water were subsequently added. The mixture obtained was purged with argon for 10 minutes followed by addition of 2.30 g (2.00 mmol) of Pd(PPh₃)₄. This mixture was stirred for 12 hours at 100° C., cooled to room temperature, and then diluted with 100 ml of water. The obtained mixture was extracted with dichloromethane (3×200 ml), the combined organic extract was dried over Na₂SO₄ and then evaporated to dryness. The residue was purified by flash chromatography on silica gel 60 (40-63 um, eluent: hexane-dichloromethane=10:1, vol.). Yield 15.6 g (74%) of a yellow viscous oil. ¹H NMR (CDCl₃, 400 MHz): δ 7.62 (dd, J=7.9, 1.1 Hz, 1H), 7.49 (d, J=2.4 Hz, 1H), 7.35-7.39 (m, 7H), 7.30 (d, J=4.4 Hz, 4H), 7.22-7.26 (m, 1H), 7.13-7.18 (m, 1H), 7.08 (d, J=2.4 Hz, 1H), 3.51 (d, J=4.7 Hz, 1H), 3.44 (d, J=4.7 Hz, 1H), 2.73 (s, 3H), 1.82 (s, 3H), 1.80 (s, 3H), 1.76 (s, 3H), 1.75 (s, 3H). ¹³C NMR (CDCl₃, 100 MHz): δ 151.47, 150.67, 150.48, 144.76, 142.49, 140.96, 134.66, 132.53, 132.15, 128.72, 128.45, 127.93, 127.89, 126.75, 125.94, 125.58, 125.53, 125.23, 124.33, 97.59, 56.12, 42.82, 42.41, 31.08, 30.85, 30.22, 30.06.

### 2-(2′-(Methoxymethoxy)-3′,5′-bis(2-phenylpropan-2-yl)-[1,1′-biphenyl]-2-yl)-4,4,5,5-tetramethyl-1,3,2-dioxaborolane (UU)

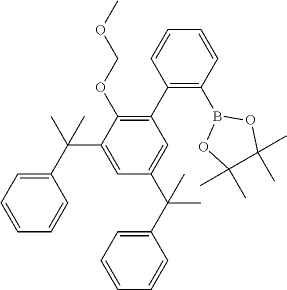 [SMILES: COCOc1c(-c2ccccc2B2OC(C)(C)C(C)(C)O2)cc(C(C)(C)c2ccccc2)cc1C(C)(C)c1ccccc1]

To a solution of 15.6 g (29.5 mmol) of 2′-bromo-2-(methoxymethoxy)-3,5-bis(2-phenylpropan-2-yl)-1,1′-biphenyl (TT) in 250 ml of dry THF, 15.4 ml (38.4 mmol) of 2.5 M ⁿ BuLi in hexanes was added dropwise for 20 minutes at −80° C. The reaction mixture was stirred for 1 hour at this temperature followed by an addition of 10.8 ml (53.1 mmol) of 2-isopropoxy-4,4,5,5-tetramethyl-1,3,2-dioxaborolane. The obtained suspension was stirred for 1 hour at room temperature, then poured into 300 ml of water. The obtained mixture was extracted with dichloromethane (3×300 ml), the combined organic extract was dried over Na₂SO₄ and then evaporated to dryness. The residue was purified by flash chromatography on silica gel 60 (40-63 um, eluent: hexane-diethyl ether=10:1, vol.) Yield 9.90 g (58%) of a colorless glassy solid. ¹H NMR (CDCl₃, 400 MHz): δ 7.82 (d, J=7.2 Hz, 1H), 7.30-7.43 (m, 8H), 7.20-7.27 (m, 5H), 7.12-7.17 (m, 1H), 7.08 (d, J=2.4 Hz, 1H), 3.57 (d, J=4.1 Hz, 1H), 3.27 (d, J=4.1 Hz, 1H), 2.70 (s, 3H), 1.81 (s, 3H), 1.79 (s, 3H), 1.78 (s, 3H), 1.69 (s, 3H), 1.22 (s, 12H). ¹³C NMR (CDCl₃, 100 MHz): δ 152.03, 151.10, 149.74, 146.07, 143.65, 141.71, 137.16, 134.63, 130.40, 129.69, 128.49, 127.79, 127.69, 126.73, 126.05, 125.99, 125.41, 125.31, 125.12, 96.52, 83.13, 56.13, 42.70, 42.38, 31.27, 31.02, 29.42, 24.80, 24.58.

### 2′,2′″-(Pyridine-2,6-diyl)bis(3,5-bis(2-phenylpropan-2-yl)-[1,1′-biphenyl]-2-ol) (VV)

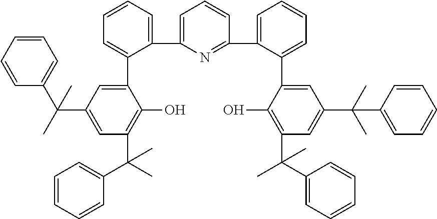 [SMILES: CC(C)(c1ccccc1)c1cc(-c2ccccc2-c2cccc(-c3ccccc3-c3cc(C(C)(C)c4ccccc4)cc(C(C)(C)c4ccccc4)c3O)n2)c(O)c(C(C)(C)c2ccccc2)c1]

To a solution of 3.63 g (6.30 mmol) of 2-(2′-(methoxymethoxy)-3′,5′-bis(2-phenylpropan-2-yl)-[1,1′-biphenyl]-2-yl)-4,4,5,5-tetramethyl-1,3,2-dioxaborolane (UU) in 14 ml of 1,4-dioxane, 745 mg (3.15 mmol) of 2,6-dibromopyridine, 5.13 g (15.8 mmol) of cesium carbonate, and 7 ml of water were subsequently added. The mixture obtained was purged with argon for 10 minutes followed by addition of 315 mg (0.315 mmol) of Pd(PPh₃)₄. This mixture was stirred for 12 hours at 100° C., then cooled to room temperature, and diluted with 50 ml of water. The obtained mixture was extracted with dichloromethane (3×50 ml), the combined organic extract was dried over Na₂SO₄ and then evaporated to dryness. To the resulting oil 30 ml of THF, 30 ml of methanol, and 2 ml of 12N HCl were subsequently added. The reaction mixture was stirred overnight at 60° C. and then poured into 500 ml of water. The obtained mixture was extracted with dichloromethane (3×35 ml), the combined organic extract was washed with 5% NaHCO₃, dried over Na₂SO₄, and then evaporated to dryness. The residue was purified by flash chromatography on silica gel 60 (40-63 um, eluent: hexane-ethyl acetate=10:1, vol.). Yield 2.22 g (79%) of a mixture of two isomers as a white foam. ¹H NMR (CDCl₃, 400 MHz): δ 7.05-7.40 (m, 29H), 6.82-6.90 (m, 2H), 6.73 (d, J=7.8 Hz, 2H), 4.85+5.52 (s, 2H), 1.31-1.65 (m, 24H). ¹³C NMR (CDCl₃, 100 MHz) δ 158.02, 151.02 (broad), 149.77 (broad), 148.46 (broad), 141.56, 140.17 (broad), 136.75 (broad), 134.89 (broad), 131.31 (broad), 130.62 (broad), 128.32, 128.23, 127.78, 127.72, 126.57, 125.71, 125.61, 125.33, 124.68 (broad), 122.22 (broad), 42.39 (broad), 41.99, 30.97 (broad), 30.77 (broad), 29.53 (broad), 29.34 (broad).

### Dimethylhafnium[2′,2′″-(pyridine-2,6-diyl)bis(4′-isopropyl-5-methyl-3-((3r,5r,7r)-3,5,7-trimethyladamantan-1-yl)-[1,1′-biphenyl]-2-olate)] (Complex 40)

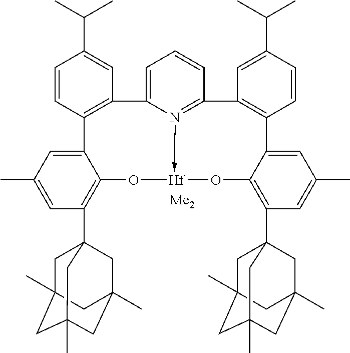

To a suspension of 120 mg (0.375 mmol) of hafnium tetrachloride (<0.05% Zr) in 50 ml of dry toluene, 530 ul (1.54 mmol) of 2.9 M MeMgBr in diethyl ether was added in one portion via syringe at 0° C. To the resulting suspension, 330 mg (0.375 mmol) of 2′,2′″-(pyridine-2,6-diyl)bis(4′-isopropyl-5-methyl-3-((3r,5r,7r)-3,5,7-trimethyladamantan-1-yl)-[1,1′-biphenyl]-2-ol) (K) was immediately added in one portion. The reaction mixture was stirred for 4 hours at room temperature and then evaporated to near dryness. The solid obtained was extracted with 2×20 ml of hot toluene, and the combined organic extract was filtered through a thin pad of Celite 503. Next, the filtrate was evaporated to dryness. The residue was triturated with 5 ml of n-hexane, the obtained precipitate was filtered off (G4), washed with 2×5 ml of n-hexane, and then dried in vacuo. Yield 272 mg (67%) of a white-beige solid. Anal. Calc. for C₆₅H₈₁HfNO₂: C, 71.83; H, 7.51; N, 1.29. Found: C 72.08; H, 7.82; N 1.15. ¹H NMR (CD₂Cl₂, 400 MHz): δ 7.77 (t, J=7.8 Hz, 1H), 7.42 (dd, J=8.1, 1.7 Hz, 2H), 7.17 (d, J=8.1, 2H), 7.16 (d, J=7.8 Hz, 2H), 7.02 (d, J=1.9 Hz, 2H), 6.80 (d, J=1.5 Hz, 2H), 6.58 (d, J=1.6 Hz, 2H), 3.30 (sept, J=6.9 Hz, 2H), 2.20 (s, 6H), 1.64-1.71 (m, 6H), 1.50-1.57 (m, 6H), 1.30 (d, J=6.9 Hz, 6H), 1.20 (d, J=6.9 Hz, 6H), 1.14-1.21 (m, 6H), 0.97-1.04 (m, 6H), 0.83 (s, 18H), −0.59 (s, 6H). ¹³C NMR (CD₂Cl₂, 100 MHz) δ 159.7, 159.2, 148.8, 140.2, 140.1, 137.6, 133.8, 133.3, 132.4, 129.2, 129.0, 128.7, 127.8, 126.7, 124.8, 51.9, 50.9, 46.5, 40.3, 33.4, 32.5, 30.1, 24.3, 23.5, 21.0.

### Dimethylzirconium[2′,2′″-(pyridine-2,6-diyl)bis(4′-isopropyl-5-methyl-3-((3r,5r,7r)-3,5,7-trimethyladamantan-1-yl)-[1,1′-biphenyl]-2-olate)] (Complex 41)

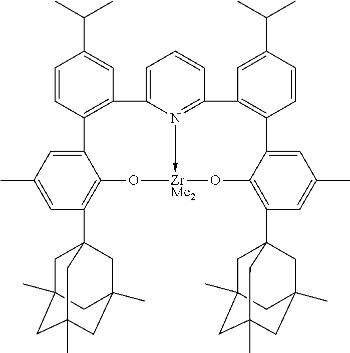

To a suspension of 88 mg (0.375 mmol) of zirconium tetrachloride in 50 ml of dry toluene, 530 ul (1.54 mmol) of 2.9 M MeMgBr in diethyl ether was added in one portion via syringe at −30° C. To the resulting suspension, 330 mg (0.375 mmol) of 2′,2′″-(pyridine-2,6-diyl)bis(4′-isopropyl-5-methyl-3-((3r,5r,7r)-3,5,7-trimethyladamantan-1-yl)-[1,1′-biphenyl]-2-ol) (K) was immediately added in one portion. The reaction mixture was stirred for 4 hours at room temperature and then evaporated to near dryness. The solid obtained was extracted with 2×20 ml of hot toluene, and the combined organic extract was filtered through a thin pad of Celite 503. Next, the filtrate was evaporated to dryness. The residue was triturated with 5 ml of n-hexane, the obtained precipitate was filtered off (G4), washed with 2×5 ml of n-hexane, and then dried in vacuo. Yield 217 mg (58%) of a beige solid. Anal. Calc. for C₆₅H₈₁ZrNO₂: C, 78.10; H, 8.17; N, 1.40. Found: C 78.42; H, 8.35; N 1.23. ¹H NMR (CD₂Cl₂, 400 MHz): 7.77 (t, J=7.8 Hz, 1H), 7.41 (dd, J=8.1, 1.7 Hz, 2H), 7.17 (d, J=8.1 Hz, 2H), 7.14 (d, J=7.8 Hz, 2H), 7.01 (d, J=2.0 Hz, 2H), 6.78 (d, J=1.6 Hz, 2H), 6.58 (d, J=1.6 Hz, 2H), 3.02 (sept, J=6.8 Hz, 2H), 2.20 (s, 6H), 1.67-1.74 (m, 6H), 1.53-1.60 (m, 6H), 1.29 (d, J=6.8 Hz, 6H), 1.19 (d, J=6.8 Hz, 6H), 1.13-1.19 (m, 6H), 0.97-1.04 (m, 6H), 0.83 (s, 18H), −0.36 (s, 6H). ¹³C NMR (CD₂Cl₂, 100 MHz) δ 159.4, 159.3, 148.8, 140.2, 140.0, 137.1, 134.1, 133.2, 132.7, 129.3, 128.9, 128.6, 127.7, 126.8, 124.4, 50.9, 46.6, 43.8, 40.4, 33.3, 32.5, 31.0, 24.4, 23.4, 21.0.

### Dimethylhafnium[2′,2′″-(4-(trifluoromethyl)pyridine-2,6-diyl)bis(4′-isopropyl-5-methyl-3-((3r,5r,7r)-3,5,7-trimethyladamantan-1-yl)-[1,1′-biphenyl]-2-olate)] (Complex 42)

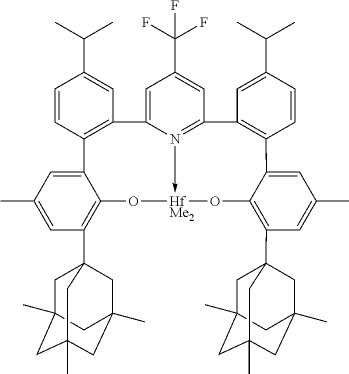

To a suspension of 135 mg (0.422 mmol) of hafnium tetrachloride (<0.05% Zr) in 50 ml of dry toluene, 600 ul (1.73 mmol) of 2.9 M MeMgBr in diethyl ether was added in one portion via syringe at 0° C. To the resulting suspension, 400 mg (0.422 mmol) of 2′,2′″-(4-(trifluoromethyl)pyridine-2,6-diyl)bis(4′-isopropyl-5-methyl-3-((3r,5r,7r)-3,5,7-trimethyladamantan-1-yl)-[1,1′-biphenyl]-2-ol) (M) was immediately added in one portion. The reaction mixture was stirred for 4 hours at room temperature and then evaporated to near dryness. The solid obtained was extracted with 2×20 ml of hot toluene, and the combined organic extract was filtered through a thin pad of Celite 503. Next, the filtrate was evaporated to dryness. The residue was triturated with 5 ml of n-hexane, the obtained precipitate was filtered off (G4), washed with 2×5 ml of n-hexane, and then dried in vacuo. Yield 317 mg (65%) of a yellow solid. Anal. Calc. for C₆₆H₈₀F₃HfNO₂: C, 68.64; H, 6.98; N, 1.21. Found: C 68.87; H, 7.13; N 1.05. ¹H NMR (CD₂Cl₂, 400 MHz): δ 7.19-7.29 (m, 6H), 7.11 (s, 2H), 6.98 (d, J=1.5 Hz, 2H), 6.71 (d, J=1.6 Hz, 2H), 3.06 (sept, J=6.9 Hz, 2H), 2.20 (s, 6H), 1.91-1.97 (m, 6H), 1.76-1.82 (m, 6H), 1.27-1.34 (m, 6H), 1.28 (d, J=6.9 Hz, 6H), 1.18 (d, J=6.9 Hz, 6H), 1.05-1.10 (m, 6H), 0.98 (s, 18H), 0.04 (s, 6H). ¹³C NMR (C₆D₆, 100 MHz) δ 161.4, 160.1, 149.1, 140.7, 138.1, 134.1, 133.4, 132.3, 129.9, 129.4, 128.5, 127.4, 120.4 (q, J_{C,F}=3.3 Hz), 53.5, 51.0, 46.9, 40.7, 33.7, 32.7, 31.4, 24.7, 23.7, 21.4.

### Dimethylzirconium[2′,2′″-(4-(trifluoromethyl)pyridine-2,6-diyl)bis(4′-isopropyl-5-methyl-3-((3r,5r,7r)-3,5,7-trimethyladamantan-1-yl)-[1,1′-biphenyl]-2-olate)] (Complex 43)

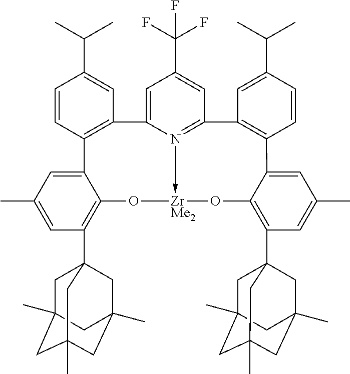

To a suspension of 98 mg (0.422 mmol) of zirconium tetrachloride in 50 ml of dry toluene, 600 ul (1.73 mmol) of 2.9 M MeMgBr in diethyl ether was added in one portion via syringe at −30° C. To the resulting suspension, 400 mg (0.422 mmol) of 2′,2′″-(4-(trifluoromethyl)pyridine-2,6-diyl)bis(4′-isopropyl-5-methyl-3-((3r,5r,7r)-3,5,7-trimethyladamantan-1-yl)-[1,1′-biphenyl]-2-ol) (M) was immediately added in one portion. The reaction mixture was stirred for 4 hours at room temperature and then evaporated to near dryness. The solid obtained was extracted with 2×20 ml of hot toluene, and the combined organic extract was filtered through a thin pad of Celite 503. Next, the filtrate was evaporated to dryness. The residue was triturated with 5 ml of n-hexane, the obtained precipitate was filtered off (G4), washed with 2×5 ml of n-hexane, and then dried in vacuo. Yield 390 mg (86%) of a yellow solid. Anal. Calc. for C₆₆H₈₀F₃ZrNO₂: C, 74.25; H, 7.55; N, 1.31. Found: C 74.46; H, 7.71; N 1.13. ¹H NMR (C₆D₆, 400 MHz): δ 7.22-7.35 (m, 8H), 7.02 (d, J=1.7 Hz, 2H), 6.76 (d, J=1.7 Hz, 2H), 3.12 (sept, J=6.9 Hz, 2H), 2.26 (s, 6H), 2.00-2.07 (m, 6H), 1.84-1.91 (m, 6H), 1.34-1.40 (m, 6H), 1.33 (d, J=6.9 Hz, 6H), 1.24 (d, J=6.9 Hz, 6H), 1.10-1.17 (m, 6H), 1.04 (s, 18H), 0.33 (s, 6H). ¹³C NMR (C₆D₆, 100 MHz) δ 161.6, 159.7, 149.1, 140.6, 137.6, 134.0, 133.7, 132.6, 129.7, 129.5, 128.5, 127.5, 120.0 (q, J_{C,F}=3.5 Hz), 51.0, 46.9, 45.7, 40.8, 33.7, 32.7, 31.4, 24.7, 23.6, 21.4.

### Dimethylhafnium[2′,2′″-(4-(methoxy)pyridine-2,6-diyl)bis(4′-isopropyl-5-methyl-3-((3r,5r,7r)-3,5,7-trimethyladamantan-1-yl)-[1,1′-biphenyl]-2-olate)] (Complex 44)

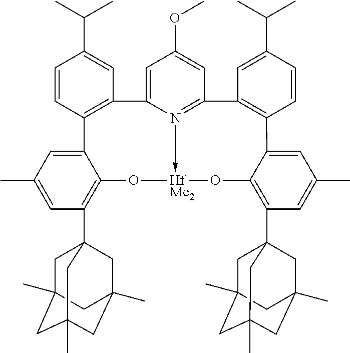

To a suspension of 123 mg (0.384 mmol) of hafnium tetrachloride (<0.05% Zr) in 50 ml of dry toluene, 540 ul (1.58 mmol) of 2.9 M MeMgBr in diethyl ether was added in one portion via syringe at 0° C. To the resulting suspension, 350 mg (0.384 mmol) of 2′,2′″-(4-(methoxy)pyridine-2,6-diyl)bis(4′-isopropyl-5-methyl-3-((3r,5r,7r)-3,5,7-trimethyladamantan-1-yl)-[1,1′-biphenyl]-2-ol) (L) was immediately added in one portion. The reaction mixture was stirred for 4 hours at room temperature and then evaporated to near dryness. The solid obtained was extracted with 2×20 ml of hot toluene, and the combined organic extract was filtered through a thin pad of Celite 503. Next, the filtrate was evaporated to dryness. The residue was triturated with 5 ml of n-hexane, the obtained precipitate was filtered off (G4), washed with 2×5 ml of n-hexane, and then dried in vacuo. Yield 332 mg (77%) of a beige solid. Anal. Calc. for C₆₆H₈₃HfNO₃: C, 70.98; H, 7.49; N, 1.25. Found: C 71.28; H, 7.72; N 1.07. ¹H NMR (C₆D₆, 400 MHz): δ 7.28-7.32 (m, 4H), 7.22 (dd, J=8.1, 1.9 Hz, 2H), 7.06 (d, J=1.9 Hz, 2H), 6.78 (d, J=2.0 Hz, 2H), 6.32 (s, 2H), 3.13 (sept, J=6.9 Hz, 2H), 2.44 (s, 3H), 2.24 (s, 6H), 2.01-2.08 (m, 6H), 1.88-1.95 (m, 6H), 1.33-1.39 (m, 6H), 1.29 (d, J=6.9 Hz, 6H), 1.22 (d, J=6.9 Hz, 6H), 1.06-1.13 (m, 6H), 1.01 (s, 18H), 0.06 (s, 6H). ¹³C NMR (C₆D₆, 100 MHz) δ 168.0, 161.0, 160.5, 148.6, 138.1, 134.4, 134.1, 132.9, 129.6, 129.2, 128.3, 126.7, 111.0, 55.0, 52.8, 51.1, 47.0, 40.8, 33.6, 32.8, 31.4, 24.8, 23.7, 21.5.

### Dimethylzirconium[2′,2′″-(4-(methoxy)pyridine-2,6-diyl)bis(4′-isopropyl-5-methyl-3-((3r,5r,7r)-3,5,7-trimethyladamantan-1-yl)-[1,1′-biphenyl]-2-olate)] (Complex 45)

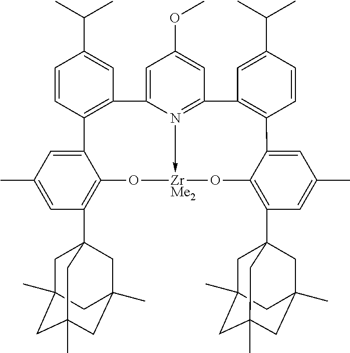

To a suspension of 102 mg (0.439 mmol) of zirconium tetrachloride in 50 ml of dry toluene, 620 ul (1.58 mmol) of 2.9 M MeMgBr in diethyl ether was added in one portion via syringe at −30° C. To the resulting suspension, 400 mg (0.439 mmol) of 2′,2′″-(4-(methoxy)pyridine-2,6-diyl)bis(4′-isopropyl-5-methyl-3-((3r,5r,7r)-3,5,7-trimethyladamantan-1-yl)- [1,1′-biphenyl]-2-ol) (L) was immediately added in one portion. The reaction mixture was stirred for 4 hours at room temperature and then evaporated to near dryness. The solid obtained was extracted with 2×20 ml of hot toluene, and the combined organic extract was filtered through a thin pad of Celite 503. Next, the filtrate was evaporated to dryness. The residue was triturated with 5 ml of n-hexane, the obtained precipitate was filtered off (G4), washed with 2×5 ml of n-hexane, and then dried in vacuo. Yield 334 mg (74%) of a beige solid. Anal. Calc. for C₆₆H₈₃ZrNO₃: C, 76.99; H, 8.13; N, 1.36. Found: C 77.28; H, 8.27; N 1.24. ¹H NMR (C₆D₆, 400 MHz): δ 7.28-7.32 (m, 4H), 7.19-7.24 (m, 2H), 7.04 (m, 2H), 6.78 (m, 2H), 6.32 (s, 2H), 3.12 (sept, J=6.8 Hz, 2H), 2.45 (s, 3H), 2.23 (s, 6H), 2.04-2.13 (m, 6H), 1.90-1.99 (m, 6H), 1.32-1.41 (m, 6H), 1.28 (d, J=6.8 Hz, 6H), 1.23 (d, J=6.8 Hz, 6H), 1.07-1.13 (m, 6H), 1.01 (s, 18H), 0.29 (s, 6H). ¹³C NMR (C₆D₆, 100 MHz) δ 168.0, 161.2, 160.0, 148.6, 140.8, 137.6, 134.7, 134.0, 133.2, 129.7, 129.0, 128.3, 126.8, 110.6, 55.0, 51.1, 47.0, 44.5, 40.9, 33.6, 32.8, 31.4, 24.8, 23.6, 21.5.

### Dimethylhafnium[2′,2′″-(4-(trifluoromethyl)pyridine-2,6-diyl)bis(5-methyl-3-((3r,5r,7r)-3,5,7-trimethyladamantan-1-yl)-[1,1′-biphenyl]-2-olate)] (Complex 46)

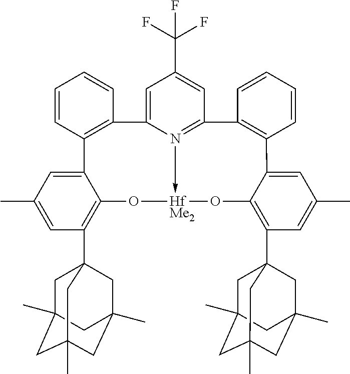

To a suspension of 111 mg (0.347 mmol) of hafnium tetrachloride (<0.05% Zr) in 50 ml of dry toluene, 490 ul (1.43 mmol) of 2.9 M MeMgBr in diethyl ether was added in one portion via syringe at 0° C. To the resulting suspension, 300 mg (0.347 mmol) of 2′,2′″-(4-(trifluoromethyl)pyridine-2,6-diyl)bis(5-methyl-3-((3r,5r,7r)-3,5,7-trimethyladamantan-1-yl)-[1,1′-biphenyl]-2-ol) (P) was immediately added in one portion. The reaction mixture was stirred for 4 hours at room temperature and then evaporated to near dryness. The solid obtained was extracted with 2×20 ml of hot toluene, and the combined organic extract was filtered through a thin pad of Celite 503. Next, the filtrate was evaporated to dryness. The residue was triturated with 5 ml of n-hexane, the obtained precipitate was filtered off (G4), washed with 2×5 ml of n-hexane, and then dried in vacuo. Yield 272 mg (73%) of a yellow solid. Anal. Calc. for C₆₀H₆₈F₃HfNO₂: C, 67.31; H, 6.40; N, 1.31. Found: C 67.66; H, 6.58; N 1.19. ¹H NMR (CD₂Cl₂, 400 MHz): 7.58 (td, J=7.6, 1.3 Hz, 2H), 7.50 (td, J=7.5, 1.2 Hz, 2H), 7.40 (s, 2H), 7.22-7.28 (m, 2H), 7.10-7.14 (m, 2H), 7.08 (d, J=2.1 Hz, 2H), 6.63 (d, J=1.8 Hz, 2H), 2.21 (s, 6H), 1.77-1.85 (m, 6H), 1.59-1.68 (m, 6H), 1.19-1.27 (m, 6H), 1.00-1.09 (m, 6H), 0.90 (s, 18H), −0.70 (s, 6H). (¹³C NMR (CD₂Cl₂, 100 MHz) δ 159.6, 159.4, 143.0, 138.0, 133.4, 132.2, 131.6, 129.9, 129.8, 128.9, 128.6, 127.2, 121.5, 50.9, 50.8, 47.0, 40.5, 32.7, 31.2, 21.0.

### Dimethylzirconium[2′,2′″-(4-(trifluoromethyl)pyridine-2,6-diyl)bis(5-methyl-3-((3r,5r,7r)-3,5,7-trimethyladamantan-1-yl)-[1,1′-biphenyl]-2-olate)] (Complex 47)

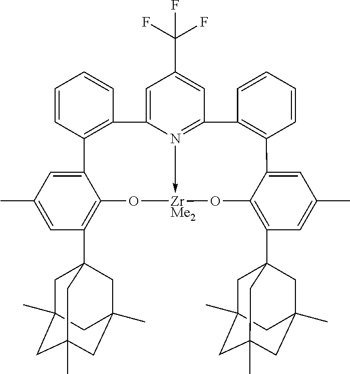

To a suspension of 76 mg (0.324 mmol) of zirconium tetrachloride in 50 ml of dry toluene, 460 ul (1.33 mmol) of 2.9 M MeMgBr in diethyl ether was added in one portion via syringe at −30° C. To the resulting suspension, 280 mg (0.324 mmol) of 2′,2′″-(4-(trifluoromethyl)pyridine-2,6-diyl)bis(5-methyl-3-((3r,5r,7r)-3,5,7-trimethyladamantan-1-yl)-[1,1′-biphenyl]-2-ol) (P) was immediately added in one portion. The reaction mixture was stirred for 4 hours at room temperature and then evaporated to near dryness. The solid obtained was extracted with 2×20 ml of hot toluene, and the combined organic extract was filtered through a thin pad of Celite 503. Next, the filtrate was evaporated to dryness. The residue was triturated with 5 ml of n-hexane, the obtained precipitate was filtered off (G4), washed with 2×5 ml of n-hexane, and then dried in vacuo. Yield 256 mg (80%) of a yellow solid. Anal. Calc. for C₆₀H₆₈F₃ZrNO₂: C, 73.28; H, 6.97; N, 1.42. Found: C 73.62; H, 7.17; N 1.19. ¹H NMR (CD₂Cl₂, 400 MHz): δ 7.56 (td, J=7.6, 1.3 Hz, 2H), 7.48 (td, J=7.5, 1.2 Hz, 2H), 7.38 (s, 2H), 7.24-7.29 (m, 2H), 7.05-7.12 (m, 4H), 6.63 (d, J=2.0 Hz, 2H), 2.21 (s, 6H), 1.79-1.86 (m, 6H), 1.62-1.69 (m, 6H), 1.19-1.27 (m, 6H), 1.00-1.09 (m, 6H), 0.89 (s, 18H), −0.45 (s, 6H). ¹³C NMR (CD₂Cl₂, 100 MHz) δ 160.0, 158.9, 142.9, 137.4, 133.3, 132.6, 132.4, 131.5, 129.8, 129.7, 128.9, 128.6, 127.3, 121.0, 50.9, 47.0, 42.9, 40.6, 32.7, 31.2, 21.0.

### Dimethylhafnium[2′,2′″-(pyridine-2,6-diyl)bis(5-methyl-3-((3r,5r,7r)-3,5,7-trimethyladamantan-1-yl)-[1,1′-biphenyl]-2-olate)] (Complex 48)

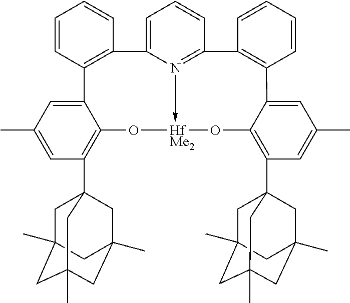

To a suspension of 121 mg (0.377 mmol) of hafnium tetrachloride (<0.05% Zr) in 50 ml of dry toluene, 530 ul (1.54 mmol) of 2.9 M MeMgBr in diethyl ether was added in one portion via syringe at 0° C. To the resulting suspension, 300 mg (0.377 mmol) of 2′,2′″-(pyridine-2,6-diyl)bis(5-methyl-3-((3r,5r,7r)-3,5,7-trimethyladamantan-1-yl)-[1,1′-biphenyl]-2-ol) (N) was immediately added in one portion. The reaction mixture was stirred for 4 hours at room temperature and then evaporated to near dryness. The solid obtained was extracted with 2×20 ml of hot toluene, and the combined organic extract was filtered through a thin pad of Celite 503. Next, the filtrate was evaporated to dryness. The residue was triturated with 5 ml of n-hexane, the obtained precipitate was filtered off (G4), washed with 2×5 ml of n-hexane, and then dried in vacuo. Yield 254 mg (67%) of a white-beige solid. Anal. Calc. for C₅₉H₆₉HfNO₂: C, 70.67; H, 6.94; N, 1.40. Found: C 70.83; H, 7.12; N 1.31. ¹H NMR (C₆D₆, 400 MHz): δ 7.36 (td, J=7.3, 2.0 Hz, 2H), 7.30 (d, J=2.2 Hz, 2H), 7.15-7.25 (m, 4H), 7.10 (d, J=7.8 Hz, 2H), 6.73 (d, J=2.3 Hz, 2H), 6.38-6.48 (m, 3H), 2.21 (s, 6H), 2.02-2.09 (m, 6H), 1.85-1.92 (m, 6H), 1.30-1.39 (m, 6H), 1.03-1.10 (m, 6H), 1.01 (s, 18H), −0.13 (s, 6H).

### Dimethylzirconium[2′,2′″-(pyridine-2,6-diyl)bis(5-methyl-3-((3r,5r,7r)-3,5,7-trimethyladamantan-1-yl)-[1,1′-biphenyl]-2-olate)] (Complex 49)

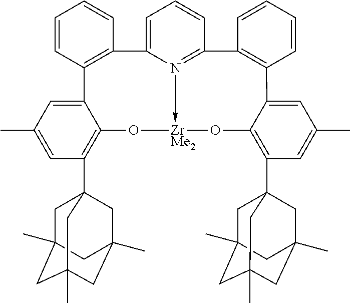

To a suspension of 88 mg (0.375 mmol) of zirconium tetrachloride in 50 ml of dry toluene, 530 ul (1.54 mmol) of 2.9 M MeMgBr in diethyl ether was added in one portion via syringe at −30° C. To the resulting suspension, 330 mg (0.375 mmol) of 2′,2′″-(pyridine-2,6-diyl)bis(5-methyl-3-((3r,5r,7r)-3,5,7-trimethyladamantan-1-yl)-[1,1′-biphenyl]-2-ol) (N) was immediately added in one portion. The reaction mixture was stirred for 4 hours at room temperature and then evaporated to near dryness. The solid obtained was extracted with 2×20 ml of hot toluene, and the combined organic extract was filtered through a thin pad of Celite 503. Next, the filtrate was evaporated to dryness. The residue was triturated with 5 ml of n-hexane, the obtained precipitate was filtered off (G4), washed with 2×5 ml of n-hexane, and then dried in vacuo. Yield 217 mg (58%) of a beige solid. Anal. Calc. for C₅₉H₆₉ZrNO₂: C, 77.41; H, 7.60; N, 1.53. Found: C 77.75; H, 7.73; N 1.38. ¹H NMR (C₆D₆, 400 MHz): δ 7.34 (td, J=7.5, 1.5 Hz, 2H), 7.29 (d, J=2.3 Hz, 2H), 7.13-7.24 (m, 4H), 7.04-7.09 (m, 2H), 6.73 (d, J=2.3 Hz, 2H), 6.38-6.50 (m, 3H), 2.21 (s, 6H), 2.04-2.12 (m, 6H), 1.87-1.94 (m, 6H), 1.31-1.38 (m, 6H), 1.04-1.10 (m, 6H), 1.01 (s, 18H), 0.11 (s, 6H). ¹³C NMR (CD₂Cl₂, 100 MHz) δ 159.1, 158.2, 142.9, 140.1, 137.4, 133.4, 133.1, 132.9, 130.9, 129.9, 129.6, 128.9, 128.2, 126.8, 124.9, 50.9, 47.0, 42.1, 40.5, 32.7, 31.2, 21.0.

### Dimethylhafnium[2′,2′″-(4-(methoxy)pyridine-2,6-diyl)bis(5-methyl-3-((3r,5r,7r)-3,5,7-trimethyladamantan-1-yl)-[1,1′-biphenyl]-2-olate)] (Complex 50)

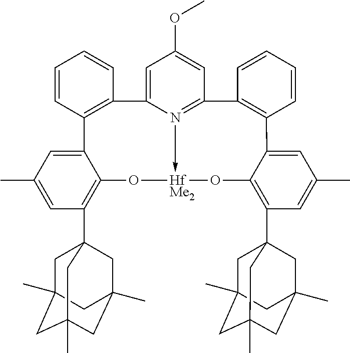

To a suspension of 97 mg (0.302 mmol) of hafnium tetrachloride (<0.05% Zr) in 50 ml of dry toluene, 430 ul (1.24 mmol) of 2.9 M MeMgBr in diethyl ether was added in one portion via syringe at 0° C. To the resulting suspension, 250 mg (0.302 mmol) of 2′,2′″-(4-(methoxy)pyridine-2,6-diyl)bis(5-methyl-3-((3r,5r,7r)-3,5,7-trimethyladamantan-1-yl)-[1,1′-biphenyl]-2-ol) (O) was immediately added in one portion. The reaction mixture was stirred for 4 hours at room temperature and then evaporated to near dryness. The solid obtained was extracted with 2×20 ml of hot toluene, and the combined organic extract was filtered through a thin pad of Celite 503. Next, the filtrate was evaporated to dryness. The residue was triturated with 5 ml of n-hexane, the obtained precipitate was filtered off (G4), washed with 2×5 ml of n-hexane, and then dried in vacuo. Yield 247 mg (80%) of a beige solid. Anal. Calc. for C₆₀H₇₁HfNO₃: C, 69.78; H, 6.93; N, 1.36. Found: C 69.97; H, 7.06; N 1.25. ¹H NMR (C₆D₆, 400 MHz): δ 7.38 (td, J=7.6, 1.5 Hz, 2H), 7.31 (d, J=2.6 Hz, 2H), 7.15-7.25 (m, 6H), 6.78 (d, J=2.2 Hz, 2H), 6.13 (s, 2H), 2.45 (s, 3H), 2.22 (s, 6H), 2.05-2.13 (m, 6H), 1.87-1.97 (m, 6H), 1.33-1.40 (m, 6H), 1.05-1.11 (m, 6H), 1.02 (s, 18H), −0.11 (s, 6H).

### Dimethylzirconium[2′,2′″-(4-(methoxy)pyridine-2,6-diyl)bis(5-methyl-3-((3r,5r,7r)-3,5,7-trimethyladamantan-1-yl)-[1,1′-biphenyl]-2-olate)] (Complex 51)

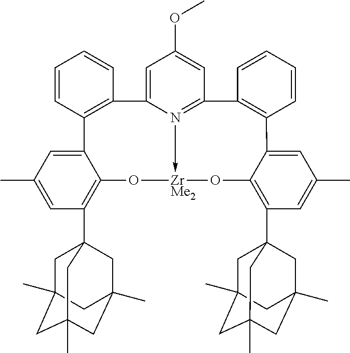

To a suspension of 102 mg (0.439 mmol) of zirconium tetrachloride in 50 ml of dry toluene, 620 ul (1.58 mmol) of 2.9 M MeMgBr in diethyl ether was added in one portion via syringe at −30° C. To the resulting suspension, 400 mg (0.439 mmol) of 2′,2′″-(4-(methoxy)pyridine-2,6-diyl)bis(5-methyl-3-((3r,5r,7r)-3,5,7-trimethyladamantan-1-yl)-[1,1′-biphenyl]-2-ol) (O) was immediately added in one portion. The reaction mixture was stirred for 4 hours at room temperature and then evaporated to near dryness. The solid obtained was extracted with 2×20 ml of hot toluene, and the combined organic extract was filtered through a thin pad of Celite 503. Next, the filtrate was evaporated to dryness. The residue was triturated with 5 ml of n-hexane, the obtained precipitate was filtered off (G4), washed with 2×5 ml of n-hexane, and then dried in vacuo. Yield 334 mg (74%) of a beige solid. Anal. Calc. for C₆₀H₇₁ZrNO₃: C, 76.22; H, 7.57; N, 1.48. Found: C 76.51; H, 7.78; N 1.23. ¹H NMR (C₆D₆, 400 MHz): δ 7.37 (td, J=7.5, 1.4 Hz, 2H), 7.29 (d, J=2.3 Hz, 2H), 7.12-7.20 (m, 6H), 6.78 (d, J=2.0 Hz, 2H), 6.13 (s, 2H), 2.46 (s, 3H), 2.22 (s, 6H), 2.08-2.15 (m, 6H), 1.90-1.98 (m, 6H), 1.33-1.40 (m, 6H), 1.05-1.11 (m, 6H)<1.02 (s, 18H), 0.13 (s, 6H).

### Dimethylhafnium[2′,2′″-(pyridine-2,6-diyl)bis(3-((3r,5r,7r)-adamantan-1-yl)-4′-isopropyl-5-methyl-[1,1′-biphenyl]-2-olate)] (Complex 52)

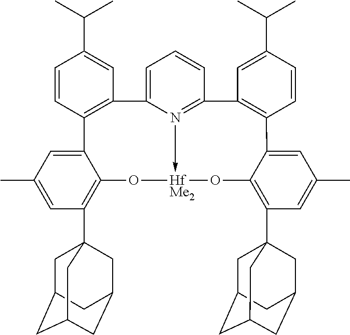

To a suspension of 161 mg (0.502 mmol) of hafnium tetrachloride (<0.05% Zr) in 50 ml of dry toluene, 710 ul (2.06 mmol) of 2.9 M MeMgBr in diethyl ether was added in one portion via syringe at 0° C. To the resulting suspension, 400 mg (0.502 mmol) of 2′,2′″-(pyridine-2,6-diyl)bis(4′-isopropyl-5-methyl-3-((3r,5r,7r-adamantan-1-yl)-[1,1′-biphenyl]-2-ol) (Z) was immediately added in one portion. The reaction mixture was stirred for 4 hours at room temperature and then evaporated to near dryness. The solid obtained was extracted with 2×20 ml of hot toluene, and the combined organic extract was filtered through a thin pad of Celite 503. Next, the filtrate was evaporated to dryness. The residue was triturated with 5 ml of n-hexane, the obtained precipitate was filtered off (G4), washed with 2×5 ml of n-hexane, and then dried in vacuo. Yield 380 mg (76%) of a white solid. Anal. Calc. for C₅₉H₆₉HfNO₂: C, 70.67; H, 6.94; N, 1.40. Found: C 70.85; H, 7.05; N 1.31. ¹H NMR (C₆D₆, 400 MHz): (7.75 (t, J=7.8 Hz, 1H), 7.45 (dd, J=8.1, 1.8 Hz, 2H), 7.13-7.18 (m, 4H), 6.98 (d, J=2.1 Hz, 2H), 6.92 (d, J=1.7 Hz, 2H), 6.59 (d, J=2.1 Hz, 2H), 2.96 (sept, J=6.9 Hz, 2H), 2.19 (s, 6H), 2.17-2.22 (m, 6H), 2.04-2.13 (m, 6H), 1.95-2.05 (m, 6H), 1.75-1.84 (m, 6H), 1.65-1.74 (m, 6H), 1.33 (d, J=6.9 Hz, 6H), 1.21 (d, J=6.9 Hz, 6H), −0.71 (s, 6H). ¹³C NMR (C₆D₆, 100 MHz) δ 159.4, 158.2, 149.0, 140.7, 140.0, 138.7, 133.4, 132.81, 132.78, 129.6, 129.4, 128.0, 127.7, 126.8, 125.9, 50.0, 41.2, 37.6, 37.5, 33.7, 29.7, 26.3, 22.1, 21.0.

### Dimethylzirconium[2′,2′″-(pyridine-2,6-diyl)bis(3-((3r,5r,7r)-adamantan-1-yl)-4′-isopropyl-5-methyl-[1,1′-biphenyl]-2-olate)] (Complex 53)

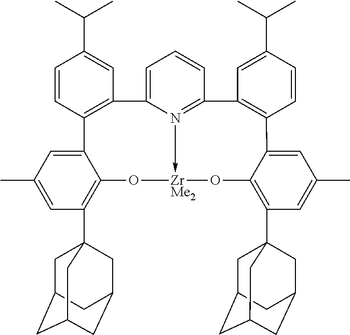

To a suspension of 102 mg (0.439 mmol) of zirconium tetrachloride in 50 ml of dry toluene, 620 ul (1.58 mmol) of 2.9 M MeMgBr in diethyl ether was added in one portion via syringe at −30° C. To the resulting suspension, 400 mg (0.439 mmol) of 2′,2′″-(pyridine-2,6-diyl)bis(3-((3r,5r,7r)-adamantan-1-yl)-4′-isopropyl-5-methyl-[1,1′-biphenyl]-2-ol) (Z) was immediately added in one portion. The reaction mixture was stirred for 4 hours at room temperature and then evaporated to near dryness. The solid obtained was extracted with 2×20 ml of hot toluene, and the combined organic extract was filtered through a thin pad of Celite 503. Next, the filtrate was evaporated to dryness. The residue was triturated with 5 ml of n-hexane, the obtained precipitate was filtered off (G4), washed with 2×5 ml of n-hexane, and then dried in vacuo. Yield 334 mg (74%) of a beige solid. Anal. Calc. for C₅₉H₆₉ZrNO₂: C, 77.41; H, 7.60; N, 1.53. Found: C 77.74; H, 7.78; N 1.32. ¹H NMR (C₆D₆, 400 MHz): δ 7.74 (t, J=7.8 Hz, 1H), 7.44 (dd, J=8.1, 1.8 Hz, 2H), 7.11-7.18 (m, 4H), 6.98 (d, J=2.0 Hz, 2H), 6.90 (d, J=1.8 Hz, 2H), 6.59 (d, J=1.7 Hz, 2H), 2.94 (sept, J=6.9 Hz, 2H), 2.19 (s, 6H), 2.18-2.27 (m, 6H), 2.07-2.14 (m, 6H), 1.96-2.06 (m, 6H), 1.76-1.84 (m, 6H), 1.67-1.75 (m, 6H), 1.32 (d, J=6.9 Hz, 6H), 1.20 (d, J=6.9 Hz, 6H), −0.47 (s, 6H). ¹³C NMR (C₆D₆, 100 MHz) δ 158.9, 158.5, 148.9, 140.6, 140.0, 138.1, 133.3, 133.2, 133.1, 129.5, 129.46, 127.9, 127.6, 126.9, 125.4, 41.7, 41.2, 37.7, 37.5, 33.7, 29.7, 26.3, 22.1, 21.0.

### Dimethylhafnium[2′,2′″-(pyridine-2,6-diyl)bis(3-((1r,3R,5S,7r)-3,5-dimethyladamantan-1-yl)-4′-isopropyl-5-methyl-[1,1′-biphenyl]-2-olate)] (Complex 54)

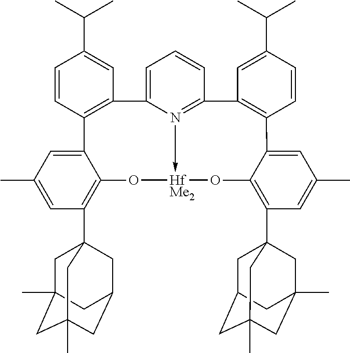

To a suspension of 150 mg (0.469 mmol) of hafnium tetrachloride (<0.05% Zr) in 50 ml of dry toluene, 663 ul (1.92 mmol) of 2.9 M MeMgBr in diethyl ether was added in one portion via syringe at 0° C. To the resulting suspension, 400 mg (0.469 mmol) of 2′,2′″-(pyridine-2,6-diyl)bis(3-((1r,3R,5S,7r)-3,5-dimethyladamantan-1-yl)-4′-isopropyl-5-methyl-[1,1′-biphenyl]-2-ol) (W) was immediately added in one portion. The reaction mixture was stirred for 4 hours at room temperature and then evaporated to near dryness. The solid obtained was extracted with 2×20 ml of hot toluene, and the combined organic extract was filtered through a thin pad of Celite 503. Next, the filtrate was evaporated to dryness. The residue was triturated with 5 ml of n-hexane, the obtained precipitate was filtered off (G4), washed with 2×5 ml of n-hexane, and then dried in vacuo. Yield 375 mg (76%) of a white solid. Anal. Calc. for C₆₃H₇₇HfNO₂: C, 71.47; H, 7.33; N, 1.32. Found: C 71.74; H, 7.48; N 1.14. ¹H NMR (CD₂Cl₂, 400 MHz): δ 7.75 (t, J=7.8 Hz, 1H), 7.45 (dd, J=8.1, 1.8 Hz, 2H), 7.14-7.18 (m, 4H), 7.00 (d, J=2.1 Hz, 2H), 6.91 (d, J=1.8 Hz, 2H), 6.59 (d, J=1.7 Hz, 2H), 2.98 (sept, J=6.9 Hz, 2H), 2.65-2.73 (m, 2H), 2.50-2.58 (m, 2H), 2.19 (s, 6H), 1.97-2.08 (m, 2H), 1.28-1.45 (m, 6H), 1.33 (d, J=6.9 Hz, 6H), 1.21 (d, J=6.9 Hz, 6H), 1.10-1.23 (m, 6H), 1.00-1.05 (m, 2H), 0.92 (s, 6H), 0.77 (s, 6H), −0.69 (s, 6H). ¹³C NMR (C₆D₆, 100 MHz) δ 159.4, 158.3, 149.0, 140.7, 140.0, 138.1, 133.4, 132.9, 132.7, 129.45, 129.43, 128.2, 127.7, 126.8, 125.8, 52.0, 50.4, 49.9, 45.9, 44.1, 42.6, 39.3, 38.6, 33.7, 32.2, 31.8, 31.6, 31.0, 30.5, 26.0, 22.4, 21.0.

### Tribenzylhafnium[3-((3r,5r,7r)-adamantan-1-yl)-5-methyl-2′-(pyridin-2-yl)-[1,1′-biphenyl]-2-olate] (Complex 55)

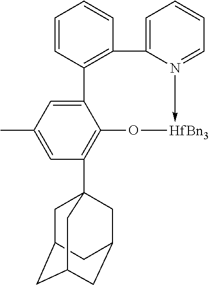

To a solution of 200 mg (0.505 mmol) of 3-((3r,5r,7r)-adamantan-1-yl)-5-methyl-2′-(pyridin-2-yl)-[1,1′-biphenyl]-2-ol (DD) in 50 ml of toluene, 274 mg (0.505 mmol) of tetrabenzylhafnium was added at room temperature. The resulting mixture was stirred overnight and then evaporated to dryness. The residue was triturated with 5 ml of n-pentane, the obtained precipitate was filtered off (G4), washed with 3 ml of n-pentane, and then dried in vacuo. Yield 288 mg (67%) of a light-yellow solid. Anal. Calc. for C₄₉H₄₉HfNO: C, 69.53; H, 5.84; N, 1.65. Found: C 69.78; H, 5.99; N 1.48. ¹H NMR (CD₂Cl₂, 400 MHz): δ 7.69 (d, J=5.4 Hz, 1H), 7.12-7.19 (m, 6H), 7.11 (td, J=7.6, 1.5 Hz, 1H), 7.04 (d, J=2.0 Hz, 1H), 7.00 (td, J=7.6, 1.5 Hz, 1H), 6.84-6.93 (m, 9H), 6.68 (d, J=2.2 Hz, 1H), 6.35-6.47|(m, 2H), 6.20-6.27 (m, 1H), 6.05 (dd, J=7.6, 1.0 Hz, 1H), 2.19-2.30 (m, 6H), 2.10-2.18 (m, 9H), 1.86-1.96 (m, 6H), 1.70-1.78 (m, 6H). ¹³C NMR (C₆D₆, 100 MHz) δ 159.4, 157.3, 148.1, 144.0, 143.8, 139.4, 138.8, 133.4, 132.8, 132.1, 132.0, 131.7, 129.1, 129.0, 128.7, 128.5, 127.9, 127.4, 123.9, 122.4, 82.6, 41.4, 37.8, 37.7, 29.9, 21.3.

### Dimethylhafnium[6,6′-(pyridine-2,6-diylbis(1-methyl-1H-indole-3,2-diyl))bis(2-((3r,5r,7r)-adamantan-1-yl)-4-methylphenolate)] (Complex 56)

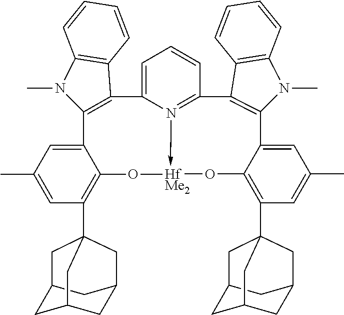

To a suspension of 195 mg (0.611 mmol) of hafnium tetrachloride (<0.05% Zr) in 50 ml of dry toluene, 860 ul (2.50 mmol) of 2.9 M MeMgBr in diethyl ether was added in one portion via syringe at −80° C. To the resulting suspension, 500 mg (0.611 mmol) of 6,6′-(pyridine-2,6-diylbis(1-methyl-1H-indole-3,2-diyl))bis(2-((3r,5r,7r)-adamantan-1-yl)-4-methylphenol) (KK) was immediately added in one portion. The reaction mixture was stirred for 4 hours at room temperature and then evaporated to near dryness. The solid obtained was extracted with 2×20 ml of hot toluene, and the combined organic extract was filtered through a thin pad of Celite 503. Next, the filtrate was evaporated to dryness. The residue was triturated with 5 ml of n-hexane, the obtained precipitate was filtered off (G4), washed with 2×5 ml of n-hexane, and then dried in vacuo. Yield 394 mg (63%, ca. 80% purity) of a white solid. ¹H NMR (C₆D₆, 400 MHz): δ 7.20-7.30 (m, 6H), 7.09-7.15 (m, 4H), 6.75-6.81 (m, 3H), 6.48 (d, J=2.2 Hz, 2H), 3.13 (s, 6H), 2.28-2.36 (m, 6H), 2.19 (s, 6H), 2.04-2.13 (m, 6H), 1.88-1.94 (m, 6H), 1.78-1.85 (m, 6H), 1.68-1.74 (m, 6H), −0.21 (s, 6H). ¹³C NMR (CD₂Cl₂, 100 MHz) δ 161.0, 154.3, 141.7, 140.3, 138.9, 129.8, 129.3, 128.1, 126.9, 126.6, 123.2, 122.2, 121.5, 119.0, 110.1, 107.0, 48.3, 40.8, 37.6, 37.3, 31.5, 29.4, 21.0.

### Dimethylhafnium[6,6′-(pyridine-2,6-diylbis(benzo[b]thiophene-3,2-diyl))bis(2-((1r,3R,5S,7r)-3,5-dimethyladamantan-1-yl)-4-methylphenolate)] (Complex 57)

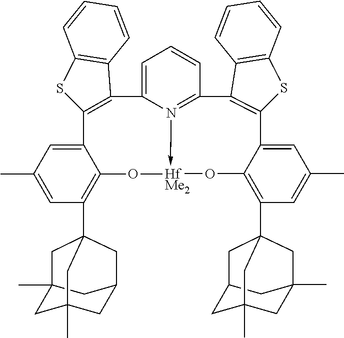

To a suspension of 145 mg (0.454 mmol) of hafnium tetrachloride (<0.05% Zr) in 50 ml of dry toluene, 640 ul (1.86 mmol) of 2.9 M MeMgBr in diethyl ether was added in one portion via syringe at 0° C. To the resulting suspension, 400 mg (0.454 mmol) of 6,6′-(pyridine-2,6-diylbis(benzo[b]thiophene-3,2-diyl))bis(2-((1r,3R,5S,7r)-3,5-dimethyladamantan-1-yl)-4-methylphenol) (CC) was immediately added in one portion. The reaction mixture was stirred for 4 hours at room temperature and then evaporated to near dryness. The solid obtained was extracted with 2×20 ml of hot toluene, and the combined organic extract was filtered through a thin pad of Celite 503. Next, the filtrate was evaporated to dryness. The residue was triturated with 5 ml of n-hexane, the obtained precipitate was filtered off (G4), washed with 2×5 ml of n-hexane, and then dried in vacuo. Yield 337 mg (68%) of a beige solid. Anal. Calc. for C₆₁H₆₅HfNO₂S₂: C, 67.42; H, 6.03; N, 1.29. Found: C 67.64; H, 6.25; N 1.07. ¹H NMR (C₆D₆, 400 MHz): δ 7.34-7.38 (m, 2H), 7.28 (d, J=2.2 Hz, 2H), 7.05-7.15 (m, 6H), 6.90 (d, J=7.2 Hz, 2H), 6.67 (t, J=7.6 Hz, 1H), 6.40-6.45 (m, 2H), 2.54-2.60 (m, 2H), 2.20 (s, 6H), 2.18-2.27 (m, 2H), 1.63-1.75 (m, 6H), 1.54-1.59 (m, 2H), 1.45-1.49 (m, 2H), 1.28-1.39 (m, 6H), 1.07-1.17 (m, 6H), 0.91 (s, 6H), 0.82 (s, 6H), 0.18 (s, 6H). ¹³C NMR (CD₂Cl₂, 100 MHz) (160.1, 154.5, 149.0, 141.3, 140.9, 140.3, 139.3, 134.4, 134.2, 130.7, 129.9, 127.0, 125.9, 125.7, 124.0, 122.8, 122.6, 51.8, 48.9, 45.7, 43.8, 42.4, 39.4, 38.4, 31.9, 31.6, 31.5, 30.9, 30.0, 21.0.

### Dimethylzirconium[6,6′-(pyridine-2,6-diylbis(benzo[b]thiophene-3,2-diyl))bis(2-((1r,3R,5S,7r)-3,5-dimethyladamantan-1-yl)-4-methylphenolate)] (Complex 58)

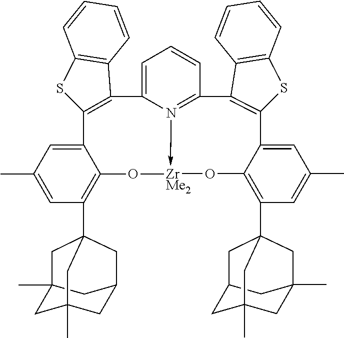

To a suspension of 80 mg (0.340 mmol) of zirconium tetrachloride in 50 ml of dry toluene, 480 ul (1.40 mmol) of 2.9 M MeMgBr in diethyl ether was added in one portion via syringe at −30° C. To the resulting suspension, 300 mg (0.340 mmol) of 6,6′-(pyridine-2,6-diylbis(benzo[b]thiophene-3,2-diyl))bis(2-((1r,3R,5S,7r)-3,5-dimethyladamantan-1-yl)-4-methylphenol) (CC) was immediately added in one portion. The reaction mixture was stirred for 4 hours at room temperature and then evaporated to near dryness. The solid obtained was extracted with 2×20 ml of hot toluene, and the combined organic extract was filtered through a thin pad of Celite 503. Next, the filtrate was evaporated to dryness. The residue was triturated with 5 ml of n-hexane, the obtained precipitate was filtered off (G4), washed with 2×5 ml of n-hexane, and then dried in vacuo. Yield 214 mg (63%) of a beige solid. Anal. Calc. for C₆₁H₆₅ZrNO₂S₂: C, 73.30; H, 6.56; N, 1.40. Found: C 73.54; H, 6.70; N 1.24. ¹H NMR (C₆D₆, 400 MHz): δ 7.32-7.37 (m, 2H), 7.28 (m, 2H), 7.08-7.16 (m, 6H), 6.87-6.92 (m, 2H), 6.67 (t, J=8.0 Hz, 1H), 6.40-6.44 (m, 2H), 2.56-2.63 (m, 2H), 2.23-2.29 (m, 2H), 2.20 (s, 6H), 1.65-1.78 (m, 6H), 1.54-1.60 (m, 2H), 1.44-1.50 (m, 2H), 1.30-1.40 (m, 6H), 1.06-1.18 (m, 6H), 0.91 (s, 6H), 0.82 (s, 6H), 0.41 (s, 6H). ¹³C NMR (CD₂Cl₂, 100 MHz) δ 159.5, 154.7, 148.7, 141.3, 140.9, 140.2, 138.7, 134.3, 134.2, 130.7, 129.8, 127.2, 126.6, 125.9, 125.6, 122.8, 122.6, 51.8, 48.8, 45.8, 43.8, 42.4, 39.5, 38.5, 31.9, 31.6, 31.5, 30.9, 30.0, 21.0.

### Dimethylhafnium[6′,6′″-(pyridine-2,6-diyl)bis(3-(tert-butyl)-5-methyl-2′,3′,4′,5′-tetrahydro-[1,1′-biphenyl]-2-olate)] (Complex 59)

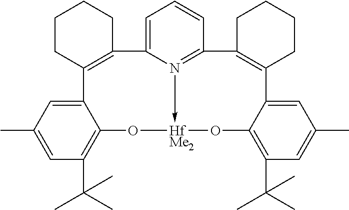

To a suspension of 91 mg (0.283 mmol) of hafnium tetrachloride (<0.05% Zr) in 50 ml of dry toluene, 400 ul (1.17 mmol) of 2.9 M MeMgBr in diethyl ether was added in one portion via syringe at 0° C. To the resulting suspension, 160 mg (0.283 mmol) of 6′,6′″-(pyridine-2,6-diyl)bis(3-(tert-butyl)-5-methyl-2′,3′,4′,5′-tetrahydro-[1,1′-biphenyl]-2-ol) (HH) was immediately added in one portion. The reaction mixture was stirred for 4 hours at room temperature and then evaporated to near dryness. The solid obtained was extracted with 2×20 ml of hot toluene, and the combined organic extract was filtered through a thin pad of Celite 503. Next, the filtrate was evaporated to dryness. The residue was triturated with 5 ml of n-hexane, the obtained precipitate was filtered off (G4), washed with 2×5 ml of n-hexane, and then dried in vacuo. Yield 146 mg (67%, ca. 90% purity) of a white solid. ¹H NMR (C₆D₆, 400 MHz): δ 7.07 (d, J=1.9 Hz, 2H), 6.62 (d, J=2.2 Hz, 2H), 6.47 (t, J=7.8 Hz, 1H), 6.19 (d, J=7.8 Hz, 2H), 2.32-2.48 (m, 4H), 2.18-2.28 (m, 2H), 2.14 (s, 6H), 1.73-1.89 (m, 6H), 1.70 (s, 18H), 1.47-1.58 (m, 4H), 0.86 (s, 6H). ¹³C NMR (CD₂Cl₂, 100 MHz) δ 160.7, 158.2, 143.9, 140.5, 138.1, 134.3, 129.4, 126.9, 126.8, 123.6, 50.0, 35.4, 34.8, 31.6, 30.4, 22.8, 22.7, 21.0.

### Dichlorozirconium[2′,2′″-(pyridine-2,6-diyl)bis(3-((3r,5r,7r)-adamantan-1-yl)-5-(tert-butyl)-[1,1′-biphenyl]-2-olate)] (Complex 60)

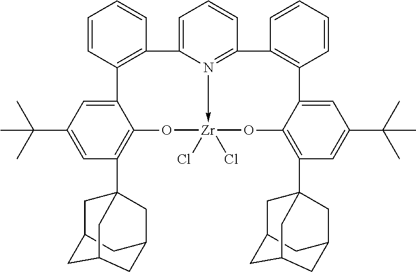

To a stirring suspension of dimethylzirconium[2′,2′″-(pyridine-2,6-diyl)bis(3-((3r,5r,7r)-adamantan-1-yl)-5-(tert-butyl)-[1,1′-biphenyl]-2-olate)] (Complex 6) (1.00 g, 1.09 mmol) in toluene (10 mL), ethylaluminum dichloride (2.4 mL, 1.0 M in hexane, 2.4 mmol, 2.2 equiv.) was added dropwise. The reaction was then stirred and heated to 60° C. for 1 hour. Then, after removing from heat, the reaction was concentrated under a stream of nitrogen and then under high vacuum. The residue was stirred in hexane (10 mL). The resulting suspension was filtered over a plastic, fritted funnel. The filtered solid was washed with additional hexane (10 mL). The filtered solid was collected and concentrated under high vacuum to afford the product as a grey solid (0.99 g, 95% yield). ¹H NMR (400 MHz, CD₂Cl₂): δ 7.86 (t, 1H, J=7.8 Hz), 7.65 (td, 2H, J=7.6, 1.4 Hz), 7.46 (td, 2H, J=7.6, 1.3 Hz), 7.35 (dd, 2H, J=7.8, 1.2 Hz), 7.27 (d, 2H, J=7.8 Hz), 7.25-7.20 (m, 4H), 6.91 (d, 2H, J=2.5 Hz), 2.18-2.08 (m, 6H), 2.09-1.97 (m, 12H), 1.86 (br d, 6H, J=12.0 Hz), 1.71 (br d, 6H, J=12.0 Hz), 1.25 (s, 18H).

### Bis([trimethylsilyl]methyl)zirconium[2′,2′″-(pyridine-2,6-diyl)bis(3-((3r,5r,7r)-adamantan-1-yl)-5-(tert-butyl)-[1,1′-biphenyl]-2-olate)] (Complex 61)

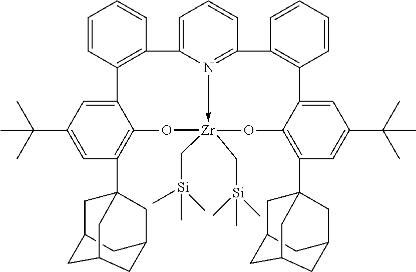

To a stirring suspension of dichlorozirconium[2′,2′″-(pyridine-2,6-diyl)bis(3-((3r,5r,7r)-adamantan-1-yl)-5-(tert-butyl)-[1,1′-biphenyl]-2-olate)] (Complex 60) (0.208 g, 0.218 mmol) in toluene (5 mL), (trimethylsilyl)methylmagnesium chloride (1.1 mL, 1.0M in diethyl ether, 1.1 mmol, 5.1 equiv.) was added. The reaction was stirred at room temperature for 24 hours. The reaction was then heated to 90° C. and stirred for an additional 1.5 hours. The reaction was removed from heat, and the contents were subsequently concentrated under a stream of nitrogen and then under high vacuum. The residue was washed with hexane (10 mL) and filtered over Celite. The filtered solid was extracted with toluene (3×3 mL). The combined toluene filtrates were concentrated under a stream of nitrogen at 90° C. and then under high vacuum to afford a fraction of the product as an off-white foam (0.150 g, 65% yield). The original hexane filtrate was concentrated under a stream of nitrogen and then under high vacuum. The residue, a brown oil, was mixed with hexane (2 mL) and cooled to −35° C. The resulting precipitate was filtered, while cold, on a plastic, fritted funnel. The filtered solid was collected and concentrated under high vacuum to afford a separate fraction of the product (0.030 g, 13% yield). ¹H NMR (400 MHz, C₆D₆): δ 7.54 (d, 2H, J=2.6 Hz), 7.46 (dd, 2H, J=7.7, 1.2 Hz), 7.27 (td, 2H, J=7.6, 1.4 Hz), 7.14-6.99 (m, 4H), 6.97 (dd, 2H, J=7.6, 1.4 Hz), 6.45 (dd, 1H, J=8.3, 7.1 Hz), 6.35-6.30 (m, 2H), 2.57 (br d, 6H, J=12.1 Hz), 2.39 (br d, 6H, J=12.1 Hz), 2.22 (br s, 6H), 2.02 (br d, 6H, J=12.1 Hz), 1.85 (br d, 6H, J=12.1 Hz), 1.29 (s, 18H), 1.17 (d, 2H, J=11.8 Hz), 0.21 (s, 18H), −1.57 (d, 2H, J=11.8 Hz).

### Tetrakis(4-tert-butylbenzyl)zirconium (Complex 62)

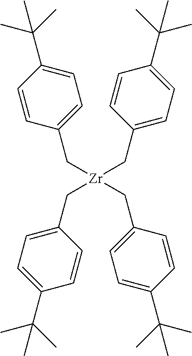

To a stirring suspension of zirconium chloride (0.290 g, 1.25 mmol) in dichloromethane (5 mL) cooled to −70° C., a solution of 4-tert-butylbenzylmagnesium bromide (2.31 g, containing diethyl ether, 56.6% purity by mass, in 5 mL dichloromethane, approximately 1.04 M, 5.20 mmol, 4.18 equiv.) was added dropwise via addition funnel. The addition funnel was then removed, the reaction vessel was covered in foil to avoid light, and the reaction was stirred for 2 hours while slowly warming to room temperature. The reaction was filtered over Celite. The filtrate was concentrated under a stream of nitrogen and then under high vacuum. The residue was stirred in pentane. The resulting suspension was filtered on a plastic, fritted funnel. The filtered solid was collected and concentrated under high vacuum to afford the product as an orange-yellow solid, containing diethyl ether (1.74 equiv.) (0.973 g, 96% yield).

### Bis(4-tert-butylbenzyl)zirconium[2′,2′″-(pyridine-2,6-diyl)bis(3-((3r,5r,7r)-adamantan-1-yl)-5-(tert-butyl)-[1,1′-biphenyl]-2-olate)] (Complex 63)

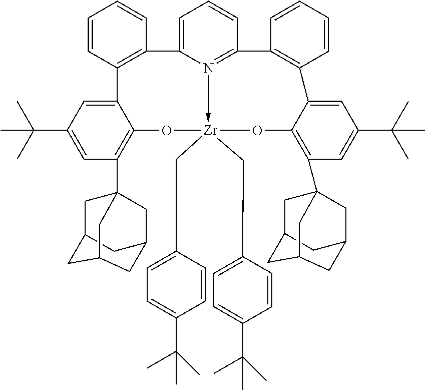

To a stirring solution of tetrakis(4-tert-butylbenzyl)zirconium (Complex 62) (0.171 g, 0.251 mmol, 1 equiv.) in toluene (10 mL), a solution of 2′,2′″-(pyridine-2,6-diyl)bis(3-((3r,5r,7r)-adamantan-1-yl)-5-(tert-butyl)-[1,1′-biphenyl]-2-ol) (QQ) (0.200 g, 0.251 mmol) in toluene (5 mL) was added slowly. The reaction was stirred at room temperature for 4 hours. The reaction was filtered over Celite. The filtrate was concentrated under a stream of nitrogen and then under high vacuum. The residue was washed with pentane (5 mL) and concentrated under high vacuum. The resulting solid was washed with minimal toluene and concentrated under high vacuum to afford the product as an off-white solid (0.108 g, 36% yield). ¹H NMR (400 MHz, C₆D₆): δ 7.64 (d, 2H, J=2.6 Hz), 7.53-7.47 (m, 2H), 7.15-6.95 (m, 12H), 6.78 (d, 4H, J=8.2 Hz), 6.48 (dd, 1H, J=8.4, 7.1 Hz), 6.38-6.34 (m, 2H), 2.53 (br d, 6H, J=12.3 Hz), 2.45-2.35 (m, 8H), 2.22 (br s, 6H), 2.06 (br d 6H, J=11.9 Hz), 1.86 (br d, 6H, J=12.1 Hz), 1.32 (s, 18H), 1.29 (s, 18H), 0.19 (d, 2H, J=11.2 Hz).

### Dimethylhafnium[2′,2′″-(pyridine-2,6-diyl)bis(3,5-bis(2-phenylpropan-2-yl)-5 [1,1′-biphenyl]-2-olate)] (Catalyst 64)

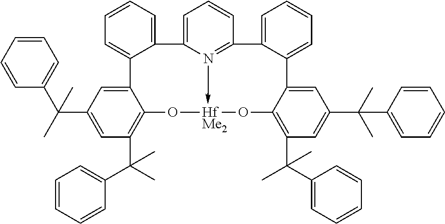

To a suspension of 144 mg (0.450 mmol) of hafnium tetrachloride in 50 mL of dry toluene, 698 ul (2.03 mmol) of 2.9 M MeMgBr in diethyl ether was added in one portion via syringe at 0° C. To the resulting suspension, 400 mg (0.450 mmol) of 2′,2′″-(pyridine-2,6-diyl)bis(3,5-bis(2-phenylpropan-2-yl)-[1,1′-biphenyl]-2-ol) (VV) was immediately added in one portion. The reaction mixture was stirred for 4 hours at room temperature and then evaporated to near dryness. The solid obtained was extracted with 2×20 mL of hot toluene, and the combined organic extract was filtered through a thin pad of Celite 503. Next, the filtrate was evaporated to dryness. The residue was triturated with 5 mL of n-hexane, the obtained precipitate was filtered off, washed with 2×5 mL of n-hexane, and then dried in vacuo. Yield 335 mg (68%) of a white-beige solid. Anal. Calc. for C₆₇H₆₅HfNO₂: C, 73.51; H, 5.98; N, 1.28. Found: C 73.85; H, 6.12; N 1.13. ¹H NMR (C₆D₆, 400 MHz): δ 7.33-7.35 (m, 6H), 7.23-7.24 (m, 4H), 7.03-7.20 (m, 15H), 6.98 (t, J=7.2 Hz, 2H), 6.86 (d, J=7.4 Hz, 2H), 6.58 (t, J=7.6 Hz, 1H), 6.33 (d, J=7.8 Hz, 2H), 1.96 (s, 6H), 1.76 (s, 6H), 1.61 (s, 6H), 1.60 (s, 6H), −0.74 (s, 6H). ¹³C NMR (CDCl₃, 100 MHz) δ 158.12, 157.62, 151.61, 150.77, 142.27, 138.95, 138.69, 136.28, 132.75, 132.18, 131.68, 130.74, 127.67, 127.40, 126.91, 126.83, 126.65, 126.20, 125.21, 124.88, 48.42, 42.89, 42.32, 32.58, 30.96, 30.84, 28.46.

### Dimethylzirconium[2′,2′″-(pyridine-2,6-diyl)bis(3,5-bis(2-phenylpropan-2-yl)-[1,1′-biphenyl]-2-olate)] (Complex 65)

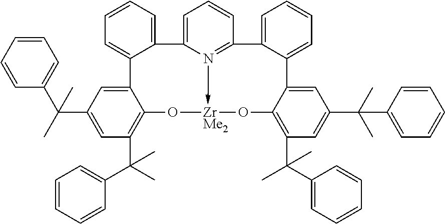

To a suspension of 584 mg (2.50 mmol) of zirconium tetrachloride in 100 ml of dry toluene, 3.50 ml (10.2 mmol) of 2.9 M MeMgBr in diethyl ether was added in one portion via syringe at −40° C. To the resulting suspension, 2.22 g (2.50 mmol) of 2′,2′″-(pyridine-2,6-diyl)bis(3,5-bis(2-phenylpropan-2-yl)-[1,1′-biphenyl]-2-ol) (VV) was immediately added in one portion. The reaction mixture was stirred for 4 hours at room temperature and then evaporated to near dryness. The solids obtained were extracted with 2×30 ml of hot toluene, and the combined organic extract was filtered through a thin pad of Celite 503. Next, the filtrate was evaporated to dryness. The residue was triturated with 5 ml of n-hexane, the obtained precipitate was filtered off, washed two times with 5 ml of n-hexane, and then dried in vacuo. Yield 2.37 g (94%) of a white-beige solid. Anal. Calc. for C₆₇H₆₅ZrNO₂: C, 79.88; H, 6.50; N, 1.39. Found: C 80.17; H, 6.71; N 1.34. ¹H NMR (C₆D₆, 400 MHz): δ 7.34-7.37 (m, 6H), 7.24-7.26 (m, 4H), 7.20 (dd, J=7.7, 1.1 Hz, 2H), 7.12-7.19 (m, 8H), 7.02-7.10 (m, 8H), 6.97 (t, J=7.3 Hz, 2H), 6.84 (dd, J=7.4, 1.3 Hz, 2H), 6.59 (t, J=7.7 Hz, 1H), 6.32 (d, J=7.8 Hz, 2H), 1.97 (s, 6H), 1.75 (s, 6H), 1.62 (s, 6H), 1.61 (s, 6H), −0.49 (s, 6H).

The following transition metal complexes were used in polymerization experiments. Detailed synthetic procedures for some of the complexes can be found in following co-pending applications:
1) U.S. Ser. No. 16/788,022, filed Feb. 11, 2020;
2) U.S. Ser. No. 16/788,088, filed Feb. 11, 2020;
3) U.S. Ser. No. 16/788,124, filed Feb. 11, 2020;
4) U.S. Ser. No. 16/787,708, filed Feb. 11, 2020; and
5) concurrently filed PCT application number ______ entitled “Propylene Copolymers Obtained Using Transition Metal Bis(Phenolate) Catalyst Complexes and Homogeneous Process for Production Thereof” (attorney docket number 2020EM048), which claims priority to U.S. Ser. No. 62/972,962, filed Feb. 11, 2020.

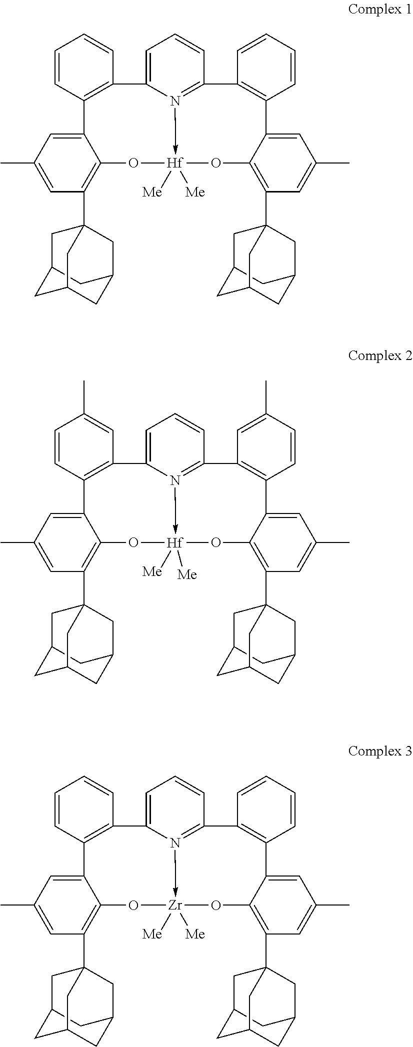

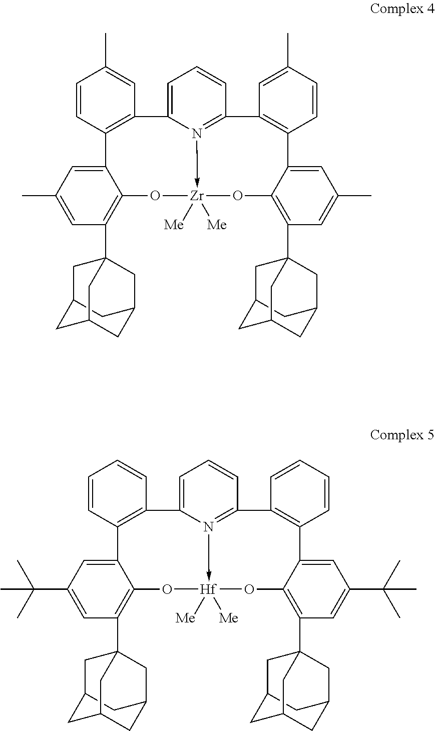

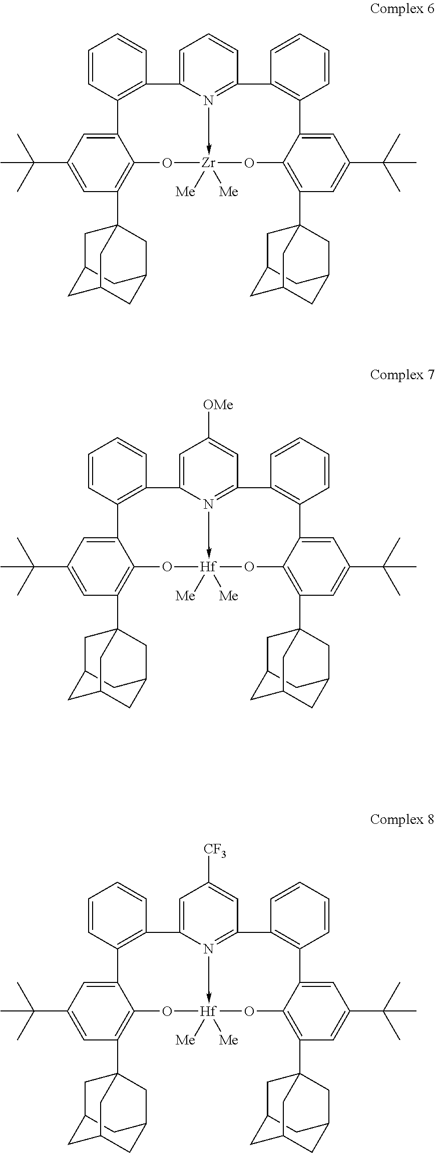

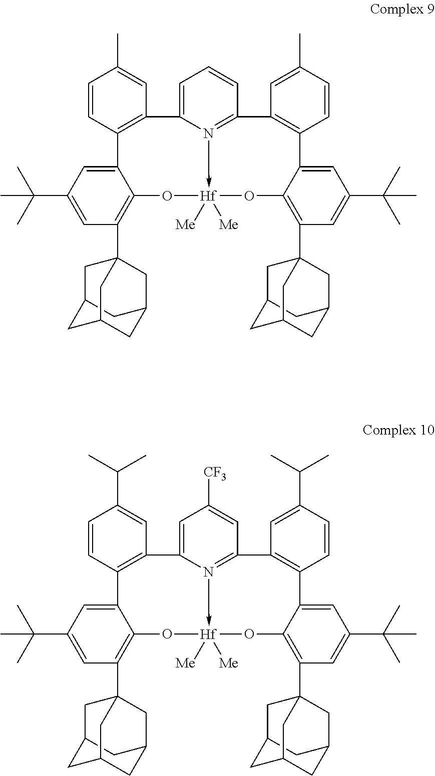

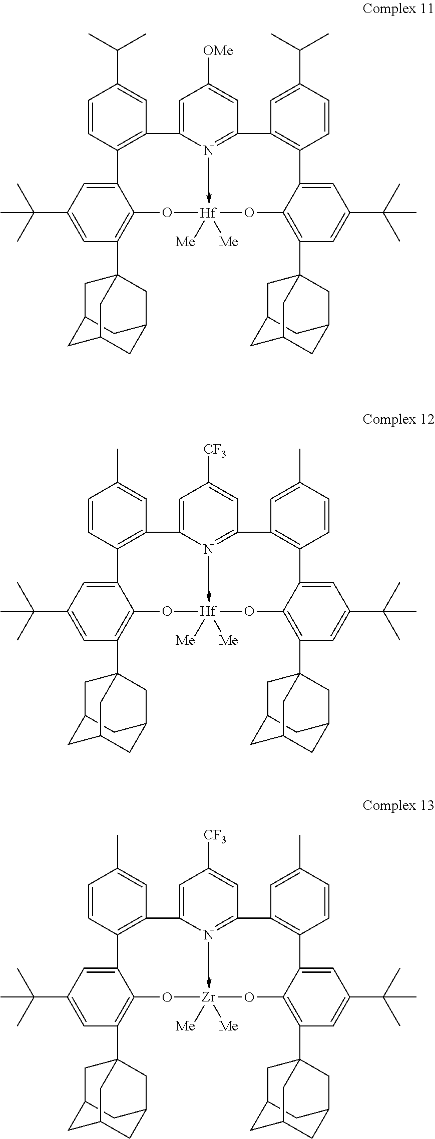

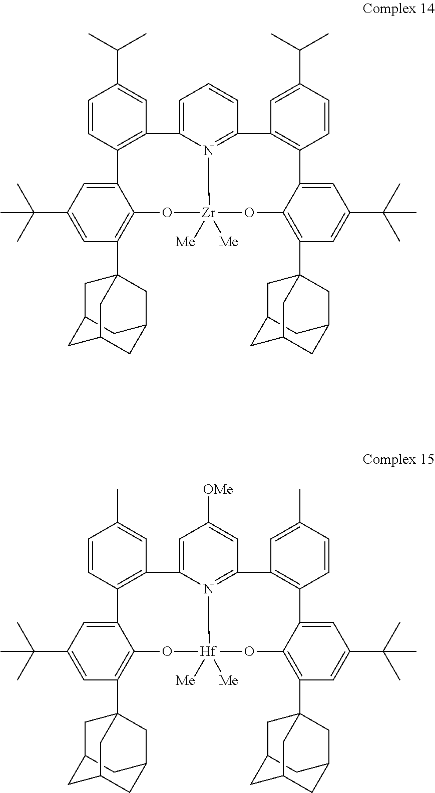

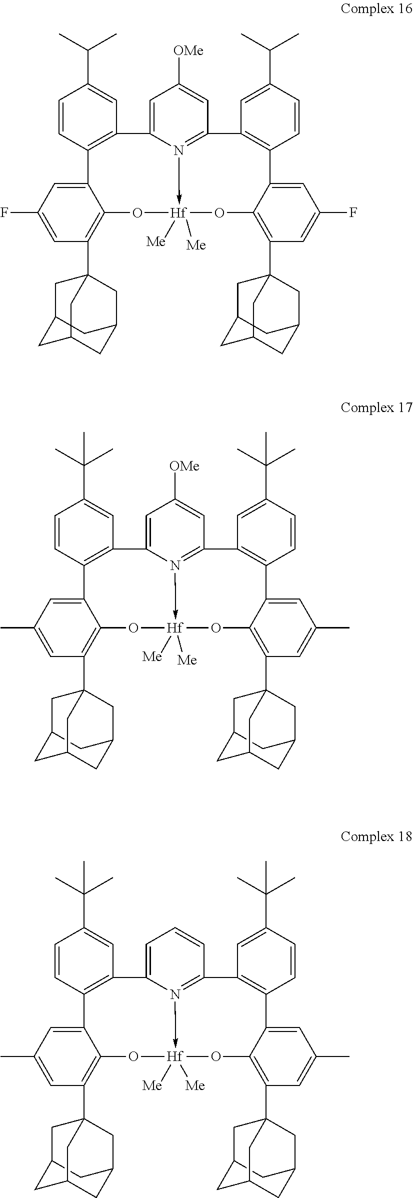

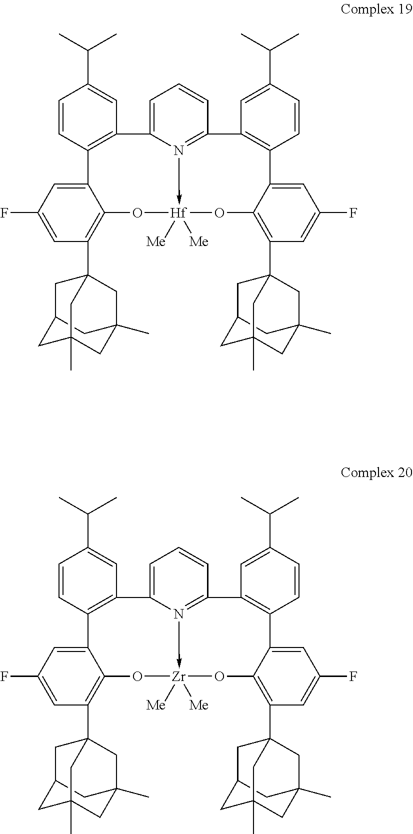

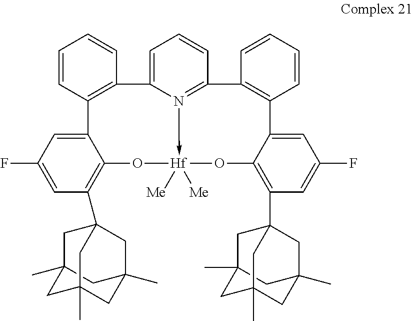

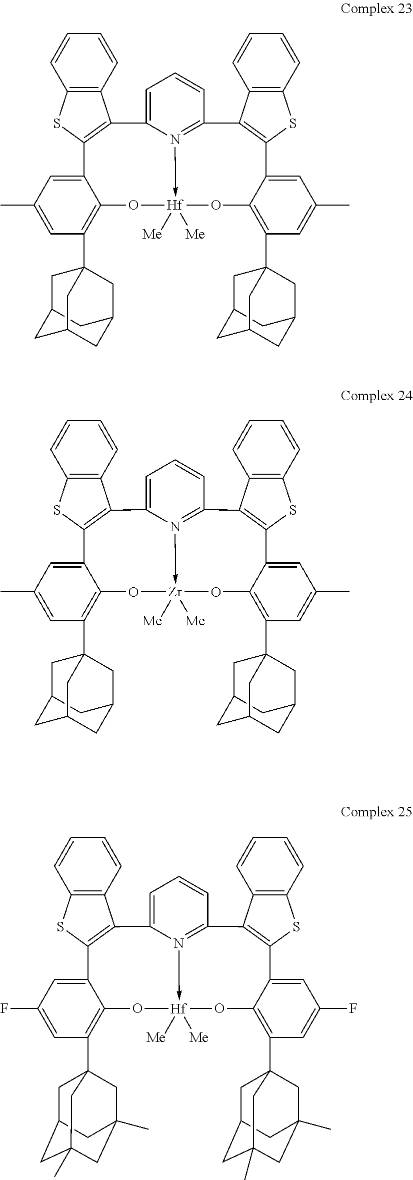

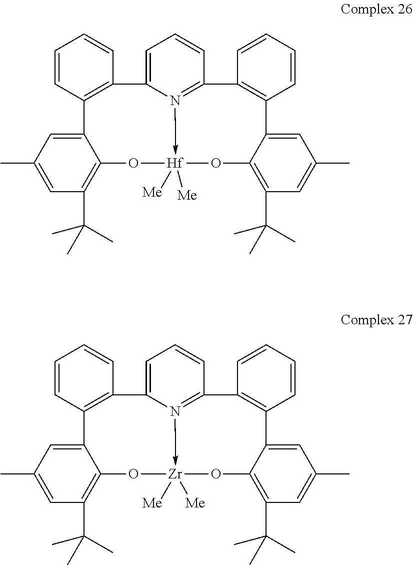

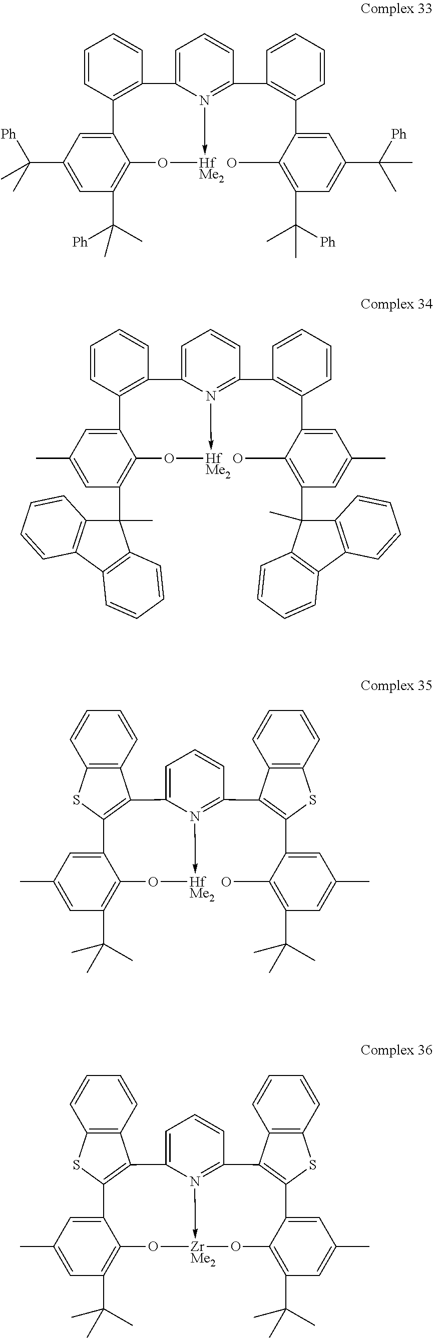

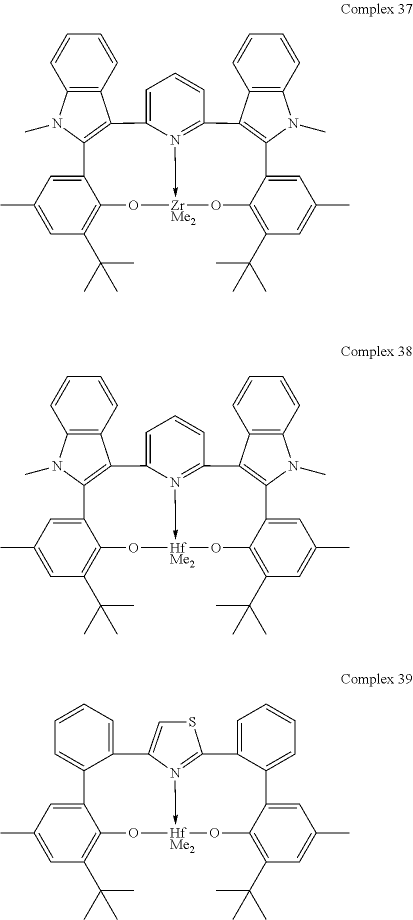

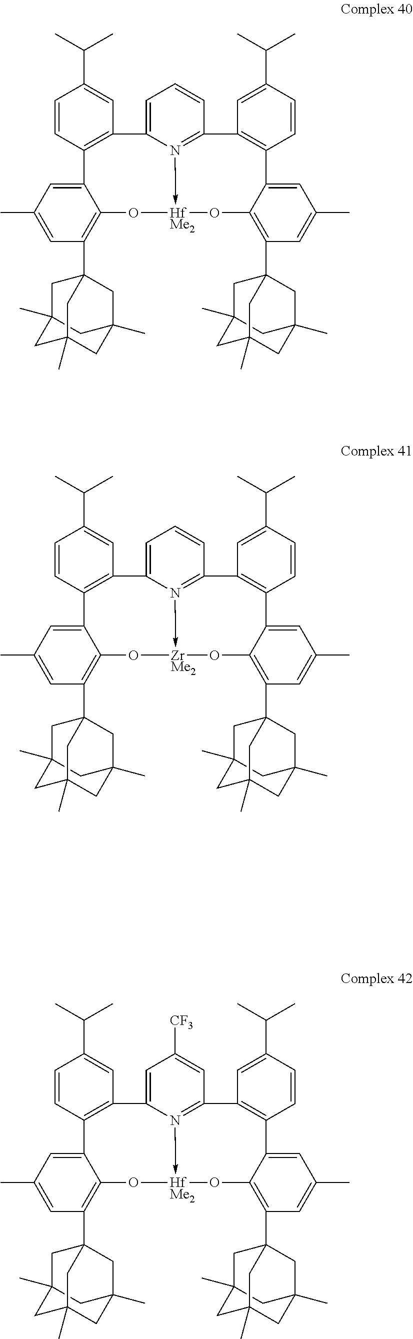

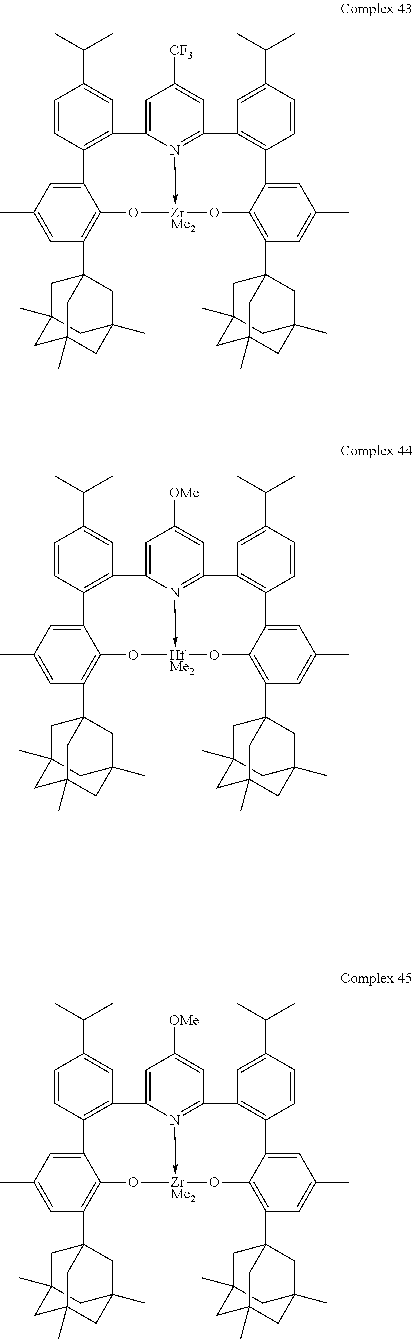

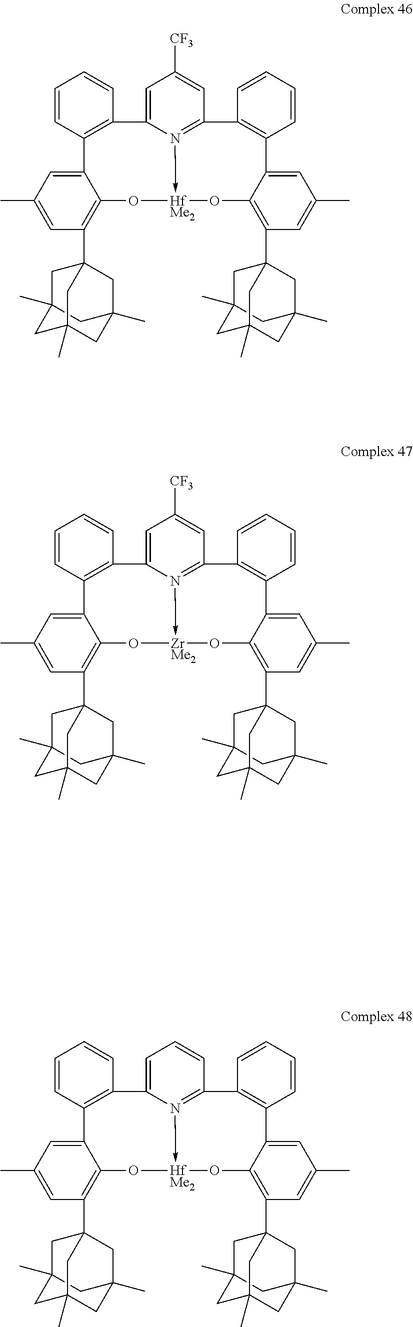

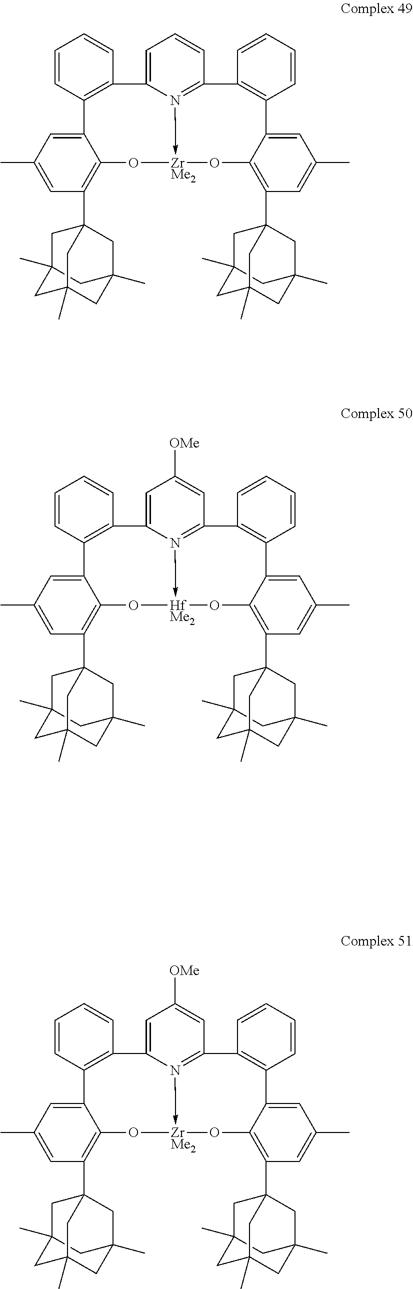

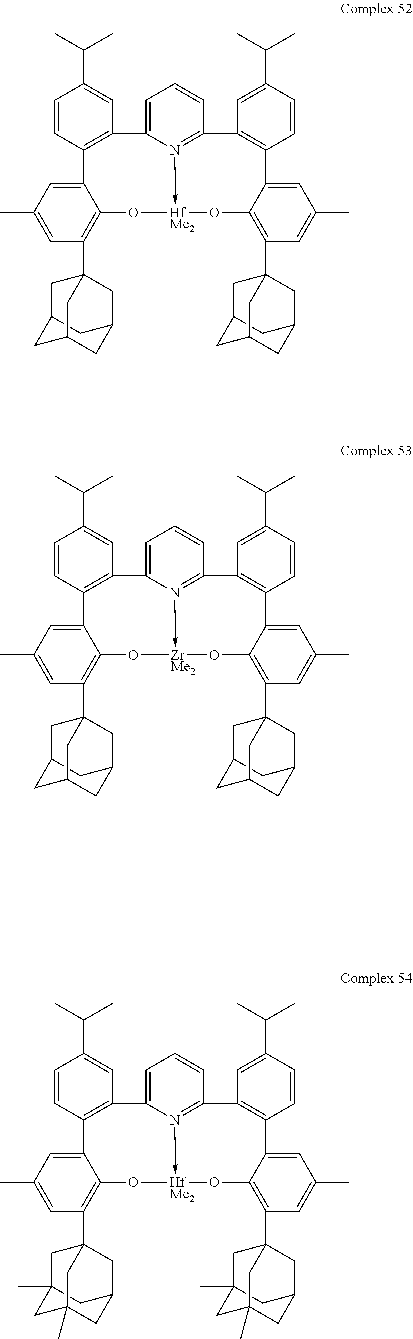

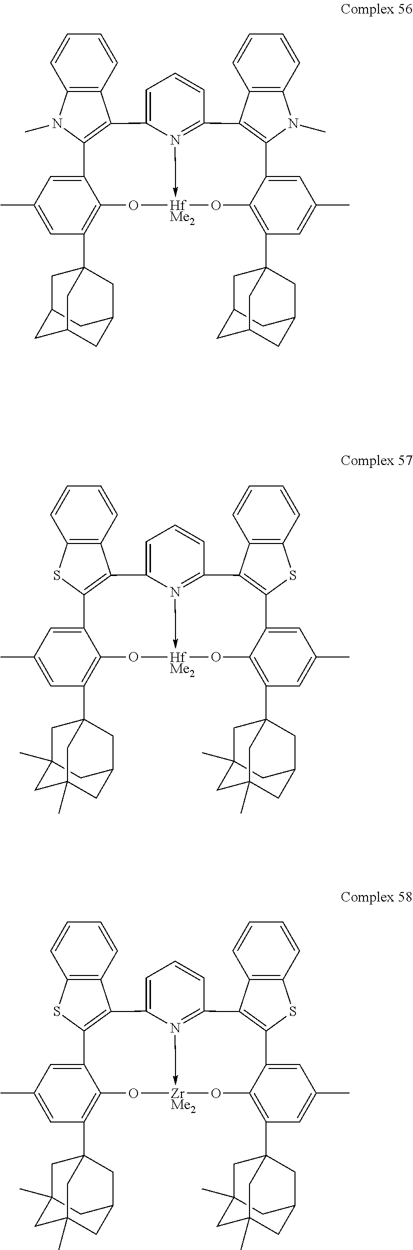

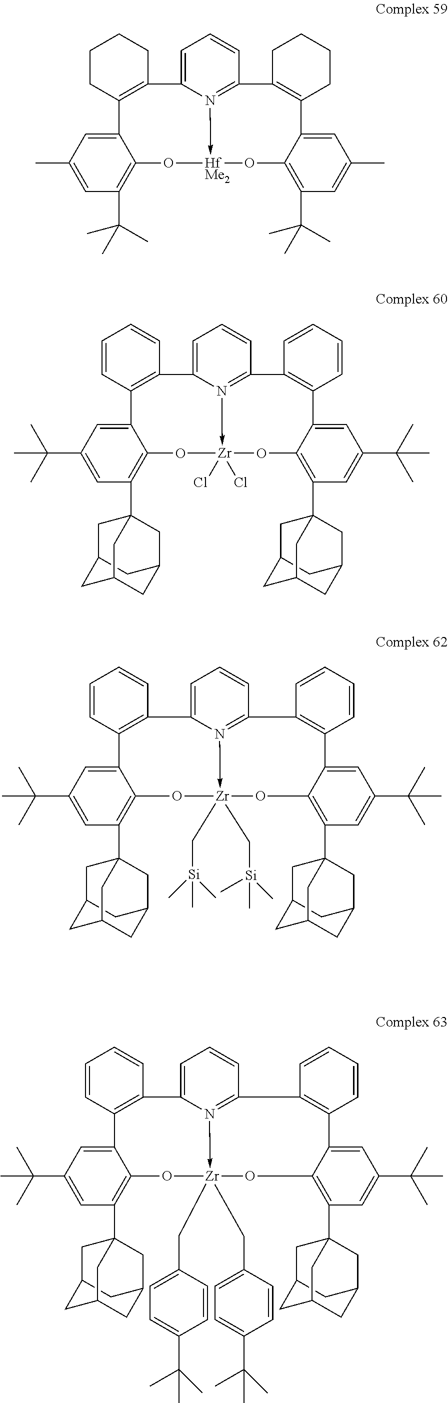

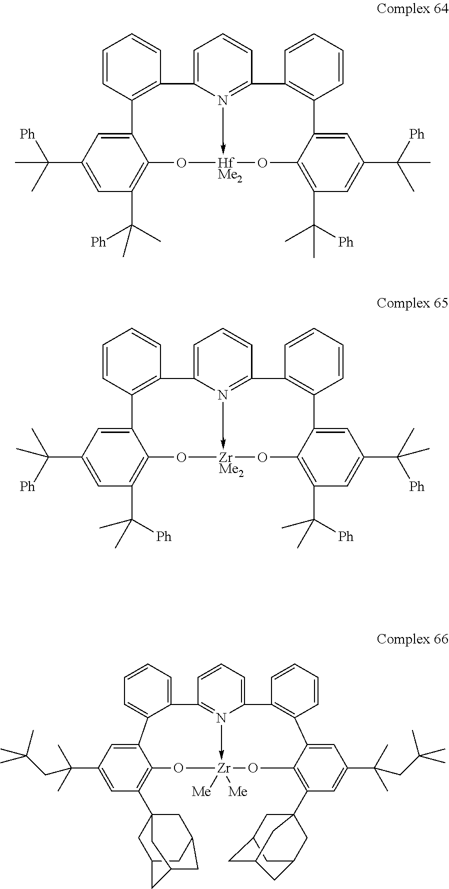

The following comparative complexes were used:

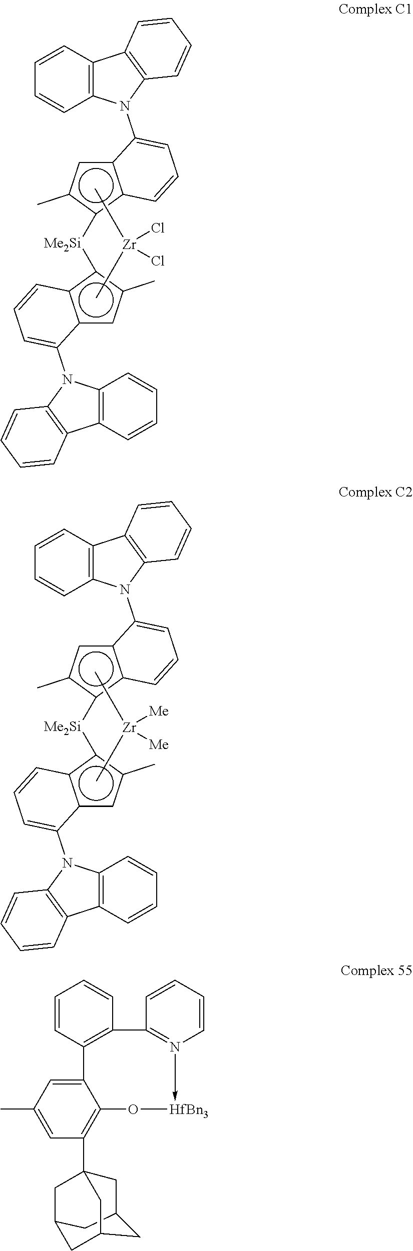

### Small Scale Polymerizations:

Polymerization Reagents. Pre-catalyst solutions were made using a given transition metal complex dissolved in toluene (ExxonMobil Chemical-anhydrous, stored under N₂) (98%), typically at a concentration of 0.5 mmol/L. When noted, some complexes were pre-alkylated using methylalumoxane (MAO, 10 wt % in toluene available from Albemarle Corp.). Prealkylation was performed by first dissolving the metallocene complex in the appropriate amount of toluene, and then adding 20 equivalents of MAO to give final pre-catalyst solution concentrations of 0.5 mmol complex/L and 10 mmol MAO/L.

Activation of the complexes was performed using either methylalumoxane (Activator D, MAO, 10 wt % in toluene, Albemarle Corp.), dimethylanilinium tetrakisperfluorophenylborate (Activator A, Boulder Scientific or W.R. Grace), triphenylcarbonium tetrakisperfluorophenylborate (Activator B, Strem Chemical Co.), or dimethylanilinium tetrakis(perfluoronaphthalen-2-yl)borate (Activator C, W.R. Grace). MAO was typically used as a 0.5 wt % or 1.0 wt % toluene solution. Micromoles of MAO reported below are based on the micromoles of aluminum in MAO, which has a formula weight of 58.0 grams/mole. N,N-Dimethylanilinium tetrakis(perfluorophenyl)borate (A), triphenylcarbenium tetrakis(perfluorophenyl)borate (B), and N,N-dimethylanilinium tetrakis(perfluoronaphthalen-2-yl)borate (C) were typically used as a 5 mmol/L solution in toluene.

For polymerization runs using borate activators (A, B or C), tri-n-octylaluminum (TNOAL, neat, AkzoNobel) was also used as a scavenger prior to introduction of the activator and metallocene complex into the reactor. TNOAL was typically used as a 5 mmol/L solution in toluene.

Solvents, polymerization grade toluene and/or isohexanes were supplied by ExxonMobil Chemical Co. and were purified by passage through a series of columns: two 500 cc OXYCLEAR cylinders in series from Labclear (Oakland, Calif.), followed by two 500 cc columns in series packed with dried 3 Å molecular sieves (8-12 mesh; Aldrich Chemical Company), and two 500 cc columns in series packed with dried 5 Å molecular sieves (8-12 mesh; Aldrich Chemical Company).

Polymerization grade propylene was purified by passage through a series of columns: 2,250 cc OXICLEAR cylinder from Labclear followed by a 2,250 cc column packed with 3 Amolecular sieves (8-12 mesh; Aldrich Chemical Company), then two 500 cc columns in series packed with 5 Å molecular sieves (8-12 mesh; Aldrich Chemical Company), then a 500 cc column packed with SELEXSORB CD (BASF), and finally a 500 cc column packed with SELEXSORB COS (BASF).

1-octene (C₈), 1-decene (C₁₀), 1-tetradecene (C₁₄) and 4-methyl-1-pentene (4MP1) were purified by degassing with nitrogen, stirring over Na/K, filtering through dry Celite, followed by column purification using Brockman basic alumina.

Reactor Description and Preparation: Polymerizations were conducted in an inert atmosphere (N₂) drybox using autoclaves equipped with an external heater for temperature control, glass inserts (internal volume of reactor ˜22.5 ml), septum inlets, a regulated supply of nitrogen, ethylene and propylene, and disposable PEEK mechanical stirrers (800 RPM). The autoclaves were prepared by purging with dry nitrogen at 110° C. or 115° C. for 5 hours and then at 25° C. for 5 hours.

### Propylene Polymerizations (PP):

The reactor was prepared as described above, heated to 40° C., and then purged with propylene gas at atmospheric pressure. For MAO-activated runs, toluene, MAO, propylene (1.0 ml unless otherwise listed in the tables) and comonomer (if used) were added via syringe. The reactor was then heated to process temperature (typically 70° C. or 100° C. unless otherwise mentioned) while stirring at 800 RPM. The pre-catalyst solution was added via syringe with the reactor at process conditions. The reactor temperature was monitored and typically maintained within +/−1° C. Polymerizations were halted by addition of approximately 50 psi O₂/Ar (5 mole % O₂) or an air gas mixture to the autoclaves for approximately 30 seconds. The polymerizations were quenched based on a predetermined pressure loss of approximately 8 psi unless specified differently (max quench value in psi) or for a maximum of 30 minutes polymerization time unless specified differently. The reactors were then cooled and vented. The polymers were isolated after solvent removal in vacuo. Actual quench times are reported. Quench times less than maximum reaction times indicate the reaction quenched with uptake. Yields reported include total weight of polymer and residual catalyst. Catalyst activity is reported as grams of polymer per mmol metallocene complex per hour of reaction time (gP/mmol cat·hr). Propylene homopolymerization examples including characterization are summarized in Tables 1 to 4, and 9 below. Propylene copolymerization examples including characterization are summarized in Tables 9 and 10 below.

Small Scale Polymer Characterization. For analytical testing, polymer sample solutions were prepared by dissolving polymer in 1,2,4-trichlorobenzene (TCB, 99+% purity) containing 2,6-di-tert-butyl-4-methylphenol (BHT, Sigma-Aldrich, 99%) at 165° C. in a shaker oven for approximately 3 hours. The typical concentration of polymer in solution was from 0.1 to 0.9 mg/ml with a BHT concentration of 1.25 mg BHT/ml of TCB. Samples were cooled to 135° C. for testing.

High temperature size exclusion chromatography was performed using an automated “Rapid GPC” system as described in U.S. Pat. Nos. 6,491,816; 6,491,823; 6,475,391; 6,461,515; 6,436,292; 6,406,632; 6,175,409; 6,454,947; 6,260,407; and 6,294,388; each of which is incorporated herein by reference. Molecular weights (weight average molecular weight (Mw), number average molecular weight (Mn), z-average molecular weight (Mz)) and molecular weight distribution (PDI=MWD=Mw/Mn), which is also sometimes referred to as the polydispersity (PDI) of the polymer, were measured by Gel Permeation Chromatography using a Symyx Technology GPC equipped with evaporative light scattering detector (ELSD) and calibrated using polystyrene standards (Polymer Laboratories: Polystyrene Calibration Kit S-M-10: Mp (peak Mw) between 5,000 and 3,390,000). Alternatively, samples were measured by Gel Permeation Chromatography using a Symyx Technology GPC equipped with dual wavelength infrared detector and calibrated using polystyrene standards (Polymer Laboratories: Polystyrene Calibration Kit S-M-10: Mp (peak Mw) between 580 and 3,039,000). Samples (250 μL of a polymer solution in TCB were injected into the system) were run at an eluent flow rate of 2.0 ml/minute (135° C. sample temperatures, 165° C. oven/columns) using three Polymer Laboratories: PLgel 10 μm Mixed-B 300×7.5 mm columns in series. No column spreading corrections were employed. Numerical analyses were performed using Epoch® software available from Symyx Technologies or Automation Studio software available from Freeslate. The molecular weights obtained are relative to linear polystyrene standards. Molecular weight data is reported in the Tables below under the headings Mn, Mw, Mz and PDI as defined above.

Differential Scanning Calorimetry (DSC) measurements were performed on a TA-Q100 instrument to determine the melting point of the polymers. Samples were pre-annealed at 220° C. for 15 minutes (first melt) and then allowed to cool to room temperature overnight. The samples were then heated to 220° C. at a rate of 100° C./minute (2^{nd} melt) and then cooled at a rate of 50° C./minute. Melting points were collected during the heating period. Values reported are the peak melting temperatures and for the purposes of this disclosure referred to as 2^{nd} melts. The results are reported in the Tables under the heading, Tₘ.

Table 1. Propylene polymerization runs. Cat ID corresponds to the complex numbers indicated in the charts. Standard conditions include 1.1 equiv. activator when activator A, B or C used, or 500 equiv. activator when activator D is used. Activator IDs are [PhMe₂NH][B(C₆F₅)₄] is A where C₆F₅ is perfluorophenyl; [Ph₃C][B(C₆F₅)₄] is B; [PhMe₂NH][B(C₁₀F₇)₄] is C where C₁₀F₇ is perfluoronaphthalen-2-yl; and methylalumoxane (MAO) is D. When activators A, B or C are used, 0.5 umol TnOAl (tri-n-octylaluminum) is used as a scavenger. 1 ml propylene and a total of 4.1 ml of solvents were used. The reaction was stirred at 800 rpm, and the reaction was quenched after 8 psi of pressure loss or a maximum of 30 minutes of reaction time is quench pressure not met.

Table 9. Propylene polymerization and co-polymerization runs. Cat ID corresponds to the complex numbers indicated in the charts. Standard conditions include 1.1 equiv. activator A, [PhMe₂NH][B(C₆F₅)₄], 1 ml propylene, 0, 100 or 200 ul of comonomer (1-octene, 1-decene or 1-tetradecene), 0.5 umol TnOAl (tri-n-octylaluminum) used as a scavenger, and 3.9-4.1 ml of solvent as indicated in the table. The reaction was carried out at 70° C. and stirred at 800 rpm, and the reaction was quenched after 8 psi of pressure loss or a maximum of 30 minutes of reaction time is quench pressure not met. If no Tm was reported in Table 9, the polymer was amorphous.

Table 10. Propylene co-polymerization runs using 4-methyl-1pentene as the comonomer. Cat ID corresponds to the complex numbers indicated in the charts. Standard conditions include 1.1 equiv. activator A, [PhMe₂NH][B(C₆F₅)₄], 0.1 to 0.5 ml propylene (C₃) as indicated in the table, 500 ul of 4-methyl-1-pentene, 0.5 umol TnOAl (tri-n-octylaluminum) used as a scavenger, and 4.1-4.5 ml of solvent as indicated in the table. The reaction was carried out at 100° C. and stirred at 800 rpm, and the reaction was quenched after 8 psi of pressure loss or a maximum of 30 minutes of reaction time is quench pressure not met. The polymer produced were amorphous.

TABLE 1
Propylene homo-polymerizations

| | | | | Iso- | | | | | Activity·(g· | | | | | |
|---|---|---|---|---|---|---|---|---|---|---|---|---|---|---|
| | Cat· | Act· | Cat· | hexane· | Toluene· | T· | quench· | yield· | P/mmol· | | | | | Tm· |
| Ex# [symbol] | ID [symbol] | ID [symbol] | ( [symbol] ) [symbol] | ( [symbol] ) [symbol] | ( [symbol] ) [symbol] | (C.) [symbol] | time·(s) [symbol] | (g) [symbol] | cat · hr) [symbol] | Mn [symbol] | Mw [symbol] | Mz [symbol] | PDI [symbol] | (° C.) [symbol] |
| 1 [symbol] | 1 [symbol] | A [symbol] | 0.015 [symbol] | 3874 [symbol] | 226 [symbol] | 70 [symbol] | 73 [symbol] | 0.4563 [symbol] | 1,500,164 [symbol] | 114,466 [symbol] | 489,547 [symbol] | 1,650,145 [symbol] | 4.28 [symbol] | 159.3 [symbol] |
| 2 [symbol] | 1 [symbol] | A [symbol] | 0.015 [symbol] | 3874 [symbol] | 226 [symbol] | 70 [symbol] | 85 [symbol] | 0.3556 [symbol] | 1,004,047 [symbol] | 140,909 [symbol] | 430,206 [symbol] | 1,428,541 [symbol] | 3.05 [symbol] | 159.0 [symbol] |
| 3 [symbol] | 1 [symbol] | A [symbol] | 0.015 [symbol] | 3874 [symbol] | 226 [symbol] | 70 [symbol] | 107 [symbol] | 0.4111 [symbol] | 922,093 [symbol] | 24,847 [symbol] | 442,963 [symbol] | 1,925,442 [symbol] | 17.83 [symbol] | 158.6 [symbol] |
| 4 [symbol] | 1 [symbol] | A [symbol] | 0.025 [symbol] | 3895 [symbol] | 205 [symbol] | 70 [symbol] | 45 [symbol] | 0.3795 [symbol] | 1,214,400 [symbol] | 78,229 [symbol] | 373,263 [symbol] | 1,617,577 [symbol] | 4.77 [symbol] | 157.6 [symbol] |
| 5 [symbol] | 1 [symbol] | A [symbol] | 0.025 [symbol] | 3895 [symbol] | 205 [symbol] | 70 [symbol] | 59 [symbol] | 0.3355 [symbol] | 818,847 [symbol] | 96,301 [symbol] | 415,579 [symbol] | 1,607,802 [symbol] | 4.32 [symbol] | 157.4 [symbol] |
| 6 [symbol] | 1 [symbol] | A [symbol] | 0.025 [symbol] | 3895 [symbol] | 205 [symbol] | 70 [symbol] | 52 [symbol] | 0.4031 [symbol] | 1,116,277 [symbol] | 84,820 [symbol] | 371,054 [symbol] | 1,348,438 [symbol] | 4.37 [symbol] | 156.9 [symbol] |
| 7 [symbol] | 1 [symbol] | A [symbol] | 0.015 [symbol] | 3874 [symbol] | 226 [symbol] | 100 [symbol] | 55 [symbol] | 0.2204 [symbol] | 961,745 [symbol] | 75,757 [symbol] | 153,238 [symbol] | 419,644 [symbol] | 2.02 [symbol] | 158.4 [symbol] |
| 8 [symbol] | 1 [symbol] | A [symbol] | 0.015 [symbol] | 3874 [symbol] | 226 [symbol] | 100 [symbol] | 44 [symbol] | 0.2229 [symbol] | 1,215,818 [symbol] | 75,647 [symbol] | 169,707 [symbol] | 606,761 [symbol] | 2.24 [symbol] | 158.4 [symbol] |
| 9 [symbol] | 1 [symbol] | A [symbol] | 0.015 [symbol] | 3874 [symbol] | 226 [symbol] | 100 [symbol] | 46 [symbol] | 0.2208 [symbol] | 1,152,000 [symbol] | 80,499 [symbol] | 164,360 [symbol] | 471,700 [symbol] | 2.04 [symbol] | 157.6 [symbol] |
| 10 [symbol] | 1 [symbol] | A [symbol] | 0.025 [symbol] | 3895 [symbol] | 205 [symbol] | 100 [symbol] | 24 [symbol] | 0.2510 [symbol] | 1,506,000 [symbol] | 51,229 [symbol] | 147,215 [symbol] | 576,352 [symbol] | 2.87 [symbol] | 157.1 [symbol] |
| 11 [symbol] | 1 [symbol] | A [symbol] | 0.025 [symbol] | 3895 [symbol] | 205 [symbol] | 100 [symbol] | 30 [symbol] | 0.2502 [symbol] | 1,200,960 [symbol] | 50,406 [symbol] | 121,184 [symbol] | 346,391 [symbol] | 2.40 [symbol] | 157.1 [symbol] |
| 12 [symbol] | 1 [symbol] | A [symbol] | 0.025 [symbol] | 3895 [symbol] | 205 [symbol] | 100 [symbol] | 26 [symbol] | 0.2602 [symbol] | 1,441,108 [symbol] | 38,376 [symbol] | 123,993 [symbol] | 441,392 [symbol] | 3.23 [symbol] | 156.9 [symbol] |
| 13 [symbol] | 2 [symbol] | A [symbol] | 0.015 [symbol] | 3874 [symbol] | 226 [symbol] | 70 [symbol] | 75 [symbol] | 0.3729 [symbol] | 1,193,280 [symbol] | 125,777 [symbol] | 334,087 [symbol] | 1,073,656 [symbol] | 2.66 [symbol] | 160.7 [symbol] |
| 14 [symbol] | 2 [symbol] | A [symbol] | 0.015 [symbol] | 3874 [symbol] | 226 [symbol] | 70 [symbol] | 80 [symbol] | 0.3253 [symbol] | 975,900 [symbol] | 165,597 [symbol] | 334,380 [symbol] | 903,938 [symbol] | 2.02 [symbol] | 160.6 [symbol] |
| 15 [symbol] | 2 [symbol] | A [symbol] | 0.015 [symbol] | 3874 [symbol] | 226 [symbol] | 70 [symbol] | 75 [symbol] | 0.3297 [symbol] | 1,055,040 [symbol] | 114,722 [symbol] | 316,540 [symbol] | 1,030,692 [symbol] | 2.76 [symbol] | 160.4 [symbol] |
| 16 [symbol] | 2 [symbol] | A [symbol] | 0.025 [symbol] | 3895 [symbol] | 205 [symbol] | 70 [symbol] | 62 [symbol] | 0.3619 [symbol] | 840,542 [symbol] | 60,669 [symbol] | 314,652 [symbol] | 1,329,302 [symbol] | 5.19 [symbol] | 159.3 [symbol] |
| 17 [symbol] | 2 [symbol] | A [symbol] | 0.025 [symbol] | 3895 [symbol] | 205 [symbol] | 70 [symbol] | 57 [symbol] | 0.3694 [symbol] | 933,221 [symbol] | 111,718 [symbol] | 314,923 [symbol] | 1,136,460 [symbol] | 2.82 [symbol] | 159.1 [symbol] |
| 18 [symbol] | 2 [symbol] | A [symbol] | 0.025 [symbol] | 3895 [symbol] | 205 [symbol] | 70 [symbol] | 58 [symbol] | 0.3826 [symbol] | 949,903 [symbol] | 103,234 [symbol] | 327,189 [symbol] | 1,165,677 [symbol] | 3.17 [symbol] | 158.5 [symbol] |
| 19 [symbol] | 2 [symbol] | A [symbol] | 0.015 [symbol] | 3874 [symbol] | 226 [symbol] | 100 [symbol] | 59 [symbol] | 0.2047 [symbol] | 832,578 [symbol] | 61,125 [symbol] | 122,674 [symbol] | 253,423 [symbol] | 2.01 [symbol] | 160.7 [symbol] |
| 20 [symbol] | 2 [symbol] | A [symbol] | 0.015 [symbol] | 3874 [symbol] | 226 [symbol] | 100 [symbol] | 54 [symbol] | 0.2062 [symbol] | 916,444 [symbol] | 22,140 [symbol] | 120,721 [symbol] | 248,648 [symbol] | 1.94 [symbol] | 160.6 [symbol] |
| 21 [symbol] | 2 [symbol] | A [symbol] | 0.015 [symbol] | 3874 [symbol] | 226 [symbol] | 100 [symbol] | 62 [symbol] | 0.1908 [symbol] | 738,581 [symbol] | 68,611 [symbol] | 129,273 [symbol] | 256,101 [symbol] | 1.88 [symbol] | 160.2 [symbol] |
| 22 [symbol] | 2 [symbol] | A [symbol] | 0.025 [symbol] | 3895 [symbol] | 205 [symbol] | 100 [symbol] | 64 [symbol] | 0.2433 [symbol] | 547,425 [symbol] | 53,787 [symbol] | 114,198 [symbol] | 333,094 [symbol] | 2.12 [symbol] | 158.9 [symbol] |
| 23 [symbol] | 2 [symbol] | A [symbol] | 0.025 [symbol] | 3895 [symbol] | 205 [symbol] | 100 [symbol] | 40 [symbol] | 0.2190 [symbol] | 788,400 [symbol] | 59,497 [symbol] | 120,699 [symbol] | 312,369 [symbol] | 2.03 [symbol] | 158.4 [symbol] |
| 24 [symbol] | 2 [symbol] | A [symbol] | 0.025 [symbol] | 3895 [symbol] | 205 [symbol] | 100 [symbol] | 35 [symbol] | 0.2276 [symbol] | 936,411 [symbol] | 55,450 [symbol] | 113,423 [symbol] | 298,555 [symbol] | 2.05 [symbol] | 158.3 [symbol] |
| 25 [symbol] | 3 [symbol] | A [symbol] | 0.015 [symbol] | 3874 [symbol] | 226 [symbol] | 70 [symbol] | 14 [symbol] | 0.4037 [symbol] | 6,920,571 [symbol] | 67,290 [symbol] | 428,075 [symbol] | 1,753,319 [symbol] | 6.36 [symbol] | 148.1 [symbol] |
| 26 [symbol] | 3 [symbol] | A [symbol] | 0.015 [symbol] | 3874 [symbol] | 226 [symbol] | 70 [symbol] | 15 [symbol] | 0.3543 [symbol] | 5,668,800 [symbol] | 57,753 [symbol] | 372,797 [symbol] | 1,464,190 [symbol] | 6.46 [symbol] | 147.5 [symbol] |
| 27 [symbol] | 3 [symbol] | A [symbol] | 0.015 [symbol] | 3874 [symbol] | 226 [symbol] | 70 [symbol] | 13 [symbol] | 0.4127 [symbol] | 7,619,077 [symbol] | 64,376 [symbol] | 502,823 [symbol] | 2,141,863 [symbol] | 7.81 [symbol] | 147.3 [symbol] |
| 28 [symbol] | 3 [symbol] | A [symbol] | 0.025 [symbol] | 3895 [symbol] | 205 [symbol] | 70 [symbol] | 9 [symbol] | 0.4117 [symbol] | 6,587,200 [symbol] | 47,250 [symbol] | 341,708 [symbol] | 1,138,024 [symbol] | 7.23 [symbol] | 146.4 [symbol] |
| 29 [symbol] | 3 [symbol] | A [symbol] | 0.025 [symbol] | 3895 [symbol] | 205 [symbol] | 70 [symbol] | 12 [symbol] | 0.38 [symbol] 9 [symbol] | 4,678,800 [symbol] | 30,862 [symbol] | 378,892 [symbol] | 1,226,503 [symbol] | 12.28 [symbol] | 145.9 [symbol] |
| 30 [symbol] | 3 [symbol] | A [symbol] | 0.025 [symbol] | 3895 [symbol] | 205 [symbol] | 70 [symbol] | 18 [symbol] | 0.4025 [symbol] | 3,220, [symbol] 00 [symbol] | 49,716 [symbol] | 337,334 [symbol] | 1,245,032 [symbol] | 8.79 [symbol] | 144.9 [symbol] |
| 31 [symbol] | 3 [symbol] | A [symbol] | 0.015 [symbol] | 3874 [symbol] | 226 [symbol] | 100 [symbol] | 20 [symbol] | 0.2204 [symbol] | 2,644,800 [symbol] | 48,586 [symbol] | 169,007 [symbol] | 824,268 [symbol] | 3.48 [symbol] | 147.0 [symbol] |
| 32 [symbol] | 3 [symbol] | A [symbol] | 0.015 [symbol] | 3874 [symbol] | 226 [symbol] | 100 [symbol] | 16 [symbol] | 0.2921 [symbol] | 3,531,500 [symbol] | 28,762 [symbol] | 152,087 [symbol] | 846,846 [symbol] | 5.29 [symbol] | 145.8 [symbol] |
| 33 [symbol] | 3 [symbol] | A [symbol] | 0.015 [symbol] | 3874 [symbol] | 226 [symbol] | 100 [symbol] | 17 [symbol] | 0.3151 [symbol] | 4,448,471 [symbol] | 34,55 [symbol] | 155,81 [symbol] | 585, [symbol] 46 [symbol] | 4.51 [symbol] | 145. [symbol] |
| 34 [symbol] | 3 [symbol] | A [symbol] | 0.025 [symbol] | 3895 [symbol] | 205 [symbol] | 100 [symbol] | 19 [symbol] | 0.2373 [symbol] | 1,798,484 [symbol] | 52,629 [symbol] | 157,432 [symbol] | 494,408 [symbol] | 2.99 [symbol] | 146.6 [symbol] |
| 35 [symbol] | 3 [symbol] | A [symbol] | 0.025 [symbol] | 3895 [symbol] | 205 [symbol] | 100 [symbol] | 12 [symbol] | 0.3252 [symbol] | 3, [symbol] 14,400 [symbol] | 18, [symbol] 57 [symbol] | 136, [symbol] 76 [symbol] | 578,843 [symbol] | 5.43 [symbol] | 143.3 [symbol] |
| 36 [symbol] | 4 [symbol] | A [symbol] | 0.015 [symbol] | 3874 [symbol] | 226 [symbol] | 70 [symbol] | 29 [symbol] | 0.3914 [symbol] | 3,239,172 [symbol] | 18,561 [symbol] | 174,783 [symbol] | 1,116,895 [symbol] | 9.42 [symbol] | 150.9 [symbol] |
| 37 [symbol] | 4 [symbol] | A [symbol] | 0.015 [symbol] | 3874 [symbol] | 226 [symbol] | 70 [symbol] | 24 [symbol] | 0.4204 [symbol] | 4,204,000 [symbol] | 27,138 [symbol] | 162,274 [symbol] | 998,810 [symbol] | 5.98 [symbol] | 150.6 [symbol] |
| 38 [symbol] | 4 [symbol] | A [symbol] | 0.015 [symbol] | 3874 [symbol] | 226 [symbol] | 70 [symbol] | 23 [symbol] | 0.3712 [symbol] | 3,873,391 [symbol] | 17,744 [symbol] | 126,712 [symbol] | 777,832 [symbol] | 7.14 [symbol] | 150.3 [symbol] |
| 39 [symbol] | 4 [symbol] | A [symbol] | 0.025 [symbol] | 3895 [symbol] | 205 [symbol] | 70 [symbol] | 17 [symbol] | 0.4182 [symbol] | 3,525,459 [symbol] | 13,852 [symbol] | 125,458 [symbol] | 517,939 [symbol] | 9.08 [symbol] | 149.0 [symbol] |
| 40 [symbol] | 4 [symbol] | A [symbol] | 0.025 [symbol] | 3895 [symbol] | 205 [symbol] | 70 [symbol] | 15 [symbol] | 0.4075 [symbol] | 3,912,000 [symbol] | 22,516 [symbol] | 144,647 [symbol] | 756,294 [symbol] | 6.42 [symbol] | 148.8 [symbol] |
| 41 [symbol] | 4 [symbol] | A [symbol] | 0.015 [symbol] | 3874 [symbol] | 226 [symbol] | 100 [symbol] | 25 [symbol] | 0.2921 [symbol] | 2,884,160 [symbol] | [symbol] | 49,95 [symbol] | 158,275 [symbol] | 3.28 [symbol] | 148.9 [symbol] |
| 42 [symbol] | 4 [symbol] | A [symbol] | 0.015 [symbol] | 3874 [symbol] | 226 [symbol] | 100 [symbol] | 23 [symbol] | 0.2986 [symbol] | 3,115,826 [symbol] | 14,340 [symbol] | 52,166 [symbol] | 182,314 [symbol] | 3.64 [symbol] | 148.6 [symbol] |
| 43 [symbol] | 4 [symbol] | A [symbol] | 0.015 [symbol] | 3874 [symbol] | 226 [symbol] | 100 [symbol] | 16 [symbol] | 0.2981 [symbol] | 4, [symbol] 85,508 [symbol] | 12,695 [symbol] | 47,275 [symbol] | 157,729 [symbol] | 3.72 [symbol] | 147.4 [symbol] |
| 44 [symbol] | 4 [symbol] | A [symbol] | 0.025 [symbol] | 3895 [symbol] | 205 [symbol] | 100 [symbol] | 6 [symbol] | 0.2473 [symbol] | 5,935,209 [symbol] | 19,0 [symbol] | 38,235 [symbol] | 113,476 [symbol] | 3.79 [symbol] | 146.9 [symbol] |
| 45 [symbol] | 4 [symbol] | A [symbol] | 0.025 [symbol] | 3895 [symbol] | 205 [symbol] | 100 [symbol] | 10 [symbol] | 0.3095 [symbol] | 4,465,800 [symbol] | 12,335 [symbol] | 38,756 [symbol] | 113,564 [symbol] | 3.14 [symbol] | 146.0 [symbol] |
| 46 [symbol] | 4 [symbol] | A [symbol] | 0.025 [symbol] | 3895 [symbol] | 205 [symbol] | 100 [symbol] | 10 [symbol] | 0.307 [symbol] | 4,422,240 [symbol] | 8,151 [symbol] | 33,301 [symbol] | 109,122 [symbol] | 4.09 [symbol] | 145.8 [symbol] |
| 47 [symbol] | 5 [symbol] | A [symbol] | 0.015 [symbol] | 3874 [symbol] | 226 [symbol] | 50 [symbol] | 65 [symbol] | 0.3110 [symbol] | 1,148,308 [symbol] | 362, [symbol] 03 [symbol] | 836,901 [symbol] | 2,313,285 [symbol] | 2.31 [symbol] | 153.1 [symbol] |
| 48 [symbol] | 5 [symbol] | A [symbol] | 0.020 [symbol] | 3832 [symbol] | 268 [symbol] | 50 [symbol] | 41 [symbol] | 0.3343 [symbol] | 1,467,559 [symbol] | 323,013 [symbol] | [symbol] 23,436 [symbol] | 2,436,278 [symbol] | 2.54 [symbol] | 160.5 [symbol] |
| 49 [symbol] | 5 [symbol] | A [symbol] | 0.015 [symbol] | 3874 [symbol] | 225 [symbol] | 50 [symbol] | 77 [symbol] | 0.3518 [symbol] | 1,095,519 [symbol] | 221,689 [symbol] | 571,824 [symbol] | 1,714,574 [symbol] | 2.58 [symbol] | 159.8 [symbol] |
| 50 [symbol] | 5 [symbol] | A [symbol] | 0.020 [symbol] | 3832 [symbol] | 285 [symbol] | 50 [symbol] | 62 [symbol] | 0.3572 [symbol] | 1,037,032 [symbol] | 187,9 [symbol] | 630,452 [symbol] | 2,287,541 [symbol] | 3.36 [symbol] | 158.4 [symbol] |
| 51 [symbol] | 5 [symbol] | A [symbol] | 0.015 [symbol] | 3874 [symbol] | 226 [symbol] | 70 [symbol] | 58 [symbol] | 0.3296 [symbol] | 1,340,339 [symbol] | 155,932 [symbol] | 393,075 [symbol] | 1,312,570 [symbol] | 2.62 [symbol] | 159.1 [symbol] |
| 52 [symbol] | 5 [symbol] | A [symbol] | 0.015 [symbol] | 3874 [symbol] | 226 [symbol] | 70 [symbol] | 58 [symbol] | 0.3641 [symbol] | 1,285,059 [symbol] | 148,571 [symbol] | 394,258 [symbol] | 1,105,985 [symbol] | 2.65 [symbol] | 158.8 [symbol] |
| 53 [symbol] | 5 [symbol] | A [symbol] | 0.015 [symbol] | 3874 [symbol] | 226 [symbol] | 70 [symbol] | 64 [symbol] | 0.3418 [symbol] | 1,281,750 [symbol] | 97,345 [symbol] | 379,898 [symbol] | 1,531,93 [symbol] | 3.9 [symbol] | 158.1 [symbol] |
| 54 [symbol] | 5 [symbol] | A [symbol] | 0.015 [symbol] | 3874 [symbol] | 226 [symbol] | 70 [symbol] | 57 [symbol] | 0.3552 [symbol] | 1,537,884 [symbol] | 73,434 [symbol] | 376,992 [symbol] | 1,587,355 [symbol] | 5.13 [symbol] | 157.9 [symbol] |
| 55 [symbol] | 5 [symbol] | A [symbol] | 0.015 [symbol] | 3874 [symbol] | 226 [symbol] | 70 [symbol] | 7 [symbol] | 0.3701 [symbol] | 1,265,914 [symbol] | 115,04 [symbol] | 350,4 [symbol] 6 [symbol] | 1,191,971 [symbol] | 3.13 [symbol] | 157.8 [symbol] |
| 56 [symbol] | 5 [symbol] | A [symbol] | 0.015 [symbol] | 3874 [symbol] | 226 [symbol] | 70 [symbol] | 58 [symbol] | 0.3412 [symbol] | 1,411,862 [symbol] | 145,110 [symbol] | 351,12 [symbol] | 1,231,459 [symbol] | 2.63 [symbol] | 157.7 [symbol] |
| 57 [symbol] | 5 [symbol] | A [symbol] | 0.015 [symbol] | 3874 [symbol] | 226 [symbol] | 70 [symbol] | 73 [symbol] | 0.4134 [symbol] | 1,359,123 [symbol] | 78,853 [symbol] | 446, [symbol] 00 [symbol] | 2,319,812 [symbol] | 5.67 [symbol] | 157.1 [symbol] |
| 58 [symbol] | 5 [symbol] | A [symbol] | 0.020 [symbol] | 3832 [symbol] | 268 [symbol] | 70 [symbol] | 62 [symbol] | 0.3653 [symbol] | 1,060,548 [symbol] | 126,581 [symbol] | 411,551 [symbol] | 1,585,182 [symbol] | 3.25 [symbol] | 157.0 [symbol] |
| 59 [symbol] | 5 [symbol] | A [symbol] | 0.025 [symbol] | 3895 [symbol] | 205 [symbol] | 70 [symbol] | 38 [symbol] | 0.1412 [symbol] | 535,074 [symbol] | 20,272 [symbol] | 310,784 [symbol] | 1,810,541 [symbol] | 15.33 [symbol] | 154.7 [symbol] |
| 60 [symbol] | 5 [symbol] | A [symbol] | 0.025 [symbol] | 3895 [symbol] | 205 [symbol] | 70 [symbol] | 36 [symbol] | 0.4070 [symbol] | 1,628,000 [symbol] | 57,745 [symbol] | 274,363 [symbol] | 1,031,835 [symbol] | 4.05 [symbol] | 154.3 [symbol] |
| 61 [symbol] | 5 [symbol] | A [symbol] | 0.025 [symbol] | 3895 [symbol] | 205 [symbol] | 70 [symbol] | 40 [symbol] | 0.2350 [symbol] | 846,000 [symbol] | 48,901 [symbol] | 244,435 [symbol] | 856,990 [symbol] | 5.00 [symbol] | 151.7 [symbol] |
| 62 [symbol] | 5 [symbol] | A [symbol] | 0.015 [symbol] | 3874 [symbol] | 226 [symbol] | 100 [symbol] | 42 [symbol] | 0.2077 [symbol] | 1,186,857 [symbol] | 78,612 [symbol] | 162,336 [symbol] | 427,679 [symbol] | 2.07 [symbol] | 159.4 [symbol] |
| 63 [symbol] | 5 [symbol] | A [symbol] | 0.015 [symbol] | 3874 [symbol] | 226 [symbol] | 100 [symbol] | 33 [symbol] | 0.2318 [symbol] | 1,585,818 [symbol] | 65,743 [symbol] | 137,626 [symbol] | 413,504 [symbol] | 2.09 [symbol] | 158.3 [symbol] |
| 64 [symbol] | 5 [symbol] | A [symbol] | 0.015 [symbol] | 3874 [symbol] | 226 [symbol] | 100 [symbol] | 55 [symbol] | 0.2066 [symbol] | 901,527 [symbol] | 60,264 [symbol] | 144,653 [symbol] | 405,635 [symbol] | 2.40 [symbol] | 158.0 [symbol] |
| 65 [symbol] | 5 [symbol] | A [symbol] | 0.015 [symbol] | 3874 [symbol] | 225 [symbol] | 100 [symbol] | 36 [symbol] | 0.2135 [symbol] | 1,423,333 [symbol] | 61,349 [symbol] | 119,262 [symbol] | 288,955 [symbol] | 1.94 [symbol] | 157.8 [symbol] |
| 66 [symbol] | 5 [symbol] | A [symbol] | 0.015 [symbol] | 3874 [symbol] | 226 [symbol] | 100 [symbol] | 36 [symbol] | 0.2424 [symbol] | 1,616,000 [symbol] | 53,262 [symbol] | 113,175 [symbol] | 260,329 [symbol] | 2.12 [symbol] | 157.4 [symbol] |
| 67 [symbol] | 5 [symbol] | A [symbol] | 0.015 [symbol] | 3874 [symbol] | 226 [symbol] | 100 [symbol] | 39 [symbol] | 0.2577 [symbol] | 1,585,846 [symbol] | 45,793 [symbol] | 110,904 [symbol] | 285,324 [symbol] | 2.42 [symbol] | 157.2 [symbol] |
| 68 [symbol] | 5 [symbol] | A [symbol] | 0.015 [symbol] | 3874 [symbol] | 226 [symbol] | 100 [symbol] | 32 [symbol] | 0.2554 [symbol] | 1,915,500 [symbol] | 53,455 [symbol] | 132,919 [symbol] | 459,818 [symbol] | 2.49 [symbol] | 156.9 [symbol] |
| 69 [symbol] | 5 [symbol] | A [symbol] | 0.020 [symbol] | 3832 [symbol] | 268 [symbol] | 100 [symbol] | 32 [symbol] | 0.2374 [symbol] | 1,335,375 [symbol] | 65,144 [symbol] | 129,333 [symbol] | 341,643 [symbol] | 1.99 [symbol] | 157.9 [symbol] |
| 70 [symbol] | 5 [symbol] | A [symbol] | 0.025 [symbol] | 3895 [symbol] | 205 [symbol] | 100 [symbol] | 21 [symbol] | 0.2516 [symbol] | 1,725,257 [symbol] | 36,370 [symbol] | 112,218 [symbol] | 385,587 [symbol] | 3.09 [symbol] | 156.1 [symbol] |
| 71 [symbol] | 5 [symbol] | A [symbol] | 0.025 [symbol] | 3895 [symbol] | 205 [symbol] | 100 [symbol] | 18 [symbol] | 0.2172 [symbol] | 1,737,600 [symbol] | 33,092 [symbol] | 121,551 [symbol] | 391,578 [symbol] | 3.67 [symbol] | 156.1 [symbol] |
| 72 [symbol] | 5 [symbol] | A [symbol] | 0.025 [symbol] | 3895 [symbol] | 205 [symbol] | 100 [symbol] | 19 [symbol] | 0.2650 [symbol] | 2,008,421 [symbol] | 40,888 [symbol] | 123,661 [symbol] | 457,099 [symbol] | 3.02 [symbol] | 155.8 [symbol] |
| 73 [symbol] | 5 [symbol] | A [symbol] | 0.015 [symbol] | 3874 [symbol] | 226 [symbol] | 110 [symbol] | 37 [symbol] | 0.1623 [symbol] | 1,052,757 [symbol] | 50,500 [symbol] | 97,179 [symbol] | 232,180 [symbol] | 1.92 [symbol] | 157.8 [symbol] |
| 74 [symbol] | 5 [symbol] | A [symbol] | 0.020 [symbol] | 3832 [symbol] | 268 [symbol] | 110 [symbol] | 35 [symbol] | 0.2323 [symbol] | 1,194,586 [symbol] | 48,548 [symbol] | 94,167 [symbol] | 225,976 [symbol] | 1.94 [symbol] | 156.9 [symbol] |
| 75 [symbol] | 5 [symbol] | A [symbol] | 0.015 [symbol] | 3874 [symbol] | 226 [symbol] | 115 [symbol] | 42 [symbol] | 0.1884 [symbol] | 1,076,571 [symbol] | 56,302 [symbol] | 96,952 [symbol] | 233,193 [symbol] | 1.72 [symbol] | 156.8 [symbol] |
| 76 [symbol] | 5 [symbol] | A [symbol] | 0.020 [symbol] | 3832 [symbol] | 268 [symbol] | 115 [symbol] | 31 [symbol] | 0.1905 [symbol] | 1,106,129 [symbol] | 43,087 [symbol] | 79,855 [symbol] | 184,316 [symbol] | 1.85 [symbol] | 155.3 [symbol] |
| 77 [symbol] | 5 [symbol] | B [symbol] | 0.015 [symbol] | 3874 [symbol] | 225 [symbol] | 70 [symbol] | 238 [symbol] | 0.2599 [symbol] | 262,084 [symbol] | 426,424 [symbol] | 756,222 [symbol] | 1,822,106 [symbol] | 1.77 [symbol] | 159.4 [symbol] |
| 78 [symbol] | 5 [symbol] | B [symbol] | 0.015 [symbol] | 3874 [symbol] | 226 [symbol] | 70 [symbol] | 155 [symbol] | 0.2622 [symbol] | 405,987 [symbol] | 354,658 [symbol] | 616,635 [symbol] | 1,330,579 [symbol] | 1.69 [symbol] | 158.9 [symbol] |
| 79 [symbol] | 5 [symbol] | B [symbol] | 0.015 [symbol] | 3874 [symbol] | 226 [symbol] | 70 [symbol] | 202 [symbol] | 0.2756 [symbol] | 327,446 [symbol] | 352,949 [symbol] | 670,255 [symbol] | 1,499,145 [symbol] | 1.90 [symbol] | 158.5 [symbol] |
| 80 [symbol] | 5 [symbol] | B [symbol] | 0.015 [symbol] | 3874 [symbol] | 226 [symbol] | 100 [symbol] | 1800 [symbol] | 0.0064 [symbol] | 853 [symbol] | [symbol] | [symbol] | [symbol] | [symbol] | [symbol] |
| 81 [symbol] | 5 [symbol] | B [symbol] | 0.015 [symbol] | 3874 [symbol] | 226 [symbol] | 100 [symbol] | 1801 [symbol] | 0.0077 [symbol] | 1,026 [symbol] | [symbol] | [symbol] | [symbol] | [symbol] | [symbol] |
| 82 [symbol] | 5 [symbol] | B [symbol] | 0.015 [symbol] | 3874 [symbol] | 225 [symbol] | 100 [symbol] | 1801 [symbol] | 0.0056 [symbol] | 746 [symbol] | [symbol] | [symbol] | [symbol] | [symbol] | [symbol] |
| 83 [symbol] | 5 [symbol] | C [symbol] | 0.015 [symbol] | 3874 [symbol] | 225 [symbol] | 70 [symbol] | 61 [symbol] | 0.3710 [symbol] | 1,459,672 [symbol] | 102,011 [symbol] | 337,880 [symbol] | 1,133,722 [symbol] | 3.31 [symbol] | 157.6 [symbol] |
| 84 [symbol] | 5 [symbol] | C [symbol] | 0.015 [symbol] | 3874 [symbol] | 226 [symbol] | 70 [symbol] | 68 [symbol] | 0.3853 [symbol] | 3,359,882 [symbol] | 119,203 [symbol] | 383,611 [symbol] | 1,513,227 [symbol] | 3.22 [symbol] | 157.6 [symbol] |
| 85 [symbol] | 5 [symbol] | C [symbol] | 0.015 [symbol] | 3874 [symbol] | 226 [symbol] | 70 [symbol] | 59 [symbol] | 0.3922 [symbol] | 3,595,390 [symbol] | 93,290 [symbol] | 363,630 [symbol] | 1,313,735 [symbol] | 3.90 [symbol] | 156.8 [symbol] |
| 86 [symbol] | 5 [symbol] | C [symbol] | 0.015 [symbol] | 3874 [symbol] | 226 [symbol] | 100 [symbol] | 43 [symbol] | 0.2326 [symbol] | 1,298,233 [symbol] | 62,879 [symbol] | 132,679 [symbol] | 364,902 [symbol] | 2.11 [symbol] | 157.9 [symbol] |
| 87 [symbol] | 5 [symbol] | C [symbol] | 0.015 [symbol] | 3874 [symbol] | 226 [symbol] | 100 [symbol] | 37 [symbol] | 0.2425 [symbol] | 1,572,973 [symbol] | 56,814 [symbol] | 157,280 [symbol] | 655,515 [symbol] | 2.77 [symbol] | 157.6 [symbol] |
| 88 [symbol] | 5 [symbol] | C [symbol] | 0.015 [symbol] | 3874 [symbol] | 226 [symbol] | 100 [symbol] | 33 [symbol] | 0.2392 [symbol] | 1,739,636 [symbol] | 69,889 [symbol] | 175,511 [symbol] | 750,768 [symbol] | 2.51 [symbol] | 157.3 [symbol] |
| 89 [symbol] | 6 [symbol] | A [symbol] | 0.015 [symbol] | 3874 [symbol] | 226 [symbol] | 70 [symbol] | 7 [symbol] | 0.3795 [symbol] | 13,011,429 [symbol] | 118,914 [symbol] | 474,918 [symbol] | 1,790,054 [symbol] | 3.99 [symbol] | 148.8 [symbol] |
| 90 [symbol] | 6 [symbol] | A [symbol] | 0.015 [symbol] | 3899 [symbol] | 201 [symbol] | 70 [symbol] | 17 [symbol] | 0.3559 [symbol] | 5,024,471 [symbol] | 76,437 [symbol] | 450,220 [symbol] | 1,929,618 [symbol] | 5.89 [symbol] | 148.5 [symbol] |
| 91 [symbol] | 6 [symbol] | A [symbol] | 0.015 [symbol] | 3899 [symbol] | 201 [symbol] | 70 [symbol] | 29 [symbol] | 0.4118 [symbol] | 3,408,000 [symbol] | 105,184 [symbol] | 462,494 [symbol] | 1,688,421 [symbol] | 4.40 [symbol] | 148.1 [symbol] |
| 92 [symbol] | 6 [symbol] | A [symbol] | 0.015 [symbol] | 3899 [symbol] | 201 [symbol] | 70 [symbol] | 21 [symbol] | 0.3950 [symbol] | 4,514,285 [symbol] | 103,834 [symbol] | 456,352 [symbol] | 1,650,050 [symbol] | 4.39 [symbol] | 147.8 [symbol] |
| 93 [symbol] | 6 [symbol] | A [symbol] | 0.015 [symbol] | 3874 [symbol] | 226 [symbol] | 70 [symbol] | 15 [symbol] | 0.4021 [symbol] | 6,433,600 [symbol] | 56,318 [symbol] | 386,035 [symbol] | 1,832,132 [symbol] | 5.82 [symbol] | 147.7 [symbol] |
| 94 [symbol] | 6 [symbol] | A [symbol] | 0.015 [symbol] | 3874 [symbol] | 226 [symbol] | 70 [symbol] | 11 [symbol] | 0.4079 [symbol] | 8,899,636 [symbol] | 158,183 [symbol] | 461,138 [symbol] | 1,272,034 [symbol] | 2.92 [symbol] | 147.7 [symbol] |
| 95 [symbol] | 6 [symbol] | A [symbol] | 0.025 [symbol] | 3895 [symbol] | 205 [symbol] | 70 [symbol] | 10 [symbol] | 0.5049 [symbol] | 7,270,560 [symbol] | 54,923 [symbol] | 412,179 [symbol] | 1,583,284 [symbol] | 7.50 [symbol] | 150.9 [symbol] |
| 96 [symbol] | 6 [symbol] | A [symbol] | 0.025 [symbol] | 3895 [symbol] | 205 [symbol] | 70 [symbol] | 14 [symbol] | 0.3719 [symbol] | 3,825,257 [symbol] | 55,438 [symbol] | 404,974 [symbol] | 1,360,776 [symbol] | 7.30 [symbol] | 146.9 [symbol] |
| 97 [symbol] | 6 [symbol] | A [symbol] | 0.025 [symbol] | 3895 [symbol] | 205 [symbol] | 70 [symbol] | 8 [symbol] | 0.4157 [symbol] | 7,482,600 [symbol] | 63,264 [symbol] | 395,569 [symbol] | 1,792,391 [symbol] | 7.43 [symbol] | 146.2 [symbol] |
| 98 [symbol] | 6 [symbol] | A [symbol] | 0.015 [symbol] | 3899 [symbol] | 201 [symbol] | 100 [symbol] | 13 [symbol] | 0.1692 [symbol] | 3,123,692 [symbol] | 78,532 [symbol] | 191,558 [symbol] | 622,897 [symbol] | 2.44 [symbol] | 148.6 [symbol] |
| 99 [symbol] | 6 [symbol] | A [symbol] | 0.015 [symbol] | 3899 [symbol] | 201 [symbol] | 100 [symbol] | 21 [symbol] | 0.2996 [symbol] | 3,424,000 [symbol] | 59,868 [symbol] | 185,038 [symbol] | 608,943 [symbol] | 3.09 [symbol] | 147.9 [symbol] |
| 100 [symbol] | 6 [symbol] | A [symbol] | 0.015 [symbol] | 3899 [symbol] | 201 [symbol] | 100 [symbol] | 19 [symbol] | 0.3026 [symbol] | 3,822,316 [symbol] | 47,864 [symbol] | 176,148 [symbol] | 650,186 [symbol] | 3.68 [symbol] | 145.7 [symbol] |
| 101 [symbol] | 6 [symbol] | A [symbol] | 0.015 [symbol] | 3874 [symbol] | 226 [symbol] | 100 [symbol] | 17 [symbol] | 0.2957 [symbol] | 4,174,588 [symbol] | 41,805 [symbol] | 137,097 [symbol] | 437,336 [symbol] | 3.28 [symbol] | 146.7 [symbol] |
| 102 [symbol] | 6 [symbol] | A [symbol] | 0.015 [symbol] | 3874 [symbol] | 226 [symbol] | 100 [symbol] | 16 [symbol] | 0.3116 [symbol] | 4,674,000 [symbol] | 36,075 [symbol] | 145,393 [symbol] | 558,114 [symbol] | 4.03 [symbol] | 146.7 [symbol] |
| 103 [symbol] | 6 [symbol] | A [symbol] | 0.015 [symbol] | 3874 [symbol] | 226 [symbol] | 100 [symbol] | 34 [symbol] | 0.3299 [symbol] | 2,328,706 [symbol] | 40,450 [symbol] | 161,508 [symbol] | 782,341 [symbol] | 3.99 [symbol] | 146.2 [symbol] |
| 104 [symbol] | 6 [symbol] | A [symbol] | 0.025 [symbol] | 3895 [symbol] | 205 [symbol] | 100 [symbol] | 12 [symbol] | 0.3261 [symbol] | 3,913,200 [symbol] | 15,045 [symbol] | 123,087 [symbol] | 812,911 [symbol] | 8.18 [symbol] | 144.6 [symbol] |
| 105 [symbol] | 6 [symbol] | A [symbol] | 0.025 [symbol] | 3895 [symbol] | 205 [symbol] | 100 [symbol] | 10 [symbol] | 0.3294 [symbol] | 4,743,360 [symbol] | 21,299 [symbol] | 144,305 [symbol] | 621,716 [symbol] | 6.78 [symbol] | 144.1 [symbol] |
| 106 [symbol] | 6 [symbol] | A [symbol] | 0.025 [symbol] | 3895 [symbol] | 205 [symbol] | 100 [symbol] | 15 [symbol] | 0.3190 [symbol] | 3,062,400 [symbol] | 23,333 [symbol] | 132,940 [symbol] | 1,035,127 [symbol] | 5.70 [symbol] | 143.6 [symbol] |
| 107 [symbol] | 6 [symbol] | B [symbol] | 0.015 [symbol] | 3874 [symbol] | 226 [symbol] | 70 [symbol] | 105 [symbol] | 0.3591 [symbol] | 820,800 [symbol] | 245,294 [symbol] | 578,298 [symbol] | 1,523,246 [symbol] | 2.36 [symbol] | 151.1 [symbol] |
| 108 [symbol] | 6 [symbol] | B [symbol] | 0.015 [symbol] | 3874 [symbol] | 226 [symbol] | 70 [symbol] | 48 [symbol] | 0.3526 [symbol] | 1,763,000 [symbol] | 134,885 [symbol] | 506,647 [symbol] | 1,589,253 [symbol] | 3.76 [symbol] | 149.7 [symbol] |
| 109 [symbol] | 6 [symbol] | B [symbol] | 0.015 [symbol] | 3874 [symbol] | 226 [symbol] | 70 [symbol] | 82 [symbol] | 0.3303 [symbol] | 966,732 [symbol] | 205,620 [symbol] | 557,373 [symbol] | 1,594,146 [symbol] | 2.71 [symbol] | 149.7 [symbol] |
| 110 [symbol] | 6 [symbol] | B [symbol] | 0.015 [symbol] | 3874 [symbol] | 226 [symbol] | 100 [symbol] | 1800 [symbol] | 0.0553 [symbol] | 7,373 [symbol] | 264,743 [symbol] | 411,777 [symbol] | 833,940 [symbol] | 1.56 [symbol] | 150.2 [symbol] |
| 111 [symbol] | 6 [symbol] | B [symbol] | 0.015 [symbol] | 3874 [symbol] | 226 [symbol] | 100 [symbol] | 420 [symbol] | 0.0747 [symbol] | 42,686 [symbol] | 223,744 [symbol] | 354,740 [symbol] | 712,784 [symbol] | 1.59 [symbol] | 150.2 [symbol] |
| 112 [symbol] | 6 [symbol] | B [symbol] | 0.015 [symbol] | 3874 [symbol] | 226 [symbol] | 100 [symbol] | 259 [symbol] | 0.0597 [symbol] | 55,320 [symbol] | 224,380 [symbol] | 324,573 [symbol] | 504,329 [symbol] | 1.45 [symbol] | 149.7 [symbol] |
| 113 [symbol] | 6 [symbol] | C [symbol] | 0.015 [symbol] | 3874 [symbol] | 226 [symbol] | 70 [symbol] | 15 [symbol] | 0.4004 [symbol] | 6,405,400 [symbol] | 61,960 [symbol] | 359,365 [symbol] | 1,386,797 [symbol] | 5.80 [symbol] | 145.9 [symbol] |
| 114 [symbol] | 6 [symbol] | C [symbol] | 0.015 [symbol] | 3874 [symbol] | 226 [symbol] | 70 [symbol] | 11 [symbol] | 0.4177 [symbol] | 9,113,455 [symbol] | 103,910 [symbol] | 420,308 [symbol] | 1,426,376 [symbol] | 4.04 [symbol] | 145.9 [symbol] |
| 115 [symbol] | 6 [symbol] | C [symbol] | 0.015 [symbol] | 3874 [symbol] | 226 [symbol] | 70 [symbol] | 17 [symbol] | 0.4241 [symbol] | 5,987,294 [symbol] | 80,127 [symbol] | 382,187 [symbol] | 1,235,156 [symbol] | 4.77 [symbol] | 146.5 [symbol] |
| 116 [symbol] | 6 [symbol] | C [symbol] | 0.015 [symbol] | 3874 [symbol] | 226 [symbol] | 100 [symbol] | 16 [symbol] | 0.3077 [symbol] | 4,615,500 [symbol] | 32,003 [symbol] | 167,446 [symbol] | 733,489 [symbol] | 5.23 [symbol] | 145.9 [symbol] |
| 117 [symbol] | 6 [symbol] | C [symbol] | 0.015 [symbol] | 3874 [symbol] | 226 [symbol] | 100 [symbol] | 19 [symbol] | 0.3073 [symbol] | 3,881,684 [symbol] | 47,498 [symbol] | 155,800 [symbol] | 579,569 [symbol] | 3.28 [symbol] | 145.7 [symbol] |
| 118 [symbol] | 6 [symbol] | C [symbol] | 0.015 [symbol] | 3874 [symbol] | 226 [symbol] | 100 [symbol] | 17 [symbol] | 0.3157 [symbol] | 4,456,941 [symbol] | 42,617 [symbol] | 156,382 [symbol] | 574,717 [symbol] | 3.67 [symbol] | 145.7 [symbol] |
| 119 [symbol] | 7 [symbol] | A [symbol] | 0.015 [symbol] | 3874 [symbol] | 226 [symbol] | 70 [symbol] | 65 [symbol] | 0.3707 [symbol] | 1,368,738 [symbol] | 96,491 [symbol] | 420,800 [symbol] | 2,185,151 [symbol] | 4.36 [symbol] | 160.4 [symbol] |
| 120 [symbol] | 7 [symbol] | A [symbol] | 0.015 [symbol] | 3874 [symbol] | 226 [symbol] | 70 [symbol] | 55 [symbol] | 0.3750 [symbol] | 1,636,364 [symbol] | 73,631 [symbol] | 416,915 [symbol] | 2,300,681 [symbol] | 5.66 [symbol] | 159.1 [symbol] |
| 121 [symbol] | 7 [symbol] | A [symbol] | 0.015 [symbol] | 3874 [symbol] | 226 [symbol] | 70 [symbol] | 58 [symbol] | 0.3728 [symbol] | 1,542,621 [symbol] | 104,115 [symbol] | 408,527 [symbol] | 2,023,472 [symbol] | 3.92 [symbol] | 158.6 [symbol] |
| 122 [symbol] | 7 [symbol] | A [symbol] | 0.025 [symbol] | 3895 [symbol] | 205 [symbol] | 70 [symbol] | 47 [symbol] | 0.3867 [symbol] | 1,184,783 [symbol] | 82,818 [symbol] | 418,093 [symbol] | 1,917,700 [symbol] | 5.05 [symbol] | 159.3 [symbol] |
| 123 [symbol] | 7 [symbol] | A [symbol] | 0.025 [symbol] | 3895 [symbol] | 205 [symbol] | 70 [symbol] | 31 [symbol] | 0.3624 [symbol] | 1,683,406 [symbol] | 33,128 [symbol] | 341,316 [symbol] | 1,757,046 [symbol] | 10.30 [symbol] | 157.3 [symbol] |
| 124 [symbol] | 7 [symbol] | A [symbol] | 0.025 [symbol] | 3895 [symbol] | 205 [symbol] | 70 [symbol] | 34 [symbol] | 0.4134 [symbol] | 1,750,871 [symbol] | 36,855 [symbol] | 327,546 [symbol] | 1,507,616 [symbol] | 8.89 [symbol] | 156.8 [symbol] |
| 125 [symbol] | 7 [symbol] | A [symbol] | 0.015 [symbol] | 3874 [symbol] | 226 [symbol] | 100 [symbol] | 29 [symbol] | 0.2755 [symbol] | 2,280,000 [symbol] | 33,147 [symbol] | 109,233 [symbol] | 357,333 [symbol] | 3.30 [symbol] | 158.0 [symbol] |
| 126 [symbol] | 7 [symbol] | A [symbol] | 0.015 [symbol] | 3874 [symbol] | 226 [symbol] | 100 [symbol] | 34 [symbol] | 0.2756 [symbol] | 1,945,412 [symbol] | 30,104 [symbol] | 91,877 [symbol] | 246,715 [symbol] | 3.05 [symbol] | 157.5 [symbol] |
| 127 [symbol] | 7 [symbol] | A [symbol] | 0.015 [symbol] | 3874 [symbol] | 226 [symbol] | 100 [symbol] | 31 [symbol] | 0.2734 [symbol] | 2,116,645 [symbol] | 41,093 [symbol] | 102,267 [symbol] | 254,470 [symbol] | 2.49 [symbol] | 157.4 [symbol] |
| 128 [symbol] | 7 [symbol] | A [symbol] | 0.025 [symbol] | 3895 [symbol] | 205 [symbol] | 100 [symbol] | 20 [symbol] | 0.2582 [symbol] | 1,859,040 [symbol] | 31,837 [symbol] | 108,214 [symbol] | 428,914 [symbol] | 3.40 [symbol] | 157.1 [symbol] |
| 129 [symbol] | 7 [symbol] | A [symbol] | 0.025 [symbol] | 3895 [symbol] | 205 [symbol] | 100 [symbol] | 21 [symbol] | 0.2567 [symbol] | 1,760,229 [symbol] | 45,982 [symbol] | 117,786 [symbol] | 362,307 [symbol] | 2.56 [symbol] | 156.8 [symbol] |
| 130 [symbol] | 7 [symbol] | A [symbol] | 0.025 [symbol] | 3895 [symbol] | 205 [symbol] | 100 [symbol] | 19 [symbol] | 0.2640 [symbol] | 2,000,842 [symbol] | 38,903 [symbol] | 118,110 [symbol] | 469,640 [symbol] | 3.04 [symbol] | 156.6 [symbol] |
| 131 [symbol] | 8 [symbol] | A [symbol] | 0.015 [symbol] | 3874 [symbol] | 226 [symbol] | 70 [symbol] | 69 [symbol] | 0.1396 [symbol] | 485,565 [symbol] | 221,954 [symbol] | 414,051 [symbol] | 948,937 [symbol] | 1.87 [symbol] | 153.0 [symbol] |
| 132 [symbol] | 8 [symbol] | A [symbol] | 0.015 [symbol] | 3874 [symbol] | 226 [symbol] | 70 [symbol] | 132 [symbol] | 0.2025 [symbol] | 368,182 [symbol] | 217,410 [symbol] | 410,493 [symbol] | 969,131 [symbol] | 1.89 [symbol] | 152.8 [symbol] |
| 133 [symbol] | 8 [symbol] | A [symbol] | 0.015 [symbol] | 3874 [symbol] | 226 [symbol] | 70 [symbol] | 117 [symbol] | 0.1833 [symbol] | 376,000 [symbol] | 219,456 [symbol] | 388,248 [symbol] | 912,947 [symbol] | 1.77 [symbol] | 152.7 [symbol] |
| 134 [symbol] | 8 [symbol] | A [symbol] | 0.025 [symbol] | 3895 [symbol] | 205 [symbol] | 70 [symbol] | 71 [symbol] | 0.2931 [symbol] | 594,456 [symbol] | 94,603 [symbol] | 305,434 [symbol] | 808,807 [symbol] | 3.23 [symbol] | 151.5 [symbol] |
| 135 [symbol] | 8 [symbol] | A [symbol] | 0.025 [symbol] | 3895 [symbol] | 205 [symbol] | 70 [symbol] | 73 [symbol] | 0.2732 [symbol] | 538,915 [symbol] | 118,590 [symbol] | 310,029 [symbol] | 773,287 [symbol] | 2.61 [symbol] | 151.3 [symbol] |
| 136 [symbol] | 8 [symbol] | A [symbol] | 0.025 [symbol] | 3895 [symbol] | 205 [symbol] | 70 [symbol] | 65 [symbol] | 0.2603 [symbol] | 575,665 [symbol] | 153,571 [symbol] | 299,372 [symbol] | 665,532 [symbol] | 1.95 [symbol] | 151.2 [symbol] |
| 137 [symbol] | 8 [symbol] | A [symbol] | 0.015 [symbol] | 3874 [symbol] | 226 [symbol] | 100 [symbol] | 155 [symbol] | 0.1025 [symbol] | 158,710 [symbol] | 92,421 [symbol] | 157,438 [symbol] | 357,993 [symbol] | 1.70 [symbol] | 153.2 [symbol] |
| 138 [symbol] | 8 [symbol] | A [symbol] | 0.015 [symbol] | 3874 [symbol] | 226 [symbol] | 100 [symbol] | 80 [symbol] | 0.1523 [symbol] | 456,900 [symbol] | 76,265 [symbol] | 141,310 [symbol] | 337,323 [symbol] | 1.85 [symbol] | 153.1 [symbol] |
| 139 [symbol] | 8 [symbol] | A [symbol] | 0.015 [symbol] | 3874 [symbol] | 226 [symbol] | 100 [symbol] | 102 [symbol] | 0.1334 [symbol] | 313,882 [symbol] | 89,843 [symbol] | 150,781 [symbol] | 334,179 [symbol] | 1.68 [symbol] | 152.6 [symbol] |
| 140 [symbol] | 8 [symbol] | A [symbol] | 0.025 [symbol] | 3895 [symbol] | 205 [symbol] | 100 [symbol] | 46 [symbol] | 0.2106 [symbol] | 659,270 [symbol] | 46,511 [symbol] | 122,427 [symbol] | 364,279 [symbol] | 2.63 [symbol] | 151.7 [symbol] |
| 141 [symbol] | 8 [symbol] | A [symbol] | 0.025 [symbol] | 3895 [symbol] | 205 [symbol] | 100 [symbol] | 54 [symbol] | 0.2152 [symbol] | 573,867 [symbol] | 58,371 [symbol] | 122,681 [symbol] | 345,441 [symbol] | 2.10 [symbol] | 151.1 [symbol] |
| 142 [symbol] | 8 [symbol] | A [symbol] | 0.025 [symbol] | 3895 [symbol] | 205 [symbol] | 100 [symbol] | 53 [symbol] | 0.2220 [symbol] | 603,170 [symbol] | 50,235 [symbol] | 118,356 [symbol] | 321,957 [symbol] | 2.36 [symbol] | 150.8 [symbol] |
| 143 [symbol] | 9 [symbol] | A [symbol] | 0.015 [symbol] | 3899 [symbol] | 201 [symbol] | 70 [symbol] | 51 [symbol] | 0.3773 [symbol] | 1,775,529 [symbol] | 117,874 [symbol] | 310,304 [symbol] | 915,337 [symbol] | 2.63 [symbol] | 160.4 [symbol] |
| 144 [symbol] | 9 [symbol] | A [symbol] | 0.015 [symbol] | 3899 [symbol] | 201 [symbol] | 70 [symbol] | 50 [symbol] | 0.3469 [symbol] | 1,665,120 [symbol] | 124,917 [symbol] | 330,194 [symbol] | 1,050,495 [symbol] | 2.64 [symbol] | 159.7 [symbol] |
| 145 [symbol] | 9 [symbol] | A [symbol] | 0.015 [symbol] | 3899 [symbol] | 201 [symbol] | 70 [symbol] | 60 [symbol] | 0.4035 [symbol] | 1,614,000 [symbol] | 96,278 [symbol] | 345,774 [symbol] | 1,434,803 [symbol] | 3.59 [symbol] | 159.4 [symbol] |
| 146 [symbol] | 9 [symbol] | A [symbol] | 0.025 [symbol] | 3895 [symbol] | 205 [symbol] | 70 [symbol] | 51 [symbol] | 0.4035 [symbol] | 1,139,294 [symbol] | 52,073 [symbol] | 323,282 [symbol] | 1,536,029 [symbol] | 6.21 [symbol] | 158.9 [symbol] |
| 147 [symbol] | 9 [symbol] | A [symbol] | 0.025 [symbol] | 3895 [symbol] | 205 [symbol] | 70 [symbol] | 38 [symbol] | 0.4195 [symbol] | 1,589,684 [symbol] | 30,074 [symbol] | 296,559 [symbol] | 1,362,544 [symbol] | 9.86 [symbol] | 156.8 [symbol] |
| 148 [symbol] | 9 [symbol] | A [symbol] | 0.025 [symbol] | 3895 [symbol] | 205 [symbol] | 70 [symbol] | 35 [symbol] | 0.3982 [symbol] | 1,638,309 [symbol] | 13,956 [symbol] | 230,370 [symbol] | 1,045,408 [symbol] | 16.51 [symbol] | 156.6 [symbol] |
| 149 [symbol] | 9 [symbol] | A [symbol] | 0.015 [symbol] | 3899 [symbol] | 201 [symbol] | 100 [symbol] | 40 [symbol] | 0.2391 [symbol] | 1,434,600 [symbol] | 58,972 [symbol] | 139,520 [symbol] | 443,404 [symbol] | 2.37 [symbol] | 159.7 [symbol] |
| 150 [symbol] | 9 [symbol] | A [symbol] | 0.015 [symbol] | 3899 [symbol] | 201 [symbol] | 100 [symbol] | 31 [symbol] | 0.1557 [symbol] | 1,205,419 [symbol] | 74,814 [symbol] | 150,248 [symbol] | 399,543 [symbol] | 2.01 [symbol] | 159.5 [symbol] |
| 151 [symbol] | 9 [symbol] | A [symbol] | 0.015 [symbol] | 3899 [symbol] | 201 [symbol] | 100 [symbol] | 55 [symbol] | 0.2251 [symbol] | 982,255 [symbol] | 64,509 [symbol] | 147,679 [symbol] | 437,771 [symbol] | 2.29 [symbol] | 159.2 [symbol] |
| 152 [symbol] | 9 [symbol] | A [symbol] | 0.025 [symbol] | 3895 [symbol] | 205 [symbol] | 100 [symbol] | 25 [symbol] | 0.2493 [symbol] | 1,435,968 [symbol] | 38,869 [symbol] | 110,528 [symbol] | 382,210 [symbol] | 2.85 [symbol] | 157.9 [symbol] |
| 153 [symbol] | 9 [symbol] | A [symbol] | 0.025 [symbol] | 3895 [symbol] | 205 [symbol] | 100 [symbol] | 30 [symbol] | 0.2616 [symbol] | 1,255,680 [symbol] | 35,121 [symbol] | 93,168 [symbol] | 297,224 [symbol] | 2.65 [symbol] | 157.6 [symbol] |
| 154 [symbol] | 9 [symbol] | A [symbol] | 0.025 [symbol] | 3895 [symbol] | 205 [symbol] | 100 [symbol] | 22 [symbol] | 0.2682 [symbol] | 1,755,491 [symbol] | 37,020 [symbol] | 112,848 [symbol] | 434,741 [symbol] | 3.05 [symbol] | 156.9 [symbol] |
| 155 [symbol] | 10 [symbol] | A [symbol] | 0.015 [symbol] | 3874 [symbol] | 226 [symbol] | 70 [symbol] | 59 [symbol] | 0.2298 [symbol] | 934,780 [symbol] | 84,383 [symbol] | 132,546 [symbol] | 247,855 [symbol] | 1.57 [symbol] | 160.2 [symbol] |
| 156 [symbol] | 10 [symbol] | A [symbol] | 0.015 [symbol] | 3874 [symbol] | 226 [symbol] | 70 [symbol] | 56 [symbol] | 0.2461 [symbol] | 1,054,714 [symbol] | 71,943 [symbol] | 126,703 [symbol] | 289,153 [symbol] | 1.76 [symbol] | 159.7 [symbol] |
| 157 [symbol] | 10 [symbol] | A [symbol] | 0.025 [symbol] | 3895 [symbol] | 205 [symbol] | 70 [symbol] | 29 [symbol] | 0.3488 [symbol] | 1,731,972 [symbol] | 55,761 [symbol] | 103,795 [symbol] | 241,351 [symbol] | 1.86 [symbol] | 158.7 [symbol] |
| 158 [symbol] | 10 [symbol] | A [symbol] | 0.025 [symbol] | 3895 [symbol] | 205 [symbol] | 70 [symbol] | 29 [symbol] | 0.3259 [symbol] | 1,618,262 [symbol] | 58,998 [symbol] | 105,251 [symbol] | 242,181 [symbol] | 1.78 [symbol] | 157.9 [symbol] |
| 159 [symbol] | 10 [symbol] | A [symbol] | 0.025 [symbol] | 3895 [symbol] | 205 [symbol] | 70 [symbol] | 39 [symbol] | 0.4229 [symbol] | 1,561,477 [symbol] | 55,906 [symbol] | 102,374 [symbol] | 238,789 [symbol] | 1.83 [symbol] | 157.2 [symbol] |
| 160 [symbol] | 10 [symbol] | A [symbol] | 0.015 [symbol] | 3874 [symbol] | 226 [symbol] | 100 [symbol] | 80 [symbol] | 0.1018 [symbol] | 305,400 [symbol] | 51,447 [symbol] | 85,250 [symbol] | 150,973 [symbol] | 1.66 [symbol] | 157.2 [symbol] |
| 161 [symbol] | 10 [symbol] | A [symbol] | 0.015 [symbol] | 3874 [symbol] | 226 [symbol] | 100 [symbol] | 50 [symbol] | 0.1099 [symbol] | 439,600 [symbol] | 49,474 [symbol] | 81,942 [symbol] | 144,672 [symbol] | 1.66 [symbol] | 157.2 [symbol] |
| 162 [symbol] | 10 [symbol] | A [symbol] | 0.015 [symbol] | 3874 [symbol] | 226 [symbol] | 100 [symbol] | 56 [symbol] | 0.1086 [symbol] | 465,429 [symbol] | 50,500 [symbol] | 82,800 [symbol] | 146,533 [symbol] | 1.64 [symbol] | 157.1 [symbol] |
| 163 [symbol] | 10 [symbol] | A [symbol] | 0.025 [symbol] | 3895 [symbol] | 205 [symbol] | 100 [symbol] | 32 [symbol] | 0.2023 [symbol] | 910,350 [symbol] | 33,780 [symbol] | 66,144 [symbol] | 139,537 [symbol] | 1.96 [symbol] | 156.4 [symbol] |
| 164 [symbol] | 10 [symbol] | A [symbol] | 0.025 [symbol] | 3895 [symbol] | 205 [symbol] | 100 [symbol] | 28 [symbol] | 0.2162 [symbol] | 1,111,886 [symbol] | 31,032 [symbol] | 66,306 [symbol] | 163,729 [symbol] | 2.14 [symbol] | 155.9 [symbol] |
| 165 [symbol] | 10 [symbol] | A [symbol] | 0.025 [symbol] | 3895 [symbol] | 205 [symbol] | 100 [symbol] | 27 [symbol] | 0.2096 [symbol] | 1,117,867 [symbol] | 41,870 [symbol] | 71,790 [symbol] | 148,567 [symbol] | 1.71 [symbol] | 155.5 [symbol] |
| 166 [symbol] | 11 [symbol] | A [symbol] | 0.025 [symbol] | 3895 [symbol] | 205 [symbol] | 70 [symbol] | 190 [symbol] | 0.1405 [symbol] | 106,484 [symbol] | 185,619 [symbol] | 328,172 [symbol] | 708,555 [symbol] | 1.77 [symbol] | 162.0 [symbol] |
| 167 [symbol] | 11 [symbol] | A [symbol] | 0.025 [symbol] | 3895 [symbol] | 205 [symbol] | 70 [symbol] | 180 [symbol] | 0.1435 [symbol] | 114,800 [symbol] | 103,168 [symbol] | 294,337 [symbol] | 667,126 [symbol] | 2.85 [symbol] | 161.4 [symbol] |
| 168 [symbol] | 11 [symbol] | A [symbol] | 0.025 [symbol] | 3895 [symbol] | 205 [symbol] | 70 [symbol] | 182 [symbol] | 0.1560 [symbol] | 123,429 [symbol] | 159,195 [symbol] | 279,173 [symbol] | 562,263 [symbol] | 1.75 [symbol] | 161.0 [symbol] |
| 169 [symbol] | 11 [symbol] | A [symbol] | 0.025 [symbol] | 3895 [symbol] | 205 [symbol] | 100 [symbol] | 155 [symbol] | 0.1046 [symbol] | 97,177 [symbol] | 80,933 [symbol] | 139,494 [symbol] | 284,659 [symbol] | 1.72 [symbol] | 161.9 [symbol] |
| 170 [symbol] | 11 [symbol] | A [symbol] | 0.025 [symbol] | 3895 [symbol] | 205 [symbol] | 100 [symbol] | 1258 [symbol] | 0.0672 [symbol] | 7,692 [symbol] | 33,804 [symbol] | 113,848 [symbol] | 267,437 [symbol] | 3.37 [symbol] | 160.6 [symbol] |
| 171 [symbol] | 11 [symbol] | A [symbol] | 0.025 [symbol] | 3895 [symbol] | 205 [symbol] | 100 [symbol] | 141 [symbol] | 0.1137 [symbol] | 116,119 [symbol] | 63,852 [symbol] | 125,563 [symbol] | 255,692 [symbol] | 1.97 [symbol] | 159.8 [symbol] |
| 172 [symbol] | 12 [symbol] | A [symbol] | 0.015 [symbol] | 3874 [symbol] | 226 [symbol] | 70 [symbol] | 44 [symbol] | 0.2789 [symbol] | 1,521,273 [symbol] | 146,270 [symbol] | 290,344 [symbol] | 703,139 [symbol] | 1.98 [symbol] | 158.9 [symbol] |
| 173 [symbol] | 12 [symbol] | A [symbol] | 0.015 [symbol] | 3874 [symbol] | 226 [symbol] | 70 [symbol] | 38 [symbol] | 0.2896 [symbol] | 1,829,053 [symbol] | 139,309 [symbol] | 282,465 [symbol] | 778,339 [symbol] | 2.03 [symbol] | 158.1 [symbol] |
| 174 [symbol] | 12 [symbol] | A [symbol] | 0.015 [symbol] | 3874 [symbol] | 226 [symbol] | 70 [symbol] | 41 [symbol] | 0.3211 [symbol] | 1,879,510 [symbol] | 115,357 [symbol] | 249,864 [symbol] | 664,624 [symbol] | 2.17 [symbol] | 157.6 [symbol] |
| 175 [symbol] | 12 [symbol] | A [symbol] | 0.025 [symbol] | 3895 [symbol] | 205 [symbol] | 70 [symbol] | 27 [symbol] | 0.3953 [symbol] | 2,108,267 [symbol] | 42,002 [symbol] | 194,664 [symbol] | 647,170 [symbol] | 4.63 [symbol] | 156.9 [symbol] |
| 176 [symbol] | 12 [symbol] | A [symbol] | 0.025 [symbol] | 3895 [symbol] | 205 [symbol] | 70 [symbol] | 28 [symbol] | 0.3839 [symbol] | 2,025,771 [symbol] | 45,776 [symbol] | 211,847 [symbol] | 756,521 [symbol] | 4.63 [symbol] | 156.2 [symbol] |
| 177 [symbol] | 12 [symbol] | A [symbol] | 0.025 [symbol] | 3895 [symbol] | 205 [symbol] | 70 [symbol] | 27 [symbol] | 0.3731 [symbol] | 1,989,867 [symbol] | 45,677 [symbol] | 224,458 [symbol] | 934,294 [symbol] | 4.91 [symbol] | 155.5 [symbol] |
| 178 [symbol] | 12 [symbol] | A [symbol] | 0.015 [symbol] | 3874 [symbol] | 226 [symbol] | 100 [symbol] | 44 [symbol] | 0.1443 [symbol] | 787,091 [symbol] | 89,441 [symbol] | 166,845 [symbol] | 523,735 [symbol] | 1.87 [symbol] | 157.6 [symbol] |
| 179 [symbol] | 12 [symbol] | A [symbol] | 0.015 [symbol] | 3874 [symbol] | 226 [symbol] | 100 [symbol] | 37 [symbol] | 0.1451 [symbol] | 941,189 [symbol] | 90,435 [symbol] | 152,608 [symbol] | 349,816 [symbol] | 1.69 [symbol] | 157.3 [symbol] |
| 180 [symbol] | 12 [symbol] | A [symbol] | 0.015 [symbol] | 3874 [symbol] | 226 [symbol] | 100 [symbol] | 38 [symbol] | 0.1515 [symbol] | 956,842 [symbol] | 58,429 [symbol] | 144,936 [symbol] | 423,058 [symbol] | 2.48 [symbol] | 157.1 [symbol] |
| 181 [symbol] | 12 [symbol] | A [symbol] | 0.025 [symbol] | 3895 [symbol] | 205 [symbol] | 100 [symbol] | 20 [symbol] | 0.2352 [symbol] | 1,693,440 [symbol] | 37,414 [symbol] | 105,899 [symbol] | 296,643 [symbol] | 2.83 [symbol] | 156.0 [symbol] |
| 182 [symbol] | 12 [symbol] | A [symbol] | 0.025 [symbol] | 3895 [symbol] | 205 [symbol] | 100 [symbol] | 22 [symbol] | 0.2175 [symbol] | 1,423,536 [symbol] | 33,047 [symbol] | 108,680 [symbol] | 322,118 [symbol] | 3.29 [symbol] | 156.0 [symbol] |
| 183 [symbol] | 12 [symbol] | A [symbol] | 0.025 [symbol] | 3895 [symbol] | 205 [symbol] | 100 [symbol] | 16 [symbol] | 0.2159 [symbol] | 1,943,100 [symbol] | 35,788 [symbol] | 110,117 [symbol] | 341,042 [symbol] | 3.08 [symbol] | 155.9 [symbol] |
| 184 [symbol] | 13 [symbol] | A [symbol] | 0 015 [symbol] | 3874 [symbol] | 226 [symbol] | 70 [symbol] | 16 [symbol] | 0.3878 [symbol] | 5,817,000 [symbol] | 49,236 [symbol] | 151,383 [symbol] | 648,392 [symbol] | 3.28 [symbol] | 145.5 [symbol] |
| 185 [symbol] | 13 [symbol] | A [symbol] | 0.015 [symbol] | 3874 [symbol] | 226 [symbol] | 70 [symbol] | 20 [symbol] | 0.4131 [symbol] | 4,957,200 [symbol] | 45,927 [symbol] | 159,308 [symbol] | 617,869 [symbol] | 3.47 [symbol] | 145.5 [symbol] |
| 186 [symbol] | 13 [symbol] | A [symbol] | 0.015 [symbol] | 3874 [symbol] | 226 [symbol] | 70 [symbol] | 17 [symbol] | 0.4334 [symbol] | 6,118,58 [symbol] | 40,362 [symbol] | 150,799 [symbol] | 619,430 [symbol] | 3.74 [symbol] | 145.3 [symbol] |
| 187 [symbol] | 13 [symbol] | A [symbol] | 0.025 [symbol] | 3895 [symbol] | 235 [symbol] | 70 [symbol] | 17 [symbol] | 0.3988 [symbol] | 3,378,071 [symbol] | 38,456 [symbol] | 153,387 [symbol] | 539,355 [symbol] | 3.99 [symbol] | 145.8 [symbol] |
| 188 [symbol] | 13 [symbol] | A [symbol] | 0.025 [symbol] | 3895 [symbol] | 205 [symbol] | 70 [symbol] | 14 [symbol] | 0.4163 [symbol] | 4,281,943 [symbol] | 23,991 [symbol] | 134,186 [symbol] | 502,688 [symbol] | 5.59 [symbol] | 144.5 [symbol] |
| 189 [symbol] | 13 [symbol] | A [symbol] | 0.025 [symbol] | 3895 [symbol] | 205 [symbol] | 70 [symbol] | 13 [symbol] | 0.4107 [symbol] | 4,549,292 [symbol] | 22,317 [symbol] | 127,256 [symbol] | 444,171 [symbol] | 5.70 [symbol] | 144.1 [symbol] |
| 190 [symbol] | 13 [symbol] | A [symbol] | 0.015 [symbol] | 3874 [symbol] | 226 [symbol] | 100 [symbol] | 20 [symbol] | 0.2807 [symbol] | 3,368,400 [symbol] | 35,649 [symbol] | 82,850 [symbol] | 252,359 [symbol] | 2.32 [symbol] | 144.0 [symbol] |
| 191 [symbol] | 13 [symbol] | A [symbol] | 0.015 [symbol] | 3874 [symbol] | 226 [symbol] | 100 [symbol] | 19 [symbol] | 0.2893 [symbol] | 3,654,316 [symbol] | 34,679 [symbol] | 77,908 [symbol] | 205,082 [symbol] | 2.25 [symbol] | 143.5 [symbol] |
| 192 [symbol] | 13 [symbol] | A [symbol] | 0.015 [symbol] | 3874 [symbol] | 226 [symbol] | 100 [symbol] | 17 [symbol] | 0.2765 [symbol] | 3,903,529 [symbol] | 31,341 [symbol] | 70,550 [symbol] | 160,080 [symbol] | 2.25 [symbol] | 143.5 [symbol] |
| 193 [symbol] | 13 [symbol] | A [symbol] | 0.025 [symbol] | 3895 [symbol] | 205 [symbol] | 100 [symbol] | 27 [symbol] | 0.2479 [symbol] | 1,322,133 [symbol] | 36,394 [symbol] | 97,389 [symbol] | 256,208 [symbol] | 2.68 [symbol] | 144.7 [symbol] |
| 194 [symbol] | 13 [symbol] | A [symbol] | 0.025 [symbol] | 3895 [symbol] | 205 [symbol] | 100 [symbol] | 12 [symbol] | 0.3057 [symbol] | 3,668,400 [symbol] | 18,468 [symbol] | 65,201 [symbol] | 220,490 [symbol] | 3.96 [symbol] | 142.8 [symbol] |
| 195 [symbol] | 13 [symbol] | A [symbol] | 0.025 [symbol] | 3895 [symbol] | 205 [symbol] | 100 [symbol] | 12 [symbol] | 0.3158 [symbol] | 3,789,600 [symbol] | 14,516 [symbol] | 61,810 [symbol] | 236,516 [symbol] | 4.26 [symbol] | 142.2 [symbol] |
| 196 [symbol] | 14 [symbol] | A [symbol] | 0.015 [symbol] | 3874 [symbol] | 226 [symbol] | 70 [symbol] | 129 [symbol] | 0.1976 [symbol] | 367,628 [symbol] | 135,871 [symbol] | 278,711 [symbol] | 597,323 [symbol] | 2.05 [symbol] | 161.6 [symbol] |
| 197 [symbol] | 14 [symbol] | A [symbol] | 0.015 [symbol] | 3874 [symbol] | 226 [symbol] | 70 [symbol] | 129 [symbol] | 0.1889 [symbol] | 351,442 [symbol] | 167,562 [symbol] | 276,114 [symbol] | 554,940 [symbol] | 1.65 [symbol] | 161.4 [symbol] |
| 198 [symbol] | 14 [symbol] | A [symbol] | 0.015 [symbol] | 3874 [symbol] | 226 [symbol] | 70 [symbol] | 127 [symbol] | 0.2059 [symbol] | 389,102 [symbol] | 180,217 [symbol] | 294,473 [symbol] | 612,269 [symbol] | 1.63 [symbol] | 160.6 [symbol] |
| 199 [symbol] | 14 [symbol] | A [symbol] | 0.025 [symbol] | 3895 [symbol] | 205 [symbol] | 70 [symbol] | 93 [symbol] | 0.2268 [symbol] | 351,174 [symbol] | 145,962 [symbol] | 275,670 [symbol] | 647,259 [symbol] | 1.89 [symbol] | 162.5 [symbol] |
| 200 [symbol] | 14 [symbol] | A [symbol] | 0.025 [symbol] | 3895 [symbol] | 205 [symbol] | 70 [symbol] | 111 [symbol] | 0.2282 [symbol] | 296,043 [symbol] | 162,443 [symbol] | 317,515 [symbol] | 721,467 [symbol] | 1.74 [symbol] | 161.5 [symbol] |
| 201 [symbol] | 14 [symbol] | A [symbol] | 0.025 [symbol] | 3895 [symbol] | 205 [symbol] | 70 [symbol] | 92 [symbol] | 0.2242 [symbol] | 350,922 [symbol] | 171,325 [symbol] | 296,987 [symbol] | 616,445 [symbol] | 1.73 [symbol] | 161.1 [symbol] |
| 202 [symbol] | 14 [symbol] | A [symbol] | 0.015 [symbol] | 3874 [symbol] | 226 [symbol] | 100 [symbol] | 114 [symbol] | 0.1465 [symbol] | 308,421 [symbol] | 76,807 [symbol] | 129,124 [symbol] | 232,401 [symbol] | 1.68 [symbol] | 160.5 [symbol] |
| 203 [symbol] | 14 [symbol] | A [symbol] | 0.015 [symbol] | 3874 [symbol] | 226 [symbol] | 100 [symbol] | 113 [symbol] | 0.1296 [symbol] | 275,257 [symbol] | 94,439 [symbol] | 144,461 [symbol] | 254,721 [symbol] | 1.53 [symbol] | 160.3 [symbol] |
| 204 [symbol] | 14 [symbol] | A [symbol] | 0.015 [symbol] | 3874 [symbol] | 226 [symbol] | 100 [symbol] | 116 [symbol] | 0.1415 [symbol] | 292,759 [symbol] | 76,166 [symbol] | 132,161 [symbol] | 241,002 [symbol] | 1.74 [symbol] | 160.2 [symbol] |
| 205 [symbol] | 14 [symbol] | A [symbol] | 0.025 [symbol] | 3895 [symbol] | 205 [symbol] | 100 [symbol] | 94 [symbol] | 0.1598 [symbol] | 244,800 [symbol] | 70,536 [symbol] | 122,926 [symbol] | 268,329 [symbol] | 1.74 [symbol] | 160.1 [symbol] |
| 206 [symbol] | 14 [symbol] | A [symbol] | 0.025 [symbol] | 3895 [symbol] | 205 [symbol] | 100 [symbol] | 85 [symbol] | 0.1691 [symbol] | 286,475 [symbol] | 71,117 [symbol] | 121,627 [symbol] | 247,730 [symbol] | 1.71 [symbol] | 160.0 [symbol] |
| 207 [symbol] | 14 [symbol] | A [symbol] | 0.025 [symbol] | 3895 [symbol] | 205 [symbol] | 100 [symbol] | 77 [symbol] | 0.1699 [symbol] | 317,735 [symbol] | 70,244 [symbol] | 121,260 [symbol] | 273,876 [symbol] | 1.73 [symbol] | 159.0 [symbol] |
| 208 [symbol] | 15 [symbol] | A [symbol] | 0.015 [symbol] | 3874 [symbol] | 226 [symbol] | 70 [symbol] | 74 [symbol] | 0.3575 [symbol] | 1,159,459 [symbol] | 119,886 [symbol] | 290,039 [symbol] | 942,218 [symbol] | 2.42 [symbol] | 161.6 [symbol] |
| 209 [symbol] | 15 [symbol] | A [symbol] | 0.015 [symbol] | 3874 [symbol] | 226 [symbol] | 70 [symbol] | 77 [symbol] | 0.3860 [symbol] | 1,203,117 [symbol] | 107,158 [symbol] | 320,828 [symbol] | 1,122,488 [symbol] | 2.99 [symbol] | 161.6 [symbol] |
| 210 [symbol] | 15 [symbol] | A [symbol] | 0.015 [symbol] | 3874 [symbol] | 226 [symbol] | 70 [symbol] | 77 [symbol] | 0.3735 [symbol] | 1,164,156 [symbol] | 110,748 [symbol] | 310,245 [symbol] | 984,005 [symbol] | 2.80 [symbol] | 160.8 [symbol] |
| 211 | 15 | A | 0.025 | 3895 | 205 | 70 | 47 | 0.3817 | 1,169,464 | 51,310 | 267,244 | 989,989 | 5.21 | 159.9 |
| 212 | 15 | A | 0.025 | 3895 | 205 | 70 | 48 | 0.4079 | 1,223,700 | 50,171 | 292,892 | 1,186,319 | 5.84 | 159.6 |
| 213 | 15 | A | 0.025 | 3895 | 205 | 70 | 54 | 0.3908 | 1,042,133 | 56,452 | 331,496 | 1,598,621 | 5.87 | 159.4 |
| 214 | 15 | A | 0.015 | 3874 | 226 | 100 | 56 | 0.2208 | 946,286 | 62,463 | 118,588 | 253,690 | 1.90 | 161.3 |
| 215 | 15 | A | 0.015 | 3874 | 226 | 100 | 43 | 0.2332 | 1,301,581 | 59,080 | 111,122 | 235,729 | 1.88 | 160.9 |
| 216 | 15 | A | 0.015 | 3874 | 226 | 100 | 45 | 0.2523 | 1,345,600 | 48,008 | 115,829 | 402,984 | 2.41 | 160.5 |
| 217 | 15 | A | 0.025 | 3895 | 205 | 100 | 129 | 0.1431 | 159,740 | 76,634 | 178,963 | 421,736 | 2.34 | 160.8 |
| 218 | 15 | A | 0.025 | 3895 | 205 | 100 | 27 | 0.2643 | 1,409,600 | 26,000 | 94,589 | 343,952 | 3.64 | 159.4 |
| 219 | 15 | A | 0.025 | 3895 | 205 | 100 | 36 | 0.2671 | 1,068,400 | 40,468 | 100,265 | 331,014 | 2.48 | 159.2 |
| 220 | 16 | A | 0.015 | 3874 | 226 | 70 | 168 | 0.1514 | 216,286 | 211,948 | 353,711 | 695,936 | 1.67 | 162.4 |
| 221 | 16 | A | 0.015 | 3874 | 226 | 70 | 166 | 0.1620 | 234,217 | 220,371 | 363,530 | 706,255 | 1.65 | 162.1 |
| 222 | 16 | A | 0.015 | 3874 | 226 | 70 | 174 | 0.1427 | 196,828 | 232,443 | 383,689 | 752,363 | 1.65 | 161.4 |
| 223 | 16 | A | 0.025 | 3895 | 205 | 70 | 131 | 0.1787 | 196,434 | 179,724 | 303,763 | 613,969 | 1.69 | 162.5 |
| 224 | 16 | A | 0.025 | 3895 | 205 | 70 | 120 | 0.2056 | 246,720 | 173,961 | 316,662 | 720,440 | 1.82 | 162.2 |
| 225 | 16 | A | 0.025 | 3895 | 205 | 70 | 128 | 0.2305 | 259,425 | 181,492 | 312,028 | 659,414 | 1.72 | 161.6 |
| 226 | 16 | A | 0.015 | 3874 | 226 | 100 | 1801 | 0.0370 | 4,931 | 112,191 | 186,280 | 378,163 | 1.66 | 162.5 |
| 227 | 16 | A | 0.015 | 3874 | 226 | 100 | 1801 | 0.0147 | 1,959 | 113,776 | 188,756 | 372,742 | 1.66 | 161.1 |
| 228 | 16 | A | 0.015 | 3874 | 226 | 100 | 226 | 0.0744 | 79,009 | 100,327 | 170,565 | 343,646 | 1.70 | 160.9 |
| 229 | 16 | A | 0.025 | 3895 | 205 | 100 | 183 | 0.0859 | 67,593 | 88,904 | 143,365 | 270,561 | 1.61 | 161.0 |
| 230 | 16 | A | 0.025 | 3895 | 205 | 100 | 103 | 0.1348 | 188,458 | 77,457 | 127,688 | 245,796 | 1.65 | 160.5 |
| 231 | 16 | A | 0.025 | 3895 | 205 | 100 | 122 | 0.1210 | 142,820 | 81,642 | 135,052 | 257,052 | 1.65 | 160.2 |
| 232 | 17 | A | 0.015 | 3874 | 226 | 70 | 1800 | 0.0075 | 1,000 | | | | | |
| 233 | 17 | A | 0.015 | 3874 | 226 | 70 | 1802 | 0.0078 | 1,039 | | | | | |
| 234 | 17 | A | 0.015 | 3874 | 225 | 70 | 1801 | 0.0056 | 746 | | | | | |
| 235 | 17 | A | 0.025 | 3895 | 205 | 70 | 1800 | 0.0154 | 1,232 | 109,727 | 172,348 | 344,763 | 1.57 | 161.7 |
| 236 | 17 | A | 0.025 | 3895 | 205 | 70 | 1801 | 0.0147 | 1,175 | 96,648 | 154,141 | 288,452 | 1.59 | 161.4 |
| 237 | 17 | A | 0.025 | 3895 | 205 | 70 | 1801 | 0.0142 | 1,135 | 62,583 | 100,850 | 198,403 | 1.61 | 160.5 |
| 238 | 17 | A | 0.015 | 3874 | 226 | 100 | 1800 | 0.0002 | 27 | | | | | |
| 239 | 17 | A | 0.015 | 3874 | 226 | 100 | 1801 | −0.0006 | −80 | | | | | |
| 240 | 17 | A | 0.015 | 3874 | 226 | 100 | 1801 | 0.0010 | 133 | | | | | |
| 241 | 17 | A | 0.025 | 3895 | 205 | 100 | 1801 | 0.0272 | 2,175 | 42,811 | 71,127 | 139,719 | 1.66 | 156.9 |
| 242 | 17 | A | 0.025 | 3895 | 205 | 100 | 1802 | 0.0221 | 1,766 | 39,718 | 68,569 | 146,013 | 1.73 | 156.7 |
| 243 | 17 | A | 0.025 | 3895 | 205 | 100 | 1800 | 0.0238 | 1,904 | 36,219 | 65,197 | 134,551 | 1.80 | 156.0 |
| 244 | 18 | A | 0.015 | 3874 | 226 | 70 | 1801 | 0.0289 | 3,851 | 94,741 | 157,074 | 318,366 | 1.66 | 161.7 |
| 245 | 18 | A | 0.015 | 3874 | 226 | 70 | 1800 | 0.0277 | 3,693 | 89,484 | 141,777 | 275,634 | 1.58 | 160.7 |
| 245 | 18 | A | 0.015 | 3874 | 226 | 70 | 1800 | 0.0194 | 2,587 | 104,985 | 168,698 | 355,199 | 1.61 | 160.4 |
| 247 | 18 | A | 0.025 | 3895 | 205 | 70 | 1801 | 0.0458 | 3,662 | 101,664 | 161,824 | 308,669 | 1.59 | 160.5 |
| 248 | 18 | A | 0.025 | 3895 | 205 | 70 | 1801 | 0.0389 | 3,110 | 72,866 | 122,210 | 239,343 | 1.68 | 160.4 |
| 249 | 13 | A | 0.025 | 3895 | 205 | 70 | 1802 | 0.0505 | 4,036 | 85,819 | 145,585 | 284,728 | 1.70 | 159.9 |
| 250 | 18 | A | 0.015 | 3874 | 226 | 100 | 1801 | 0.0002 | 27 | | | | | |
| 251 | 18 | A | 0.015 | 3874 | 226 | 100 | 1800 | −0.0006 | −80 | | | | | |
| 252 | 18 | A | 0.015 | 3874 | 226 | 100 | 1801 | −0.0006 | −80 | | | | | |
| 253 | 18 | A | 0.025 | 3895 | 205 | 100 | 1466 | 0.0555 | 5,452 | 50,863 | 79,492 | 159,373 | 1.56 | 157.0 |
| 254 | 18 | A | 0.025 | 3895 | 205 | 100 | 1801 | 0.0467 | 3,734 | 47,598 | 76,559 | 147,217 | 1.61 | 156.9 |
| 255 | 18 | A | 0.025 | 3895 | 205 | 100 | 1802 | 0.0298 | 2,381 | 45,554 | 74,549 | 146,381 | 1.64 | 155.5 |
| 256 | 19 | A | 0.015 | 3874 | 226 | 50 | 277 | 0.1462 | 126,671 | 606,451 | 962,850 | 1,807,015 | 1.59 | 165.4 |
| 257 | 19 | A | 0.020 | 3832 | 268 | 50 | 228 | 0.1372 | 108,315 | 480,870 | 859,208 | 1,824,424 | 1.79 | 166.1 |
| 258 | 19 | A | 0.015 | 3874 | 226 | 60 | 358 | 0.0915 | 61,341 | 504,203 | 738,710 | 1,326,316 | 1.47 | 164.8 |
| 259 | 19 | A | 0.020 | 3832 | 268 | 60 | 209 | 0.1576 | 135,732 | 394,004 | 653,605 | 1,246,132 | 1.66 | 165.7 |
| 260 | 19 | A | 0.015 | 3874 | 226 | 70 | 197 | 0.1291 | 157,279 | 389,178 | 534,771 | 895,536 | 1.37 | 164.9 |
| 261 | 19 | A | 0.015 | 3874 | 226 | 70 | 222 | 0.1112 | 120,216 | 412,937 | 682,452 | 1,379,085 | 1.65 | 164.1 |
| 262 | 19 | A | 0.015 | 3874 | 226 | 70 | 213 | 0.1351 | 152,225 | 366,407 | 556,215 | 1,064,994 | 1.52 | 163.5 |
| 263 | 19 | A | 0.015 | 3874 | 226 | 70 | 219 | 0.1268 | 138,959 | 313,864 | 504,232 | 930,019 | 1.61 | 163.5 |
| 264 | 19 | A | 0.020 | 3832 | 268 | 70 | 157 | 0.1599 | 183,325 | 343,357 | 545,008 | 1,066,069 | 1.59 | 164.9 |
| 265 | 19 | A | 0.015 | 3874 | 226 | 100 | 1801 | 0.0628 | 8,369 | | | | | 162.9 |
| 266 | 19 | A | 0.015 | 3874 | 226 | 100 | 1800 | 0.0579 | 7,720 | 173,584 | 279,481 | 550,649 | 1.61 | 161.9 |
| 267 | 19 | A | 0.015 | 3874 | 226 | 100 | 1800 | 0.0598 | 7,973 | 134,805 | 220,588 | 404,685 | 1.64 | 160.9 |
| 268 | 19 | A | 0.015 | 3874 | 226 | 100 | 1354 | 0.0503 | 10,688 | 154,903 | 254,230 | 538,930 | 1.64 | 160.1 |
| 269 | 19 | A | 0.020 | 3832 | 268 | 100 | 219 | 0.0809 | 66,493 | 165,493 | 287,548 | 707,080 | 1.74 | 163.1 |
| 270 | 19 | A | 0.015 | 3874 | 226 | 110 | 224 | 0.0750 | 80,357 | 133,188 | 228,204 | 475,556 | 1.71 | 160.2 |
| 271 | 19 | A | 0.020 | 3832 | 268 | 110 | 218 | 0.0806 | 66,550 | 97,080 | 165,474 | 332,197 | 1.70 | 159.9 |
| 272 | 19 | A | 0.015 | 3874 | 226 | 115 | 184 | 0.0670 | 97,391 | 108,550 | 170,979 | 338,263 | 1.58 | 159.9 |
| 273 | 19 | A | 0.020 | 3832 | 268 | 115 | 225 | 0.0894 | 71,520 | 105,431 | 158,882 | 291,198 | 1.51 | 160.5 |
| 274 | 20 | A | 0.015 | 3874 | 226 | 70 | 51 | 0.2961 | 1,393,412 | 91,504 | 180,050 | 482,488 | 1.97 | 156.8 |
| 275 | 20 | A | 0.015 | 3874 | 226 | 70 | 59 | 0.2944 | 1,197,559 | 111,683 | 224,774 | 579,509 | 2.01 | 155.9 |
| 276 | 20 | A | 0.015 | 3874 | 226 | 70 | 57 | 0.3251 | 1,368,842 | 106,054 | 191,739 | 441,346 | 1.81 | 155.7 |
| 277 | 20 | A | 0.015 | 3874 | 226 | 100 | 76 | 0.1811 | 571,895 | 46,262 | 85,694 | 200,460 | 1.85 | 153.9 |
| 278 | 20 | A | 0.015 | 3874 | 226 | 100 | 49 | 0.2147 | 1,051,592 | 38,212 | 64,507 | 151,954 | 1.69 | 153.6 |
| 279 | 20 | A | 0.015 | 3874 | 226 | 100 | 45 | 0.2041 | 1,088,533 | 36,396 | 69,386 | 173,368 | 1.91 | 153.4 |
| 280 | 21 | A | 0.015 | 3874 | 226 | 70 | 89 | 0.2498 | 673,618 | 290,087 | 522,788 | 1,256,300 | 1.80 | 160.5 |
| 281 | 21 | A | 0.015 | 3874 | 226 | 70 | 103 | 0.2777 | 647,068 | 265,095 | 467,578 | 1,005,189 | 1.76 | 160.1 |
| 282 | 21 | A | 0.015 | 3874 | 226 | 70 | 123 | 0.2502 | 488,195 | 254,920 | 520,019 | 1,153,915 | 2.04 | 160.1 |
| 283 | 21 | A | 0.015 | 3874 | 226 | 100 | 77 | 0.1493 | 465,351 | 116,895 | 213,507 | 455,527 | 1.83 | 159.6 |
| 284 | 21 | A | 0.015 | 3874 | 226 | 100 | 75 | 0.1306 | 417,920 | 129,205 | 229,975 | 512,124 | 1.78 | 159.1 |
| 285 | 21 | A | 0.015 | 3874 | 226 | 100 | 63 | 0.1537 | 585,524 | 143,333 | 252,722 | 564,805 | 1.76 | 158.9 |
| 286 | 23 | A | 0.015 | 3874 | 226 | 50 | 168 | 0.2134 | 304,857 | 337,494 | 518,394 | 912,721 | 1.54 | 164.8 |
| 287 | 23 | A | 0.020 | 3832 | 268 | 50 | 145 | 0.3337 | 414,248 | 324,526 | 494,489 | 883,505 | 1.52 | 164.1 |
| 288 | 23 | A | 0.015 | 3874 | 226 | 60 | 121 | 0.2309 | 457,983 | 275,114 | 428,037 | 800,354 | 1.56 | 163.9 |
| 289 | 23 | A | 0.020 | 3832 | 268 | 60 | 106 | 0.3051 | 518,094 | 227,610 | 377,059 | 731,405 | 1.66 | 163.2 |
| 290 | 23 | A | 0.015 | 3874 | 226 | 70 | 131 | 0.1550 | 283,969 | 236,065 | 379,539 | 787,141 | 1.61 | 163.3 |
| 291 | 23 | A | 0.015 | 3874 | 226 | 70 | 104 | 0.1861 | 429,462 | 241,281 | 369,976 | 707,824 | 1.53 | 162.6 |
| 292 | 23 | A | 0.015 | 3874 | 226 | 70 | 102 | 0.2184 | 513,882 | 193,764 | 349,127 | 715,200 | 1.80 | 162.4 |
| 293 | 23 | A | 0.015 | 3874 | 226 | 70 | 112 | 0.1871 | 400,929 | 213,875 | 345,238 | 656,339 | 1.61 | 162.2 |
| 294 | 23 | A | 0.020 | 3832 | 268 | 70 | 74 | 0.2126 | 517,135 | 211,641 | 324,925 | 594,111 | 1.54 | 163.2 |
| 295 | 23 | A | 0.025 | 3895 | 205 | 70 | 79 | 0.2886 | 526,056 | 188,096 | 314,208 | 645,088 | 1.67 | 162.0 |
| 296 | 23 | A | 0.025 | 3895 | 205 | 70 | 80 | 0.2997 | 539,460 | 69,284 | 302,072 | 699,279 | 4.36 | 160.6 |
| 297 | 23 | A | 0.025 | 3895 | 205 | 70 | 82 | 0.3203 | 562,478 | 180,646 | 327,583 | 740,348 | 1.81 | 160.3 |
| 298 | 23 | A | 0.015 | 3874 | 226 | 100 | 1801 | 0.0566 | 7,542 | 90,558 | 160,712 | 432,645 | 1.77 | 161.2 |
| 299 | 23 | A | 0.015 | 3874 | 226 | 100 | 148 | 0.0833 | 135,081 | 74,952 | 145,111 | 280,595 | 1.94 | 161.1 |
| 300 | 23 | A | 0.015 | 3874 | 226 | 100 | 1105 | 0.0769 | 16,702 | 101,096 | 155,958 | 324,701 | 1.64 | 160.9 |
| 301 | 23 | A | 0.015 | 3874 | 226 | 100 | 704 | 0.0805 | 27,443 | 118,048 | 180,668 | 336,268 | 1.53 | 160.7 |
| 302 | 23 | A | 0.020 | 3832 | 268 | 100 | 84 | 0.1119 | 239,786 | 96,678 | 151,524 | 281,712 | 1.57 | 161.6 |
| 303 | 23 | A | 0.025 | 3895 | 205 | 100 | 75 | 0.1600 | 307,200 | 64,220 | 141,167 | 355,711 | 2.20 | 160.1 |
| 304 | 23 | A | 0.025 | 3895 | 205 | 100 | 68 | 0.1736 | 367,624 | 78,118 | 147,424 | 325,451 | 1.89 | 160.1 |
| 305 | 23 | A | 0.025 | 3895 | 205 | 100 | 60 | 0.1802 | 432,480 | 45,329 | 132,969 | 292,492 | 2.93 | 158.8 |
| 306 | 23 | A | 0.015 | 3874 | 226 | 110 | 1800 | 0.0700 | 9,333 | 70,979 | 114,730 | 209,637 | 1.62 | 159.9 |
| 307 | 23 | A | 0.020 | 3832 | 268 | 110 | 139 | 0.0774 | 100,230 | 53,974 | 89,649 | 175,927 | 1.65 | 158.6 |
| 308 | 23 | A | 0.015 | 3874 | 226 | 115 | 1801 | 0.0406 | 5,410 | 54,791 | 89,068 | 176,609 | 1.63 | 157.8 |
| 309 | 23 | A | 0.020 | 3832 | 268 | 115 | 392 | 0.0746 | 34,255 | 53,096 | 76,753 | 139,547 | 1.45 | 156.9 |
| 310 | 24 | A | 0.015 | 3874 | 226 | 70 | 54 | 0.2594 | 1,152,889 | 122,299 | 265,834 | 538,521 | 2.17 | 155.6 |
| 311 | 24 | A | 0.015 | 3874 | 226 | 70 | 68 | 0.2214 | 781,412 | 225,712 | 382,889 | 790,054 | 1.70 | 155.3 |
| 312 | 24 | A | 0.015 | 3874 | 226 | 70 | 40 | 0.3031 | 1,818,600 | 143,976 | 283,789 | 696,323 | 1.97 | 154.3 |
| 313 | 24 | A | 0.025 | 3790 | 310 | 70 | 37 | 0.3414 | 1,328,692 | 76,664 | 209,265 | 685,408 | 2.73 | 154.1 |
| 314 | 24 | A | 0.025 | 3790 | 310 | 70 | 22 | 0.3565 | 2,333,455 | 37,846 | 189,474 | 704,394 | 5.01 | 153.8 |
| 315 | 24 | A | 0.025 | 3790 | 310 | 70 | 25 | 0.3207 | 1,847,232 | 92,568 | 237,070 | 742,756 | 2.56 | 153.5 |
| 316 | 24 | A | 0.015 | 3874 | 226 | 100 | 1801 | 0.0593 | 9,235 | 109,183 | 183,055 | 379,218 | 1.68 | 154.3 |
| 317 | 24 | A | 0.015 | 3874 | 226 | 100 | 37 | 0.1880 | 1,219,459 | 42,141 | 93,868 | 242,159 | 2.23 | 152.8 |
| 318 | 24 | A | 0.015 | 3874 | 226 | 100 | 1801 | 0.0287 | 3,825 | 57,058 | 162,395 | 391,985 | 2.85 | 152.3 |
| 319 | 24 | A | 0.025 | 3790 | 310 | 100 | 49 | 0.1762 | 517,812 | 68,434 | 127,635 | 301,381 | 1.87 | 153.3 |
| 320 | 24 | A | 0.025 | 3790 | 310 | 100 | 38 | 0.1887 | 715,074 | 46,028 | 102,123 | 258,196 | 2.22 | 153.0 |
| 321 | 24 | A | 0.025 | 3790 | 310 | 100 | 27 | 0.2579 | 1,375,467 | 31,172 | 85,995 | 259,584 | 2.76 | 150.6 |
| 322 | 25 | A | 0.015 | 3874 | 226 | 50 | 1801 | 0.0519 | 5,916 | 546,225 | 876,921 | 1,664,221 | 1.61 | 165.9 |
| 323 | 25 | A | 0.020 | 3832 | 268 | 50 | 426 | 0.0838 | 35,408 | 525,088 | 896,464 | 1,810,902 | 1.71 | 166.4 |
| 324 | 25 | A | 0.015 | 3874 | 226 | 60 | 1801 | 0.0679 | 9,048 | 461,036 | 773,389 | 1,525,688 | 1.68 | 165.1 |
| 325 | 25 | A | 0.020 | 3832 | 268 | 60 | 228 | 0.1153 | 91,026 | 523,967 | 814,072 | 1,526,165 | 1.55 | 164.6 |
| 326 | 25 | A | 0.015 | 3874 | 226 | 70 | 1801 | 0.0495 | 6,596 | 473,707 | 664,232 | 1,140,439 | 1.40 | 167.2 |
| 327 | 25 | A | 0.015 | 3874 | 226 | 70 | 235 | 0.0785 | 80,170 | 385,841 | 734,499 | 1,975,384 | 1.90 | 165.7 |
| 328 | 25 | A | 0.015 | 3874 | 226 | 70 | 1803 | 0.0582 | 7,747 | 481,757 | 696,025 | 1,266,140 | 1.44 | 165.4 |
| 329 | 25 | A | 0.015 | 3874 | 226 | 70 | 1800 | 0.0526 | 7,013 | 359,476 | 628,998 | 1,229,198 | 1.75 | 164.5 |
| 330 | 25 | A | 0.020 | 3832 | 268 | 70 | 172 | 0.1027 | 107,477 | 433,344 | 703,524 | 1,351,140 | 1.62 | 166.3 |
| 331 | 25 | A | 0.015 | 3874 | 226 | 100 | 1801 | 0.0171 | 2,279 | 190,283 | 316,542 | 631,651 | 1.66 | 163.7 |
| 332 | 25 | A | 0.015 | 3874 | 226 | 100 | 1801 | 0.0246 | 3,278 | 208,678 | 335,760 | 633,282 | 1.61 | 163.3 |
| 333 | 25 | A | 0.015 | 3874 | 226 | 100 | 1801 | 0.0181 | 2,412 | 220,076 | 331,240 | 609,615 | 1.51 | 162.6 |
| 334 | 25 | A | 0.015 | 3874 | 226 | 100 | 1801 | 0.0165 | 2,199 | 181,601 | 303,158 | 627,729 | 1.67 | 161.6 |
| 335 | 25 | A | 0.020 | 3832 | 268 | 100 | 1800 | 0.0375 | 3,750 | 181,724 | 296,099 | 546,615 | 1.63 | 162.8 |
| 336 | 25 | A | 0.015 | 3874 | 226 | 110 | 1801 | 0.0193 | 2,572 | 147,657 | 232,744 | 475,337 | 1.58 | 162.2 |
| 337 | 25 | A | 0.020 | 3832 | 268 | 110 | 1801 | 0.0335 | 3,348 | 125,497 | 203,596 | 406,458 | 1.62 | 162.6 |
| 338 | 25 | A | 0.015 | 3874 | 226 | 115 | 1800 | 0.0050 | 667 | | | | | |
| 339 | 25 | A | 0.020 | 3832 | 268 | 115 | 1801 | 0.0227 | 2,269 | 87,615 | 131,220 | 240,872 | 1.50 | 160.1 |
| 340 | 26 | A | 0.025 | 3895 | 205 | 70 | 24 | 0.3554 | 2,192,400 | 47,408 | 90,386 | 201,296 | 1.91 | 151.3 |
| 341 | 26 | A | 0.025 | 3895 | 205 | 70 | 23 | 0.3858 | 2,415,443 | 45,291 | 92,784 | 221,513 | 2.05 | 151.1 |
| 342 | 26 | A | 0.025 | 3895 | 205 | 70 | 22 | 0.3841 | 2,614,109 | 50,123 | 92,438 | 210,009 | 1.84 | 150.5 |
| 343 | 26 | A | 0.025 | 3895 | 205 | 100 | 24 | 0.2007 | 1,204,200 | 35,206 | 64,314 | 127,614 | 1.83 | 149.0 |
| 344 | 26 | A | 0.025 | 3895 | 205 | 100 | 26 | 0.1983 | 1,098,277 | 36,868 | 67,959 | 152,188 | 1.84 | 148.6 |
| 345 | 26 | A | 0.025 | 3895 | 205 | 100 | 20 | 0.2150 | 1,548,000 | 41,257 | 72,399 | 159,327 | 1.75 | 148.6 |
| 346 | 26 | D | 0.040 | 0 | 4099 | 70 | 445 | 0.0887 | 17,939 | 32,098 | 71,005 | 161,619 | 2.21 | 143.9 |
| 347 | 26 | D | 0.040 | 0 | 4099 | 70 | 416 | 0.0800 | 17,308 | 40,480 | 76,360 | 171,690 | 1.89 | 143.7 |
| 348 | 26 | D | 0.040 | 0 | 4099 | 70 | 476 | 0.0929 | 17,665 | 41,955 | 76,450 | 161,992 | 1.82 | 143.6 |
| 349 | 26 | D | 0.040 | 0 | 4099 | 100 | 341 | 0.0674 | 17,789 | 29,210 | 58,239 | 125,850 | 1.99 | 139.6 |
| 350 | 26 | D | 0.040 | 0 | 4099 | 100 | 316 | 0.0724 | 20,620 | 27,371 | 56,549 | 122,506 | 2.07 | 139.4 |
| 351 | 26 | D | 0.040 | 0 | 4099 | 100 | 314 | 0.0763 | 21,869 | 26,815 | 56,239 | 126,559 | 2.10 | 139.2 |
| 352 | 27 | A | 0.015 | 3874 | 226 | 70 | 23 | 0.6217 | 6,487,304 | 57,344 | 91,990 | 166,659 | 1.60 | 143.7 |
| 353 | 27 | A | 0.015 | 3874 | 226 | 70 | 22 | 0 6582 | 7,180,364 | 41,329 | 86,747 | 176,312 | 2.10 | 142.7 |
| 354 | 27 | A | 0.015 | 3874 | 226 | 70 | 17 | 0.4999 | 7,057,412 | 49,320 | 80,825 | 156,835 | 1.64 | 141.2 |
| 355 | 27 | A | 0.025 | 3895 | 205 | 70 | 14 | 0.3770 | 3,877,714 | 40,843 | 72,333 | 149,855 | 1.77 | 140.4 |
| 356 | 27 | A | 0.025 | 3895 | 205 | 70 | 14 | 0.3656 | 3,760,457 | 38,735 | 72,031 | 159,041 | 1.86 | 140.1 |
| 357 | 27 | A | 0.025 | 3895 | 205 | 70 | 12 | 0.3525 | 4,350,000 | 42,200 | 72,576 | 157,569 | 1.72 | 139.7 |
| 358 | 27 | A | 0.015 | 3874 | 226 | 100 | 31 | 0.3777 | 2,924,129 | 34,608 | 69,709 | 144,535 | 2.01 | 138.6 |
| 359 | 27 | A | 0.015 | 3874 | 226 | 100 | 30 | 0.4022 | 3,217,600 | 22,700 | 66,289 | 146,317 | 2.92 | 137.6 |
| 360 | 27 | A | 0.015 | 3874 | 226 | 100 | 23 | 0 3991 | 4,164,522 | 35,351 | 70,752 | 154,141 | 2.00 | 137.5 |
| 361 | 27 | A | 0.025 | 3895 | 205 | 100 | 17 | 0.2922 | 2,475,106 | 32,158 | 57,565 | 136,661 | 1.79 | 135.4 |
| 362 | 27 | A | 0.025 | 3895 | 205 | 100 | 13 | 0 2607 | 2,887,754 | 28,319 | 50,903 | 107,353 | 1.80 | 135.0 |
| 363 | 27 | A | 0.025 | 3895 | 205 | 100 | 17 | 0.2910 | 2,464,941 | 22,635 | 50,793 | 125,347 | 2.24 | 134.9 |
| 364 | 27 | D | 0.040 | 0 | 4099 | 70 | 33 | 0.3596 | 980,727 | 42,431 | 70,966 | 141,394 | 1.67 | 135.6 |
| 365 | 27 | D | 0.040 | 0 | 4099 | 70 | 32 | 0.3700 | 1,040,625 | 39,300 | 68,403 | 146,415 | 1.74 | 135.5 |
| 366 | 27 | D | 0.040 | 0 | 4099 | 70 | 32 | 0.3869 | 1,088,156 | 39,075 | 70,139 | 153,931 | 1.80 | 135.3 |
| 367 | 27 | D | 0.040 | 0 | 4099 | 100 | 27 | 0.2434 | 811,333 | 31,692 | 56,547 | 118,175 | 1.78 | 132.5 |
| 368 | 27 | D | 0.040 | 0 | 4099 | 100 | 25 | 0.2677 | 963,720 | 48,435 | 58,765 | 75,969 | 1.21 | 132.5 |
| 369 | 27 | D | 0.040 | 0 | 4099 | 100 | 25 | 0.2561 | 921,960 | 33,662 | 56,854 | 118,546 | 1.69 | 132.5 |
| 370 | 33 | A | 0.025 | 3895 | 205 | 70 | 63 | 0.2557 | 584,457 | 67,934 | 123,267 | 259,601 | 1.81 | 149.6 |
| 371 | 33 | A | 0.025 | 3895 | 205 | 70 | 68 | 0.2751 | 582,565 | 74,940 | 126,229 | 274,709 | 1.68 | 149.3 |
| 372 | 33 | A | 0.025 | 3895 | 205 | 70 | 73 | 0.2674 | 527,474 | 77,220 | 127,126 | 270,238 | 1.65 | 149.3 |
| 373 | 33 | A | 0.025 | 3895 | 205 | 100 | 54 | 0.1932 | 515,200 | 41,965 | 67,051 | 126,992 | 1.50 | 145.3 |
| 374 | 33 | A | 0.025 | 3895 | 205 | 100 | 61 | 0.2200 | 519,344 | 39,354 | 65,785 | 126,722 | 1.67 | 144.3 |
| 375 | 33 | A | 0.025 | 3895 | 205 | 100 | 60 | 0.2121 | 509,040 | 43,070 | 67,982 | 126,466 | 1.58 | 144.2 |
| 376 | 34 | A | 0.025 | 3895 | 205 | 70 | 1801 | 0.0714 | 5,709 | 47,079 | 75,250 | 147,993 | 1.60 | 146.8 |
| 377 | 34 | A | 0.025 | 3895 | 205 | 70 | 1801 | 0.0675 | 5,397 | 46,549 | 79,276 | 150,246 | 1.70 | 145.8 |
| 378 | 34 | A | 0.025 | 3895 | 205 | 70 | 1801 | 0.0718 | 5,741 | 44,957 | 73,959 | 136,915 | 1.65 | 145.6 |
| 379 | 34 | A | 0.025 | 3895 | 205 | 100 | 1802 | 0.0612 | 4,891 | 16,240 | 34,782 | 79,209 | 2.14 | 139.2 |
| 380 | 34 | A | 0.025 | 3895 | 205 | 100 | 1752 | 0.0627 | 5,153 | 14,667 | 33,959 | 76,432 | 2.32 | 138.7 |
| 381 | 34 | A | 0.025 | 3895 | 205 | 100 | 1800 | 0.0543 | 4,344 | 16,491 | 33,641 | 74,759 | 2.04 | 138.4 |
| 382 | 35 | A | 0.025 | 3895 | 205 | 70 | 54 | 0.2788 | 743,467 | 40,499 | 67,743 | 136,916 | 1.67 | 153.7 |
| 383 | 35 | A | 0.025 | 3895 | 205 | 70 | 51 | 0.2896 | 817,694 | 39,524 | 65,375 | 126,248 | 1.65 | 153.1 |
| 384 | 35 | A | 0.025 | 3895 | 205 | 70 | 50 | 0.3056 | 880,128 | 31,837 | 59,611 | 123,424 | 1.87 | 152.9 |
| 385 | 35 | A | 0.025 | 3895 | 205 | 100 | 57 | 0.1846 | 466,358 | 25,286 | 43,542 | 87,780 | 1.72 | 148.4 |
| 386 | 35 | A | 0.025 | 3895 | 205 | 100 | 48 | 0.1891 | 567,300 | 29,557 | 46,375 | 88,719 | 1.57 | 147.8 |
| 387 | 35 | A | 0.025 | 3895 | 205 | 100 | 52 | 0.1903 | 526,985 | 28,669 | 45,114 | 87,614 | 1.57 | 147.5 |
| 388 | 36 | A | 0.025 | 3895 | 205 | 70 | 32 | 0.2245 | 1,010,250 | 28,369 | 45,782 | 87,286 | 1.61 | 140.3 |
| 389 | 36 | A | 0.025 | 3895 | 205 | 70 | 29 | 0.2373 | 1,178,317 | 24,604 | 43,776 | 89,513 | 1.78 | 140.2 |
| 390 | 36 | A | 0.025 | 3895 | 205 | 70 | 33 | 0.2434 | 1,062,109 | 25,531 | 42,807 | 81,299 | 1.68 | 139.4 |
| 391 | 36 | A | 0.025 | 3895 | 205 | 100 | 53 | 0.1864 | 506,445 | 18,396 | 32,695 | 67,559 | 1.78 | 134.1 |
| 392 | 36 | A | 0.025 | 3895 | 205 | 100 | 44 | 0.1852 | 606,109 | 18,305 | 33,055 | 70,147 | 1.81 | 133.6 |
| 393 | 36 | A | 0.025 | 3895 | 205 | 100 | 55 | 0.1868 | 489,076 | 17,369 | 31,629 | 67,885 | 1.82 | 133.4 |
| 394 | 37 | A | 0.025 | 3895 | 205 | 70 | 100 | 0.1162 | 167,328 | 25,014 | 42,171 | 90,563 | 1.69 | 146.3 |
| 395 | 37 | A | 0.025 | 3895 | 205 | 70 | 84 | 0.1218 | 208,800 | 22,998 | 39,417 | 75,534 | 1.71 | 146.3 |
| 396 | 37 | A | 0.025 | 3895 | 205 | 70 | 92 | 0.1114 | 174,365 | 22,462 | 39,338 | 81,835 | 1.75 | 146.1 |
| 397 | 37 | A | 0.025 | 3895 | 205 | 100 | 739 | 0.0787 | 15,335 | 11,943 | 20,931 | 40,946 | 1.75 | 140.9 |
| 398 | 37 | A | 0.025 | 3895 | 205 | 100 | 591 | 0.0855 | 20,832 | 12,742 | 20,963 | 41,680 | 1.65 | 139.9 |
| 399 | 37 | A | 0.025 | 3895 | 205 | 100 | 543 | 0.0839 | 22,250 | 15,018 | 22,527 | 42,826 | 1.50 | 139.6 |
| 400 | 37 | D | 0.040 | 0 | 4999 | 70 | 33 | 0.2386 | 650,727 | 23,297 | 38,421 | 73,038 | 1.65 | 143.2 |
| 431 | 37 | D | 0.040 | 0 | 4999 | 70 | 35 | 0.2341 | 601,971 | 24,083 | 37,902 | 71,825 | 1.57 | 142.7 |
| 402 | 37 | D | 0.040 | 0 | 4099 | 70 | 34 | 0.2311 | 611,735 | 23,127 | 38,855 | 82,769 | 1.68 | 142.5 |
| 403 | 37 | D | 0.040 | 0 | 4099 | 100 | 56 | 0.1265 | 203,304 | 12,590 | 24,762 | 77,875 | 1.97 | 137.1 |
| 404 | 37 | D | 0.040 | 0 | 4099 | 100 | 53 | 0.1308 | 222,113 | 10,635 | 24,086 | 57,317 | 2.26 | 137.1 |
| 405 | 37 | D | 0.040 | 0 | 4099 | 100 | 56 | 0.1313 | 211,018 | 14,048 | 24,798 | 50,588 | 1.77 | 136.9 |
| 406 | 38 | A | 0.025 | 3895 | 205 | 70 | 295 | 0.1084 | 52,914 | 42,254 | 71,283 | 138,082 | 1.69 | 155.6 |
| 407 | 38 | A | 0.025 | 3895 | 205 | 70 | 294 | 0.1045 | 51,184 | 41,432 | 67,881 | 131,873 | 1.64 | 155.4 |
| 408 | 38 | A | 0.025 | 3895 | 205 | 70 | 288 | 0.1036 | 51,800 | 40,015 | 70,977 | 153,465 | 1.77 | 155.3 |
| 409 | 38 | A | 0.025 | 3895 | 205 | 100 | 306 | 0.0865 | 40,786 | 15,374 | 25,817 | 52,593 | 1.68 | 147.8 |
| 410 | 38 | A | 0.025 | 3895 | 205 | 100 | 256 | 0.0794 | 44,663 | 16,969 | 25,985 | 50,903 | 1.53 | 147.6 |
| 411 | 38 | A | 0.025 | 3895 | 205 | 100 | 274 | 0.0904 | 47,509 | 15,672 | 27,249 | 60,600 | 1.74 | 147.3 |
| 412 | 38 | D | 0.040 | 0 | 4099 | 70 | 221 | 0.1173 | 47,769 | 38,294 | 62,763 | 128,161 | 1.64 | 151.6 |
| 413 | 38 | D | 0.040 | 0 | 4099 | 70 | 196 | 0.1036 | 47,571 | 29,688 | 65,976 | 398,825 | 2.22 | 151.3 |
| 414 | 38 | D | 0.040 | 0 | 4099 | 70 | 197 | 0.1011 | 46,188 | 25,999 | 63,972 | 280,261 | 2.46 | 151.1 |
| 415 | 38 | D | 0.040 | 0 | 4099 | 100 | 235 | 0.0849 | 32,515 | 20,259 | 30,189 | 52,767 | 1.49 | 148.3 |
| 416 | 38 | D | 0.040 | 0 | 4099 | 100 | 207 | 0.0943 | 41,000 | 16,007 | 29,825 | 57,614 | 1.86 | 147.0 |
| 417 | 38 | D | 0.040 | 0 | 4099 | 100 | 223 | 0.0952 | 38,422 | 15,370 | 29,744 | 59,150 | 1.94 | 146.9 |
| 418 | 39 | A | 0.025 | 3895 | 205 | 70 | 253 | 0.1002 | 57,031 | 1,254 | 2,091 | 3,913 | 1.67 | 128.1 |
| 419 | 39 | A | 0.025 | 3895 | 205 | 70 | 270 | 0.0924 | 49,280 | 1,154 | 1,944 | 4,059 | 1.68 | 125.6 |
| 420 | 39 | A | 0.025 | 3895 | 205 | 70 | 257 | 0.0953 | 53,398 | 1,116 | 1,864 | 3,880 | 1.67 | 124.3 |
| 421 | 39 | A | 0.025 | 3895 | 205 | 100 | 166 | 0.0982 | 85,186 | 1,244 | 2,066 | 3,900 | 1.66 | 125.3 |
| 422 | 39 | A | 0.025 | 3895 | 205 | 100 | 140 | 0.1050 | 108,000 | 1,336 | 2,331 | 5,141 | 1.75 | 124.9 |
| 423 | 39 | A | 0.025 | 3895 | 205 | 100 | 124 | 0.1077 | 125,071 | 1,459 | 2,366 | 4,228 | 1.62 | 124.9 |
| 424 | 39 | D | 0.040 | 0 | 4099 | 70 | 1801 | 0.0054 | 270 | | | | | |
| 425 | 39 | D | 0.040 | 0 | 4999 | 70 | 1801 | 0.0056 | 280 | | | | | |
| 426 | 39 | D | 0.040 | 0 | 4099 | 70 | 1800 | 0.0036 | 180 | | | | | |
| 427 | 39 | D | 0.040 | 0 | 4099 | 100 | 1800 | 0.0101 | 505 | 1,079 | 1,676 | 3,224 | 1.55 | 71.1 |
| 428 | 39 | D | 0.040 | 0 | 4099 | 100 | 1801 | 0.0091 | 455 | | | | | |
| 429 | 39 | D | 0.040 | 0 | 4099 | 100 | 1801 | 0.0088 | 440 | | | | | |
| 430 | 40 | A | 0.015 | 3874 | 226 | 70 | 1800 | 0.0102 | 1,360 | 99,168 | 150,788 | 291,025 | 1.52 | 162.5 |
| 431 | 40 | A | 0.015 | 3874 | 226 | 70 | 1801 | 0.0142 | 1,892 | 99,510 | 154,136 | 288,795 | 1.55 | 162.5 |
| 432 | 40 | A | 0.015 | 3874 | 226 | 70 | 1801 | 0.0160 | 2,132 | 102,729 | 158,781 | 288,132 | 1.55 | 162.3 |
| 433 | 40 | A | 0.025 | 3790 | 310 | 70 | 1801 | 0.0267 | 2,135 | 85,451 | 152,166 | 312,837 | 1.78 | 161.0 |
| 434 | 40 | A | 0.025 | 3790 | 310 | 70 | 1801 | 0.0263 | 2,103 | 98,629 | 159,634 | 315,675 | 1.62 | 163.0 |
| 435 | 40 | A | 0.025 | 3790 | 310 | 70 | 1802 | 0.0277 | 2,214 | 107,103 | 163,521 | 295,436 | 1.53 | 161.8 |
| 436 | 40 | A | 0.015 | 3874 | 226 | 100 | 1801 | 0.0129 | 1,719 | 59,333 | 90,756 | 160,693 | 1.53 | 159.0 |
| 437 | 40 | A | 0.015 | 3874 | 226 | 100 | 1801 | 0.0179 | 2,385 | 65,028 | 99,147 | 187,466 | 1.52 | 159.2 |
| 438 | 40 | A | 0.015 | 3874 | 226 | 100 | 1801 | 0.0189 | 2,519 | 77,254 | 111,036 | 199,658 | 1.44 | 158.5 |
| 439 | 40 | A | 0.025 | 3790 | 310 | 100 | 1801 | 0.0156 | 1,247 | 50,100 | 85,489 | 173,219 | 1.71 | 159.0 |
| 440 | 40 | A | 0.025 | 3790 | 310 | 100 | 1800 | 0.0301 | 2,408 | 57,306 | 92,223 | 173,759 | 1.61 | 158.3 |
| 441 | 40 | A | 0.025 | 3790 | 310 | 100 | 1800 | 0.0308 | 2,464 | 57,296 | 95,290 | 204,404 | 1.66 | 158.8 |
| 442 | 41 | A | 0.015 | 3874 | 226 | 70 | 975 | 0.0768 | 18,905 | 50,828 | 74,302 | 131,559 | 1.46 | 150.8 |
| 443 | 41 | A | 0.015 | 3874 | 226 | 70 | 838 | 0.0820 | 23,484 | 52,917 | 80,753 | 150,610 | 1.53 | 152.0 |
| 444 | 41 | A | 0.015 | 3874 | 226 | 70 | 602 | 0.0829 | 33,050 | 56,890 | 81,229 | 144,750 | 1.43 | 152.1 |
| 445 | 41 | A | 0.015 | 3874 | 226 | 100 | 562 | 0.0530 | 22,633 | 18,831 | 29,581 | 52,551 | 1.57 | 145.8 |
| 446 | 41 | A | 0.015 | 3874 | 226 | 100 | 619 | 0.0571 | 22,139 | 21,808 | 32,885 | 57,704 | 1.51 | 147.2 |
| 447 | 41 | A | 0.015 | 3874 | 226 | 100 | 628 | 0.0943 | 36,038 | 19,445 | 30,510 | 52,571 | 1.57 | 146.1 |
| 448 | 42 | A | 0.015 | 3874 | 226 | 70 | 1801 | 0.0250 | 3,331 | 49,901 | 74,728 | 134,686 | 1.50 | 161.8 |
| 449 | 42 | A | 0.015 | 3874 | 226 | 70 | 1800 | 0.0299 | 3,987 | 52,315 | 77,845 | 137,617 | 1.49 | 161.8 |
| 450 | 42 | A | 0.015 | 3874 | 226 | 70 | 1381 | 0.0167 | 2,225 | 51,778 | 77,230 | 137,579 | 1.49 | 161.3 |
| 451 | 42 | A | 0.015 | 3874 | 226 | 100 | 1800 | 0.0119 | 1,587 | 34,828 | 50,688 | 85,115 | 1.46 | 157.3 |
| 452 | 42 | A | 0.015 | 3874 | 226 | 100 | 1801 | 0.0260 | 3,465 | 38,912 | 55,840 | 98,875 | 1.44 | 158.0 |
| 453 | 42 | A | 0.015 | 3874 | 226 | 100 | 1800 | 0.0218 | 2,907 | 32,167 | 52,962 | 112,315 | 1.65 | 157.8 |
| 454 | 43 | A | 0.015 | 3674 | 226 | 70 | 199 | 0.0995 | 120,000 | 20,071 | 29,635 | 49,748 | 1.48 | 149.8 |
| 455 | 43 | A | 0.015 | 3874 | 226 | 70 | 235 | 0.1123 | 114,689 | 17,250 | 28,184 | 53,400 | 1.63 | 149.3 |
| 456 | 43 | A | 0.015 | 3874 | 226 | 70 | 283 | 0.1004 | 85,145 | 18,380 | 29,681 | 56,466 | 1.61 | 150.0 |
| 457 | 43 | A | 0.015 | 3874 | 226 | 100 | 238 | 0.0809 | 81,580 | 11,053 | 18,488 | 34,454 | 1.67 | 144.2 |
| 458 | 43 | A | 0.015 | 3874 | 226 | 100 | 229 | 0.1384 | 145,048 | 13,532 | 21,132 | 41,650 | 1.56 | 145.7 |
| 459 | 43 | A | 0.015 | 3874 | 226 | 100 | 386 | 0.0953 | 59,254 | 16,640 | 24,594 | 41,668 | 1.48 | 147.5 |
| 460 | 44 | A | 0.040 | 3664 | 436 | 70 | 1800 | 0.0203 | 1,015 | 76,863 | 124,841 | 244,688 | 1.62 | 162.2 |
| 461 | 44 | A | 0.040 | 3664 | 436 | 70 | 1800 | 0.0190 | 950 | 69,348 | 114,181 | 213,087 | 1.65 | 159.7 |
| 462 | 44 | A | 0.040 | 3664 | 436 | 70 | 1802 | 0.0191 | 954 | 83,066 | 130,140 | 229,862 | 1.57 | 160.7 |
| 463 | 44 | A | 0.040 | 3664 | 436 | 100 | 1800 | 0.0268 | 1,340 | 50,125 | 81,205 | 155,542 | 1.62 | 159.3 |
| 464 | 44 | A | 0.040 | 3664 | 436 | 100 | 1800 | 0.0267 | 1,335 | 51,920 | 84,310 | 165,231 | 1.62 | 159.0 |
| 465 | 44 | A | 0.040 | 3664 | 436 | 100 | 1800 | 0.0262 | 1,310 | 60,190 | 96,324 | 195,639 | 1.60 | 158.7 |
| 466 | 45 | A | 0.015 | 3874 | 226 | 70 | 1800 | 0.0307 | 4,093 | 67,453 | 97,174 | 166,626 | 1.44 | 153.7 |
| 467 | 45 | A | 0.015 | 3874 | 226 | 70 | 1801 | 0.0314 | 4,184 | 71,118 | 102,327 | 170,332 | 1.44 | 153.7 |
| 468 | 45 | A | 0.015 | 3874 | 226 | 70 | 776 | 0.0290 | 8,969 | 68,379 | 103,825 | 191,130 | 1.52 | 153.2 |
| 469 | 45 | A | 0.040 | 3664 | 436 | 70 | 516 | 0.0803 | 14,006 | 52,194 | 82,034 | 160,680 | 1.57 | 152.6 |
| 470 | 45 | A | 0.040 | 3664 | 436 | 70 | 598 | 0.0814 | 12,251 | 50,766 | 83,596 | 153,652 | 1.65 | 153.6 |
| 471 | 45 | A | 0.040 | 3664 | 436 | 70 | 542 | 0.0868 | 14,413 | 57,550 | 88,753 | 162,881 | 1.54 | 152.7 |
| 472 | 45 | A | 0.015 | 3874 | 226 | 100 | 1801 | 0.0316 | 4,211 | 23,068 | 35,964 | 64,507 | 1.56 | 147.7 |
| 473 | 45 | A | 0.015 | 3874 | 226 | 100 | 1801 | 0.0661 | 8,808 | 23,229 | 35,537 | 63,583 | 1.53 | 146.7 |
| 474 | 45 | A | 0.015 | 3874 | 226 | 100 | 1665 | 0.0557 | 8,029 | 23,561 | 36,325 | 66,140 | 1.54 | 146.7 |
| 475 | 45 | A | 0.040 | 3664 | 436 | 100 | 372 | 0.0745 | 18,024 | 16,641 | 28,662 | 62,468 | 1.72 | 147.8 |
| 476 | 45 | A | 0.040 | 3664 | 436 | 100 | 435 | 0.1001 | 20,710 | 17,961 | 29,427 | 56,683 | 1.64 | 147.7 |
| 477 | 45 | A | 0.040 | 3664 | 436 | 100 | 329 | 0.0658 | 18,000 | 16,133 | 26,647 | 51,129 | 1.65 | 147.2 |
| 478 | 46 | A | 0.015 | 3874 | 226 | 70 | 40 | 0.1280 | 768,000 | 241,971 | 396,626 | 819,061 | 1.64 | 159.0 |
| 479 | 46 | A | 0.015 | 3874 | 226 | 70 | 52 | 0.1506 | 695,077 | 237,440 | 374,600 | 710,984 | 1.58 | 159.2 |
| 480 | 46 | A | 0.015 | 3874 | 226 | 70 | 62 | 0.2337 | 904,645 | 228,726 | 380,009 | 759,735 | 1.66 | 159.5 |
| 481 | 46 | A | 0.015 | 3874 | 226 | 100 | 92 | 0.1254 | 327,130 | 123,955 | 198,082 | 367,438 | 1.60 | 159.1 |
| 482 | 46 | A | 0.015 | 3874 | 226 | 100 | 87 | 0.1799 | 496,276 | 99,752 | 175,608 | 390,135 | 1.76 | 158.3 |
| 483 | 46 | A | 0.015 | 3874 | 226 | 100 | 56 | 0.1257 | 538,714 | 115,590 | 189,795 | 392,714 | 1.64 | 158.1 |
| 484 | 47 | A | 0.015 | 3874 | 226 | 70 | 35 | 0.3055 | 2,094,857 | 106,333 | 175,439 | 360,361 | 1.65 | 141.1 |
| 485 | 47 | A | 0.015 | 3874 | 226 | 70 | 67 | 0.1843 | 660,179 | 150,684 | 232,403 | 446,157 | 1.54 | 142.1 |
| 486 | 47 | A | 0.015 | 3874 | 226 | 70 | 24 | 0.3419 | 3,419,000 | 85,061 | 153,033 | 335,033 | 1.80 | 141.1 |
| 487 | 47 | A | 0.015 | 3874 | 226 | 100 | 30 | 0.2499 | 1,999,200 | 64,627 | 106,989 | 227,559 | 1.66 | 140.1 |
| 488 | 47 | A | 0.015 | 3874 | 226 | 100 | 24 | 0.2313 | 2,313,000 | 62,747 | 97,547 | 186,298 | 1.55 | 139.6 |
| 489 | 47 | A | 0.015 | 3874 | 226 | 100 | 44 | 0.3390 | 1,849,091 | 47,753 | 84,988 | 172,618 | 1.78 | 138.8 |
| 490 | 48 | A | 0.015 | 3874 | 226 | 70 | 68 | 0.2367 | 835,412 | 333,293 | 563,196 | 1,224,397 | 1.69 | 162.0 |
| 491 | 48 | A | 0.015 | 3874 | 226 | 70 | 71 | 0.2606 | 880,901 | 320,505 | 547,286 | 1,178,612 | 1.71 | 161.6 |
| 492 | 48 | A | 0.015 | 3874 | 226 | 70 | 50 | 0.2385 | 1,144,800 | 229,731 | 471,227 | 1,289,171 | 2.05 | 159.6 |
| 493 | 48 | A | 0.015 | 3874 | 226 | 100 | 69 | 0.1629 | 566,609 | 122,354 | 200,331 | 435,953 | 1.64 | 160.3 |
| 494 | 48 | A | 0.015 | 3874 | 226 | 100 | 60 | 0.1632 | 652,800 | 113,442 | 187,016 | 381,183 | 1.65 | 161.1 |
| 495 | 48 | A | 0.015 | 3874 | 226 | 100 | 45 | 0.1455 | 776,000 | 107,526 | 189,344 | 453,902 | 1.76 | 160.1 |
| 496 | 49 | A | 0.015 | 3874 | 226 | 70 | 31 | 0.3585 | 2,775,484 | 101,529 | 256,690 | 747,407 | 2.53 | 146.6 |
| 497 | 49 | A | 0.015 | 3874 | 226 | 70 | 45 | 0.3815 | 2,034,667 | 130,996 | 299,549 | 848,069 | 2.29 | 146.8 |
| 498 | 49 | A | 0.015 | 3874 | 226 | 70 | 31 | 0.3866 | 2,993,032 | 106,997 | 271,984 | 775,467 | 2.54 | 145.8 |
| 499 | 49 | A | 0.015 | 3874 | 226 | 100 | 29 | 0.2717 | 2,248,552 | 67,593 | 139,831 | 411,235 | 2.07 | 145.6 |
| 500 | 49 | A | 0.015 | 3874 | 226 | 100 | 21 | 0.2208 | 2,523,429 | 67,519 | 130,825 | 332,725 | 1.94 | 145.4 |
| 501 | 49 | A | 0.015 | 3874 | 226 | 100 | 18 | 0.2118 | 2,824,000 | 59,229 | 127,550 | 324,707 | 2.15 | 145.2 |
| 502 | 50 | A | 0.015 | 3874 | 226 | 70 | 134 | 0.2848 | 510,090 | 359,005 | 597,487 | 1,294,056 | 1.66 | 162.6 |
| 503 | 50 | A | 0.015 | 3874 | 226 | 70 | 119 | 0.3062 | 617,546 | 305,675 | 563,609 | 1,374,894 | 1.84 | 162.7 |
| 504 | 50 | A | 0.015 | 3874 | 226 | 100 | 71 | 0.1375 | 464,789 | 103,444 | 173,971 | 344,309 | 1.68 | 160.1 |
| 505 | 50 | A | 0.015 | 3874 | 226 | 100 | 73 | 0.1431 | 470,466 | 116,244 | 189,183 | 382,891 | 1.63 | 161.0 |
| 506 | 50 | A | 0.015 | 3874 | 226 | 100 | 61 | 0.1594 | 627,148 | 102,487 | 161,116 | 300,669 | 1.57 | 160.7 |
| 507 | 51 | A | 0.015 | 3874 | 226 | 70 | 29 | 0.2495 | 2,064,828 | 117,996 | 269,868 | 771,498 | 2.29 | 149.1 |
| 508 | 51 | A | 0.015 | 3874 | 226 | 70 | 54 | 0.3885 | 1,726,667 | 115,395 | 290,100 | 867,225 | 2.51 | 149.2 |
| 509 | 51 | A | 0.015 | 3874 | 226 | 70 | 30 | 0.3339 | 2,671,200 | 107,686 | 306,761 | 945,424 | 2.85 | 149.9 |
| 510 | 51 | A | 0.015 | 3874 | 226 | 100 | 34 | 0.1268 | 895,059 | 78,329 | 136,705 | 317,192 | 1.75 | 148.4 |
| 511 | 51 | A | 0.015 | 3874 | 226 | 100 | 55 | 0.3243 | 1,415,127 | 42,029 | 87,174 | 254,258 | 2.07 | 146.4 |
| 512 | 51 | A | 0.015 | 3874 | 226 | 100 | 26 | 0.1991 | 1,837,846 | 52,395 | 103,266 | 267,446 | 1.97 | 147.2 |
| 513 | 52 | A | 0.015 | 3874 | 226 | 70 | 149 | 0.0952 | 153,342 | 180,181 | 278,591 | 546,034 | 1.55 | 163.3 |
| 514 | 52 | A | 0.015 | 3874 | 226 | 70 | 214 | 0.1227 | 137,607 | | | | | |
| 515 | 52 | A | 0.015 | 3874 | 226 | 70 | 201 | 0.1377 | 164,418 | 179,130 | 280,609 | 498,516 | 1.57 | 163.4 |
| 516 | 52 | A | 0 015 | 3874 | 226 | 100 | 227 | 0.0896 | 94,731 | 89,233 | 143,132 | 280,030 | 1.60 | 160.8 |
| 517 | 52 | A | 0.015 | 3874 | 226 | 100 | 226 | 0.1306 | 138,690 | 84,416 | 130,603 | 230,560 | 1.55 | 160.4 |
| 518 | 52 | A | 0.015 | 3874 | 226 | 100 | 238 | 0.1363 | 137,445 | 83,825 | 134,263 | 246,956 | 1.60 | 160.1 |
| 519 | 53 | A | 0.015 | 3874 | 226 | 70 | 63 | 0.1998 | 761,143 | 83,212 | 136,736 | 268,787 | 1.64 | 155.9 |
| 520 | 53 | A | 0.015 | 3874 | 226 | 70 | 81 | 0.2294 | 679,704 | 82,945 | 131,448 | 269,119 | 1.58 | 155.7 |
| 521 | 53 | A | 0.015 | 3874 | 226 | 70 | 62 | 0.2590 | 1,002,581 | 74,767 | 125,585 | 259,762 | 1.68 | 156.2 |
| 522 | 53 | A | 0.015 | 3874 | 226 | 100 | 79 | 0.1358 | 412,557 | 27,714 | 42,425 | 74,824 | 1.53 | 151.3 |
| 523 | 53 | A | 0.015 | 3874 | 226 | 100 | 47 | 0.1649 | 842,043 | 22,913 | 39,191 | 90,433 | 1.71 | 150.6 |
| 524 | 53 | A | 0.015 | 3874 | 226 | 100 | 47 | 0.1675 | 855,319 | 19,644 | 37,992 | 103,817 | 1.93 | 150.1 |
| 525 | 54 | A | 0.015 | 3874 | 226 | 70 | 562 | 0.0790 | 33,737 | 293,905 | 438,425 | 776,699 | 1.49 | 165.4 |
| 526 | 54 | A | 0.015 | 3874 | 226 | 70 | 696 | 0.0864 | 29,793 | 286,705 | 451,266 | 834,675 | 1.57 | 164.8 |
| 527 | 54 | A | 0.015 | 3874 | 226 | 70 | 499 | 0.0899 | 43,238 | 304,125 | 471,930 | 872,689 | 1.55 | 164.9 |
| 528 | 54 | A | 0.025 | 3790 | 310 | 70 | 295 | 0.0885 | 43,200 | 260,417 | 429,381 | 798,539 | 1.65 | 164.5 |
| 529 | 54 | A | 0.025 | 3790 | 310 | 70 | 337 | 0.1050 | 44,866 | 261,397 | 472,474 | 953,743 | 1.81 | 163.2 |
| 530 | 54 | A | 0.025 | 3790 | 310 | 70 | 313 | 0.0975 | 44,856 | 305,136 | 523,776 | 1,172,178 | 1.72 | 163.2 |
| 531 | 54 | A | 0.015 | 3874 | 226 | 100 | 1800 | 0.0417 | 5,560 | 126,649 | 200,896 | 366,335 | 1.59 | 162.8 |
| 532 | 54 | A | 0.015 | 3874 | 226 | 100 | 419 | 0.0624 | 35,742 | 134,212 | 220,113 | 448,580 | 1.64 | 161.6 |
| 533 | 54 | A | 0.015 | 3874 | 226 | 100 | 556 | 0.0634 | 27,367 | 152,791 | 246,989 | 501,730 | 1.62 | 162.8 |
| 534 | 54 | A | 0.025 | 3790 | 310 | 100 | 848 | 0.1125 | 19,104 | 133,966 | 248,425 | 592,006 | 1.85 | 161.3 |
| 535 | 54 | A | 0.025 | 3790 | 310 | 100 | 441 | 0.1144 | 37,355 | 124,519 | 212,634 | 437,774 | 1.71 | 160.6 |
| 536 | 54 | A | 0.025 | 3790 | 310 | 100 | 270 | 0.0834 | 44,480 | 125,810 | 210,028 | 392,625 | 1.67 | 161.2 |
| 537 | 56 | A | 0.015 | 3874 | 226 | 70 | 1801 | −0.0013 | −173 | | | | | |
| 538 | 56 | A | 0.015 | 3874 | 226 | 70 | 1801 | 0.0111 | 1,479 | 162,275 | 264,072 | 508,019 | 1.63 | 165.3 |
| 539 | 56 | A | 0.015 | 3874 | 226 | 70 | 1800 | 0.0511 | 6,813 | 217,120 | 322,092 | 590,243 | 1.48 | 163.3 |
| 540 | 56 | A | 0.040 | 3664 | 436 | 70 | 787 | 0.0759 | 8,680 | 157,345 | 250,730 | 471,613 | 1.59 | 163.5 |
| 541 | 56 | A | 0.040 | 3664 | 436 | 70 | 816 | 0.0789 | 8,702 | 159,242 | 273,689 | 581,167 | 1.72 | 163.8 |
| 542 | 56 | A | 0.040 | 3664 | 436 | 70 | 868 | 0.0831 | 8,616 | 192,622 | 302,144 | 626,955 | 1.57 | 163.8 |
| 543 | 56 | A | 0.015 | 3874 | 226 | 100 | 1800 | −0.0008 | −107 | | | | | |
| 544 | 56 | A | 0.015 | 3874 | 226 | 100 | 1801 | 0.0262 | 3,491 | 43,485 | 69,330 | 125,621 | 1.59 | 160.3 |
| 545 | 56 | A | 0.015 | 3874 | 226 | 100 | 1801 | 0.0274 | 3,651 | 47,833 | 73,153 | 129,934 | 1.53 | 160.3 |
| 546 | 56 | A | 0.040 | 3664 | 436 | 100 | 816 | 0.0790 | 8,713 | 34,092 | 58,192 | 186,648 | 1.71 | 159.8 |
| 547 | 56 | A | 0.040 | 3664 | 436 | 100 | 631 | 0.0570 | 8,130 | 36,040 | 59,018 | 116,281 | 1.64 | 160.8 |
| 548 | 56 | A | 0.040 | 3664 | 436 | 100 | 665 | 0.0587 | 7,944 | 38,616 | 61,071 | 120,482 | 1.58 | 160.6 |
| 549 | 57 | A | 0.015 | 3874 | 226 | 70 | 1800 | 0.0160 | 2,133 | 292,884 | 456,077 | 807,319 | 1.56 | 164.6 |
| 550 | 57 | A | 0.015 | 3874 | 226 | 70 | 1801 | 0.0635 | 8,462 | 365,586 | 608,076 | 1,222,436 | 1.66 | 163.6 |
| 551 | 57 | A | 0.015 | 3874 | 226 | 70 | 177 | 0.1209 | 163,932 | 451,100 | 726,152 | 1,476,551 | 1.61 | 164.3 |
| 552 | 57 | A | 0.025 | 3790 | 310 | 70 | 147 | 0.2087 | 204,441 | 322,213 | 529,416 | 1,044,495 | 1.64 | 165.7 |
| 553 | 57 | A | 0.025 | 3790 | 310 | 70 | 161 | 0.2241 | 200,437 | 325,996 | 539,562 | 1,032,593 | 1.66 | 165.5 |
| 554 | 57 | A | 0.025 | 3790 | 310 | 70 | 159 | 0.2321 | 210,204 | 316,103 | 547,215 | 1,051,284 | 1.73 | 165.3 |
| 555 | 57 | A | 0.015 | 3874 | 226 | 100 | 1801 | 0.0004 | 53 | | | | | |
| 556 | 57 | A | 0.015 | 3874 | 226 | 100 | 1801 | 0.0545 | 7,263 | 213,623 | 327,142 | 602,574 | 1.53 | 161.7 |
| 557 | 57 | A | 0.015 | 3874 | 226 | 100 | 1801 | 0.0541 | 7,209 | 203,110 | 306,293 | 557,386 | 1.51 | 161.6 |
| 558 | 57 | A | 0.025 | 3790 | 310 | 100 | 127 | 0.0871 | 98,759 | 141,271 | 225,127 | 415,707 | 1.59 | 161.9 |
| 559 | 57 | A | 0.025 | 3790 | 310 | 100 | 104 | 0.1044 | 144,554 | 125,463 | 221,448 | 429,231 | 1.77 | 162.0 |
| 560 | 57 | A | 0.025 | 3790 | 310 | 100 | 98 | 0.1065 | 156,490 | 126,786 | 237,728 | 492,520 | 1.88 | 162.7 |
| 561 | 58 | A | 0.015 | 3874 | 226 | 70 | 57 | 0.2814 | 1,184,842 | 259,386 | 400,944 | 784,025 | 1.55 | 155.5 |
| 562 | 58 | A | 0.015 | 3874 | 226 | 70 | 39 | 0.3145 | 1,935,385 | 114,134 | 300,790 | 910,448 | 2.64 | 155.6 |
| 563 | 58 | A | 0.015 | 3874 | 226 | 70 | 69 | 0.3185 | 1,107,826 | 158,598 | 315,682 | 839,405 | 1.99 | 155.2 |
| 564 | 58 | A | 0.015 | 3874 | 226 | 70 | 50 | 0.3625 | 1,740,000 | 109,237 | 296,781 | 922,025 | 2.72 | 155.8 |
| 565 | 58 | A | 0.015 | 3874 | 226 | 70 | 44 | 0.3377 | 1,842,000 | 120,451 | 262,216 | 694,798 | 2.18 | 154.2 |
| 566 | 58 | A | 0.015 | 3874 | 226 | 70 | 39 | 0.3413 | 2,100,308 | 132,331 | 315,667 | 937,592 | 2.39 | 157.3 |
| 567 | 58 | A | 0.015 | 3874 | 226 | 100 | 201 | 0.0886 | 105,791 | 138,079 | 209,039 | 384,833 | 1.51 | 155.5 |
| 568 | 58 | A | 0.015 | 3874 | 226 | 100 | 50 | 0.1997 | 958,560 | 68,724 | 121,886 | 246,513 | 1.77 | 155.7 |
| 569 | 58 | A | 0.015 | 3874 | 226 | 100 | 44 | 0.1925 | 1,050,000 | 71,784 | 120,605 | 261,208 | 1.68 | 154.7 |
| 570 | 58 | A | 0.015 | 3874 | 226 | 100 | 39 | 0.1686 | 1,037,538 | 59,900 | 136,970 | 404,891 | 2.29 | 156.4 |
| 571 | 58 | A | 0.015 | 3874 | 226 | 100 | 46 | 0.1924 | 1,003,826 | 69,613 | 117,801 | 251,117 | 1.69 | 154.3 |
| 572 | 58 | A | 0.015 | 3874 | 226 | 100 | 42 | 0.2222 | 1,269,714 | 61,748 | 128,750 | 316,534 | 2.09 | 154.8 |
| 573 | 59 | A | 0.015 | 3874 | 226 | 70 | 1801 | 0.0236 | 3,145 | 47,513 | 69,623 | 119,075 | 1.47 | 153.0 |
| 574 | 59 | A | 0.015 | 3874 | 226 | 70 | 1800 | 0.0307 | 4,093 | 49,752 | 70,636 | 117,376 | 1.42 | 153.0 |
| 575 | 59 | A | 0.015 | 3874 | 226 | 70 | 1801 | 0.0430 | 5,730 | 51,072 | 72,949 | 123,669 | 1.43 | 152.7 |
| 576 | 59 | A | 0.025 | 3790 | 310 | 70 | 1801 | 0.0157 | 1,255 | 39,687 | 60,881 | 108,867 | 1.53 | 150.7 |
| 577 | 59 | A | 0.025 | 3790 | 310 | 70 | 1800 | 0.0250 | 2,000 | 42,109 | 68,472 | 140,117 | 1.63 | 151.9 |
| 578 | 59 | A | 0.025 | 3790 | 310 | 70 | 1650 | 0.0729 | 6,362 | 46,053 | 69,149 | 120,788 | 1.50 | 153.2 |
| 579 | 59 | A | 0.015 | 3874 | 226 | 100 | 1801 | 0.0169 | 2,252 | 6,937 | 10,603 | 19,482 | 1.53 | 142.0 |
| 580 | 59 | A | 0.015 | 3874 | 226 | 100 | 1801 | 0.0239 | 3,185 | 21,308 | 32,244 | 56,447 | 1.51 | 148.1 |
| 581 | 59 | A | 0.025 | 3790 | 310 | 100 | 1800 | 0.0288 | 2,304 | 8,131 | 12,449 | 22,976 | 1.53 | 142.2 |
| 582 | 59 | A | 0.025 | 3790 | 310 | 100 | 1801 | 0.0400 | 3,198 | 8,051 | 12,075 | 21,446 | 1.50 | 142.1 |
| 583 | 59 | A | 0.025 | 3790 | 310 | 100 | 1801 | 0.0443 | 3,542 | 7,961 | 13,192 | 26,781 | 1.66 | 142.0 |
| 584 | 66 | A | 0.015 | 3874 | 226 | 70 | 14 | 0.3851 | 6,601,714 | 159,342 | 411,847 | 1,059,227 | 2.58 | 147.9 |
| 585 | 66 | A | 0.015 | 3874 | 226 | 70 | 12 | 0.4152 | 8,304,000 | 135,485 | 459,460 | 1,348,474 | 3.39 | 148.0 |
| 586 | 66 | A | 0.015 | 3874 | 226 | 70 | 9 | 0.4090 | 10,906,667 | 162,946 | 454,632 | 1,253,701 | 2.79 | 148.2 |
| 587 | 66 | A | 0.015 | 4895 | 105 | 70 | 2 | 0.3177 | 38,124,000 | 151,115 | 447,103 | 1,271,334 | 2.96 | 148.6 |
| 588 | 66 | A | 0.015 | 4895 | 105 | 70 | 6 | 0.4778 | 19,112,000 | 210,339 | 501,665 | 1,299,984 | 2.39 | 147.8 |
| 589 | 66 | A | 0.015 | 4895 | 105 | 70 | 5 | 0.4552 | 21,849,600 | 140,310 | 417,751 | 1,181,311 | 2.98 | 147.4 |
| 590 | 66 | A | 0.015 | 4895 | 105 | 70 | 10 | 0.3463 | 8,311,200 | 140,870 | 391,436 | 1,075,826 | 2.78 | 147.6 |
| 591 | 66 | A | 0.020 | 4945 | 55 | 70 | 3 | 0.4389 | 26,334,000 | 187,389 | 513,970 | 1,491,780 | 2.74 | 147.2 |
| 592 | 66 | A | 0.020 | 4945 | 55 | 70 | 24 | 0.3309 | 2,481,750 | 375,945 | 682,203 | 1,548,200 | 1.81 | 150.9 |
| 593 | 66 | A | 0.020 | 4945 | 55 | 70 | 11 | 0.4498 | 7,360,364 | 167,844 | 476,684 | 1,345,683 | 2.84 | 147.4 |
| 594 | 66 | A | 0.020 | 4945 | 55 | 70 | 22 | 0.4167 | 3,409,364 | 237,220 | 527,252 | 1,325,162 | 2.22 | 148.7 |
| 595 | 66 | A | 0.020 | 4945 | 55 | 70 | 2 | 0.4382 | 39,438,000 | 155,332 | 450,488 | 1,250,302 | 2.90 | 147.1 |
| 596 | 66 | A | 0.020 | 4945 | 55 | 70 | 2 | 0.4397 | 39,573,000 | 165,647 | 441,561 | 1,161,349 | 2.67 | 147.2 |
| 597 | 66 | A | 0.015 | 3874 | 226 | 100 | 29 | 0.3560 | 2,946,207 | 50,670 | 178,199 | 564,757 | 3.52 | 145.0 |
| 598 | 66 | A | 0.015 | 3874 | 226 | 100 | 17 | 0.1448 | 2,044,235 | 46,548 | 145,190 | 500,428 | 3.12 | 144.0 |
| 599 | 66 | A | 0.015 | 3874 | 226 | 100 | 13 | 0.2665 | 4,920,000 | 72,969 | 183,907 | 489,338 | 2.52 | 145.9 |
| 600 | 66 | A | 0.015 | 4895 | 105 | 100 | 11 | 0.2471 | 5,391,273 | 88,168 | 189,600 | 463,270 | 2.15 | 146.6 |
| 601 | 66 | A | 0.015 | 4895 | 105 | 100 | 16 | 0.2438 | 3,657,000 | 88,455 | 192,599 | 483,761 | 2.18 | 148.1 |
| 602 | 66 | A | 0.015 | 4895 | 105 | 100 | 16 | 0.2633 | 3,949,500 | 93,225 | 209,126 | 587,516 | 2.24 | 147.3 |
| 603 | 66 | A | 0.015 | 4895 | 105 | 100 | 14 | 0.2368 | 4,059,429 | 88,566 | 208,187 | 561,582 | 2.35 | 147.8 |
| 604 | 66 | A | 0.020 | 4945 | 55 | 100 | 34 | 0.2287 | 1,210,765 | 144,257 | 261,362 | 568,066 | 1.81 | 148.2 |
| 605 | 66 | A | 0.020 | 4945 | 55 | 100 | 50 | 0.1954 | 703,440 | 195,778 | 314,110 | 640,818 | 1.60 | 149.1 |
| 606 | 66 | A | 0.020 | 4945 | 55 | 100 | 23 | 0.3215 | 2,516,087 | 104,631 | 211,031 | 520,313 | 2.02 | 146.4 |
| 607 | 66 | A | 0.020 | 4945 | 55 | 100 | 19 | 0.2972 | 2,815,579 | 79,986 | 191,379 | 531,146 | 2.39 | 146.4 |
| 608 | 66 | A | 0.020 | 4945 | 55 | 100 | 22 | 0.3160 | 2,585,455 | 65,369 | 195,189 | 585,188 | 2.99 | 145.7 |
| 609 | 66 | A | 0.020 | 4945 | 55 | 100 | 19 | 0.2479 | 2,348,526 | 80,058 | 196,994 | 554,076 | 2.46 | 145.7 |
| 610 | 62 | A | 0.015 | 3874 | 226 | 70 | 159 | 0.3470 | 523,774 | 425,988 | 731,854 | 1,551,140 | 1.72 | 153.0 |
| 611 | 62 | A | 0.015 | 3874 | 226 | 70 | 155 | 0.3307 | 512,052 | 445,527 | 810,960 | 1,904,855 | 1.82 | 152.0 |
| 612 | 62 | A | 0.015 | 3874 | 226 | 70 | 109 | 0.2145 | 472,294 | 496,297 | 843,255 | 1,774,860 | 1.7 | 152.6 |
| 613 | 62 | A | 0.015 | 3874 | 226 | 100 | 98 | 0.1558 | 381,551 | 189,582 | 326,415 | 650,653 | 1.72 | 149.9 |
| 614 | 62 | A | 0.015 | 3874 | 226 | 100 | 78 | 0.1309 | 402,769 | 166,731 | 319,094 | 800,071 | 1.91 | 151.4 |
| 615 | 62 | A | 0.015 | 3874 | 226 | 100 | 117 | 0.1462 | 299,897 | 209,797 | 336,548 | 698,532 | 1.6 | 149.7 |
| 616 | 63 | A | 0.015 | 3874 | 226 | 70 | 13 | 0.4206 | 7,764,923 | 75,331 | 421,253 | 1,578,065 | 5.59 | 148.9 |
| 617 | 63 | A | 0.015 | 3874 | 226 | 70 | 12 | 0.3705 | 7,410,000 | 98,122 | 448,941 | 1,696,313 | 4.58 | 149.4 |
| 618 | 63 | A | 0.015 | 3874 | 226 | 70 | 11 | 0.3438 | 7,501,091 | 149,128 | 486,789 | 1,465,216 | 3.26 | 150.7 |
| 619 | 63 | A | 0.015 | 3874 | 226 | 100 | 18 | 0.2914 | 3,885,333 | 38,824 | 139,868 | 486,111 | 3.6 | 146.6 |
| 620 | 63 | A | 0.015 | 3874 | 226 | 100 | 12 | 0.2497 | 4,994,000 | 37,610 | 149,403 | 551,958 | 3.97 | 147.0 |
| 621 | 63 | A | 0.015 | 3874 | 226 | 100 | 17 | 0.1459 | 2,059,765 | 27,625 | 120,442 | 474,367 | 4.36 | 143.7 |

[symbol]

indicates data missing or illegible when filed

TABLE 9
Propylene homo- and co-polymerizations

| | | | | Comon- | Iso- | Tol- | | | Activity (g | | | | | |
|---|---|---|---|---|---|---|---|---|---|---|---|---|---|---|
| | Cat | Cat | Comon- | omer | hexane | uene | Quench | Yield | P/mmol | | | | | Tm |
| Ex# | ID | (umol) | omer | (uL) | (uL) | (uL) | time (s) | (g) | cat · hr) | Mn | Mw | Mz | PDI | (° C.) |
| 622 | 5 | 0.020 | — | 0 | 3832 | 268 | 49 | 0.3676 | 1,350,367 | 84,070 | 262,040 | 852,508 | 3.12 | 158.5 |
| 623 | 5 | 0.020 | — | 0 | 3832 | 268 | 53 | 0.3345 | 1,136,038 | 127,569 | 370,689 | 1,349,145 | 2.91 | 159.1 |
| 624 | 5 | 0.020 | — | 0 | 3832 | 268 | 53 | 0.3558 | 1,208,377 | 87,224 | 308,309 | 1,164,102 | 3.53 | 159.5 |
| 625 | 5 | 0.020 | — | 0 | 3832 | 268 | 36 | 0.3371 | 1,685,500 | 91,839 | 318,737 | 1,196,357 | 3.47 | 159.6 |
| 626 | 5 | 0.020 | C8 | 100 | 3732 | 268 | 52 | 0.2781 | 962,654 | 143,213 | 314,629 | 858,328 | 2.20 | 98.3 |
| 627 | 5 | 0.020 | C8 | 100 | 3732 | 268 | 62 | 0.2757 | 800,419 | 170,387 | 334,559 | 847,908 | 1.96 | 99.8 |
| 628 | 5 | 0.020 | C8 | 200 | 3632 | 268 | 54 | 0.2322 | 774,000 | 146,237 | 276,727 | 609,153 | 1.89 | |
| 629 | 5 | 0.020 | C8 | 200 | 3632 | 268 | 64 | 0.2528 | 711,000 | 136,252 | 304,303 | 810,841 | 2.23 | |
| 630 | 5 | 0.020 | C10 | 100 | 3732 | 268 | 52 | 0.2464 | 852,923 | 134,150 | 314,690 | 853,662 | 2.35 | 101.8 |
| 631 | 5 | 0.020 | C10 | 100 | 3732 | 268 | 59 | 0.3469 | 1,058,339 | 130,404 | 298,937 | 856,309 | 2.29 | 113.7 |
| 632 | 5 | 0.020 | C10 | 200 | 3632 | 268 | 80 | 0.1865 | 419,625 | 189,620 | 360,832 | 798,111 | 1.90 | |
| 633 | 5 | 0.020 | C10 | 200 | 3632 | 268 | 66 | 0.3103 | 846,273 | 130,794 | 290,852 | 767,592 | 2.22 | |
| 634 | 5 | 0.020 | C14 | 100 | 3732 | 268 | 51 | 0.2451 | 865,059 | 128,282 | 355,778 | 1,024,468 | 2.77 | 115.8 |
| 635 | 5 | 0.020 | C14 | 100 | 3732 | 268 | 57 | 0.3616 | 1,141,895 | 124,970 | 301,217 | 811,646 | 2.41 | 122.8 |
| 636 | 5 | 0.020 | C14 | 200 | 3632 | 268 | 57 | 0.2862 | 903,789 | 115,484 | 336,936 | 894,349 | 2.92 | 87.0 |
| 637 | 5 | 0.020 | C14 | 200 | 3632 | 268 | 47 | 0.2223 | 851,362 | 159,821 | 326,789 | 829,025 | 2.04 | |
| 638 | 6 | 0.020 | — | 0 | 3832 | 268 | 9 | 0.3969 | 7,938,000 | 70,869 | 358,986 | 1,488,658 | 5.07 | 147.9 |
| 639 | 6 | 0.020 | — | 0 | 3832 | 268 | 15 | 0.3976 | 4,771,200 | 63,781 | 356,482 | 1,334,195 | 5.59 | 148.4 |
| 640 | 6 | 0.020 | C8 | 100 | 3732 | 268 | 60 | 0.4938 | 1,481,400 | 48,096 | 225,988 | 912,754 | 4.70 | 97.0 |
| 641 | 6 | 0.020 | C8 | 200 | 3632 | 268 | 81 | 0.5364 | 1,192,000 | 63,024 | 198,902 | 721,079 | 3.16 | |
| 642 | 6 | 0.020 | C10 | 200 | 3632 | 268 | 67 | 0.5446 | 1,463,104 | 47,304 | 228,972 | 1,225,088 | 4.84 | |
| 643 | 6 | 0.020 | C14 | 100 | 3732 | 268 | 49 | 0.4800 | 1,763,265 | 55,787 | 289,382 | 1,118,389 | 5.19 | 118.3 |
| 644 | 6 | 0.020 | C14 | 200 | 3632 | 268 | 66 | 0.5052 | 1,377,818 | 71,963 | 275,586 | 1,091,173 | 3.83 | |
| 645 | 57 | 0.025 | — | 0 | 3790 | 310 | 142 | 0.2098 | 212,755 | 312,208 | 559,318 | 1,159,003 | 1.79 | 164.6 |
| 646 | 57 | 0.025 | — | 0 | 3790 | 310 | 173 | 0.1318 | 109,706 | 264,086 | 501,589 | 1,040,883 | 1.90 | 165.1 |
| 647 | 57 | 0.025 | C8 | 100 | 3690 | 310 | 134 | 0.2061 | 221,481 | 172,851 | 401,395 | 964,719 | 2.32 | 91.5 |
| 648 | 57 | 0.025 | C8 | 100 | 3690 | 310 | 137 | 0.2291 | 240,806 | 168,688 | 354,843 | 778,576 | 2.10 | 93.3 |
| 649 | 57 | 0.025 | C8 | 200 | 3590 | 310 | 145 | 0.2117 | 210,240 | 161,543 | 315,000 | 690,976 | 1.95 | |
| 650 | 57 | 0.025 | C8 | 200 | 3590 | 310 | 150 | 0.2264 | 217,344 | 152,856 | 323,327 | 746,490 | 2.12 | |
| 651 | 57 | 0.025 | C10 | 100 | 3690 | 310 | 131 | 0.2204 | 242,272 | 199,340 | 372,534 | 743,550 | 1.87 | 94.4 |
| 652 | 57 | 0.025 | C10 | 200 | 3590 | 310 | 143 | 0.2535 | 255,273 | 184,951 | 351,512 | 735,846 | 1.90 | |
| 653 | 57 | 0.025 | C10 | 200 | 3590 | 310 | 140 | 0.2729 | 280,697 | 153,628 | 343,332 | 843,815 | 2.23 | |
| 654 | 57 | 0.025 | C14 | 100 | 3690 | 310 | 127 | 0.1785 | 202,394 | 216,764 | 450,995 | 1,028,077 | 2.08 | 100.1 |
| 655 | 57 | 0.025 | C14 | 100 | 3690 | 310 | 128 | 0.2346 | 263,925 | 239,524 | 470,156 | 1,067,185 | 1.96 | 116.8 |
| 656 | 57 | 0.025 | C14 | 200 | 3590 | 310 | 165 | 0.2923 | 255,098 | 201,143 | 408,989 | 939,956 | 2.03 | |
| 657 | 57 | 0.025 | C14 | 200 | 3590 | 310 | 124 | 0.2655 | 308,323 | 198,445 | 388,950 | 862,735 | 1.96 | |

TABLE 10
Propylene co-polymerizations with 4-methyl-1-pentene

| | | | | Iso- | Tol- | | | Activity (g | |
|---|---|---|---|---|---|---|---|---|---|
| | Cat | Cat | C3 | hexane | uene | quench | yield | P/mmol | |
| Ex# | ID | (umol) | (uL) | ( [symbol] ) | (uL) | time (s) | (g) | cat · hr) | Mn |
| 658 | 1 | 0.080 | 100 | 4064 | 436 | 21 | 0.3644 | 780,857 | 18,872 |
| 659 | 1 | 0.080 | 100 | 4064 | 436 | 21 | 0.3772 | 808,286 | 16,481 |
| 650 | 1 | 0.080 | 300 | 3864 | 436 | 16 | 0.4556 | 1,281,375 | 17,016 |
| 661 | 1 | 0.080 | 300 | 3864 | 436 | 16 | 0.4106 | 1,154,813 | 17,666 |
| 662 | 1 | 0.080 | 500 | 3664 | 436 | 14 | 0.4145 | 1,332,321 | 12,405 |
| 663 | 1 | 0.080 | 500 | 3664 | 436 | 12 | 0.4516 | 1,693,500 | 14,749 |
| 664 | 3 | 0.080 | 100 | 4064 | 436 | 91 | 0.1757 | 86,885 | 11,658 |
| 665 | 3 | 0.080 | 100 | 4064 | 436 | 88 | 0.1684 | 88,114 | 9,582 |
| 666 | 3 | 0.080 | 300 | 3864 | 436 | 43 | 0.2726 | 285,279 | 16,173 |
| 667 | 3 | 0.080 | 300 | 3864 | 436 | 42 | 0.2388 | 255,857 | 14,044 |
| 668 | 3 | 0.080 | 500 | 3684 | 436 | 29 | 0.2691 | 417,569 | 16,565 |
| 669 | 3 | 0.080 | 500 | 3684 | 436 | 32 | 0.2984 | 419,625 | 15,509 |
| 670 | 5 | 0.080 | 100 | 4064 | 436 | 25 | 0.4680 | 842,400 | 18,284 |
| 671 | 5 | 0.080 | 100 | 4064 | 436 | 29 | 0.4102 | 536,517 | 15,964 |
| 672 | 5 | 0.080 | 300 | 3864 | 436 | 15 | 0.4852 | 1,455,600 | 12,835 |
| 673 | 5 | 0.080 | 300 | 3864 | 436 | 13 | 0.4939 | 1,709,654 | 16,785 |
| 674 | 5 | 0.080 | 500 | 3664 | 436 | 13 | 0.4983 | 1,724,885 | 15,205 |
| 675 | 5 | 0.080 | 500 | 3664 | 436 | 12 | 0.4649 | 1,743,375 | 9,564 |
| 676 | 6 | 0.080 | 100 | 4054 | 436 | 80 | 0.2222 | 124,988 | 15,453 |
| 677 | 6 | 0.080 | 100 | 4054 | 436 | 94 | 0.2149 | 102,878 | 12,091 |
| 678 | 6 | 0.080 | 300 | 3854 | 436 | 38 | 0.2567 | 303,987 | 17,801 |
| 679 | 6 | 0.080 | 300 | 3664 | 436 | 37 | 0.2531 | 307,824 | 16,064 |
| 680 | 6 | 0.080 | 500 | 3664 | 436 | 30 | 0.3023 | 453,450 | 17,273 |
| 681 | 6 | 0.080 | 500 | 3664 | 436 | 29 | 0.2887 | 447,983 | 18,144 |
| 682 | 48 | 0.080 | 100 | 4064 | 436 | 26 | 0.3634 | 628,962 | 21,802 |
| 683 | 48 | 0.080 | 100 | 4084 | 436 | 26 | 0.3443 | 595,904 | 23,432 |
| 684 | 48 | 0.080 | 300 | 3884 | 436 | 23 | 0.3881 | 759,326 | 24,847 |
| 685 | 48 | 0.080 | 300 | 3864 | 436 | 22 | 0.3795 | 776,250 | 20,851 |
| 686 | 48 | 0.080 | 500 | 3664 | 436 | 18 | 0.3876 | 969,000 | 19,844 |
| 687 | 48 | 0.080 | 500 | 3664 | 436 | 18 | 0.4078 | 1,019,500 | 16,106 |
| 688 | 49 | 0.080 | 100 | 4064 | 436 | 183 | 0.1443 | 35,484 | 10,292 |
| 689 | 49 | 0.080 | 100 | 4064 | 436 | 198 | 0.1543 | 35,068 | 10,013 |
| 690 | 49 | 0.080 | 300 | 3864 | 436 | 71 | 0.1783 | 113,007 | 15,571 |
| 691 | 49 | 0.080 | 300 | 3864 | 436 | 86 | 0.1585 | 82,936 | 9,980 |
| 692 | 49 | 0.080 | 500 | 3664 | 436 | 51 | 0.1905 | 368,088 | 15,215 |
| 693 | 49 | 0.080 | 500 | 3584 | 436 | 54 | 0.1912 | 159,333 | 14,853 |
| 694 | 64 | 0.080 | 100 | 4064 | 436 | 32 | 0.2927 | 411,609 | 7,306 |
| 695 | 64 | 0.080 | 100 | 4064 | 436 | 33 | 0.2988 | 407,455 | 8,492 |
| 696 | 64 | 0.080 | 300 | 3864 | 436 | 22 | 0.3138 | 641,864 | 7,574 |
| 697 | 64 | 0.080 | 300 | 3864 | 436 | 26 | 0.3397 | 587,942 | 7,044 |
| 698 | 64 | 0.080 | 500 | 3664 | 436 | 22 | 0.3379 | 691,159 | 7,737 |
| 699 | 64 | 0.080 | 500 | 3564 | 436 | 24 | 0.4130 | 774,375 | 6,158 |
| 700 | 65 | 0.080 | 100 | 4064 | 436 | 137 | 0.1399 | 45,953 | 2,430 |
| 701 | 65 | 0.080 | 100 | 4064 | 436 | 123 | 0.1476 | 54,000 | 2,735 |
| 702 | 65 | 0.080 | 300 | 3864 | 436 | 93 | 0.1571 | 76,016 | 2,911 |
| 703 | 65 | 0.080 | 300 | 3864 | 436 | 89 | 0.1556 | 78,674 | 2,933 |
| 704 | 65 | 0.080 | 500 | 3664 | 436 | 78 | 0.1690 | 97,500 | 2,928 |
| 705 | 65 | 0.080 | 500 | 3664 | 436 | 80 | 0.1836 | 103,275 | 3,578 |

| | | | | | | [PP] | | [4MP1 − |
|---|---|---|---|---|---|---|---|---|
| | | | | 4MP1 | C3 | (mol | [4MP1 − P] | 4MP1] |
| Ex# | Mw | Mz | PDI | (mol %) | (mol %) | [symbol] ) | (mol [symbol] ) | (mol [symbol] ) |
| 658 | 43,079 | 114,324 | 2.28 | | | | | |
| 659 | 40,164 | 103,543 | 2.44 | 39.8 | 60.2 | 0.346 | 0.512 | 0.142 |
| 650 | 47,231 | 148,876 | 2.78 | | | | | |
| 661 | 43,562 | 118,076 | 2.47 | | | | | |
| 662 | 45,203 | 143,116 | 3.64 | | | | | |
| 663 | 42,580 | 116,095 | 2.89 | 33.0 | 67.0 | 0.429 | 0.484 | 0.088 |
| 664 | 20,829 | 39,798 | 1.79 | 39.8 | 60.2 | 0.346 | 0.512 | 0.142 |
| 665 | 20,519 | 44,565 | 2.14 | | | | | |
| 666 | 29,243 | 59,275 | 1.81 | | | | | |
| 667 | 26,642 | 52,989 | 1.90 | | | | | |
| 668 | 32,267 | 71,868 | 1.95 | | | | | |
| 669 | 28,554 | 60,370 | 1.84 | 29.9 | 70.1 | 0.472 | 0.457 | 0.070 |
| 670 | 44,149 | 122,245 | 2.41 | 46.0 | 54.0 | 0.297 | 0.485 | 0.218 |
| 671 | 40,905 | 104,106 | 2.56 | | | | | |
| 672 | 42,602 | 126,013 | 3.32 | | | | | |
| 673 | 48,494 | 136,966 | 2.89 | 38.0 | 62.0 | 0.370 | 0.500 | 0.130 |
| 674 | 47,598 | 143,633 | 3.13 | 35.8 | 64.2 | 0.400 | 0.484 | 0.116 |
| 675 | 41,148 | 143,959 | 4.30 | | | | | |
| 676 | 26,258 | 53,831 | 1.70 | 39.6 | 60.4 | 0.351 | 0.506 | 0.143 |
| 677 | 22,074 | 45,220 | 1.83 | | | | | |
| 678 | 31,862 | 74,385 | 1.79 | | | | | |
| 679 | 30,900 | 69,477 | 1.92 | 33.4 | 66.6 | 0.430 | 0.471 | 0.099 |
| 680 | 29,821 | 57,073 | 1.73 | 32.1 | 67.9 | 0.448 | 0.452 | 0.090 |
| 681 | 31,419 | 65,484 | 1.73 | | | | | |
| 682 | 48,148 | 128,964 | 2.21 | 42.7 | 57.3 | 0.316 | 0.516 | 0.169 |
| 683 | 47,359 | 121,821 | 2.02 | | | | | |
| 684 | 46,091 | 100,646 | 1.85 | | | | | |
| 685 | 47,125 | 118,463 | 2.26 | | | | | |
| 686 | 49,287 | 136,556 | 2.48 | | | | | |
| 687 | 43,545 | 137,060 | 2.70 | 34.0 | 66.0 | 0.418 | 0.485 | 0.097 |
| 688 | 19,633 | 39,392 | 1.91 | | | | | |
| 689 | 18,598 | 38,198 | 1.88 | 40.2 | 59.8 | 0.336 | 0.523 | 0.140 |
| 690 | 25,741 | 50,738 | 1.65 | | | | | |
| 691 | 21,063 | 43,176 | 2.11 | | | | | |
| 692 | 26,091 | 51,365 | 1.71 | | | | | |
| 693 | 26,247 | 51,870 | 1.77 | 31.9 | 68. [symbol] | 0.440 | 0.482 | 0.078 |
| 694 | 13,139 | 28,137 | 1.80 | | | | | |
| 695 | 11,473 | 23,442 | 1.77 | 39.4 | 60.5 | 0.358 | 0.500 | 0.144 |
| 696 | 13,713 | 29,828 | 1.81 | | | | | |
| 697 | 12,951 | 28,305 | 1.84 | 33.4 | 68.6 | 0.430 | 0.471 | 0.099 |
| 698 | 14,264 | 29,898 | 1.84 | | | | | |
| 699 | 14,065 | 38,639 | 2.28 | 30.4 | 69.6 | 0.474 | 0.444 | 0.082 |
| 700 | 4,234 | 9,401 | 1.74 | | | | | |
| 701 | 4,558 | 9,083 | 1.67 | 34.6 | 65.4 | 0.427 | 0.454 | 0.119 |
| 702 | 5,121 | 11,539 | 1.76 | | | | | |
| 703 | 5,359 | 12,632 | 1.83 | | | | | |
| 704 | 5,255 | 11,083 | 1.79 | | | | | |
| 705 | 5,893 | 11,000 | 1.59 | 28.4 | 71.5 | 0.519 | 0.395 | 0.006 |

[symbol]

indicates data missing or illegible when filed

TABLE 2
Comparative propylene polymerization data using highly isotactic catalysts.
Standard conditions include 1.1 equiv. activator when activator A, or C used, or 500 equiv. activator when
activator D is used. Activator IDs are [PhMe₂NH][B(C₆F₅)₄] is A where C₆F₅ is perfluorophenyl;
[PhMe₂NH][B(C₁₀F₇)₄] is C where C₁₀F₇ is perfluoronaphthalen-2-yl; and methylalumoxane (MAO) is D.
When activators A, B or C are used, 0.5 umol TnOAl (tri-n-octylaluminum) is used as a scavenger. 1 ml
propylene and a total of 4.1 mL of solvents were used. The reaction was stirred at 800 rpm, and the reaction
was quenched after 8 psi of pressure loss or a maximum of 30 minutes of reaction time is quench pressure was
not met, or unless specified otherwise. Catalyst C₁ was preactivated with 20 equiv. of MAO prior to injection
into the reactor with a total of 500 equiv. of MAO was used for the reaction. **a quench pressure of 20 psi
pressure loss was used. *a quench pressure of 15 psi pressure loss or a maximum of 15 minutes reaction time
was used. Equivalents (equiv.) are given as molar ratios.

| | | | | | | | | | Activity (g | | | | | |
|---|---|---|---|---|---|---|---|---|---|---|---|---|---|---|
| | Cat | Act | Cat | Iso-hexane | Tol-uene | T | Quench | yield | P/mmol | Mn | Mw | Mz | PDI | Tm |
| Ex# | ID | ID | (umol) | (uL) | (uL) | (C.) | time (s) | (g) | cat · hr) | (g/mol) | (g/mol) | (g/mol) | ( [symbol] /Mn) | (° C.) |
| C-1** | C1 | D | 0.080 | 3839 | 259 | 40 | 901 | 0.0194 | 969 | 473,913 | 682,112 | | 1.44 | 158.7 |
| C-2** | C1 | D | 0.080 | 3839 | 259 | 40 | 900 | 0.0234 | 1,170 | 626,564 | 902,587 | | 1.44 | 158.3 |
| C-3** | C1 | D | 0.080 | 3839 | 259 | 40 | 900 | 0.0214 | 1,070 | 531,283 | 810,946 | | 1.53 | 158.2 |
| C-4** | C1 | D | 0.000 | 3839 | 259 | 40 | 900 | 0.0155 | 775 | 461,513 | 616,297 | | 1.34 | 158.1 |
| C-5** | C1 | D | 0.080 | 3839 | 259 | 40 | 901 | 0.0302 | 1,508 | 483,465 | 820,673 | | 1.70 | 157.3 |
| C-6** | C1 | D | 0.080 | 3839 | 259 | 40 | 901 | 0.0425 | 2,124 | 542,135 | 936,373 | | 1.73 | 152.2 |
| C-7** | C1 | D | 0.080 | 3839 | 259 | 70 | 652 | 0.1789 | 12,349 | 751,244 | 1,072,754 | | 1.43 | 159.9 |
| C-8** | C1 | D | 0.080 | 3839 | 259 | 70 | 680 | 0.1325 | 8,765 | 772,306 | 1,173,134 | | 1.52 | 157.9 |
| C-9** | C1 | D | 0.080 | 3839 | 259 | 70 | 588 | 0.2026 | 15,516 | 525,234 | 991,247 | | 1.89 | 157.8 |
| C-10** | C1 | D | 0.080 | 3839 | 259 | 70 | 706 | 0.1980 | 12,613 | 728,609 | 1,124,202 | | 1.54 | 157.3 |
| C-11** | C1 | D | 0.080 | 3839 | 259 | 70 | 656 | 0.1355 | 9,289 | 765,034 | 1,101,564 | | 1.44 | 157.2 |
| C-12** | C1 | D | 0.080 | 3839 | 259 | 70 | 691 | 0.1708 | 11,125 | 819,208 | 1,150,050 | | 1.40 | 157.1 |
| C-13** | C1 | D | 0.080 | 3839 | 259 | 100 | 303 | 0.1501 | 22,300 | 214,360 | 316,777 | | 1.48 | 158.2 |
| C-14** | C1 | D | 0.080 | 3839 | 259 | 100 | 286 | 0.1363 | 21,453 | 197,114 | 310,112 | | 1.57 | 157.0 |
| C-15** | C1 | D | 0.080 | 3839 | 259 | 100 | 322 | 0.1384 | 19,318 | 207,479 | 318,331 | | 1.53 | 156.8 |
| C-16** | C1 | D | 0.080 | 3839 | 259 | 100 | 304 | 0.1369 | 20,285 | 190,725 | 316,437 | | 1.66 | 156.6 |
| C-17** | C1 | D | 0.080 | 3839 | 259 | 100 | 300 | 0.1299 | 19,504 | 179,814 | 288,837 | | 1.61 | 156.5 |
| C-18** | C1 | D | 0.080 | 3839 | 259 | 100 | 320 | 0.1191 | 16,733 | 171,710 | 271,795 | | 1.58 | 155.9 |
| C-19* | C2 | A | 0.020 | 3890 | 210 | 70 | 1089 | 0.2852 | 47,149 | 772,875 | 1,187,870 | | 1.54 | 160.6 |
| C-20* | C2 | A | 0.020 | 3890 | 210 | 70 | 1179 | 0.2381 | 36,367 | 523,109 | 765,580 | | 1.46 | 160.5 |
| C-21* | C2 | A | 0.020 | 3890 | 210 | 70 | 1079 | 0.1993 | 33,241 | 853,584 | 1,212,983 | | 1.42 | 160.0 |
| C-22 | C2 | A | 0.025 | 3895 | 205 | 70 | 417 | 0.1074 | 37,088 | 723,734 | 1,269,304 | 2,907,247 | 1.75 | 163.6 |
| C-23 | C2 | A | 0.025 | 3895 | 205 | 70 | 323 | 0.2909 | 129,689 | 516,715 | 963,614 | 2,385,727 | 1.86 | 162.4 |
| C-24 | C2 | A | 0.025 | 3895 | 205 | 70 | 268 | 0.3633 | 195,206 | 251,696 | 665,814 | 2,086,521 | 2.65 | 161.7 |
| C-25* | C2 | A | 0.020 | 3890 | 210 | 100 | 654 | 0.1398 | 38,507 | 182,851 | 318,301 | | 1.74 | 156.7 |
| C-26* | C2 | A | 0.020 | 3890 | 210 | 100 | 533 | 0.1509 | 50,961 | 214,187 | 313,219 | | 1.46 | 156.6 |
| C-27* | C2 | A | 0.020 | 3890 | 210 | 100 | 539 | 0.1451 | 46,436 | 191,837 | 273,363 | | 1.42 | 156.3 |
| C-28 | C2 | A | 0.025 | 3895 | 205 | 100 | 97 | 0.1505 | 223,423 | 125,019 | 215,082 | 445,762 | 1.72 | 155.8 |
| C-29 | C2 | A | 0.025 | 3895 | 205 | 100 | 120 | 0.1669 | 200,280 | 105,326 | 208,174 | 489,364 | 1.98 | 155.5 |
| C-30 | C2 | A | 0.025 | 3895 | 205 | 100 | 254 | 0.0678 | 38,438 | 140,442 | 243,853 | 502,914 | 1.74 | 154.8 |
| C-31* | C2 | C | 0.020 | 3890 | 210 | 70 | 459 | 0.3234 | 126,879 | 505,090 | 860,397 | | 1.70 | 161.4 |
| C-32* | C2 | C | 0.020 | 3890 | 210 | 70 | 482 | 0.3581 | 133,675 | 438,764 | 786,227 | | 1.79 | 160.0 |
| C-33* | C2 | C | 0.020 | 3890 | 210 | 70 | 546 | 0.3704 | 122,043 | 400,607 | 880,474 | | 2.20 | 158.9 |
| C-36* | C2 | C | 0.020 | 3890 | 210 | 100 | 282 | 0.1732 | 110,671 | 191,899 | 283,522 | | 1.48 | 157.3 |
| C-37* | C2 | C | 0.020 | 3890 | 210 | 100 | 305 | 0.1669 | 98,466 | 162,543 | 256,939 | | 1.58 | 156.4 |
| C-38* | C2 | C | 0.020 | 3890 | 210 | 100 | 276 | 0.1636 | 106,851 | 183,044 | 266,686 | | 1.46 | 155.9 |
| C-39 | C2 | D | 0.040 | 0 | 4099 | 70 | 188 | 0.3404 | 162,957 | 298,482 | 630,605 | 1,671,736 | 2.11 | 159.6 |
| C-40 | C2 | D | 0.040 | 0 | 4099 | 70 | 256 | 0.4490 | 157,852 | 224,554 | 560,175 | 1,621,450 | 2.49 | 159.5 |
| C-41 | C2 | D | 0.040 | 0 | 4099 | 70 | 234 | 0.4033 | 155,115 | 203,125 | 534,216 | 1,609,964 | 2.63 | 158.1 |
| C-42 | C2 | D | 0.040 | 0 | 4099 | 100 | 123 | 0.1486 | 108,732 | 166,877 | 308,565 | 674,227 | 1.85 | 157.7 |
| C-43 | C2 | D | 0.040 | 0 | 4099 | 100 | 114 | 0.1373 | 108,395 | 166,844 | 307,246 | 685,825 | 1.84 | 156.3 |
| C-44 | C2 | D | 0.040 | 0 | 4099 | 100 | 115 | 0.1392 | 108,939 | 163,385 | 298,673 | 629,187 | 1.83 | 156.3 |
| C-45 | 55 | A | 0.025 | 3790 | 310 | 70 | 1801 | −0.0012 | −96 | | | | | |
| C-46 | 55 | A | 0.025 | 3790 | 310 | 70 | 1800 | −0.0013 | −104 | | | | | |
| C-47 | 55 | A | 0.025 | 3790 | 310 | 70 | 1801 | −0.0012 | −96 | | | | | |
| C-48 | 55 | A | 0.025 | 3790 | 310 | 100 | 1801 | −0.0010 | −80 | | | | | |
| C-49 | 55 | A | 0.025 | 3790 | 310 | 100 | 1801 | −0.0011 | −88 | | | | | |
| C-50 | 55 | A | 0.025 | 3790 | 310 | 100 | 1800 | −0.0004 | −32 | | | | | |

[symbol]

indicates data missing or illegible when filed

TABLE 3
¹³C NMR data for select examples and comparative examples from Tables 1 and 2.
\hat{ }Indicates samples that were combined for NMR analysis. More specifically, the following examples were combined for
¹³C NMR analysis: 160-161; 169 & 171; 179-179; 230-231; 260 & 262; 266-268; 298-300; 326, 328 & 329; 349-351; 376-
378; 379-381; 394 & 396; 397-399; 404-405; 406-408; 409-411; 412-413; 415-417; 418-420; 421-423; 454-456; 457-459;
469-471; 475-477; 514-515; 517-518; 523-524; 528-530; 534-536; 552-553; 558-560.

| | | | | | | | | | | | | | 2,1-regio | 2,1-regio | 2,1-regio | | |
|---|---|---|---|---|---|---|---|---|---|---|---|---|---|---|---|---|---|
| | | | | | | | | | | | | stereo | (ee) | (et) | (te) | 1,3-regio | ave. |
| | | | | | | | mmrm | | | | | defects/ | defects/ | defects/ | defects/ | defects/ | meso |
| | Cat | Act | | | | | + | | | | | 10000 | 10000 | 10000 | 10000 | 10000 | run |
| Ex# | ID | ID | mmmm | mmnr | rmmr | mmrr | rmrr | rmrm | rrr | mrr | mrrm | monomer | monomer | monomer | monomer | monomer | length |
| 1 | 1 | A | 0.972 | 0.005 | 0.006 | 0.007 | 0.003 | 0.001 | 0.001 | 0.002 | 0.004 | 52.1 | 24.3 | 5.6 | 0.0 | 0.0 | 122.0 |
| 4 | 1 | A | 0.974 | 0.005 | 0.004 | 0.008 | 0.003 | 0.001 | 0.000 | 0.001 | 0.003 | 59.8 | 17.3 | 4.6 | 0.0 | 0.0 | 122.4 |
| 7 | 1 | A | 0.965 | 0.006 | 0.007 | 0.008 | 0.003 | 0.002 | 0.002 | 0.003 | 0.005 | 64.7 | 23.0 | 6.2 | 0.0 | 0.0 | 106.5 |
| 11 | 1 | A | 0.961 | 0.006 | 0.009 | 0.011 | 0.005 | 0.002 | 0.001 | 0.001 | 0.004 | 88.2 | 15.0 | 3.3 | 0.0 | 0.0 | 93.9 |
| 14 | 2 | A | 0.977 | 0.003 | 0.007 | 0.004 | 0.003 | 0.001 | 0.001 | 0.002 | 0.002 | 41.3 | 14.9 | 3.1 | 0.0 | 0.0 | 168.6 |
| 17 | 2 | A | 0.981 | 0.004 | 0.003 | 0.004 | 0.003 | 0.001 | 0.000 | 0.001 | 0.002 | 39.3 | 15.3 | 2.1 | 0.0 | 0.0 | 176.4 |
| 20 | 2 | A | 0.966 | 0.005 | 0.009 | 0.007 | 0.005 | 0.001 | 0.001 | 0.002 | 0.004 | 62.5 | 18.3 | 4.0 | 0.0 | 0.0 | 117.9 |
| 24 | 2 | A | 0.962 | 0.006 | 0.009 | 0.008 | 0.007 | 0.002 | 0.001 | 0.001 | 0.003 | 86.8 | 16.0 | 0.0 | 0.0 | 0.0 | 97.3 |
| 26 | 3 | A | 0.964 | 0.008 | 0.006 | 0.010 | 0.004 | 0.002 | 0.000 | 0.001 | 0.004 | 78.0 | 64.9 | 9.1 | 0.0 | 3.8 | 64.2 |
| 28 | 3 | A | 0.968 | 0.010 | 0.004 | 0.008 | 0.004 | 0.001 | 0.001 | 0.001 | 0.004 | 62.4 | 68.4 | 10.2 | 0.0 | 2.9 | 69.5 |
| 32 | 3 | A | 0.953 | 0.008 | 0.007 | 0.011 | 0.006 | 0.003 | 0.002 | 0.002 | 0.007 | 100.5 | 66.5 | 11.0 | 0.0 | 0.0 | 56.2 |
| 35 | 3 | A | 0.941 | 0.013 | 0.011 | 0.013 | 0.007 | 0.005 | 0.002 | 0.002 | 0.007 | 120.6 | 68.2 | 10.7 | 0.0 | 11.5 | 47.4 |
| 38 | 4 | A | 0.964 | 0.005 | 0.009 | 0.007 | 0.008 | 0.001 | 0.001 | 0.003 | 0.003 | 74.1 | 48.8 | 6.1 | 0.0 | 0.0 | 77.5 |
| 39 | 4 | A | 0.947 | 0.005 | 0.007 | 0.007 | 0.007 | 0.004 | 0.002 | 0.010 | 0.011 | 84.9 | 48.3 | 0.0 | 0.0 | 21.3 | 64.7 |
| 41 | 4 | A | 0.945 | 0.008 | 0.009 | 0.010 | 0.016 | 0.001 | 0.002 | 0.004 | 0.004 | 132.8 | 50.9 | 0.0 | 0.0 | 0.0 | 54.4 |
| 45 | 4 | A | 0.944 | 0.010 | 0.008 | 0.010 | 0.016 | 0.003 | 0.002 | 0.003 | 0.004 | 137.2 | 47.3 | 0.0 | 0.0 | 7.8 | 52.0 |
| 47 | 5 | A | 0.977 | 0.004 | 0.005 | 0.004 | 0.003 | 0.001 | 0.001 | 0.002 | 0.003 | 42.1 | 14.7 | 3.6 | 0.0 | 0.0 | 165.6 |
| 49 | 5 | A | 0.976 | 0.004 | 0.006 | 0.004 | 0.003 | 0.001 | 0.000 | 0.002 | 0.002 | 43.6 | 15.0 | 3.6 | 0.0 | 0.0 | 160.8 |
| 51 | 5 | A | 0.975 | 0.005 | 0.005 | 0.006 | 0.003 | 0.000 | 0.001 | 0.002 | 0.003 | 45.0 | 17.9 | 3.9 | 0.0 | 0.0 | 149.7 |
| 52 | 5 | A | 0.979 | 0.005 | 0.005 | 0.004 | 0.003 | 0.000 | 0.000 | 0.001 | 0.002 | 35.9 | 16.9 | 3.9 | 0.0 | 0.0 | 176.4 |
| 53 | 5 | A | 0.968 | 0.005 | 0.007 | 0.007 | 0.004 | 0.002 | 0.001 | 0.002 | 0.004 | 63.7 | 16.0 | 4.7 | 0.0 | 0.0 | 118.5 |
| 61 | 5 | A | 0.972 | 0.008 | 0.004 | 0.007 | 0.003 | 0.001 | 0.000 | 0.000 | 0.004 | 58.9 | 56.0 | 9.9 | 0.0 | 2.6 | 78.5 |
| 62 | 5 | A | 0.958 | 0.005 | 0.010 | 0.007 | 0.007 | 0.003 | 0.001 | 0.005 | 0.006 | 81.2 | 15.7 | 0.0 | 0.0 | 0.0 | 103.2 |
| 63 | 5 | A | 0.961 | 0.007 | 0.007 | 0.008 | 0.005 | 0.002 | 0.002 | 0.003 | 0.005 | 71.6 | 17.3 | 4.5 | 0.0 | 0.0 | 107.1 |
| 66 | 5 | A | 0.935 | 0.007 | 0.016 | 0.012 | 0.012 | 0.004 | 0.002 | 0.004 | 0.008 | 139.4 | 16.6 | 0.0 | 0.0 | 0.0 | 64.1 |
| 71 | 5 | A | 0.954 | 0.009 | 0.009 | 0.009 | 0.007 | 0.003 | 0.002 | 0.001 | 0.005 | 97.9 | 19.6 | 0.0 | 0.0 | 0.0 | 85.1 |
| 73 | 5 | A | 0.962 | 0.006 | 0.011 | 0.007 | 0.006 | 0.001 | 0.001 | 0.003 | 0.003 | 69.0 | 15.1 | 4.5 | 0.0 | 0.0 | 112.9 |
| 75 | 5 | A | 0.956 | 0.006 | 0.011 | 0.008 | 0.007 | 0.002 | 0.001 | 0.004 | 0.005 | 84.4 | 14.9 | 4.4 | 0.0 | 0.0 | 96.4 |
| 78 | 5 | B | 0.964 | 0.007 | 0.010 | 0.007 | 0.004 | 0.001 | 0.001 | 0.003 | 0.004 | 63.7 | 22.3 | 4.3 | 0.0 | 0.0 | 110.7 |
| 83 | 5 | C | 0.971 | 0.005 | 0.007 | 0.006 | 0.004 | 0.001 | 0.000 | 0.002 | 0.003 | 51.5 | 17.2 | 4.9 | 0.0 | 0.0 | 135.9 |
| 88 | 5 | C | 0.961 | 0.006 | 0.008 | 0.008 | 0.005 | 0.002 | 0.001 | 0.003 | 0.005 | 75.4 | 24.5 | 4.2 | 0 | 0.0 | 96.1 |
| 91 | 6 | A | 0.958 | 0.008 | 0.008 | 0.010 | 0.005 | 0.003 | 0.001 | 0.001 | 0.005 | 89.9 | 60.6 | 9.9 | 0.0 | 3.9 | 60.9 |
| 93 | 6 | A | 0.960 | 0.008 | 0.007 | 0.008 | 0.006 | 0.002 | 0.001 | 0.002 | 0.005 | 80.4 | 71.9 | 8.5 | 0.0 | 0.0 | 62.2 |
| 96 | 6 | A | 0.954 | 0.009 | 0.009 | 0.010 | 0.006 | 0.003 | 0.002 | 0.001 | 0.005 | 95.9 | 56.9 | 9.5 | 0.0 | 4.3 | 60.0 |
| 99 | 6 | A | 0.960 | 0.013 | 0.005 | 0.010 | 0.004 | 0.002 | 0.001 | 0.001 | 0.005 | 76.2 | 68.9 | 11.2 | 0.0 | 3.8 | 62.5 |
| 102 | 6 | A | 0.960 | 0.009 | 0.009 | 0.001 | 0.007 | 0.003 | 0.001 | 0.004 | 0.007 | 47.1 | 168.3 | 10.4 | 0.0 | 0.0 | 44.3 |
| 106 | 6 | A | 0.959 | 0.012 | 0.005 | 0.011 | 0.005 | 0.002 | 0.000 | 0.000 | 0.005 | 87.1 | 61.5 | 10.2 | 0.0 | 11.9 | 58.6 |
| 107 | 6 | B | 0.969 | 0.007 | 0.010 | 0.000 | 0.005 | 0.001 | 0.001 | 0.003 | 0.005 | 28.0 | 161.2 | 8.8 | 0.0 | 0.0 | 50.5 |
| 113 | 6 | C | 0.958 | 0.008 | 0.008 | 0.009 | 0.005 | 0.002 | 0.001 | 0.003 | 0.005 | 80.2 | 75.9 | 10.1 | 0.0 | 0.0 | 60.2 |
| 116 | 6 | C | 0.953 | 0.009 | 0.009 | 0.010 | 0.006 | 0.002 | 0.001 | 0.003 | 0.006 | 91.9 | 80.7 | 9.9 | 0.0 | 0.0 | 54.8 |
| 119 | 7 | A | 0.975 | 0.004 | 0.007 | 0.005 | 0.003 | 0.001 | 0.001 | 0.002 | 0.003 | 43.8 | 12.8 | 4.1 | 0.0 | 0.0 | 164.7 |
| 123 | 7 | A | 0.979 | 0.005 | 0.004 | 0.005 | 0.003 | 0.001 | 0.001 | 0.001 | 0.002 | 43.8 | 11.4 | 2.6 | 0.0 | 1.0 | 170.1 |
| 126 | 7 | A | 0.960 | 0.006 | 0.010 | 0.009 | 0.006 | 0.002 | 0.001 | 0.002 | 0.005 | 83.8 | 10.4 | 0.0 | 0.0 | 0.0 | 106.2 |
| 130 | 7 | A | 0.968 | 0.008 | 0.006 | 0.007 | 0.004 | 0.002 | 0.001 | 0.001 | 0.003 | 61.2 | 13.3 | 3.7 | 0.0 | 3.1 | 123.0 |
| 133 | 8 | A | 0.953 | 0.011 | 0.007 | 0.014 | 0.004 | 0.001 | 0.001 | 0.003 | 0.007 | 93.7 | 32.2 | 11.0 | 0.0 | 0.0 | 73.0 |
| 136 | 8 | A | 0.960 | 0.010 | 0.004 | 0.013 | 0.003 | 0.002 | 0.001 | 0.001 | 0.007 | 85.3 | 30.1 | 11.5 | 0.0 | 1.7 | 77.8 |
| 138 | 8 | A | 0.945 | 0.011 | 0.010 | 0.015 | 0.005 | 0.003 | 0.001 | 0.003 | 0.008 | 109.4 | 25.7 | 12.9 | 0.0 | 0.0 | 67.6 |
| 141 | 8 | A | 0.947 | 0.011 | 0.008 | 0.015 | 0.005 | 0.003 | 0.002 | 0.002 | 0.008 | 113.2 | 27.3 | 9.6 | 0.0 | 4.9 | 64.5 |
| 144 | 9 | A | 0.960 | 0.004 | 0.004 | 0.005 | 0.003 | 0.001 | 0.001 | 0.001 | 0.003 | 44.0 | 13.6 | 2.8 | 0.0 | 0.0 | 165.6 |
| 148 | 9 | A | 0.976 | 0.005 | 0.004 | 0.006 | 0.003 | 0.001 | 0.001 | 0.001 | 0.003 | 52.9 | 13.0 | 2.2 | 0.0 | 2.3 | 142.0 |
| 151 | 9 | A | 0.962 | 0.006 | 0.009 | 0.008 | 0.006 | 0.003 | 0.002 | 0.002 | 0.004 | 82.0 | 14.6 | 0.0 | 0.0 | 0.0 | 103.5 |
| 154 | 9 | A | 0.962 | 0.009 | 0.007 | 0.007 | 0.006 | 0.003 | 0.001 | 0.001 | 0.004 | 80.5 | 13.7 | 0.0 | 0.0 | 0.0 | 106.2 |
| 155 | 10 | A | 0.961 | 0.005 | 0.011 | 0.008 | 0.006 | 0.001 | 0.001 | 0.003 | 0.004 | 72.4 | 17.5 | 0.0 | 0.0 | 0.0 | 111.2 |
| 158 | 10 | A | 0.971 | 0.005 | 0.005 | 0.007 | 0.004 | 0.002 | 0.001 | 0.001 | 0.004 | 65.8 | 22.6 | 3.6 | 0.0 | 0.0 | 108.7 |
| 160\hat{ } | 10 | A | 0.958 | 0.005 | 0.012 | 0.009 | 0.007 | 0.002 | 0.001 | 0.003 | 0.003 | 86.7 | 22.2 | 0.0 | 0.0 | 0.0 | 91.8 |
| 161\hat{ } | 10 | A | 0.958 | 0.005 | 0.012 | 0.009 | 0.007 | 0.002 | 0.001 | 0.003 | 0.003 | 86.7 | 22.2 | 0.0 | 0.0 | 0.0 | 91.8 |
| 163 | 10 | A | 0.953 | 0.007 | 0.011 | 0.010 | 0.009 | 0.003 | 0.001 | 0.001 | 0.004 | 111.2 | 23.4 | 0.0 | 0.0 | 0.0 | 74.3 |
| 168 | 11 | A | 0.979 | 0.003 | 0.006 | 0.004 | 0.004 | 0.002 | 0.001 | 0.000 | 0.002 | 48.1 | 16.7 | 0.0 | 0.0 | 0.0 | 154.3 |
| 169\hat{ } | 11 | A | 0.968 | 0.004 | 0.009 | 0.006 | 0.006 | 0.002 | 0.001 | 0.001 | 0.003 | 70.9 | 18.7 | 0.0 | 0.0 | 0.0 | 111.6 |
| 171\hat{ } | 11 | A | 0.968 | 0.004 | 0.009 | 0.006 | 0.006 | 0.002 | 0.001 | 0.001 | 0.003 | 70.9 | 18.7 | 0.0 | 0.0 | 0.0 | 111.6 |
| 172 | 12 | A | 0.973 | 0.006 | 0.005 | 0.002 | 0.002 | 0.001 | 0.001 | 0.002 | 0.004 | 52.8 | 19.3 | 4.9 | 0.0 | 0.0 | 129.9 |
| 177 | 12 | A | 0.962 | 0.007 | 0.005 | 0.010 | 0.005 | 0.003 | 0.001 | 0.001 | 0.006 | 88.4 | 18.2 | 3.8 | 0.0 | 0.0 | 90.6 |
| 178\hat{ } | 12 | A | 0.964 | 0.007 | 0.007 | 0.009 | 0.003 | 0.001 | 0.001 | 0.002 | 0.005 | 66.1 | 23.9 | 7.2 | 0.0 | 0.0 | 102.9 |
| 179\hat{ } | 12 | A | 0.964 | 0.007 | 0.007 | 0.009 | 0.003 | 0.001 | 0.001 | 0.002 | 0.005 | 66.1 | 23.9 | 7.2 | 0.0 | 0.0 | 102.9 |
| 182 | 12 | A | 0.948 | 0.008 | 0.010 | 0.011 | 0.009 | 0.004 | 0.002 | 0.002 | 0.006 | 121.0 | 17.7 | 0.0 | 0.0 | 0.0 | 72.1 |
| 184 | 13 | A | 0.960 | 0.008 | 0.007 | 0.012 | 0.005 | 0.002 | 0.001 | 0.002 | 0.005 | 89.3 | 89.7 | 12.6 | 0.0 | 0.0 | 52.2 |
| 189 | 13 | A | 0.956 | 0.009 | 0.007 | 0.012 | 0.008 | 0.003 | 0.001 | 0.001 | 0.004 | 105.9 | 81.8 | 11.9 | 0.0 | 6.2 | 48.6 |
| 192 | 13 | A | 0.951 | 0.009 | 0.008 | 0.013 | 0.007 | 0.002 | 0.002 | 0.003 | 0.006 | 105.9 | 96.2 | 13.8 | 0.0 | 0.0 | 46.3 |
| 195 | 13 | A | 0.939 | 0.010 | 0.009 | 0.014 | 0.011 | 0.005 | 0.002 | 0.002 | 0.008 | 141.2 | 88.1 | 12.5 | 0.0 | 9.4 | 39.8 |
| 198 | 14 | A | 0.974 | 0.003 | 0.007 | 0.005 | 0.004 | 0.001 | 0.001 | 0.002 | 0.003 | 51.2 | 14.2 | 0.0 | 0.0 | 0.0 | 152.9 |
| 199 | 14 | A | 0.967 | 0.006 | 0.007 | 0.007 | 0.005 | 0.002 | 0.001 | 0.001 | 0.003 | 68.0 | 15.3 | 0.0 | 0.0 | 0.0 | 120.0 |
| 202 | 14 | A | 0.967 | 0.005 | 0.007 | 0.007 | 0.004 | 0.002 | 0.001 | 0.003 | 0.004 | 63.3 | 19.6 | 3.7 | 0.0 | 0.0 | 115.5 |
| 205 | 14 | A | 0.955 | 0.005 | 0.009 | 0.010 | 0.006 | 0.003 | 0.001 | 0.001 | 0.010 | 92.0 | 18.4 | 0.0 | 0.0 | 0.0 | 90.6 |
| 208 | 15 | A | 0.977 | 0.004 | 0.007 | 0.005 | 0.003 | 0.001 | 0.000 | 0.002 | 0.002 | 45.4 | 13.0 | 3.1 | 0.0 | 0.0 | 162.6 |
| 211 | 15 | A | 0.982 | 0.004 | 0.003 | 0.005 | 0.002 | 0.001 | 0.000 | 0.000 | 0.002 | 40.6 | 12.4 | 2.1 | 0.0 | 0.0 | 181.5 |
| 215 | 15 | A | 0.964 | 0.005 | 0.009 | 0.007 | 0.006 | 0.002 | 0.001 | 0.002 | 0.004 | 74.9 | 13.7 | 0.0 | 0.0 | 0.0 | 112.9 |
| 219 | 15 | A | 0.964 | 0.006 | 0.008 | 0.010 | 0.005 | 0.002 | 0.001 | 0.001 | 0.002 | 87.7 | 13.2 | 0.0 | 0.0 | 0.0 | 99.1 |
| 224 | 16 | A | 0.980 | 0.004 | 0.004 | 0.003 | 0.004 | 0.001 | 0.000 | 0.000 | 0.002 | 44.9 | 11.4 | 0.0 | 0.0 | 0.0 | 177.6 |
| 230\hat{ } | 16 | A | 0.962 | 0.005 | 0.008 | 0.005 | 0.008 | 0.003 | 0.002 | 0.002 | 0.005 | 84.0 | 17.1 | 0.0 | 0.0 | 0.0 | 98.9 |
| 231\hat{ } | 16 | A | 0.962 | 0.005 | 0.008 | 0.005 | 0.008 | 0.003 | 0.002 | 0.002 | 0.005 | 84.0 | 17.1 | 0.0 | 0.0 | 0.0 | 98.9 |
| 257 | 19 | A | 0.987 | 0.001 | 0.005 | 0.002 | 0.002 | 0.000 | 0.000 | 0.001 | 0.001 | 23.6 | 5.4 | 0.0 | 0.0 | 0.0 | 344.8 |
| 260\hat{ } | 19 | A | 0.990 | 0.002 | 0.002 | 0.002 | 0.002 | 0.001 | 0.000 | 0.000 | 0.001 | 22.8 | 8.9 | 0.0 | 0.0 | 0.0 | 315.5 |
| 262\hat{ } | 19 | A | 0.990 | 0.002 | 0.002 | 0.002 | 0.002 | 0.001 | 0.000 | 0.000 | 0.001 | 22.8 | 8.9 | 0.0 | 0.0 | 0.0 | 315.5 |
| 264 | 19 | A | 0.984 | 0.001 | 0.006 | 0.002 | 0.002 | 0.001 | 0.001 | 0.001 | 0.001 | 26.5 | 8.9 | 0.0 | 0.0 | 0.0 | 282.5 |
| 266\hat{ } | 19 | A | 0.981 | 0.004 | 0.003 | 0.004 | 0.003 | 0.001 | 0.001 | 0.001 | 0.002 | 42.7 | 15.8 | 0.0 | 0.0 | 0.0 | 170.9 |
| 267\hat{ } | 19 | A | 0.981 | 0.004 | 0.003 | 0.004 | 0.003 | 0.001 | 0.001 | 0.001 | 0.002 | 42.7 | 15.8 | 0.0 | 0.0 | 0.0 | 170.9 |
| 268\hat{ } | 19 | A | 0.981 | 0.004 | 0.003 | 0.004 | 0.003 | 0.001 | 0.001 | 0.001 | 0.002 | 42.7 | 15.8 | 0.0 | 0.0 | 0.0 | 170.9 |
| 274 | 20 | A | 0.986 | 0.003 | 0.001 | 0.003 | 0.003 | 0.001 | 0.000 | 0.000 | 0.001 | 34.7 | 49.7 | 0.0 | 0.0 | 0.0 | 118.5 |
| 278 | 20 | A | 0.975 | 0.005 | 0.007 | 0.006 | 0.005 | 0.002 | 0.000 | 0.000 | 0.000 | 64.3 | 57.6 | 0.0 | 0.0 | 0.0 | 82.0 |
| 281 | 21 | A | 0.986 | 0.002 | 0.003 | 0.003 | 0.002 | 0.001 | 0.000 | 0.000 | 0.001 | 32.2 | 21.3 | 0.0 | 0.0 | 0.0 | 186.9 |
| 283 | 21 | A | 0.980 | 0.003 | 0.004 | 0.005 | 0.003 | 0.002 | 0.000 | 0.000 | 0.002 | 46.6 | 25.5 | 0.0 | 0.0 | 0.0 | 138.7 |
| 287 | 23 | A | 0.980 | 0.002 | 0.006 | 0.003 | 0.003 | 0.001 | 0.001 | 0.002 | 0.002 | 36.3 | 10.6 | 0.0 | 0.0 | 0.0 | 213.2 |
| 291 | 23 | A | 0.982 | 0.003 | 0.006 | 0.004 | 0.002 | 0.000 | 0.000 | 0.001 | 0.001 | 31.4 | 11.4 | 0.0 | 0.0 | 0.0 | 233.6 |
| 294 | 23 | A | 0.980 | 0.003 | 0.006 | 0.003 | 0.003 | 0.001 | 0.000 | 0.001 | 0.002 | 36.5 | 11.9 | 0.0 | 0.0 | 0.0 | 206.6 |
| 295 | 23 | A | 0.973 | 0.005 | 0.007 | 0.005 | 0.004 | 0.002 | 0.001 | 0.001 | 0.003 | 52.5 | 15.3 | 0.0 | 0.0 | 0.0 | 147.5 |
| 298\hat{ } | 23 | A | 0.974 | 0.004 | 0.009 | 0.006 | 0.004 | 0.000 | 0.000 | 0.002 | 0.000 | 48.8 | 18.5 | 0.0 | 0.0 | 0.0 | 148.6 |
| 299\hat{ } | 23 | A | 0.974 | 0.004 | 0.009 | 0.006 | 0.004 | 0.000 | 0.000 | 0.002 | 0.000 | 48.8 | 18.5 | 0.0 | 0.0 | 0.0 | 148.6 |
| 300\hat{ } | 23 | A | 0.974 | 0.004 | 0.009 | 0.006 | 0.004 | 0.000 | 0.000 | 0.002 | 0.000 | 48.8 | 18.5 | 0.0 | 0.0 | 0.0 | 148.5 |
| 305 | 23 | A | 0.963 | 0.005 | 0.009 | 0.008 | 0.006 | 0.002 | 0.002 | 0.002 | 0.004 | 80.6 | 16.1 | 0.0 | 0.0 | 0.0 | 103.4 |
| 310 | 24 | A | 0.980 | 0.005 | 0.003 | 0.005 | 0.003 | 0.001 | 0.001 | 0.001 | 0.003 | 42.8 | 50.5 | 3.2 | 0.0 | 0.0 | 103.6 |
| 313 | 24 | A | 0.974 | 0.006 | 0.004 | 0.006 | 0.004 | 0.001 | 0.001 | 0.001 | 0.003 | 54.9 | 52.2 | 3.4 | 0.0 | 0.0 | 90.5 |
| 317 | 24 | A | 0.974 | 0.006 | 0.004 | 0.007 | 0.004 | 0.001 | 0.001 | 0.001 | 0.003 | 59.7 | 51.4 | 3.6 | 0.0 | 0.0 | 80.2 |
| 321 | 24 | A | 0.971 | 0.007 | 0.004 | 0.007 | 0.004 | 0.001 | 0.001 | 0.001 | 0.004 | 62.0 | 60.5 | 3.8 | 0.0 | 1.8 | 78.1 |
| 326\hat{ } | 25 | A | 0.984 | 0.004 | 0.003 | 0.003 | 0.002 | 0.001 | 0.000 | 0.000 | 0.001 | 33.7 | 8.8 | 0.0 | 0.0 | 0.0 | 235.3 |
| 328\hat{ } | 25 | A | 0.984 | 0.004 | 0.003 | 0.003 | 0.002 | 0.001 | 0.000 | 0.000 | 0.001 | 33.7 | 8.8 | 0.0 | 0.0 | 0.0 | 235.3 |
| 329\hat{ } | 25 | A | 0.984 | 0.004 | 0.003 | 0.003 | 0.002 | 0.001 | 0.000 | 0.000 | 0.001 | 33.7 | 8.8 | 0.0 | 0.0 | 0.0 | 235.3 |
| 340 | 26 | A | 0.936 | 0.014 | 0.009 | 0.019 | 0.008 | 0.002 | 0.001 | 0.001 | 0.009 | 145.0 | 14.5 | 0.0 | 11.0 | 0.0 | 58.7 |
| 344 | 26 | A | 0.913 | 0.018 | 0.011 | 0.024 | 0.012 | 0.004 | 0.003 | 0.002 | 0.012 | 198.4 | 18.3 | 0.0 | 17.2 | 0.0 | 42.8 |
| 349\hat{ } | 26 | D | 0.894 | 0.025 | 0.006 | 0.035 | 0.014 | 0.004 | 0.003 | 0.003 | 0.015 | 262.6 | 58.7 | 0.0 | 46.4 | 0.0 | 27.2 |
| 350\hat{ } | 26 | D | 0.894 | 0.025 | 0.006 | 0.035 | 0.014 | 0.004 | 0.003 | 0.003 | 0.015 | 262.6 | 58.7 | 0.0 | 46.4 | 0.0 | 27.2 |
| 351\hat{ } | 26 | D | 0.894 | 0.025 | 0.006 | 0.035 | 0.014 | 0.004 | 0.003 | 0.003 | 0.015 | 262.6 | 58.7 | 0.0 | 46.4 | 0.0 | 27.2 |
| 353 | 27 | A | 0.916 | 0.017 | 0.013 | 0.024 | 0.010 | 0.003 | 0.002 | 0.004 | 0.012 | 182.8 | 51.9 | 29.0 | 0.0 | 0.0 | 37.9 |
| 355 | 27 | A | 0.918 | 0.020 | 0.010 | 0.027 | 0.011 | 0.003 | 0.000 | 0.000 | 0.012 | 196.1 | 53.8 | 41.2 | 0.0 | 0.0 | 34.4 |
| 360 | 27 | A | 0.899 | 0.020 | 0.012 | 0.030 | 0.013 | 0.005 | 0.002 | 0.004 | 0.015 | 229.6 | 57.0 | 35.2 | 0.0 | 0.0 | 31.1 |
| 361 | 27 | A | 0.890 | 0.027 | 0.016 | 0.034 | 0.015 | 0.006 | 0.001 | 0.002 | 0.008 | 268.1 | 71.1 | 51.2 | 0.0 | 0.0 | 25.6 |
| 365 | 27 | D | 0.919 | 0.025 | 0.005 | 0.029 | 0.005 | 0.001 | 0.001 | 0.000 | 0.015 | 174.1 | 63.8 | 42.6 | 47.9 | 0.0 | 30.5 |
| 368 | 27 | D | 0.898 | 0.027 | 0.008 | 0.036 | 0.009 | 0.002 | 0.001 | 0.002 | 0.018 | 228.8 | 72.9 | 47.1 | 56.9 | 0.0 | 24.6 |
| 372 | 33 | A | 0.955 | 0.009 | 0.009 | 0.014 | 0.005 | 0.002 | 0.000 | 0.001 | 0.005 | 103.1 | 57.4 | 15.5 | 0.0 | 0.0 | 56.8 |
| 374 | 33 | A | 0.933 | 0.011 | 0.010 | 0.022 | 0.007 | 0.003 | 0.002 | 0.002 | 0.008 | 162.5 | 75.9 | 21.8 | 0.0 | 0.0 | 38.4 |
| 376\hat{ } | 34 | A | 0.933 | 0.010 | 0.011 | 0.020 | 0.009 | 0.004 | 0.002 | 0.003 | 0.008 | 163.1 | 72.0 | 27.3 | 0.0 | 0.0 | 38.1 |
| 377\hat{ } | 34 | A | 0.933 | 0.010 | 0.011 | 0.020 | 0.009 | 0.004 | 0.002 | 0.003 | 0.008 | 163.1 | 72.0 | 27.3 | 0.0 | 0.0 | 38.1 |
| 378\hat{ } | 34 | A | 0.933 | 0.010 | 0.011 | 0.020 | 0.009 | 0.004 | 0.002 | 0.003 | 0.008 | 163.1 | 72.0 | 27.3 | 0.0 | 0.0 | 38.1 |
| 379\hat{ } | 34 | A | 0.907 | 0.014 | 0.009 | 0.032 | 0.011 | 0.007 | 0.003 | 0.004 | 0.014 | 238.8 | 88.9 | 27.7 | 0.0 | 0.0 | 28.1 |
| 380\hat{ } | 34 | A | 0.907 | 0.014 | 0.009 | 0.032 | 0.011 | 0.007 | 0.003 | 0.004 | 0.014 | 238.8 | 88.9 | 27.7 | 0.0 | 0.0 | 28.1 |
| 381\hat{ } | 34 | A | 0.907 | 0.014 | 0.009 | 0.032 | 0.011 | 0.007 | 0.003 | 0.004 | 0.014 | 238.8 | 88.9 | 27.7 | 0.0 | 0.0 | 28.1 |
| 383 | 35 | A | 0.949 | 0.011 | 0.011 | 0.016 | 0.005 | 0.002 | 0.001 | 0.001 | 0.006 | 113.9 | 19.3 | 9.0 | 0.0 | 0.0 | 70.3 |
| 385 | 35 | A | 0.931 | 0.014 | 0.009 | 0.022 | 0.008 | 0.002 | 0.001 | 0.001 | 0.010 | 160.5 | 27.7 | 12.6 | 4.7 | 0.0 | 48.7 |
| 390 | 36 | A | 0.930 | 0.014 | 0.009 | 0.026 | 0.007 | 0.002 | 0.002 | 0.001 | 0.009 | 172.2 | 77.9 | 29.5 | 11.9 | 0.0 | 34.3 |
| 391 | 36 | A | 0.914 | 0.017 | 0.009 | 0.032 | 0.009 | 0.003 | 0.002 | 0.002 | 0.013 | 211.8 | 95.9 | 37.8 | 17.7 | 0.0 | 27.5 |
| 394\hat{ } | 37 | A | 0.936 | 0.015 | 0.005 | 0.018 | 0.008 | 0.005 | 0.002 | 0.000 | 0.011 | 152.8 | 44.0 | 0.0 | 0.0 | 0.0 | 50.8 |
| 396\hat{ } | 37 | A | 0.936 | 0.015 | 0.005 | 0.018 | 0.008 | 0.005 | 0.002 | 0.000 | 0.011 | 152.8 | 44.0 | 0.0 | 0.0 | 0.0 | 50.8 |
| 397\hat{ } | 37 | A | 0.904 | 0.021 | 0.005 | 0.025 | 0.019 | 0.006 | 0.004 | 0.002 | 0.016 | 236.3 | 62.3 | 14.7 | 0.0 | 0.0 | 31.9 |
| 398\hat{ } | 37 | A | 0.904 | 0.021 | 0.005 | 0.025 | 0.019 | 0.006 | 0.004 | 0.002 | 0.016 | 236.3 | 62.3 | 14.7 | 0.0 | 0.0 | 31.9 |
| 399\hat{ } | 37 | A | 0.904 | 0.021 | 0.005 | 0.025 | 0.019 | 0.006 | 0.004 | 0.002 | 0.016 | 236.3 | 62.3 | 14.7 | 0.0 | 0.0 | 31.9 |
| 402\hat{ } | 37 | D | 0.918 | 0.005 | 0.015 | 0.023 | 0.017 | 0.004 | 0.003 | 0.003 | 0.012 | 216.0 | 61.3 | 12.9 | 0.0 | 0.0 | 34.5 |
| 404\hat{ } | 37 | D | 0.910 | 0.019 | 0.010 | 0.026 | 0.017 | 0.003 | 0.002 | 0.001 | 0.013 | 218.0 | 87.8 | 23.6 | 0.0 | 0.0 | 30.4 |
| 405\hat{ } | 37 | D | 0.910 | 0.019 | 0.010 | 0.026 | 0.017 | 0.003 | 0.002 | 0.001 | 0.013 | 218.0 | 87.8 | 23.6 | 0.0 | 0.0 | 30.4 |
| 406\hat{ } | 36 | D | 0.951 | 0.011 | 0.009 | 0.013 | 0.004 | 0.004 | 0.001 | 0.000 | 0.009 | 100.3 | 8.7 | 0.0 | 0.0 | 0.0 | 91.7 |
| 407\hat{ } | 38 | A | 0.951 | 0.011 | 0.009 | 0.013 | 0.004 | 0.004 | 0.001 | 0.000 | 0.009 | 100.3 | 8.7 | 0.0 | 0.0 | 0.0 | 91.7 |
| 408\hat{ } | 38 | A | 0.951 | 0.011 | 0.009 | 0.013 | 0.004 | 0.004 | 0.001 | 0.000 | 0.009 | 100.3 | 8.7 | 0.0 | 0.0 | 0.0 | 91.7 |
| 409\hat{ } | 38 | A | 0.910 | 0.004 | 0.009 | 0.021 | 0.022 | 0.008 | 0.004 | 0.007 | 0.015 | 250.4 | 15.1 | 0.0 | 0.0 | 0.0 | 37.7 |
| 410\hat{ } | 38 | A | 0.910 | 0.004 | 0.009 | 0.021 | 0.022 | 0.008 | 0.004 | 0.007 | 0.015 | 250.4 | 15.1 | 0.0 | 0.0 | 0.0 | 37.7 |
| 411\hat{ } | 36 | A | 0.910 | 0.004 | 0.009 | 0.021 | 0.022 | 0.008 | 0.004 | 0.007 | 0.015 | 250.4 | 15.1 | 0.0 | 0.0 | 0.0 | 37.7 |
| 412\hat{ } | 38 | D | 0.961 | 0.009 | 0.005 | 0.013 | 0.005 | 0.001 | 0.000 | 0.000 | 0.006 | 90.1 | 21.4 | 4.9 | 0.0 | 0.0 | 85.9 |
| 413\hat{ } | 38 | D | 0.961 | 0.009 | 0.005 | 0.013 | 0.005 | 0.001 | 0.000 | 0.000 | 0.006 | 90.1 | 21.4 | 4.9 | 0.0 | 0.0 | 85.9 |
| 415\hat{ } | 38 | D | 0.937 | 0.015 | 0.005 | 0.021 | 0.009 | 0.002 | 0.001 | 0.001 | 0.010 | 156.0 | 28.4 | 7.9 | 0.0 | 0.0 | 52.0 |
| 416\hat{ } | 38 | D | 0.937 | 0.015 | 0.005 | 0.021 | 0.009 | 0.002 | 0.001 | 0.001 | 0.010 | 156.0 | 28.4 | 7.9 | 0.0 | 0.0 | 52.0 |
| 417\hat{ } | 38 | D | 0.937 | 0.015 | 0.005 | 0.021 | 0.009 | 0.002 | 0.001 | 0.001 | 0.000 | 156.0 | 28.4 | 7.9 | 0.0 | 0.0 | 52.0 |
| 418\hat{ } | 39 | A | 0.771 | 0.104 | 0.014 | 0.009 | 0.073 | 0.006 | 0.011 | −0.003 | 0.014 | 366.8 | 42.8 | 23.6 | 0.0 | 16.7 | 22.2 |
| 419\hat{ } | 39 | A | 0.771 | 0.104 | 0.014 | 0.009 | 0.073 | 0.006 | 0.011 | −0.003 | 0.014 | 366.8 | 42.8 | 23.6 | 0.0 | 16.7 | 22.2 |
| 420\hat{ } | 39 | A | 0.771 | 0.104 | 0.014 | 0.009 | 0.073 | 0.006 | 0.011 | −0.003 | 0.014 | 366.8 | 42.8 | 23.6 | 0.0 | 16.7 | 22.2 |
| 421\hat{ } | 39 | A | 0.738 | 0.103 | 0.016 | 0.020 | 0.078 | 0.008 | 0.012 | 0.007 | 0.018 | 443.7 | 61.6 | 33.9 | 0.0 | 25.0 | 17.7 |
| 422\hat{ } | 39 | A | 0.738 | 0.103 | 0.016 | 0.020 | 0 078 | 0.008 | 0.012 | 0.007 | 0.018 | 443.7 | 61.6 | 33.9 | 0.0 | 25.0 | 17.7 |
| 423\hat{ } | 39 | A | 0.738 | 0.103 | 0.016 | 0.020 | 0.078 | 0.008 | 0.012 | 0.007 | 0.018 | 443.7 | 61.6 | 33.9 | 0.0 | 25.0 | 17.7 |
| 454\hat{ } | 43 | A | 0.949 | 0.010 | 0.014 | 0.006 | 0.010 | 0.002 | 0.002 | 0.004 | 0.003 | 84.8 | 76.3 | 0.0 | 0.0 | 0.0 | 62.1 |
| 457\hat{ } | 43 | A | 0.939 | 0.015 | 0.015 | 0.007 | 0.013 | 0.003 | 0.001 | 0.003 | 0.003 | 114.1 | 99.6 | 0.0 | 0.0 | 0.0 | 46.8 |
| 469\hat{ } | 45 | A | 0.969 | 0.004 | 0.011 | 0.004 | 0.007 | 0.001 | 0.001 | 0.002 | 0.001 | 59.5 | 85.8 | 0.0 | 0.0 | 0.0 | 68.8 |
| 475\hat{ } | 45 | A | 0.927 | 0.018 | 0.008 | 0.009 | 0.021 | 0.003 | 0.003 | 0.005 | 0.006 | 159.3 | 119.3 | 0.0 | 0.0 | 0.0 | 35.9 |
| 480 | 46 | A | 0.979 | 0.003 | 0.006 | 0.004 | 0.003 | 0.000 | 0.001 | 0.002 | 0.002 | 33.5 | 34.0 | 0.0 | 0.0 | 0.0 | 148.1 |
| 480 | 46 | A | 0.979 | 0.003 | 0.006 | 0.004 | 0.003 | 0.000 | 0.001 | 0.002 | 0.002 | 33.5 | 34.0 | 0.0 | 0.0 | 0.0 | 148.1 |
| 482 | 46 | A | 0.968 | 0.004 | 0.008 | 0.005 | 0.004 | 0.001 | 0.001 | 0.002 | 0.005 | 53.0 | 40.8 | 0.0 | 0.0 | 0.0 | 106.6 |
| 484 | 47 | A | 0.966 | 0.005 | 0.009 | 0.005 | 0.006 | 0.002 | 0.001 | 0.003 | 0.003 | 59.1 | 179.7 | 6.2 | 0.0 | 0.0 | 40.8 |
| 489 | 47 | A | 0.965 | 0.005 | 0.010 | 0.006 | 0.006 | 0.002 | 0.001 | 0.002 | 0.003 | 64.5 | 183.9 | 5.8 | 0.0 | 0.0 | 39.3 |
| 490 | 48 | A | 0.984 | 0.002 | 0.005 | 0.003 | 0.002 | 0.000 | 0.001 | 0.001 | 0.001 | 25.5 | 25.0 | 0.0 | 0.0 | 0.0 | 198.0 |
| 494 | 48 | A | 0.978 | 0.003 | 0.007 | 0.004 | 0.003 | 0.001 | 0.000 | 0.002 | 0.002 | 39.7 | 30.7 | 0.0 | 0.0 | 0.0 | 142.0 |
| 497 | 49 | A | 0.978 | 0.003 | 0.007 | 0.003 | 0.004 | 0.001 | 0.001 | 0.002 | 0.002 | 38.3 | 120.6 | 0.0 | 0.0 | 0.0 | 62.9 |
| 500 | 49 | A | 0.976 | 0.004 | 0.008 | 0.004 | 0.004 | 0.001 | 0.001 | 0.002 | 0.001 | 41.5 | 132.9 | 0.0 | 0.0 | 0.0 | 57.3 |
| 503 | 50 | A | 0.979 | 0.003 | 0.008 | 0.003 | 0.003 | 0.000 | 0.000 | 0.002 | 0.001 | 33.5 | 23.4 | 0.0 | 0.0 | 0.0 | 175.7 |
| 506 | 50 | A | 0.982 | 0.003 | 0.005 | 0.003 | 0.002 | 0.000 | 0.001 | 0.002 | 0.002 | 30.0 | 29.3 | 0.0 | 0.0 | 0.0 | 168.6 |
| 509 | 51 | A | 0.975 | 0.003 | 0.009 | 0.003 | 0.004 | 0.001 | 0.001 | 0.002 | 0.002 | 39.7 | 99.7 | 0.0 | 0.0 | 0.0 | 71.7 |
| 512 | 51 | A | 0.968 | 0.004 | 0.007 | 0.005 | 0.006 | 0.002 | 0.002 | 0.003 | 0.003 | 64.5 | 111.8 | 0.0 | 0.0 | 0.0 | 56.7 |
| 514 | 52 | A | 0.977 | 0.004 | 0.007 | 0.004 | 0.003 | 0.000 | 0.000 | 0.002 | 0.002 | 35.8 | 14.8 | 0.0 | 0.0 | 0.0 | 197.6 |
| 517 | 52 | A | 0.967 | 0.006 | 0.008 | 0.006 | 0.004 | 0.002 | 0.002 | 0.003 | 0.003 | 57.8 | 23.7 | 0.0 | 0.0 | 0.0 | 122.7 |
| 520 | 53 | A | 0.954 | 0.005 | 0.009 | 0.007 | 0.008 | 0.003 | 0.004 | 0.005 | 0.006 | 86.4 | 52.8 | 0.0 | 0.0 | 0.0 | 71.8 |
| 523 | 53 | A | 0.960 | 0.008 | 0.009 | 0.007 | 0.009 | 0.001 | 0.001 | 0.003 | 0.003 | 79.6 | 61.6 | 0.0 | 0.0 | 0.0 | 70.8 |
| 528 | 54 | A | 0.976 | 0.003 | 0.008 | 0.003 | 0.004 | 0.001 | 0.001 | 0.003 | 0.002 | 41.0 | 12.0 | 0.0 | 0.0 | 0.0 | 188.7 |
| 534 | 54 | A | 0.969 | 0.004 | 0.009 | 0.004 | 0.005 | 0.002 | 0.001 | 0.003 | 0.003 | 51.5 | 20.3 | 0.0 | 0.0 | 0.0 | 139.3 |
| 552 | 57 | A | 0.978 | 0.002 | 0.008 | 0.003 | 0.003 | 0.001 | 0.001 | 0.003 | 0.002 | 31.9 | 12.0 | 0.0 | 0.0 | 0.0 | 227.8 |
| 558 | 57 | A | 0.976 | 0.004 | 0.008 | 0.003 | 0.003 | 0.000 | 0.001 | 0.003 | 0.002 | 34.3 | 22.8 | 0.0 | 0.0 | 0.0 | 175.1 |
| 562 | 58 | A | 0.983 | 0.002 | 0.005 | 0.003 | 0.003 | 0.001 | 0.001 | 0.002 | 0.002 | 31.1 | 60.5 | 1.9 | 0.0 | 0.0 | 107.0 |
| 572 | 58 | A | 0.973 | 0.002 | 0.008 | 0.004 | 0.005 | 0.002 | 0.001 | 0.002 | 0.002 | 52.9 | 68.9 | 0.0 | 0.0 | 0.0 | 82.1 |
| C-7 | C1 | D | 0.989 | 0.003 | 0.001 | 0.003 | 0.001 | 0.001 | 0.000 | 0.000 | 0.001 | 23.1 | 21.7 | 0.0 | 0.0 | 2.3 | 212.3 |
| C-15 | C1 | D | 0.975 | 0.006 | 0.001 | 0.007 | 0.003 | 0.002 | 0.001 | 0.001 | 0.003 | 60.4 | 18.4 | 0.0 | 0.0 | 11.5 | 110.7 |
| C-19 | C2 | A | 0.976 | 0.013 | 0.005 | 0.003 | 0.002 | 0.001 | 0.000 | 0.000 | 0.001 | 27.0 | 18.0 | 0.0 | 0.0 | 3.0 | 208.3 |
| C-23 | C2 | A | 0.988 | 0.003 | 0.000 | 0.003 | 0.003 | 0.001 | 0.000 | 0.001 | 0.001 | 35.6 | 16.0 | 0.0 | 0.0 | 4.8 | 177.3 |
| C-26 | C2 | A | 0.964 | 0.019 | 0.007 | 0.004 | 0.002 | 0.001 | 0.001 | 0.001 | 0.003 | 34.0 | 36.0 | 0.0 | 0.0 | 13.0 | 120.5 |
| C-29 | C2 | A | 0.973 | 0.010 | 0.005 | 0.007 | 0.002 | 0.001 | 0.000 | 0.000 | 0.003 | 47.8 | 13.9 | 0.0 | 0.0 | 13.3 | 133.3 |
| C-33 | C2 | C | 0.975 | 0.013 | 0.004 | 0.003 | 0.002 | 0.001 | 0.000 | 0.000 | 0.001 | 33.0 | 17.0 | 0.0 | 0.0 | 6.0 | 178.6 |
| C-36 | C2 | C | 0.964 | 0.016 | 0.005 | 0.006 | 0.003 | 0.002 | 0.000 | 0.001 | 0.003 | 52.5 | 15.0 | 0.0 | 0.0 | 11.0 | 127.4 |
| C-39 | C2 | D | 0.985 | 0.003 | 0.003 | 0.004 | 0.002 | 0.001 | 0.000 | 0.000 | 0.002 | 32.7 | 21.6 | 0.0 | 0.0 | 7.1 | 162.9 |
| C-42 | C2 | D | 0.977 | 0.005 | 0.005 | 0.005 | 0.003 | 0.001 | 0.000 | 0.000 | 0.002 | 47.7 | 17.7 | 0.0 | 0.0 | 12.4 | 128.5 |

TABLE 4
¹H NMR data illustrating chain end unsaturation for select examples.

| | | | vinyl- | | | vinyl- | total | % | | | % |
|---|---|---|---|---|---|---|---|---|---|---|---|
| | Cat | Act | enes/ | trisubs/ | vinyls/ | idenes/ | unsat/ | vinyl- | % | % | vinyl- |
| Ex# | ID | ID | 1000C | 1000C | 1000C | 1000C | 1000C | ene | trisub | vinyl | idene |
| 14 | 2 | A | 0.07 | 0.07 | 0.04 | 0.12 | 0.3 | 23.3 | 23.3 | 13.3 | 40.0 |
| 19 | 2 | A | 0.15 | 0.11 | 0.11 | 0.28 | 0.7 | 23.1 | 16.9 | 16.9 | 43.1 |
| 38 | 4 | A | 0.74 | 0.17 | 0.14 | 0.44 | 1.5 | 49.7 | 11.4 | 9.4 | 29.5 |
| 41 | 4 | A | 1.02 | 0.15 | 0.18 | 0.53 | 1.9 | 54.3 | 8.0 | 9.6 | 28.2 |
| 51 | 5 | A | 0.04 | 0.07 | 0.09 | 0.15 | 0.4 | 11.4 | 20.0 | 25.7 | 42.9 |
| 53 | 5 | A | 0.06 | 0.15 | 0.12 | 0.14 | 0.5 | 12.8 | 31.9 | 25.5 | 29.8 |
| 65 | 5 | A | 0.18 | 0.14 | 0.22 | 0.29 | 0.8 | 21.7 | 16.9 | 26.5 | 34.9 |
| 67 | 5 | A | 0.20 | 0.17 | 0.23 | 0.27 | 0.9 | 23.0 | 19.5 | 26.4 | 31.0 |
| 93 | 6 | A | 0.13 | 0.05 | 0.19 | 0.18 | 0.6 | 23.6 | 9.1 | 34.5 | 32.7 |
| 101 | 6 | A | 0.22 | 0.07 | 0.27 | 0.23 | 0.8 | 27.8 | 8.9 | 34.2 | 29.1 |
| 119 | 7 | A | 0.10 | 0.07 | 0.10 | 0.19 | 0.5 | 21.7 | 15.2 | 21.7 | 41.3 |
| 125 | 7 | A | 0.23 | 0.14 | 0.24 | 0.35 | 1.0 | 24.0 | 14.6 | 25.0 | 36.5 |
| 144 | 9 | A | 0.10 | 0.11 | 0.09 | 0.20 | 0.5 | 20.0 | 22.0 | 18.0 | 40.0 |
| 149 | 9 | A | 0.10 | 0.06 | 0.07 | 0.22 | 0.5 | 22.2 | 13.3 | 15.6 | 48.9 |
| 211 | 15 | A | 0.12 | 0.06 | 0.08 | 0.24 | 0.5 | 24.0 | 12.0 | 16.0 | 48.0 |
| 218 | 15 | A | 0.31 | 0.09 | 0.18 | 0.47 | 1.1 | 29.5 | 8.6 | 17.1 | 44.8 |
| 224 | 16 | A | 0.01 | 0.09 | 0.08 | 0.28 | 0.5 | 2.2 | 19.6 | 17.4 | 60.9 |
| 313 | 24 | A | 0.13 | 0.09 | 0.07 | 0.24 | 0.5 | 24.5 | 17.0 | 13.2 | 45.3 |
| 319 | 24 | A | 0.18 | 0.10 | 0.08 | 0.30 | 0.7 | 27.3 | 15.2 | 12.1 | 45.5 |

Continuous stirred tank reactor runs: Polymerizations were carried out in a continuous stirred tank reactor. Autoclave reactor (1 L) was equipped with a stirrer, a water cooling/steam heating element with a temperature controller and a pressure controller. The reactor was maintained at a pressure in excess of the bubbling point pressure of the reactant mixture to keep the reactants in the liquid phase. The reactors were operated liquid full. Isohexane (used as the solvent), and propylene were purified over beds of alumina and molecular sieves. Toluene for preparing catalyst solutions was also purified by the same technique. All feeds were pumped into the reactors by a Pulsa feed pump. All liquid flow rates were controlled using Brooks mass flow controller. Propylene feed was mixed with a pre-chilled isohexane stream that had been cooled to at least 0° C. The mixture was fed into the reactor through a single port.

An isohexane solution of tri-n-octyl aluminum (TNOAL) (25 wt % in hexane, Sigma Aldrich) scavenger was added to the combined solvent and monomer stream just before it entered the reactor to further reduce any catalyst poisons. The feed rate of the scavenger solution was adjusted to optimize catalyst activity.

The catalyst used was complex 6 described above. The catalyst (ca. 20 mg) was activated with N,N-dimethylanilinium tetrakis(perfluorophenyl)borate (Activator A) at a molar ratio of about 1:1 in 900 ml of toluene. The catalyst solution was then fed into the reactor through a separate port using an ISCO syringe pump.

The polymer produced in the reactor exited through a back pressure control valve that reduced the pressure to atmospheric. This caused the unconverted monomers in the solution to flash into a vapor phase which was vented from the top of a vapor liquid separator. The liquid phase, comprising mainly polymer and solvent, was collected for polymer recovery. The collected samples were first air-dried in a hood to evaporate most of the solvent, and then dried in a vacuum oven at a temperature of about 908 C for about 12 hours. The vacuum oven dried samples were weighed to obtain yields. The detailed polymerization process conditions are listed in Tables 5-8 below. The scavenger feed rate and catalyst feed rate were adjusted to reach the targeted conversion listed. All the reactions were carried out at a pressure of about 2.4 MPa/g unless otherwise mentioned.

TABLE 5
Continuous stirred tank reactor runs making polypropylene.

| Example | PP-1 | PP-2 | PP-3 |
|---|---|---|---|
| Rxr T (C) | 100 | 120 | 93 |
| Catalyst/Activator | 6/A | 6/A | 6/A |
| Cat (mol/min) | 3.23E−08 | 3.64E−08 | 2.43E−08 |
| Scavenger (mol/min) | 7.39E−06 | 7.39E−06 | 7.39E−06 |
| Propylene (g/min) | 14 | 14 | 14 |
| Isohexane (g/min) | 47.7 | 47.7 | 47.7 |
| polymer made (g/min) | 12.8 | 12.6 | 4.7 |
| polymer made (g) | 255.6 | 252.2 | 66.0 |
| Catalyst Productivity | 433,038 | 378,037 | 211,463 |
| (g cat/g polymer) | | | |
| Conversion (%) | 91.4 | 90.0 | 33.6 |
| MFR (g/10 min) | 17.3 | 882.7 | 11.1 |
| Mn_FTIR (g/mol) | 103,850 | 32,663 | 117,473 |
| Mw_FTIR (g/mol) | 296,814 | 89,494 | 410,583 |
| Mz_FTIR (g/mol) | 598,942 | 173,187 | 946,259 |
| MWD FTIR (Mw/Mn) | 2.86 | 2.74 | 3.50 |
| Mn_LS (g/mol) | 103,709 | 35,214 | 125,866 |
| Mw_LS (g/mol) | 342,866 | 101,586 | 412,246 |
| Mz_LS (g/mol) | 818,795 | 204,293 | 885,121 |
| g′vis | 0.842 | 0.834 | 0.973 |
| Tc (° C.) | 108.8 | 109.3 | 108.4 |
| Tm (° C.) | 147.8 | 145.0 | 148.3 |
| delta H (J/g) | 92.5 | 97.0 | 95.2 |
| ¹H NMR data | | | |
| vinyl % | 27.3 | 26.5 | 36.4 |
| Vinyls/1000 C | 0.03 | 0.13 | 0.04 |
| Vinylenes/1000 C | 0.00 | 0.03 | 0.01 |
| Vinylidenes/1000 C | 0.08 | 0.15 | 0.01 |
| trisubstituted olefin/1000 C | 0.00 | 0.08 | 0.00 |
| ¹³C NMR Data | | | |
| [mmmm] | 0.966 | 0.955 | 0.973 |
| [mmmr] | 0.009 | 0.011 | 0.008 |
| [rmmr] | 0.005 | 0.007 | 0.003 |
| [mmrr] | 0.009 | 0.010 | 0.008 |
| [mmrm + rmrr] | 0.004 | 0.006 | 0.003 |
| [rmrm] | 0.002 | 0.003 | 0.001 |
| [rrrr] | 0.001 | 0.001 | 0.000 |
| [mrrr] | 0.001 | 0.002 | 0.000 |
| [mrrm] | 0.005 | 0.006 | 0.004 |
| stereo defects/10000 monomer | 71.6 | 95.9 | 57.6 |
| 2,1-regio (ee) defects/10000 monomer | 65.0 | 66.7 | 65.9 |
| 2,1-regio (et) defects/10000 monomer | 9.1 | 10.8 | 10.1 |
| 2,1-regio (te) defects/10000 monomer | 0.0 | 0.0 | 0.0 |
| 1,3 regio defects/10000 monomer | 0.0 | 0.0 | 0.0 |
| total regio defects/10000 monomer | 74.1 | 77.5 | 76.0 |
| total regio and stereo defects/10000 | 145.7 | 173.4 | 133.6 |
| monomer | | | |
| Avg. meso Run Length | 68.6 | 57.7 | 74.9 |

*Conversion % = [(polymer yield)/(propylene feed)] × 100

TABLE 6
Continuous stirred tank reactor runs making polypropylene.

| Example | PP-4 | PP-5 | PP-6 |
|---|---|---|---|
| Rxr T (C) | 120 | 110 | 100 |
| Catalyst/Activator | 5/A | 5/A | 5/A |
| Cat (mol/min) | 4.43E−08 | 4.43E−08 | 4.43E−08 |
| Scavenger (mol/min) | 7.39E−06 | 7.39E−06 | 7.39E−06 |
| Propylene (g/min) | 14.0 | 14.0 | 14.0 |
| Isohexane (g/min) | 47.7 | 47.7 | 47.7 |
| polymer made (g/min) | 3.6 | 4.6 | 4.7 |
| polymer made (g) | 72.0 | 91.1 | 47.1 |
| Catalyst Productivity (g cat/g polymer) | 81,011 | 102,502 | 105,990 |
| Conversion (%) | 25.7% | 32.5% | 33.6% |
| MFR (g/10 min) | 407.0 | 72.4 | 17.6 |
| Mn_FTIR (g/mol) | 44,398 | 72,855 | 116,176 |
| Mw_FTIR (g/mol) | 94,588 | 160,766 | 245,067 |
| Mz_FTIR (g/mol) | 158,486 | 290,189 | 413,606 |
| MWD FTIR (Mw/Mn) | 2.13 | 2.21 | 2.11 |
| Mn_LS (g/mol) | 47,297 | 79,783 | 124,115 |
| Mw_LS (g/mol) | 97,536 | 165,215 | 249,622 |
| Mz_LS (g/mol) | 155,206 | 271,176 | 390,773 |
| g′vis | 0.991 | 0.990 | 1.001 |
| Tc (° C.) | 115.5 | 112.9 | 114.8 |
| Tm (° C.) | 154.6 | 156.2 | 158.6 |
| delta H (J/g) | 106.1 | 105.1 | 103.2 |
| ¹³C NMR Data | | | |
| [mmmm] | 0.966 | 0.969 | 0.978 |
| [mmmr] | 0.007 | 0.006 | 0.005 |
| [rmmr] | 0.006 | 0.005 | 0.003 |
| [mmrr] | 0.008 | 0.007 | 0.007 |
| [mmrm + rmrr] | 0.005 | 0.004 | 0.002 |
| [rmrm] | 0.002 | 0.002 | 0.001 |
| [rrrr] | 0.001 | 0.001 | 0.001 |
| [mrrr] | 0.001 | 0.001 | 0.001 |
| [mrrm] | 0.004 | 0.004 | 0.003 |
| stereo defects/10000 monomer | 77.1 | 67.3 | 48.8 |
| 2,1-regio (ee) defects/10000 monomer | 16.9 | 16.4 | 15.1 |
| 2,1-regio (et) defects/10000 monomer | 4.5 | 4.5 | 4.3 |
| 2,1-regio (te) defects/10000 monomer | 0 | 0 | 0 |
| 1,3 regio defects/10000 monomer | 0 | 0 | 0 |
| total regio defects/10000 monomer | 21.4 | 20.9 | 19.4 |
| total regio and stereo defects/10000 monomer | 98.5 | 88.2 | 68.2 |
| Avg. meso Run Length | 102 | 113 | 147 |

*Conversion % = [(polymer yield)/(propylene feed)] × 100

TABLE 7
Continuous stirred tank reactor runs making polypropylene.

| Example | PP-7 | PP-8 | PP-9 |
|---|---|---|---|
| Rxr T (C) | 130 | 120 | 110 |
| Catalyst/Activator | 25/A | 25/A | 25/A |
| Cat (mol/min) | 1.27E−07 | 1.27E−07 | 1.27E−07 |
| Scavenger (mol/min) | 7.39E−06 | 7.39E−06 | 7.39E−06 |
| Propylene (g/min) | 14.0 | 14.0 | 14.0 |
| Isohexane (g/min) | 47.7 | 47.7 | 47.7 |
| polymer made (g/min) | 4.2 | 3.4 | 4.5 |
| polymer made (g) | 83.6 | 68.7 | 89.3 |
| Catalyst Productivity (g cat/g polymer) | 30,089 | 24,726 | 32,141 |
| Conversion (%) | 29.9 | 24.5 | 31.9 |
| MFR (g/10 min) | 509.0 | 108.0 | 21.7 |
| MFR HL | | | 1727.2 |
| Mn_FTIR (g/mol) | 45,371 | 67,086 | 101,759 |
| Mw_FTIR (g/mol) | 93,593 | 138,233 | 213,356 |
| Mz_FTIR (g/mol) | 153,407 | 223,683 | 348,288 |
| MWD FTIR (Mw/Mn) | 2.06 | 2.06 | 2.10 |
| Tc (° C.) | 120.7 | 119.7 | 118.6 |
| Tm (° C.) | 157.1 | 159.0 | 161.4 |
| delta H (J/g) | 111.9 | 111.0 | 110.7 |
| ¹³C NMR Data | | | |
| [mmmm] | 0.960 | 0.956 | 0.951 |
| [mmmr] | 0.007 | 0.006 | 0.006 |
| [rmmr] | 0.011 | 0.010 | 0.013 |
| [mmrr] | 0.008 | 0.008 | 0.008 |
| [mmrm + rmrr] | 0.005 | 0.007 | 0.007 |
| [rmrm] | 0.001 | 0.002 | 0.004 |
| [rrrr] | 0.001 | 0.002 | 0.003 |
| [mrrr] | 0.004 | 0.004 | 0.004 |
| [mrrm] | 0.004 | 0.005 | 0.005 |
| stereo defects/10000 monomer | 67.8 | 83.7 | 88.9 |
| 2,1-regio (ee) defects/10000 monomer | 21.3 | 20.4 | 17.4 |
| 2,1-regio (et) defects/10000 monomer | 0 | 0 | 0 |
| 2,1-regio (te) defects/10000 monomer | 0 | 0 | 0 |
| 1,3 regio defects/10000 monomer | 0 | 0 | 0 |
| total regio defects/10000 monomer | 21.3 | 20.4 | 17.4 |
| total regio and stereo defects/10000 monomer | 89.1 | 104.1 | 106.3 |
| Avg. meso Run Length | 112 | 96 | 94 |

*Conversion % = [(polymer yield)/(propylene feed)] × 100

TABLE 8
Comparative continuous stirred tank
reactor runs making polypropylene.

| Example | CPP-1 | CPP-2 | CPP-3 |
|---|---|---|---|
| Rxr T (C) | 130 | 120 | 110 |
| Catalyst/Activator | C2/A | C2/A | C2/A |
| Cat (mol/min) | 1.44E−06 | 1.44E−06 | 1.44E−06 |
| Scavenger (mol/min) | | | |
| Propylene (g/min) | 14.0 | 14.0 | 14.0 |
| hexane (g/min) | 80.0 | 80.0 | 80.0 |
| polymer made (g/min) | 10.28 | 10.74 | 11.45 |
| polymer made (g) | | | |
| Catalyst Productivity (g cat/g | 9,317 | 9,734 | 10,378 |
| polymer) | | | |
| Conversion (%) | 73.4 | 76.7 | 81.8 |
| Mn_DRI (g/mol) | 19,370 | 28,690 | 48,450 |
| Mw_DRI (g/mol) | 44,460 | 66,420 | 106,260 |
| Mz_DRI (g/mol) | 75,600 | 112,660 | 185,190 |
| MWD DRI (Mw/Mn) | 2.3 | 2.32 | 2.19 |
| Tc (° C.) | 101.3 | 100.2 | 105.3 |
| Tm (° C.) | 144.7 | 147.8 | 150.2 |
| delta H (J/g) | 88.9 | 93 | 92.8 |

*Conversion % = [(polymer yield)/(propylene feed)] × 100

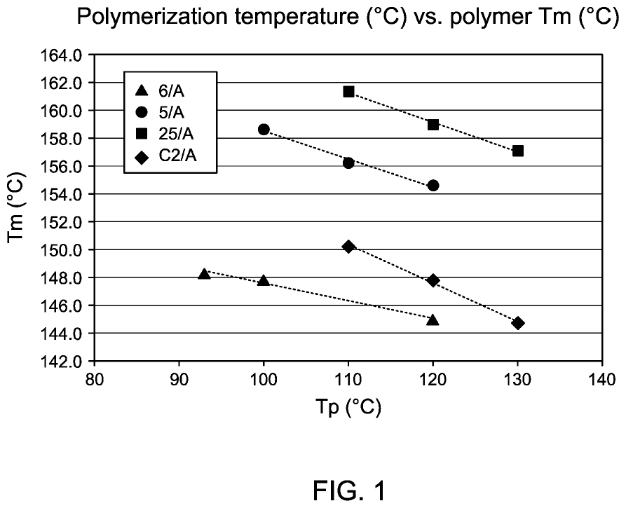

FIG. 1 illustrates the high polypropylene Tm (° C.) at a given reactor polymerization temperature (° C.) for the polymers produced from hafnium based inventive catalysts 6 and 25, as compared to the zirconium based analog, 5, and the comparative catalyst C₂.

### Test Methods

### ¹³C-NMR Spectroscopy on Polyolefins—Large Scale and Small Scale Experiments

¹³C NMR spectroscopy was used to characterize some polypropylene polymer samples produced in experiments. Unless otherwise indicated the polymer samples for ¹³C NMR spectroscopy were dissolved in d₂-1,1,2,2-tetrachloroethane and the samples were recorded at 120° C. using a NMR spectrometer with a ¹³C NMR frequency of 125 MHz or greater. Polymer resonance peaks are referenced to mmmm=21.83 ppm. Calculations involved in the characterization of polymers by NMR follow the work of Bovey, F. A. (1969) in Polymer Conformation and Configuration, Academic Press, New York and Randall, J. (1977) in Polymer Sequence Determination, Carbon-¹³NMR Method, Academic Press, New York.

The stereodefects measured as “stereo defects/10,000 monomer units” are calculated from the sum of the intensities of mmrr, mmrm+rrmr, and rmrm resonance peaks times 5,000. The intensities used in the calculations are normalized to the total number of monomers in the sample. Methods for measuring 2,1 regio defects/10,000 monomers and 1,3 regio defects/10,000 monomers follow standard methods. Additional references include Grassi, A. et.al. (1988) Macromolecules, v. 21, pp. 617-622 and Busico et.al. (1994) Macromolecules, v. 27, pp. 7538-7543. Total regio defects/10,000 monomer units is the sum of the 2,1-regio (ee) defects/10,000 monomer units, 2,1-regio (et) defects/10,000 monomer units, 2,1-regio (te) defects/10,000 monomer units and 1,3-regio defects/10,000 monomer units. The average meso run length=10,000/[(stereo defects/10,000 monomer units)+(2,1-regio defects/10,000 monomer units)+(1,3-regio-defects/10,000 monomer units)].

For some samples, polymer end-group analysis was determined by ¹H NMR using a Bruker 600 MHz instrument run with a single 30° flip angle, RF pulse. 512 pulses with a delay of 5 seconds between pulses were signal averaged. The polymer sample was dissolved in heated d₂-1,1,2,2-tetrachloroethane and signal collection took place at 120° C. Vinylenes were measured as the number of vinylenes per 1,000 carbon atoms using the resonances between 5.55-5.31 ppm. Trisubstituted end-groups (“trisubs”) were measured as the number of trisubstituted groups per 1,000 carbon atoms using the resonances between 5.30-5.11 ppm. Vinyl end-groups were measured as the number of vinyls per 1,000 carbon atoms using the resonances between 5.13-4.98 ppm. Vinylidene end-groups were measured as the number of vinylidenes per 1,000 carbon atoms using the resonances between 4.88-4.69 ppm. The values reported are % vinylene, % trisubstituted (% trisub), % vinyl and % vinylidene where the percentage is relative to the total olefinic unsaturation per 1,000 carbon atoms.

Propylene-4-methyl-1-pentene copolymers were dissolved in deuterated 1,1,2,2-tetrachloroethane (tce-d2) at a concentration of 67 mg/mL at 140° C. Spectra were recorded at 120° C. using a Bruker NMR spectrometer of at least 600 MHz with a 10 mm cryoprobe. A 90° pulse, 60 second delay, 512 transients, and inverse gated decoupling were used for measuring the ¹³C NMR. Polymer resonance peaks are referenced to the CH₃ at 21.83 ppm for propylene based materials. Assignments were determined from S. Losio et.al. Macromolecules, 2011, v. 44, pp. 3276-3286. The diads were determined from the au CH₂ region of the spectra (au defined in the paper). The peak integration regions were as follows:

| Integration | | Chemical shift | |
|---|---|---|---|
| Region | Assignment | range (ppm) | Diads |
| A | αα (P) + CH₂ (sc) | 47-45 | 2PP + 0.5*PY |
| B | αα (PY) | 45-43 | PY |
| C | αα (YY) | 43-41 | YY |

sc = side chain of the 4-methyl-1-pentene,
Y = 4-methyl-1-pentene,
P = propylene
To determine PP diad, region A = 2PP + 0.5*PY, so PP = ((A − 0.5*B)/2)/total, PY = B/total, and region YY = C/total.
Total = PP + PY + YY.
For mole fraction, P = PP + 0.5*PY, and Y = YY + 0.5*PY times 100 to give mole %.

### DSC—Large Scale Polymerizations.

Peak melting point, Tm, (also referred to as melting point), peak crystallization temperature, Tc, (also referred to as crystallization temperature), glass transition temperature (Tg), heat of fusion (ΔH_{f}), and percent crystallinity were determined using the following DSC procedure according to ASTM D3418-03. Differential scanning calorimetric (DSC) data were obtained using a TA Instruments model Q200 machine or similar machine. Samples weighing approximately 5-10 mg were sealed in an aluminum hermetic sample pan. The DSC data were recorded by first gradually heating the sample to 200° C. at a rate of 10° C./minute. The sample was kept at 200° C. for 2 minutes, then cooled to −90° C. at a rate of 10° C./minute, followed by an isothermal for 2 minutes and heating to 200° C. at 10° C./minute. Both the first and second cycle thermal events were recorded. Areas under the endothermic peaks were measured and used to determine the heat of fusion and the percent of crystallinity. The percent crystallinity is calculated using the formula, [area under the melting peak (Joules/gram)/B (Joules/gram)]*100, where B is the heat of fusion for the 100% crystalline homopolymer of the major monomer component. These values for B are to be obtained from the Polymer Handbook, Fourth Edition, published by John Wiley and Sons, New York 1999, provided however that a value of 189 J/g (B) is used as the heat of fusion for 100% crystalline polypropylene, a value of 290 J/g is used for the heat of fusion for 100% crystalline polyethylene. The melting and crystallization temperatures reported here were obtained during the second heating/cooling cycle unless otherwise noted. This DSC technique described was used for polymers produced from continuous stirred tank reactor runs.

Melt flow rate (MFR) was determined according to ASTM D₁₂₃₈ using a load of 2.16 kg at a temperature of 230° C. The melt flow rate at the high load condition (HL MFR) was determined according to ASTM D₁₂₃₈ using a load of 21.6 kg at a temperature of 230° C.

GPC 4D Procedure for Molecular Weight and Comonomer Composition Determination by GPC-IR Hyphenated with Multiple Detectors (GPC-4D).

Unless otherwise indicated, the distribution and the moments of molecular weight (Mw, Mn, Mw/Mn, etc.) and the comonomer content (C₂, C₃, C₆, etc.) are determined by using a high temperature Gel Permeation Chromatography (Polymer Char GPC-IR) equipped with a multiple-channel band-filter based Infrared detector IR5, an 18-angle light scattering detector and a viscometer. Three Agilent PLgel 10-μm Mixed-B LS columns are used to provide polymer separation. Aldrich reagent grade 1,2,4-trichlorobenzene (TCB) with 300 ppm antioxidant butylated hydroxytoluene (BHT) is used as the mobile phase. The TCB mixture is filtered through a 0.1-μm Teflon filter and degassed with an online degasser before entering the GPC instrument. The nominal flow rate is 1.0 mLmL/min and the nominal injection volume is 200 μL. The whole system including transfer lines, columns, and detectors are contained in an oven maintained at 145° C. The polymer sample is weighed and sealed in a standard vial with 80-μL flow marker (Heptane) added to it. After loading the vial in the auto-sampler, polymer is automatically dissolved in the instrument with 8 mLmL added TCB solvent. The polymer is dissolved at 160° C. with continuous shaking for about 1 hour for most PE samples or 2 hours for PP samples. The TCB densities used in concentration calculation are 1.463 g/mLmL at room temperature and 1.284 g/mLmL at 145° C. The sample solution concentration is from 0.2 to 2.0 mg/mLmL, with lower concentrations being used for higher molecular weight samples. The concentration (c), at each point in the chromatogram is calculated from the baseline-subtracted IR5 broadband signal intensity (I), using the following equation: c=βI, where β is the mass constant. The mass recovery is calculated from the ratio of the integrated area of the concentration chromatography over elution volume and the injection mass which is equal to the pre-determined concentration multiplied by injection loop volume. The conventional molecular weight (IR MW) is determined by combining universal calibration relationship with the column calibration which is performed with a series of monodispersed polystyrene (PS) standards ranging from 700 g/mol to 10,000,000 g/mol. The MW at each elution volume is calculated with (1):

$$log M = \frac{log ( {K}_{PS} / K )}{a + 1} + \frac{{a}_{PS} + 1}{a + 1} log {M}_{PS} \qquad ( 1 )$$

where the variables with subscript “PS” stand for polystyrene while those without a subscript are for the test samples. In this method, α_{PS}=0.67 and K_{PS}=0.000175 while a and K are for other materials as calculated and published in literature (Sun, T. et al. (2001) Macromolecules, v. 34, 6812 pgs.), except that for purposes of this invention and claims thereto, α=0.695 and K=0.000579 for linear ethylene polymers, α=0.705 and K=0.0002288 for linear propylene polymers, α=0.695 and K=0.000181 for linear butene polymers. Concentrations are expressed in g/cm³, molecular weight is expressed in g/mol, and intrinsic viscosity (hence K in the Mark-Houwink equation) is expressed in dL/g unless otherwise noted.

The comonomer composition is determined by the ratio of the IR5 detector intensity corresponding to CH₂ and CH₃ channel calibrated with a series of PE and PP homo/copolymer standards whose nominal value are predetermined by NMR or FTIR. In particular, this provides the methyls per 1,000 total carbons (CH₃/1000TC) as a function of molecular weight. The short-chain branch (SCB) content per 1000TC (SCB/1000TC) is then computed as a function of molecular weight by applying a chain-end correction to the CH₃/1000TC function, assuming each chain to be linear and terminated by a methyl group at each end. The weight % comonomer is then obtained from the following expression in which f is 0.3, 0.4, 0.6, 0.8, and so on for C₃, C₄, C₆, C₈, and so on co-monomers, respectively:

w2=f*SCB/1000TC (2)

The bulk composition of the polymer from the GPC-IR and GPC-4D analyses is obtained by considering the entire signals of the CH₃ and CH₂ channels between the integration limits of the concentration chromatogram. First, the following ratio is obtained

$$Bulk IR ratio = \frac{Area of {CH}_{3} signal within integration limits}{Area of {CH}_{2} signal within integration limits} \qquad ( 3 )$$

Then the same calibration of the CH₃ and CH₂ signal ratio, as mentioned previously in obtaining the CH3/1000TC as a function of molecular weight, is applied to obtain the bulk CH₃/1000TC. A bulk methyl chain ends per 1000TC (bulk CH₃end/1000TC) is obtained by weight-averaging the chain-end correction over the molecular-weight range. Then,

w2b=f*bulk CH3/1000TC (4)

bulk SCB/1000TC=bulk CH3/1000TC−bulk CH₃end/1000TC (5)

and bulk SCB/1000TC is converted to bulk w2 in the same manner as described above.

The LS detector is the 18-angle Wyatt Technology High Temperature DAWN HELEOSII. The LS molecular weight (M) at each point in the chromatogram is determined by analyzing the LS output using the Zimm model for static light scattering (Light Scattering from Polymer Solutions; Huglin, M. B., Ed.; Academic Press, 1972.):

$$\frac{{K}_{o} c}{Δ R ( θ )} = \frac{1}{MP ( θ )} + 2 {A}_{2} c \qquad ( 6 )$$

Here, ΔR(θ) is the measured excess Rayleigh scattering intensity at scattering angle θ, c is the polymer concentration determined from the IR5 analysis, A₂ is the second virial coefficient, P(θ) is the form factor for a monodisperse random coil, and Ko is the optical constant for the system:

$${K}_{o} = \frac{4 {π}^{2} {{n}^{2} ( dn / dc )}^{2}}{{λ}^{4} {N}_{A}} \qquad ( 7 )$$

where N_{A} is Avogadro's number, and (dn/dc) is the refractive index increment for the system. The refractive index, n=1.500 for TCB at 145° C. and λ=665 nm.

A high temperature Agilent (or Viscotek Corporation) viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, ηs, for the solution flowing through the viscometer is calculated from their outputs. The intrinsic viscosity, [η], at each point in the chromatogram is calculated from the equation [η]=η/c, where c is concentration and is determined from the IR5 broadband channel output. The viscosity MW at each point is calculated as M=K_{PS}M^{a}^{_{PS}}⁺¹/[n], where αₚₛ is 0.67 and Kₚₛ is 0.000175.

All documents described herein are incorporated by reference herein, including any priority documents and/or testing procedures to the extent they are not inconsistent with this text. As is apparent from the foregoing general description and the specific embodiments, while forms of the invention have been illustrated and described, various modifications can be made without departing from the spirit and scope of the invention. Accordingly, it is not intended that the invention be limited thereby. Likewise, the term “comprising” is considered synonymous with the term “including.” Likewise whenever a composition, an element or a group of elements is preceded with the transitional phrase “comprising”, it is understood that we also contemplate the same composition or group of elements with transitional phrases “consisting essentially of,” “consisting of”, “selected from the group of consisting of,” or “is” preceding the recitation of the composition, element, or elements and vice versa.

### Gel Permeation Chromatography (GPC-DRI).

The analysis was performed using a Waters 2000 (Gel Permeation Chromatograph) with DRI detector. The detailed GPC conditions are listed in Table 11 below. Standards and samples were prepared in inhibited TCB (1,2,4-trichlorobenzene) solvent. Nineteen polystyrene standards (PS) were used for calibrating the GPC. PS standards used are from EasiCal Pre-prepared Polymer calibrants (PL Laboratories). Calculation for converting narrow polystyrene standard peak molecular weight (for example 7,500,000 polystyrene) to polypropylene peak molecular weight (4630505) is: Mₚₚ=10\hat{ }(log 10(0.000175/0.0002288)/(1+0.705)+log 10(Mₚs)*(1+0.67)/(1+0.705)), where Mₚₚ is molecular weight for polypropylene and Mₚₛ is the molecular weight for polystyrene. From this, an elution retention time to polypropylene molecular weight relationship is obtained.

The samples were accurately weighed and diluted to a ˜0.75 mg/mL concentration and recorded. The standards and samples were placed on a PL Labs 260 Heater/Shaker at 160° C. for two hours. These were filtered through a 0.45 micron steel filter cup then analyzed.

TABLE 11
Gel Permeation Chromatography (GPC) measurement conditions

| Instrument | | Waters 2000 |
|---|---|---|
| Column | Type: | 3 × Mixed Bed Type “LS” “B” |
| | | 10 Micron PD (high porosity col.'s) |
| | Length: | 300 mm |
| | ID: | 7.8 mm |
| | Supplier: | Polymer Labs |
| Solvent Program | | 0.5 ml/min TCB inhibited |
| | | (inhibited with BHT at 1,500 ppm w/v %) |
| | | BHT is 2,6-di-tert-butyl-4-methyl phenol |
| Detector | | Differential Refractive Index (DRI) |
| Temperature | Injector: | 135° C. |
| | Detector: | 135° C. |
| | Column: | 135° C. |
| Injection Volume | | 301.5 μL |
| Sample | | (0.75 mg./ml.) |
| Concentration | | |
| | | (6 mg polymer to 8 ml TCB)(135° C.) |
| Solvent Diluent | | TCB inhibited |

Alpha & K Values in TCB @ 135° C.

| | | |
|---|---|---|
| Polymer | Alpha (α) | K |
| Polystyrene | 0.670 | 1.750 × 10−4 |
| Polypropylene | 0.705 | 2.288 × 10−4 |

What is claimed is:

1. A polymerization process comprising contacting in a homogeneous phase, propylene with a catalyst system comprising activator and catalyst compound represented by the Formula (I): 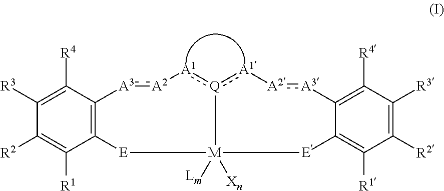
wherein:
M is a group 3, 4, 5, or 6 transition metal or a Lanthanide;
E and E′ are each independently O, S, or NR⁹ where R⁹ is independently hydrogen, a C₁-C₄₀ hydrocarbyl, a C₁-C₄₀ substituted hydrocarbyl or a heteroatom-containing group;
Q is group 14, 15, or 16 atom that forms a dative bond to metal M;
A¹QA^{1′} are part of a heterocyclic Lewis base containing 4 to 40 non-hydrogen atoms that links A² to A^{2′} via a 3-atom bridge with Q being the central atom of the 3-atom bridge, A¹ and A^{1′} are independently C, N, or C(R²²), where R²² is selected from hydrogen, C₁-C₂₀ hydrocarbyl, C₁-C₂₀ substituted hydrocarbyl; 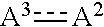
is a divalent group containing 2 to 40 non-hydrogen atoms that links A¹ to the E-bonded aryl group via a 2-atom bridge; 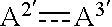
is a divalent group containing 2 to 40 non-hydrogen atoms that links A^{1′} to the E′-bonded aryl group via a 2-atom bridge;
L is a Lewis base;
X is an anionic ligand;
n is 1, 2 or 3;
m is 0, 1, or 2;
n+m is not greater than 4;
each of R¹, R², R³, R⁴, R^{1′}, R^{2′}, R^{3′}, and R^{4′} is independently hydrogen, a C₁-C₄₀ hydrocarbyl, a C₁-C₄₀ substituted hydrocarbyl, a heteroatom or a heteroatom-containing group,
and one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings;
any two L groups may be joined together to form a bidentate Lewis base;
an X group may be joined to an L group to form a monoanionic bidentate group;
any two X groups may be joined together to form a dianionic ligand group; and obtaining propylene polymer.

2. The process of claim 1 where the catalyst compound represented by the Formula (II): 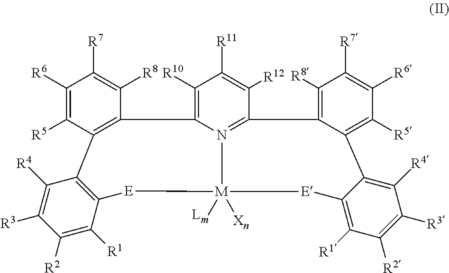
wherein:
M is a group 3, 4, 5, or 6 transition metal or a Lanthanide;
E and E′ are each independently O, S, or NR⁹, where R⁹ is independently hydrogen, a C₁-C₄₀ hydrocarbyl, a C₁-C₄₀ substituted hydrocarbyl, or a heteroatom-containing group;
each L is independently a Lewis base;
each X is independently an anionic ligand;
n is 1, 2 or 3;
m is 0, 1, or 2;
n+m is not greater than 4;
each of R¹, R², R³, R⁴, R^{1′}, R^{2′}, R^{3′}, and R^{4′} is independently hydrogen, C₁-C₄₀ hydrocarbyl, C₁-C₄₀ substituted hydrocarbyl, a heteroatom or a heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings; any two L groups may be joined together to form a bidentate Lewis base;
an X group may be joined to an L group to form a monoanionic bidentate group;
any two X groups may be joined together to form a dianionic ligand group;
each of R⁵, R⁶, R⁷, R⁸, R^{5′}, R^{6′}, R^{7′}, R^{8′}, R¹⁰, R¹¹, and R¹² is independently hydrogen, a C₁-C₄₀ hydrocarbyl, a C₁-C₄₀ substituted hydrocarbyl, a heteroatom or a heteroatom-containing group, or one or more of R⁵ and R⁶, R⁶ and R⁷, R⁷ and R⁸, R^{5′} and R^{6′}, R^{6′} and R^{7′}, R^{7′} and R^{8′}, R¹⁰ and R¹¹, or R¹¹ and R¹² may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings.

3. The process of claim 1 wherein the M is Hf, Zr or Ti.

4. The process of claim 1, wherein E and E′ are each O.

5. The process of claim 1, wherein R¹ and R^{1′} is independently selected from the group consisting of a C₄-C₄₀ tertiary hydrocarbyl group, a C₄-C₄₀ cyclic tertiary hydrocarbyl group, and a C₄-C₄₀ polycyclic tertiary hydrocarbyl group.

6.-7. (canceled)

8. The process claim 1 wherein each X is, independently, selected from the group consisting of substituted or unsubstituted hydrocarbyl radicals having from 1 to 30 carbon atoms, substituted or unsubstituted silylcarbyl radicals having from 3 to 30 carbon atoms, hydrides, amides, alkoxides, sulfides, phosphides, halides, substituted benzyl radicals having from 8 to 30 carbon atoms, and a combination thereof, (two X's may form a part of a fused ring or a ring system).

9. The process claim 1 wherein each L is, independently, selected from the group consisting of: ethers, thioethers, amines, phosphines, ethyl ether, tetrahydrofuran, dimethylsulfide, triethylamine, pyridine, alkenes, alkynes, allenes, and carbenes and a combinations thereof, optionally two or more L's may form a part of a fused ring or a ring system).

10. The process of claim 1, wherein M is Zr or Hf, Q is nitrogen, both A¹ and A^{1′} are carbon, both E and E′ are oxygen, and both R¹ and R^{1′} are C₄-C₂₀ cyclic tertiary alkyls.

11. The process of claim 1, wherein M is Zr or Hf, Q is nitrogen, both A¹ and A^{1′} are carbon, both E and E′ are oxygen, and both R¹ and R^{1′} are adamantan-1-yl or substituted adamantan-1-yl.

12.-13. (canceled)

14. The process of claim 1, wherein Q is carbon, A¹ and A^{1′} are both nitrogen, and both E and E′ are oxygen.

15. The process of claim 1, wherein Q is carbon, A¹ is nitrogen, A^{1′} is C(R²²), and both E and E′ are oxygen, where R²² is selected from hydrogen, C₁-C₂₀ hydrocarbyl, C₁-C₂₀ substituted hydrocarbyl.

16. The process of claim 1, wherein the heterocyclic Lewis base is selected from the groups represented by the following formulas: 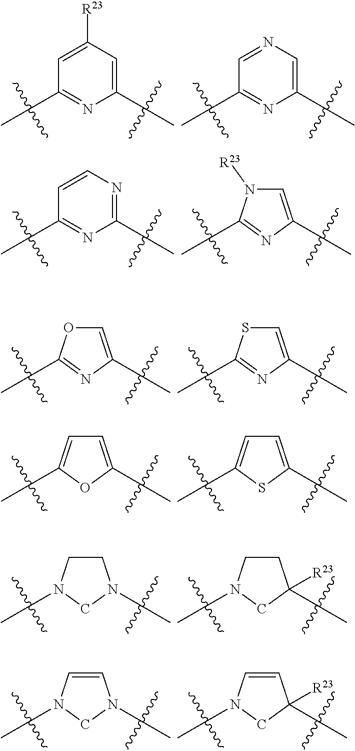
where each R²³ is independently selected from hydrogen, C₁-C₂₀ alkyls, and C₁-C₂₀ substituted alkyls.

17.-22. (canceled)

23. The process of claim 1 wherein the catalyst compound is represented by one or more of the following formulas:

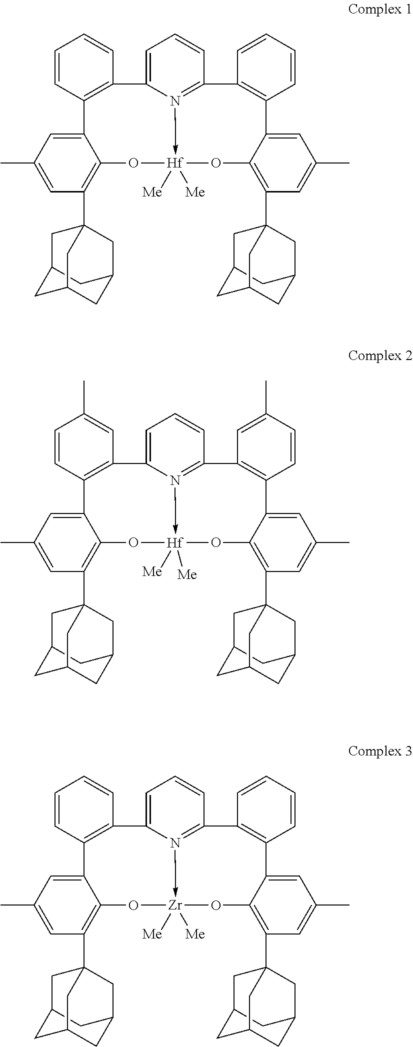

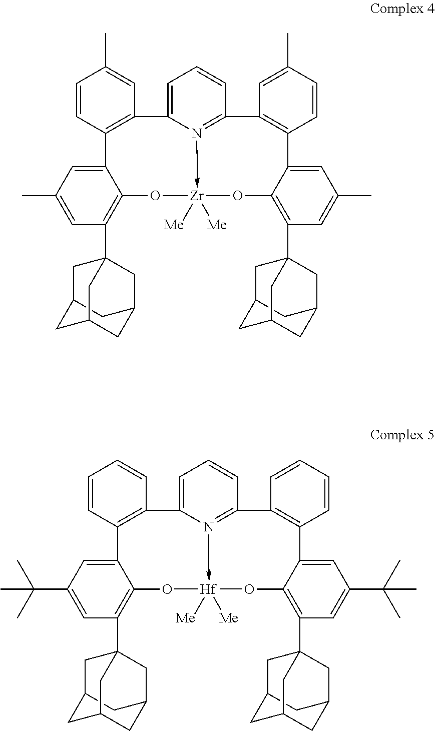

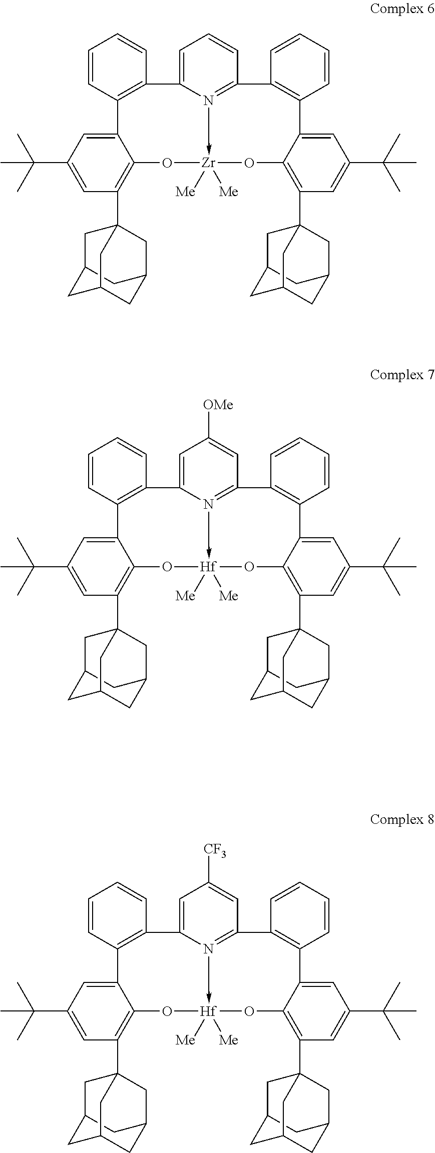

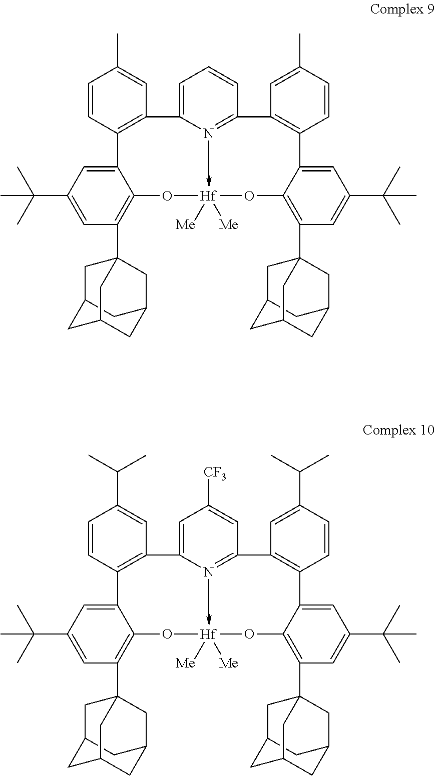

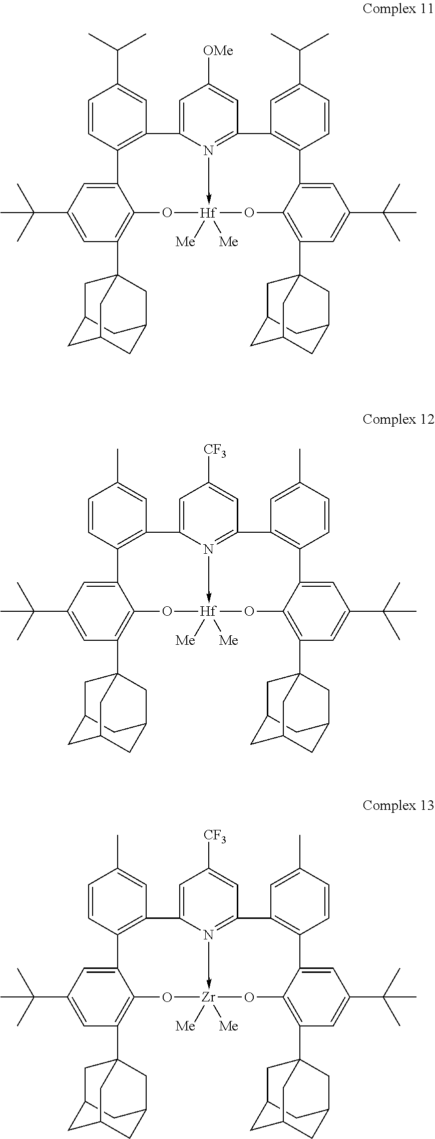

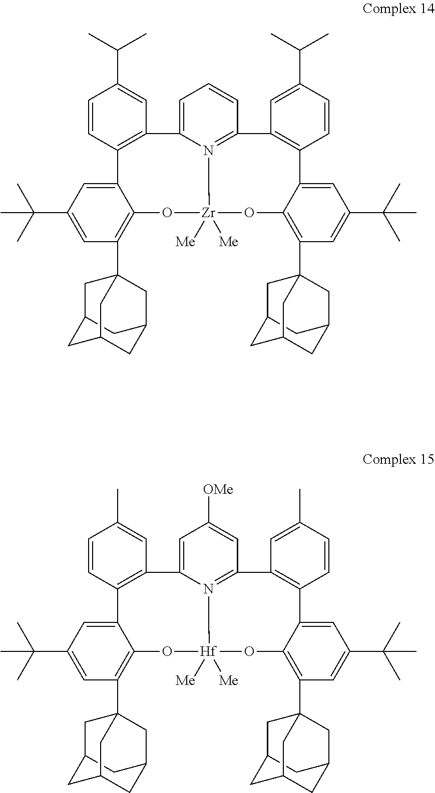

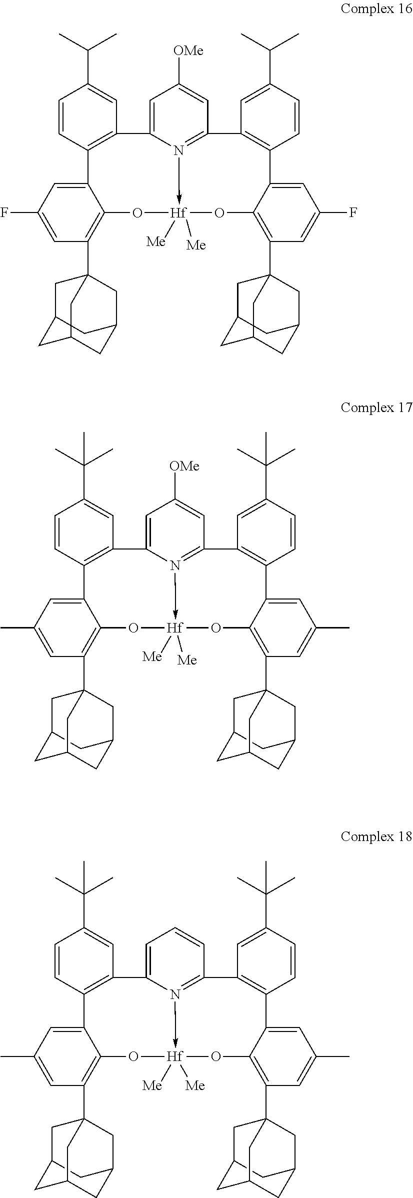

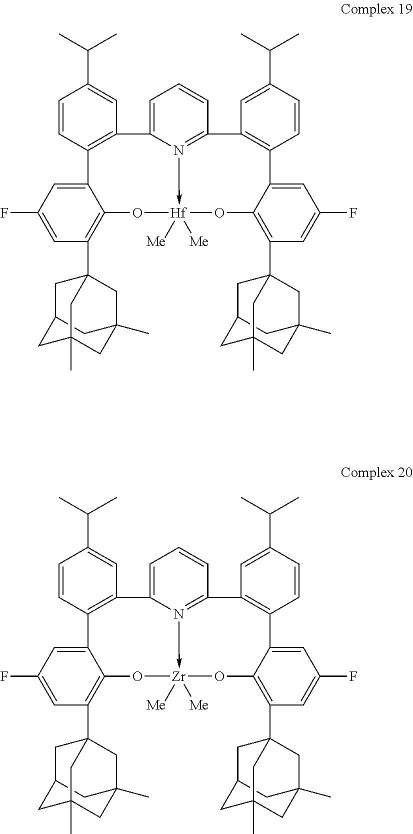

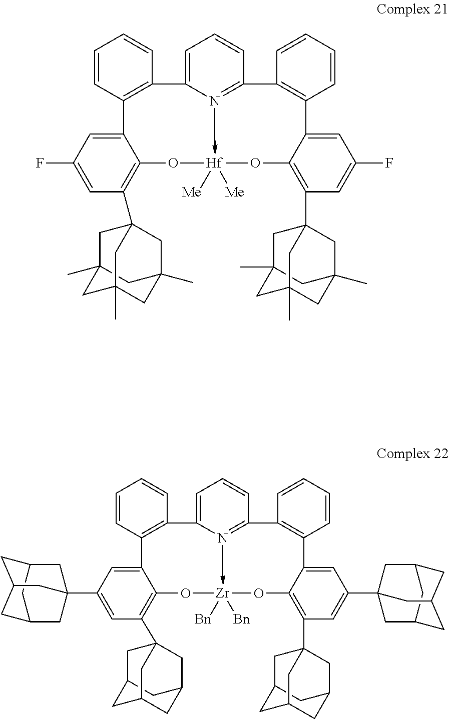

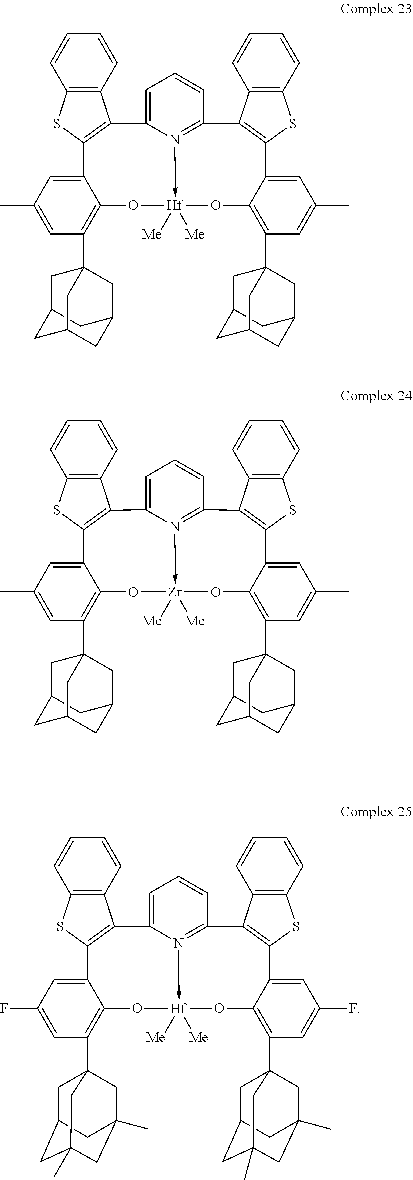

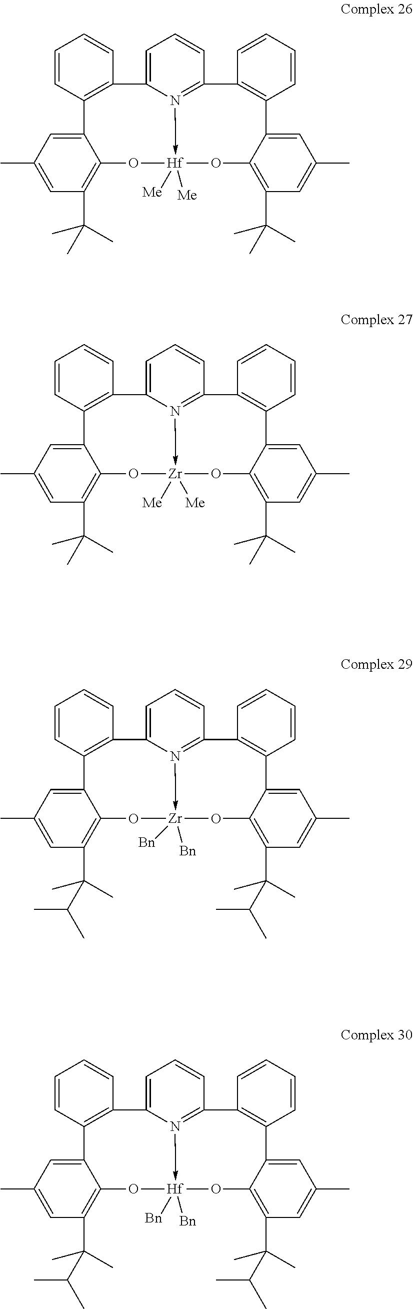

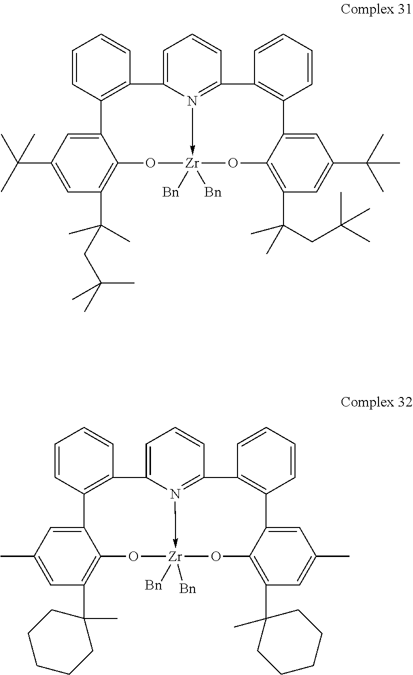

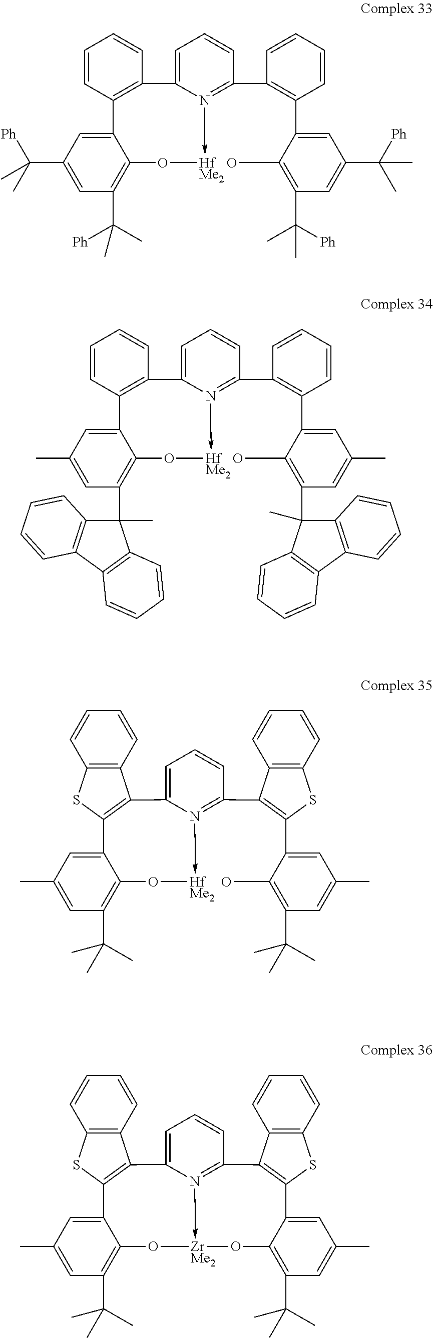

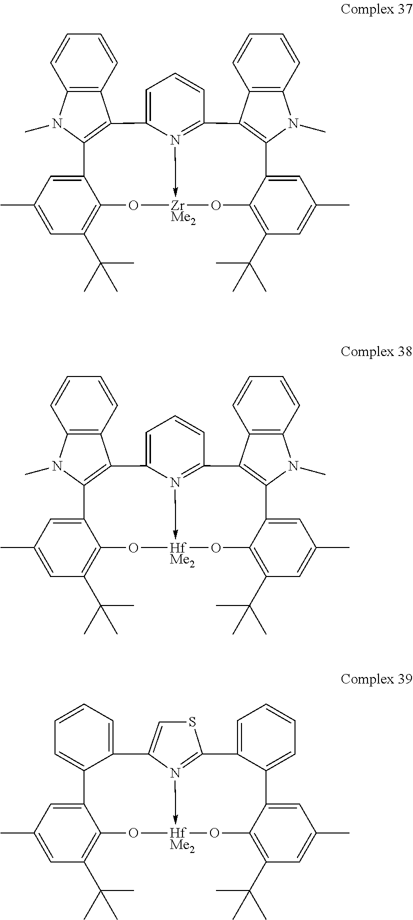

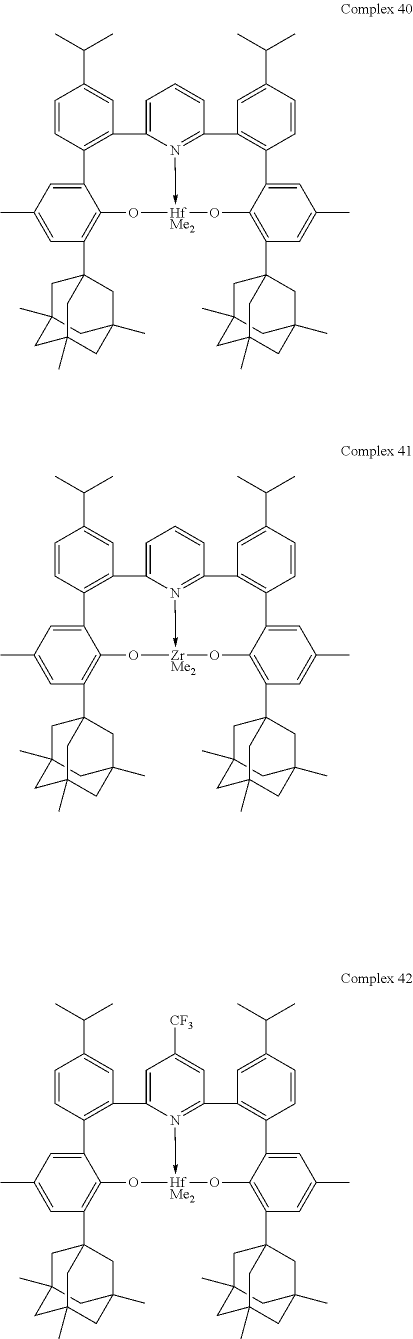

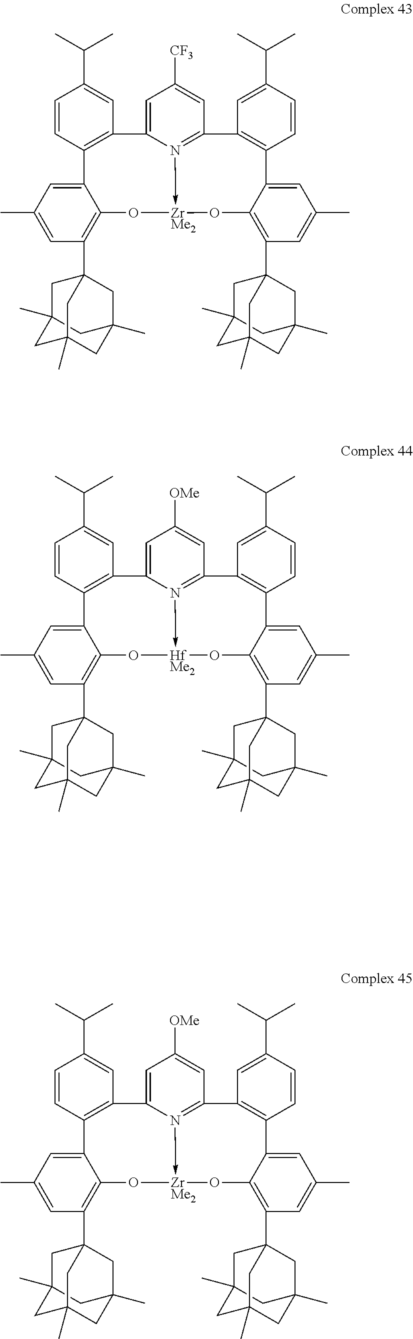

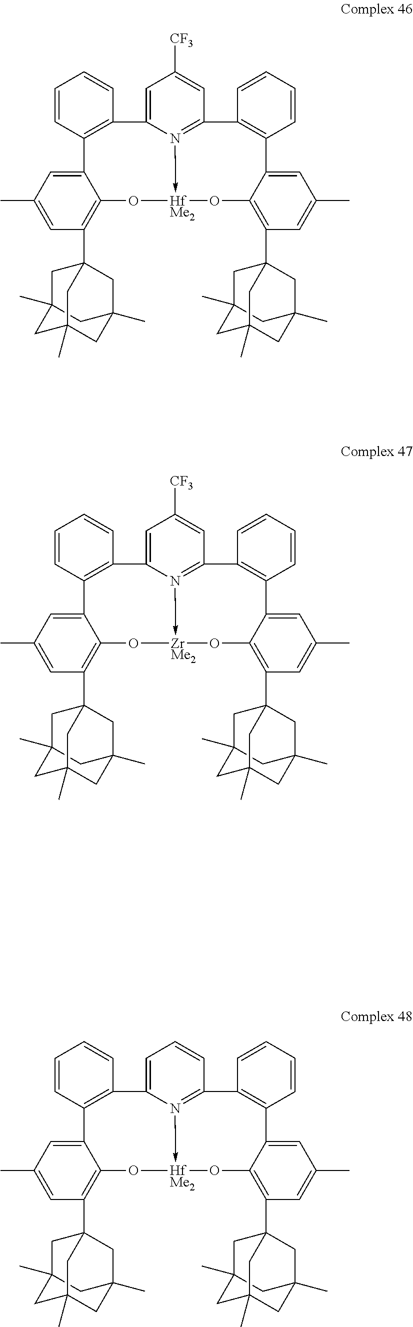

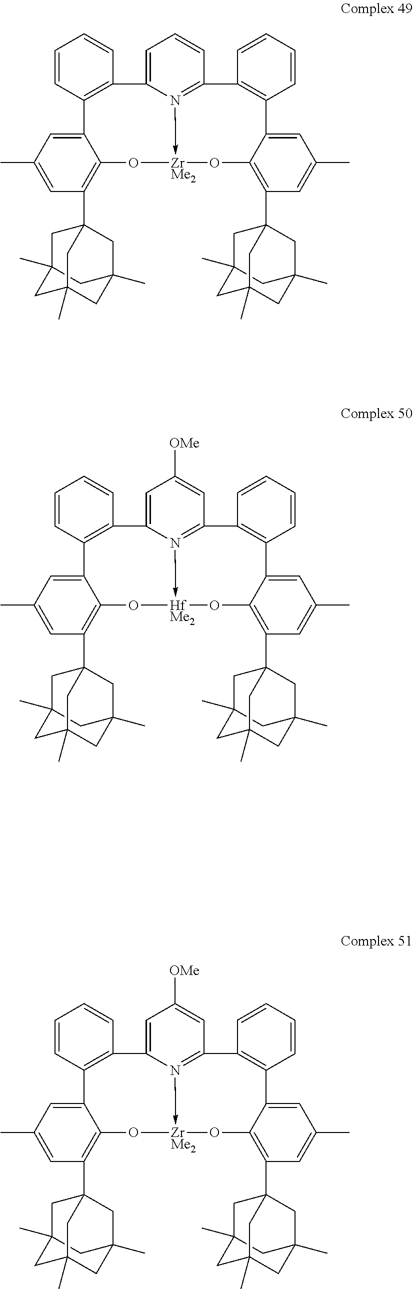

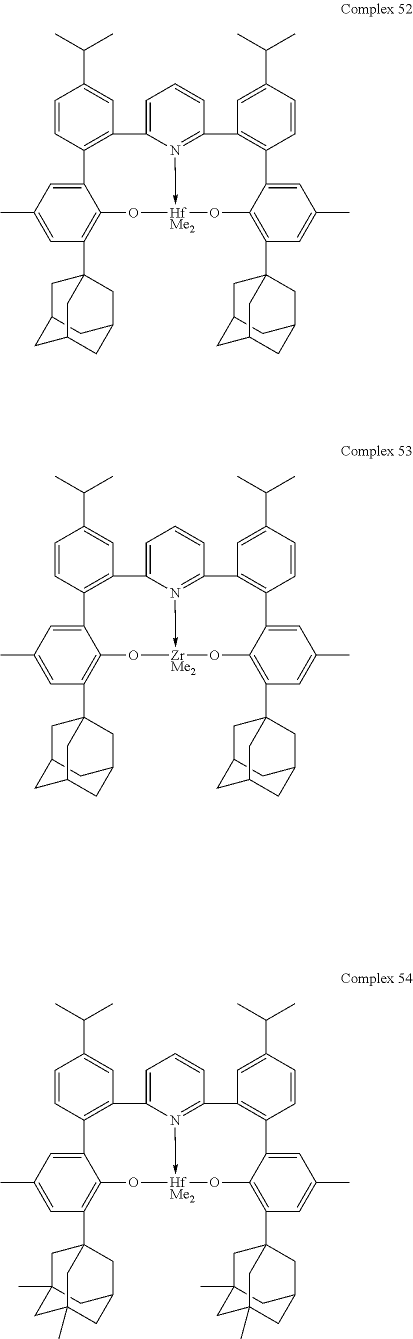

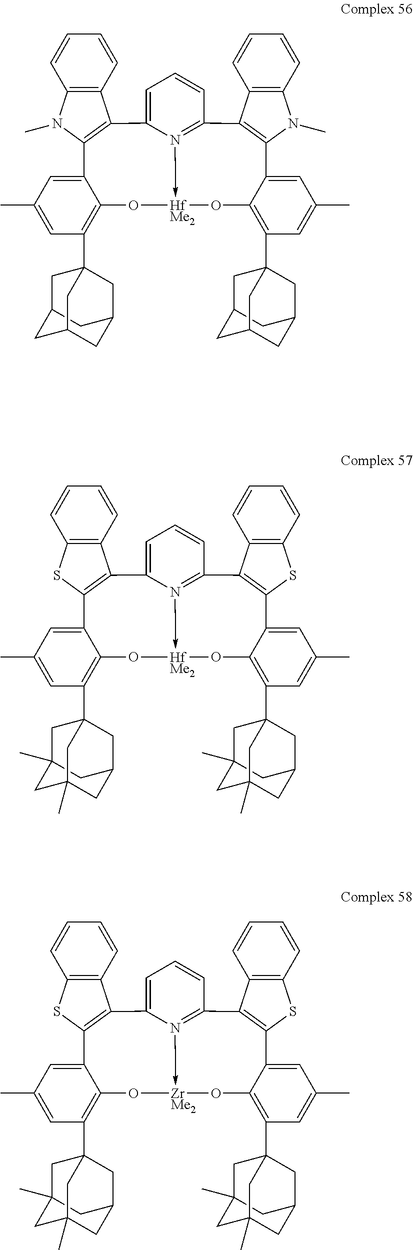

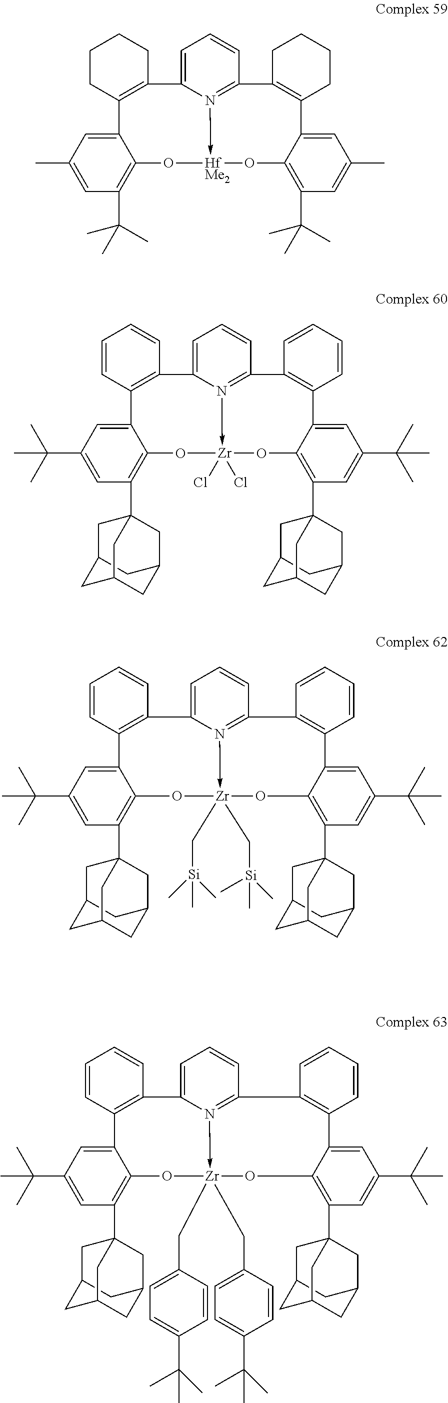

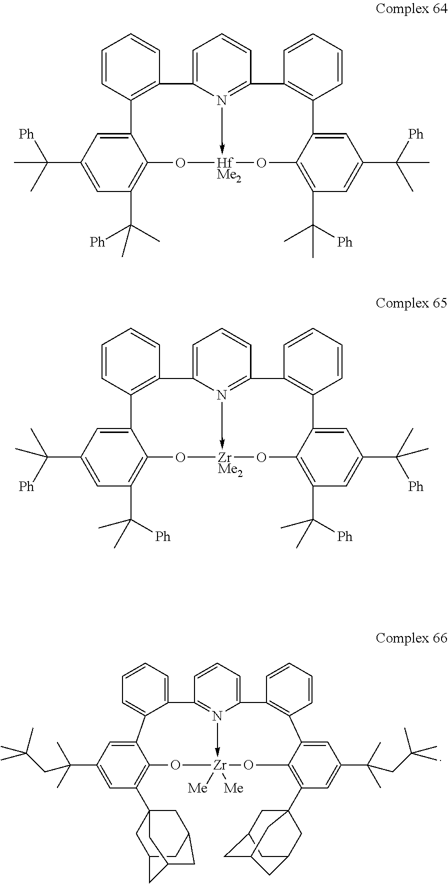

24.-31. (canceled)

32. The process of claim 1, wherein the process is a solution process.

33.-34. (canceled)

35. The process of claim 1 further comprising obtaining propylene polymer comprising at least 55 mol % propylene.

36. The process of claim 35 wherein the propylene polymer is isotactic and has a mmmm pentad tacticity index of 75% or greater.

37. The process of claim 35 wherein the polymer has a Tm of 150° C. or greater as measured by DSC, alternately greater that 155° C.

38. The process of claim 35 wherein the polymer has a Mw of 50,000 g/mol or greater (as measured by GPC-DRI, relative to linear polystyrene standards).

39. The process of claim 35 wherein the polymer has less than 200 total regio defects/10,000 monomer units and greater than 1 total regio defects/10,000 monomer units as measured by ¹³C-NMR spectroscopy.

40. (canceled)

41. The process of claim 35 wherein the polymer has a percentage of total regio defects less than 40%.

42. (canceled)

43. The process of claim 35 wherein the polymer has greater than 0.05 unsaturated end-groups per 1,000 C as determined by ¹H NMR.

44. The process of claim 35 wherein the polymer has 1) a Mw (GPC-DRI, relative to linear polystyrene standards) less than (10⁻⁸)(e^{0.1962z}) where z is the Tm (° C.) of the polymer as measured by DSC (2^{nd} melt), and 2) a Mw greater than (2×10⁻¹⁶)(e^{0.2956x}) where x is the Tm of the polymer as measured by DSC (2^{nd} melt), and 3) wherein the Tm of the polymer is 155° C. or greater.

45. The process of claim 35 wherein the polymer is a propylene-alpha-olefin copolymer wherein the alpha-olefin is a C₄-C₂₀ alpha olefin and wherein the propylene-alpha-olefin copolymer contains as 20 mol % propylene or greater, with the lower limit of C₄-C₂₀ alpha-olefin being 1 mol %.

46.-47. (canceled)

48. An isotactic polypropylene polymer
1) Tm of 155° C. or greater as measured by DSC (2^{nd} melt),
2) a mmmm pentad tacticity index of 90% or greater,
3) a Mw of 50,000 g/mol or greater (as measured by GPC-DRI, relative to linear polystyrene standards),
4) less than 35 total regio defects/10,000 monomer units and greater than 1 total regio defects/10,000 monomer units as measured by ¹³C-NMR.

49. The polymer of claim 48 wherein the polymer has less than 5 1,3-regio defects/10,000 monomer units as measured by ¹³C-NMR.

50. The polymer of claim 48 wherein the polymer has a percentage of total regio defects less than 30%.

51. The polymer of claim 48 wherein the polymer has 1) total regio defects/10,000 monomer units of less than −1.18×Tm+210, and 2) wherein the total regio defects is not less than 3 total regio defects/10,000 monomer units.

52. The polymer of claim 48 wherein the polymer has greater than 0.05 unsaturated end-groups per 1000 C as determined by ¹H NMR.

53. The polymer of claim 48 wherein the polymer has 1) a Mw (GPC-DRI, relative to linear polystyrene standards) less than (10⁻⁸)(e^{0.1962x})^{z} where z is the Tm (° C.) of the polymer as measured by DSC (2^{nd} melt) and 2) a Mw greater than (2×10⁻¹⁶)(e^{0.2956z}) where z is the Tm of the polymer as measured by DSC (2^{nd} melt), and 3) wherein the Tm of the polymer is 155° C. or greater.

54.-56. (canceled)

57. An isotactic crystalline propylene polymer produced in a process comprising contacting in a homogeneous phase, propylene with a catalyst system comprising activator and a transition metal catalyst complex of a dianionic, tridentate ligand that features a central neutral heterocyclic Lewis base and two phenolate donors, where the tridentate ligand coordinates to the metal center to form two eight-membered rings.

58. The polymer of claim 57 wherein the polymer has a melting point of 120° C. or higher.

59. The polymer of claim 57 wherein the polymer has a mmmm pentad tacticity index of 70% or greater.

60.-66. (canceled)

67. The process of claim 1, wherein the propylene copolymer has a heat of fusion of greater than 100 J/g, preferably greater than 110 J/g.

68. An isotactic crystalline propylene polymer produced by a polymerization process comprising contacting in a homogeneous phase propylene with a catalyst system comprising an activator and a group 4 bis(phenolate) catalyst compound, wherein the polymerization process takes place at a temperature of 90° C. or higher, to produce a polymer with the following characteristics:
i) a Mw (GPC-DRI, relative to linear polystyrene standards) less than (10⁻⁸) (e^{0.1962z}) where z is the Tₘ (° C.) of the polymer as measured by DSC (2nd melt);
ii) a Mw (GPC-DRI, relative to linear polystyrene standards) greater than (2×10⁻¹⁶)(e^{0.2956z}) where z is the Tm (° C.) of the polymer as measured by DSC (2^{nd} melt).

69. The polymer of claim 68 wherein the Tₘ is 160° C. or greater.

70. The polymer of claim 68 wherein the Mw is 100,000 g/mol or greater.

71. The polymer of claim 68 wherein the mmmm pentad tacticity index of 95% or greater.
